(19) United States
(12) Patent Application Publication
(10) Pub. No.: US 2026/0069910 A1
(43) Pub. Date: Mar. 12, 2026

(54) ENVIRONMENTALLY-CLEAN WATER-BASED FIRE INHIBITING BIOCHEMICAL SOLUTIONS AND METHODS OF AND APPARATUS FOR APPLYING THE SAME TO PROTECT PROPERTY AGAINST WILDFIRE

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 19/212,477

(22) Filed: May 19, 2025

Related U.S. Application Data
(63) Continuation-in-part of application No. 18/669,077, filed on May 20, 2024.
Application No. 18/669,077 is a continuation-in-part of application No. 18/496,862, filed on Oct. 28, 2023.
Application No. 18/496,862 is a continuation of application No. 17/167,084, filed on Feb. 4, 2021, now Pat. No. 11,865,390.
(63) Continuation-in-part of application No. 18/496,896, filed on Oct. 29, 2023.
Application No. 18/496,896 is a continuation of application No. 17/233,961, filed on Apr. 19, 2021, now Pat. No. 11,236,972.
(63) Continuation-in-part of application No. 18/423,274, filed on Jan. 25, 2024.
Application No. 18/423,274 is a continuation of application No. 17/591,592, filed on Feb. 2, 2022, now Pat. No. 11,911,643.
(63) Continuation-in-part of application No. 18/329,979, filed on Jun. 6, 2023.
(63) Continuation-in-part of application No. 18/420,717, filed on Jan. 23, 2024.
(63) Continuation-in-part of application No. 19/082,106, filed on Mar. 17, 2025.
(63) Continuation-in-part of application No. 18/964,428, filed on Nov. 30, 2024.

(51) Int. Cl. A62D 1/00; A62C 3/02; A62C 27/00; C09K 21/02

(52) U.S. Cl. CPC A62D 1/0035; A62C 3/02; C09K 21/02; A62C 3/0242; A62C 3/0271; A62C 27/00; A62D 1/005

(57) ABSTRACT

Environmentally-clean wildfire inhibitor liquid biochemical solutions produced from an aqueous mixture of alkali metal salt derived from a non-polymerized saturated carboxylic acid, and dissolved in water along with a dispersing and coalescing agent, realized as an ester of a non-polymerized saturated carboxylic acid, and dissolved in the water to provide a liquid fire inhibitor solution that can be sprayed on combustible surfaces to form thin alkali metal salt crystalline coatings on the combustible surfaces when and as water molecules in the liquid fire inhibitor evaporate to the environment during drying operations, to inhibit fire ignition, flame spread and smoke development.

### RELATED CASES

The present patent application is a Continuation-in-Part of: co-pending U.S. patent application Ser. No. 18/669,077 filed May 20, 2024, which is a Continuation-in-Part of copending U.S. patent application Ser. No. 18/496,862 filed Oct. 28, 2023, which is a Continuation of U.S. patent application Ser. No. 17/167,084 filed Feb. 4, 2021, now U.S. Pat. No. 11,865,390 issued on Jan. 9, 2024; co-pending U.S. patent application Ser. No. 18/496,896 filed Oct. 29, 2023, which is Continuation of U.S. patent application Ser. No. 17/233,461 filed Apr. 17, 2021, now U.S. Pat. No. 11,865,394 issued on Jan. 9, 2024; co-pending U.S. patent application Ser. No. 18/423,274 filed Jan. 25, 2024, which is a Continuation of U.S. patent Ser. No. 17/951,592 filed Feb. 2, 2022, now U.S. Pat. No. 11,911,643 issued on Feb. 27, 2024; co-pending U.S. patent application Ser. No. 18/329,979 filed Jun. 6, 2023; co-pending U.S. patent application Ser. No. 18/420,717 filed Jan. 23, 2024; co-pending U.S. patent application Ser. No. 19/082,106 filed Mar. 17, 2025; and co-pending U.S. patent application Ser. No. 18/964,428 filed Nov. 30, 2024; and co-pending U.S. patent application Ser. No. 18/814,508 filed Aug. 24, 2024; wherein each said US patent application is commonly owned by Mighty Fire Breaker LLC and incorporated herein by reference as if fully set forth herein.

### BACKGROUND OF INVENTION

### Field of Invention

The present invention is directed towards improvements in science and technology applied in the defense of human and animal life and property, against the ravaging and destructive forces of fire caused by lightning, accident, arson, and terrorism.

### Brief Description of the State of Knowledge in the Art

Throughout the ages, mankind has had a complex relationship with fire. On one hand, mankind has feared fire for its power to damage and destroy property and life during warfare and acts of terrorism. On the other hand, mankind has worshipped before fire giving thanks to the power of fire to generate heat energy to keep us warm, cook foods to provide nourishment, make medicines to heal, make tools to abridge labor, and power machines to do physical work. Thus, there has been a great need to discover new and improved ways of controlling the ignition and spread of fire, and prevent the accidental and intentional damage and destruction of property and life by fire.

While most fear the thought of wildfire raging in a forest, in modern times, there is general agreement throughout the forest management industry that wildfires have positive ecological and environmental functions when they occur deep in the forests, far away from human inhabitants and human society at large. However, when wildfires rage close to where people are living and working in towns and communities, there is strong agreement that such wildfires need to be brought under quick control and containment to minimize the risk of damage to property and lives, and mitigate the production of air, water and other forms of environmental pollution caused by wildfires.

Unfortunately, over the past century, tens of millions of people have developed and settled towns, counties and neighborhoods in regions that today are called the Wildfire Urban Interface (WUI), which are at high risk to wildfires, and this is impacting home owners and property insurance industry. For man to live and survive a sustainable future in the urban-wildfire interface, human society must quickly adapt to survive the destructive effects of wildfires.

Currently, conventional methods of wildfire fighting defense are proving inadequate because demographics have changed where people live and work relative to presence of wildfire:
Making firebreaks with bulldozers and shovels have not viable in most urbanized communities;
Making firebreaks with backfires provide ineffective and often dangerous as wildfires themselves;
Dropping PhosChek® AMP from 5000 Feet in urban areas is dangerous and not viable or effective in wildfire defense;
Thinning forests of dead trees and debris is effective in urban regions, especially near power poles, buildings, and structures.

Current methods of wildfire defense and fighting are becoming unsustainable because the financial losses due to wildfire are exceeding what the insurance industry is willing to insure, as the damage caused by wildfire to the environment is typically catastrophic and destruction.

FIG. 1 provides a table summarizing the primary conventional methods currently being used when fighting and defending against wild fires and forest fires, alike: aerial water dropping illustrated in FIG. 2A; aerial fire retardant chemical (e.g. PhosChek® Fire Retardant) dropping illustrated in FIGS. 2B1, 2B2 and 2B3; physical fire break by bulldozing, to stall the advance of wild fire; physical fire break by pre-burning, to stall the advance of wild fire; and chemical fire breaks by dropping fire retardant chemical such as PhosChek® chemical over land, to stall the advance of wild fire. While these methods are used, the results have not been adequate in most instances where wild fires rage across land under strong winds.

Except for spraying fire-retardant foams and gels, all the methods described above are generally “reactive” in nature, because they are either applied or practiced in response to the presence or incidence of wildfire, in effort to suppress and extinguish the wildfire, rather than proactively inhibiting wildfire from igniting combustible material along a wildfire's tracks moving in the direction of prevailing winds. Consequently, Phoschek® water airdrops are generally reactive methods, because these methods are applied too often when it's too late to suppress and extinguish a wildfire, and at best, airdropping this water-based fire retardant generates enormous quantities of smoke and noxious ammonia gases as well. Also, Phoschek® airdrops are very risky when applied to wildfires raging in wildfire urban interface (WUI) regions where people are living and working, because airdrops involve many tons of water falling to earth at high speed and with great force. This is little surprise when one understands the composition of this phosphorous-based chemical blended with tons of water.

### Composition of Phoschek™ Fire Retardant: MAP, DAP, Gum Thickener & Coloring Agent

PhosChek® MVP-F is a dry concentrate formulation that uses a combination of monoammonium phosphate [MAP; NH4H2PO4] and diammonium phosphate [DAP; (NH4)2HPO4] as the fire-retardant salts. PhosChek® MVP-F fire retardant also contains a gum thickener to provide a medium viscosity product for improved drop characteristics. The formulation contains a coloring agent having an alarming red color. The color fades over time with exposure to sunlight. A quick look at the chemical composition of the MAP and DAP components of PhosChek® fire retardant will be illuminating.

Monoammonium phosphate (MAP) is soluble in water and crystallizes as the anhydrous salt in the tetragonal system, as elongated prisms, or needles. It is practically insoluble in ethanol. Solid monoammonium phosphate (MAP) can be considered stable in practice for temperatures up to 200° C., when it decomposes into gaseous ammonia NH3 and molten phosphoric acid H3PO4. At 125° C. the partial pressure of ammonia is 0.05 mm Hg. A solution of stoichiometric monoammonium phosphate is acidic (pH 4.7 at 0.1% concentration, 4.2 at 5%).

According to the diammonium phosphate MSDS from CF Industries, Inc., decomposition starts as low as 70° C. “Hazardous Decomposition Products: Gradually loses ammonia when exposed to air at room temperature. Decomposes to ammonia and monoammonium phosphate at around 70° C. (158° F.). At 155° C. (311° F.), DAP emits phosphorus oxides, nitrogen oxides and ammonia.”

When airdropped from planes, the gum thickener contained in PhosChek® fire retardant binds MAP and DAP to water to provide mass and help drop the water onto the raging wildfire in effort to extinguish it. When airdropping, most firefighters understand that they have lost control of the wildfire, and that the target wildfire is destined to rage across property populated with buildings structures including homes, then Phoschek® airdrops are made on targeted property of home owners and towns—which can be observed by the red-colored Phoschek® fire retardant coating all over ground surfaces, in effort to protect the targeted property against wildfire.

Many photographs are posted on the WWW showing the airdropping of Phoschek® fire retardant from airplanes. However, these firefighting operations should be viewed as a last-ditch effort to save property and lives from a raging wildfire.

Airdropping Phoschek® infused water over wildfires is not a proactive measure of any sort, and it's often too late, too expensive, and too in-effective to be continued as a best practice to contain and subdue wildfires raging across the WUI regions of America.

Also, the use of water-based phosphorous-rich fire retardants, and pick & shovel and bulldozer methods for defending against wildfires, does not represent technological advancement, progress and firefighter and environmental safety, within the rapidly expanding wildfire urban interface (WUI) regions of America and around the world. The world must do significantly better in response to the growing threat of climate-change driven wildfires, mixed with the challenges of a viral pandemic.

### Smoke-Induced Asthma is Now Presenting a Great Health Risk to Wildfire Fighters and Citizens Alike

This past year, the Centers for Disease Control and Prevention (CDC) stated “when wildfires burn either in your area or many miles away, they produce smoke that may reach your community. Wildfire smoke is a mixture of gases and fine particles from burning trees and other plant materials. This smoke can hurt your eyes, irritate your respiratory system, and worsen chronic heart and lung diseases.”

Also, Asthma and Allergy Foundation of America (AAFA) stated that “each year, wildfires rage across the U.S. producing smoke in the air containing tiny particles that affect air quality. These particles can irritate your eyes, nose, throat, and lungs. Poor air quality can worsen asthma symptoms. Children and those with respiratory disease like asthma are at high risk for asthma episodes when the air quality is poor Wildfires do not only affect those in the immediate fire area. Smoke can blow many miles away and impact people hundreds of miles away.”

The American Lung Organization stated that “wildfires, including grassland fires and forest fires, are an ongoing concern where there is dry, hot weather. During a wildfire, people throughout the surrounding area may suffer the effects of the smoke. Talk with your doctor about how to prepare for this smoke, especially if you or someone in the family fits into one of these categories: works outdoors; is under age 18 or over age 65; or has asthma, COPD or other lung diseases, chronic heart disease, or diabetes. Monitor your breathing and exposure to the smoke.”

Clearly, the message from these health and health policy organizations is to “protect yourself from wildfire smoke”, and that includes those wildfire fighters trying to contain and suppress raging wildfires across the WUI regions across our Nation. Also, it is well known that, in high doses, irritants, such hydrochloric acid, sulfur dioxide and ammonia, will induce occupational asthma, and this is something that wildfire fighters should be thinking about as well. On this point, it should be noted that Phoschek® fire retardant, when used to fight against raging forest fires rapidly decomposes at 200 C into gaseous ammonia NH3 and molten phosphoric acid H3PO4. Thus, when such phosphorous agents are dropped onto wildfires, in effort to suppress or quell wildfire, decomposition into gaseous ammonia will only increase the toxic effects of smoke production from wildfires.

It is no secret that individuals with asthma are at substantially higher risks when exposed or infected by the Covid-19 virus. For those with asthma, there is great fear that they will have a worse outcome or be more likely to get SARS-CoV-2 (the virus that causes COVID-19). While there is currently no evidence of increased infection rates in those with asthma, the Centers for Disease Control and Prevention has stated that patients with moderate-severe asthma could be at greater risk for more severe disease.

In the May 6, 2020, NY Times article “Will Smoke From Controlled Burns Hurt Covid-19 Patients?”, Cal Fire spokesman, Scott McLean, said “What is Covid-19? A respiratory issue”. And then continued by stating “We're not naïve to that, but we have to provide for the well-being of the public.” The NY Times article also reported that “Forest Service officials said they were concerned that assembling a work force to conduct the burns would expose traveling employees to the virus and potentially contribute to its spread. They also raised doubts about how their fire crews could tend to burn while also abiding by social distancing directives. They said they would continue to use other methods —such as removing brush by hand and with heavy machinery that reduce combustible forest fuel without generating smoke.”

### Searching for Better Solutions to Fight Wildfires and Forest Firefires

U.S. Pat. No. 8,273,813 assigned to BASF Aktiengesellshaft provides a comprehensive overview of the state of the art in 2012, of worldwide efforts to develop and deliver chemical solutions for preventing and fighting wildfires and forest fires around the world.

As disclosed, firefighters have long utilized solutions of inorganic salts, for example, alkali metal or alkaline earth metal salts of carbonic acid, phosphoric acid, or boric acid. The salts augment the extinguishing action of water and are used as concentrated solutions. These salts are effective because they release inert gases, for example carbon dioxide from carbonates, or melt and so form an air-impervious layer on combustible materials. In either case, access of air to combustible material is controlled. The disadvantage with this approach is the formation of a coating which is later difficult to remove. They have no cooling effect and are barely able to extinguish burning matter, since the latter, like water as well, runs off very rapidly. Any protective effect is solely due to preceding and repeated spraying of objects. A salt solution does not adhere to smooth or waxy objects, such as leaves, planks, or glass panes, to any significant extent, if at all.

The use of salts of organic carboxylic acids, for example oxalic acid, tartaric acid, or citric acid, in firefighting has been known since the 1970s. In contradistinction to inorganic salts mentioned above, the coatings formed from the salts of organic carboxylic acids are easy to remove after the fire has been extinguished. Examples of the use of salts of organic carboxylic acids in firefighting are identified in the following patent documents: DE-C 13 02 520, DE-A 35 25 684, EP-A 059 178, EP-A 426 178, U.S. Pat. Nos. 1,278,718, 4,888,136, 5,945,025, and WO 88/00482. A brief overview of these prior art references will be useful at this juncture.

DE-C 13 02 520 discloses the use of alkali metal salts of oxy carboxylic acids in dry extinguishing powders.

DE-A 35 25 684 describes solutions consisting of citric acid/citrate, potassium hydroxide and water that are useful for firefighting and for impregnating combustible materials. More particularly, the solution is said to be capable of binding acidic gases generated in a fire.

EP-A 059 178 describes the use of concentrated solutions of alkali metal salts of citric acid as extinguishing compositions.

EP-A 426 178 discloses fire-retardant asphalt compositions, the fire-retarding component comprising potassium citrate and a silicone polymer.

U.S. Pat. No. 1,278,718 discloses compositions consisting of concentrated solutions of alkali metal salt of citric acid and alkali metal bicarbonate, as filling for fire extinguishers.

U.S. Pat. No. 4,888,136 describes the use of aluminum salts of citric acid and of lactic acid for fire-retarding impregnations of cellulosic fibers.

U.S. Pat. No. 5,945,025 describes compositions of potassium citrate and sodium bicarbonate for firefighting.

WO 88/00482 discloses compositions of matter for firefighting and for producing fire-retarding coatings based on alkali metal salts of citric acid.

The compositions mentioned above can be applied as aqueous solutions and retain their fire-retarding effect even after drying, and therefore, have a pronounced long-term effect.

The use of hydrogels was proposed more than 35 years, for example in U.S. Pat. Nos. 3,229,769 and 5,849,210, for the purpose of cooling the source of the fire by retaining water close to the flame. These hydrogels are produced from a water-absorbing polymer and water. The hydrogel binds the water and so stops the water from flowing away from the source of the fire. Because hydrogels can maintain a large amount of water near the fire, hydrogels have a good immediate extinguishing effect. In contrast, the long-term effect of hydrogels is poor. Hydrogels can dry and thereby rapidly lose their effect. The remaining salt-like dried hydrogels have a very low fire-retarding effect.

U.S. Pat. No. 8,273,813 (assigned to BASF) proposed combining water-absorbing polymers with fire-retarding salts to form fire-retarding compositions having a good immediate extinguishing effect and a good long-term effect. This fire retarding chemical solution is schematically depicted in FIG. 3A.

As illustrated in FIG. 3B, Hartindo's aqueous-based anti-fire (AF) chemical solution AF31 employs as its active ingredient, Potassium Citrate, or TPC, dissolved in water, with minor amounts of a natural gum added to provide some cling. Tripotassium citrate (TPC) is considered Generally Recognized As Safe or “GRAS” by the United States Food and Drug Administration without restriction as to the quantity of use within good manufacturing practice.

Hartidino's AF31 chemical solution has been used by others in many diverse applications, namely: (i) preventing and suppressing peat fires in Malaysia, as disclosed on Hartindo's WWW site, (ii) treating wood to provide Class-A fire-protection as taught in U.S. patent Ser. No. 10/260,232 (Conboy); and (iii) proactively treating native fuel, ground cover and fixtures and buildings on real property, for the purpose of defending life and property against the threat of wildfires, as taught in U.S. patent Ser. No. 10/653,904 assigned to Applicant/Assignee (M-Fire Holdings, LLC) employing new and innovative technologies for proactively-protecting property and life against wildfires in the WUI region. These technologies include the use of a cloud-based GPS-tracking/mapping wildfire defense system network designed to support many different methods of proactively spraying equipment for efficient GPS-tracking and mapping of environmentally-clean wildfire inhibitor spraying operations, within a secure global database, to manage the strategic creation and maintenance of clean-chemistry wildfire breaks, created out in front of and around property and life to be proactively protected from wildfires.

Applicant/Assignee's methods operate in stark contrast to conventional methods of reactively-fighting wildfires by air-dropping tons of PhosChek® containing agricultural-grade fertilizer onto raging wild fires while brave fire fighters manually create wildfire breaks using picks, shovels, and bulldozers, and are exposed to life threatening risks of fire, smoke, and COVID-19 viral infection. Notably, Applicant's wildfire defense methods include the use of: GPS-guided, tracking and mapping spray drones; GPS-tracking mobile/backpack sprayers; GPS-tracking vehicle-supported high-pressure sprayers; mobile computing devices; data centers; wireless networking infrastructure; and the like. Each of these GPS-tracking mobile spraying systems is deployed on and supported by the GPS-tracking/mapping wild fire defense network illustrated in U.S. Pat. No. 10,260,232.

Clearly, in these times of climate change and narrowing gaps between wildfire regions and urbanized areas, we must adapt to and defend against wildfires in new and better and smarter ways—that are more proactive and less reactive—because “an ounce of prevention is worth a pound of cure,” as Benjamin Franklin taught the world over back in the mid-1750's.

Thus, there needs to be better, safer, and more effective fire inhibiting chemical compositions, and methods and technology for applying the same to proactively defend property and life from wildfires in the rapidly expanding WUI region, and to do so, without creating risks of smoke and injury to firefighters, property owners, animals, and the human population at large, while overcoming the shortcomings and drawbacks of prior art compositions, apparatus, and methodologies.

### OBJECTS AND SUMMARY OF THE PRESENT INVENTION

Accordingly, a primary object of the present is to provide new and improved method of and system and network for managing the supply, delivery, and spray-application of safer and more effective environmentally-clean fire-inhibiting biochemically-based liquid compositions and solutions, on private and public properties to reduce the risks of damage and/or destruction to property and life caused by wild fires, while overcoming the shortcomings and drawbacks of prior art methods and apparatus.

Another object of the present invention is to provide new and improved environmentally-clean aqueous-based wildfire inhibiting biochemical compositions in liquid phase over a broad ambient working temperature range, that can be atomized and sprayed as a fine mist over ground surfaces, native ground fuel, living plants, trees and shrubs and being an effective wildfire inhibitor, when dried forming a durable gas pervious coating having improved surface coverage.

Another object of the present invention is to provide new and improved environmentally-clean aqueous-based wildfire inhibitor biochemical compositions in liquid phase over its wide ambient working temperature ranges and pressure conditions.

Another object of the present invention is to provide new and improved wildfire inhibiting liquid biochemical solutions that allows its active fire inhibiting chemistry (e.g. potassium mineral salts) to efficiently penetrate into the combustible surfaces of natural fuels during atomization spraying and quick drying operations, in effort to improve the duration of fire protection offered by potassium mineral salts contained in thin and ultra-thin fire-inhibiting alkali metal salt crystalline coatings, formed on combustible surfaces as and when water molecules in sprayed coatings evaporate to the environment during operations.

Another object of the present invention is to provide a new and improved family of environmentally-clean wildfire inhibitor liquid biochemical solutions comprising an aqueous mixture of (i) major amount of alkali metal salt derived from a non-polymerized saturated carboxylic acid characterized by having less than 8 carbon atoms, and dissolved in (ii) a major amount of water (H2O along with (iii) a minor amount of dispersing and coalescing agent, realized as an ester of a non-polymerized saturated carboxylic acid, and dissolved in the water, to provide a liquid fire inhibitor that can be sprayed on combustible surfaces to form thin alkali metal salt crystalline coatings on the combustible surfaces when and as water molecules in the liquid fire inhibitor evaporate to the environment during drying operations, to inhibit fire ignition, flame spread and smoke development.

Another object of the present invention is to provide a new and improved family of environmentally-clean fire inhibitor liquid biochemical solutions (i.e. compositions) for proactively fire-protecting combustible surfaces, comprising (i) a major amount of water, (ii) a major amount of metal alkali salt dissolved in the quantity of water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, 32 F to 130 F, and (iii) a minor amount of one or more esters dissolved in the water and derived from the saturated non-polymerized carboxylic acid and/or another saturated non-polymerized carboxylic acid, promoting dispersing and coalescing properties of metal alkali ions in the aqueous solution that promote the formation of thin alkali metal salt crystalline structures and coatings on combustible surfaces upon the evaporation of water molecules from applied aqueous solution.

Another object of the present invention is to provide such new and improved family of environmentally-clean fire inhibitor liquid biochemical solutions, wherein the liquid biochemical solutions can be applied to combustible surfaces to form thin alkali salt crystalline coatings over diverse temperature environments ranging from, for example, 32 F to 130 F, so as to provide alkali metal ions in the coatings that are free and available to inhibit fire ignition, flame spread and the production of smoke by interrupting free radical chain reactions driving the combustible phase of the fire, while supporting the transport of oxygen and carbon-dioxide gases across living plant tissue on leaves of trees, plants, flowers and grasses and other botanical lifeforms, without adversely affecting the vitality of the living plant tissue when said living plant tissue is sprayed with the fire inhibiting biochemical liquid composition.

Another object of the present invention is to provide the environmentally safest (i.e. greenest) fire inhibiting biochemical liquid solutions possible for use in forming, by spraying, thin alkali metal salt crystalline coatings on combustible surfaces to be protected against all sources of fire, including wildfire.

Another object of the present invention is to provide safe and effective environmentally-clean (bio)chemicals designed for use in proactive fire inhibition and/or active fire suppression applications.

Another object of the present invention is to provide, consistent with Applicant's U.S. Pat. No. 11,865,390, many additional families of environmentally-clean water-based fire inhibiting compositions/solutions designed for spray application on combustible surfaces, and air-drying to the ambient atmosphere, wherein each water-based composition is formed by (i) mixing a major amount of a metal alkali salt of a saturated non-polymerized carboxylic acid, that is dissolvable in a major amount of a water, and (ii) then mixing the solution with a minor amount of an ester derived from a saturated non-polymerized carboxylic acid carboxylic acid and/or another saturated non-polymerized carboxylic acid, promoting dispersing and coalescing properties of metal alkali ions in the aqueous solution that promote formation of thin alkali metal salt crystalline structures and coatings (i.e. alkali organo-metallic species) on combustible surfaces upon evaporation of water molecules from applied aqueous solution, and wherein the metal alkali atom is selected from the group consisting of (ecologically-friendly metals) including potassium, calcium, sodium and magnesium, and wherein the carbon chain length of the carboxylic acid is less than eight (C1-C7), and the resulting water-based liquid solution is stable when mixed and its chemical components do not precipitate in the aqueous solution when stored in a storage container, making the aqueous solution ready for use in diverse temperature environments (e.g. 120 F to 34 F).

Another object of the present invention is to provide biochemical compositions that are soluble in water, and safe and non-toxic to the environment and animal and plant life living in it.

Another object of the present invention is to provide different kinds of alkali metal salts for use in producing liquid fire inhibitor formulations.

Another object of the present invention is to provide new and improved liquid fire inhibitor formulations for forming thin fire inhibiting alkali metal salt crystalline coatings sprayed onto combustible surfaces, and produced from alkali metal salts derived from a carboxylic acid (R—COOH), selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

Another object of the present invention is to provide a new and improved environmentally-clean aqueous-based fire inhibiting biochemical composition, wherein the alkali metal salts of nonpolymeric saturated carboxylic acids for inclusion in the biochemical composition comprises: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide an environmentally-clean liquid fire inhibiting composition for spray application on combustible surfaces and air-drying to the ambient atmosphere, comprising: a water functioning as a solvent, dispersant and carrier; at least one alkali metal salt dissolved in the water, functioning as a fire inhibiting agent, and derived from a non-polymerized saturated carboxylic acid characterized by having carbon chain length of less than eight carbon atoms (C1-C7), wherein the alkali metal contained in said alkali metal salt is selected from the group consisting of potassium, calcium, sodium and/or magnesium; and a dispersing and coalescing agent, dissolved in the water and derived from said saturated non-polymerized carboxylic acid and/or another saturated non-polymerized carboxylic acid, and functioning to promote (i) the dispersing and coalescing properties of alkali metal ions present in the resulting aqueous solution when applied to combustible surfaces, and (ii) the formation of thin alkali metal salt crystalline structures and coatings on the combustible surfaces upon evaporation of water molecules from the applied aqueous solution; wherein the thin alkali metal salt crystalline coatings formed on the combustible surfaces contain alkali metal ions that inhibit fire ignition, flame spread and production of smoke.

Another object of the present invention is to provide such an environmentally-clean liquid fire inhibiting composition, wherein the water is present in a major amount having a weight percent of about 60.00% to about 90.00% relative to the total weight of the liquid fire inhibiting biochemical composition; wherein said at least one alkali metal salt is present in a major amount having a weight percent of about 10.00% to about 40.00% relative to the total weight of the liquid fire inhibiting composition; wherein said dispersing and coalescing agent is present in a minor amount having a weight percent of about 0.50% to about 5.00% relative to the total weight of the liquid fire inhibiting composition; and wherein the sum of the weight percent of the chemical components in the liquid fire inhibiting composition does not exceed 100% by weight.

Another object of the present invention is to provide such an environmentally-clean liquid fire inhibiting composition, wherein the low viscosity of the resulting aqueous solution is in the range of at about 5.0 [mPas] (or 5.0 centipois) [cps]), and preferably not more than 50.0 [mPas] (or 50.0 centipois) [cps]), when uses in diverse temperature environments ranging from as low as 32 F to as high as 130 F, so as to facilitate use of spray-atomization methods to apply said environmentally-clean liquid fire inhibiting composition on combustible surface, and form said thin alkali metal salt crystalline structures and coatings on the combustible surfaces upon evaporation of water molecules from the applied aqueous solution, wherein the thin alkali metal salt crystalline coatings formed on the combustible surfaces contain alkali metal ions that inhibit fire ignition, flame spread and production of smoke.

Another object of the present invention is to provide such an environmentally-clean liquid fire inhibiting composition, wherein said at least one alkali metal salt is derived from the non-polymeric saturated carboxylic acid (R—COOH) selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

Another object of the present invention is to provide such an environmentally-clean liquid fire inhibiting composition, wherein the said at least one alkali metal salt is selected from the group consisting of: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Another object of the present invention is to provide such an environmentally-clean liquid fire inhibiting composition, wherein said at least one alkali metal salt is derived from the C1 carboxylic acid (R—COOH), called formic acid (i.e. methanoic acid), and selected from the group consisting of: potassium formate; calcium formate; sodium formate; and magnesium formate.

Another object of the present invention is to provide such an environmentally-clean liquid fire inhibiting composition, wherein said at least one alkali metal salt is derived from the C1 carboxylic acid (R—COOH), carbonic acid (i.e. hydroxymethanoic acid), and selected from the group consisting of: potassium carbonate; sodium bicarbonate; and magnesium carbonate.

Another object of the present invention is to provide such an environmentally-clean liquid fire inhibiting composition, wherein said at least one alkali metal salt is derived from the C2 carboxylic acid (R—COOH), called acetic acid (ethanoic acid), and selected from the group consisting of: potassium acetate; calcium acetate; sodium acetate; and magnesium acetate.

Another object of the present invention is to provide such an environmentally-clean liquid fire inhibiting composition, wherein said at least one alkali metal salt is derived from the C2 carboxylic acid (R—COOH), called glycolic acid (hydroxyacetic acid), and are selected from the group consisting of: potassium glycolate;calcium glycolate; and sodium glycolate.

Another object of the present invention is to provide such an environmentally-clean liquid fire inhibiting composition, wherein said at least one alkali metal salt is derived from the C2 carboxylic acid (R—COOH), called glyoxylic acid C₂H₂O₃, and are selected from the group consisting of: potassium glyoxylate; calcium glyoxylate; and sodium glyoxylate (monohydrate).

Another object of the present invention is to provide such an environmentally-clean liquid fire inhibiting composition, wherein said at least one alkali metal salt is derived from the C2 carboxylic acid (R—COOH), called oxalic acid, and are selected from the group consisting of: potassium oxalate; calcium oxalate; and sodium oxalate.

Another object of the present invention is to provide such an environmentally-clean liquid fire inhibiting composition, wherein said at least one alkali metal salt is derived from the C3 carboxylic acid (R—COOH), called propionic acid, and are selected from the group consisting of: potassium propionate; calcium propionate; sodium propionate; and magnesium propionate.

Another object of the present invention is to provide such an environmentally-clean liquid fire inhibiting composition, wherein said at least one alkali metal salt is derived from the C3 carboxylic acid (R—COOH), called lactic acid, specifically, and are selected from the group consisting of: potassium lactate; calcium lactate; sodium lactate; and magnesium lactate.

Another object of the present invention is to provide such an environmentally-clean liquid fire inhibiting composition, wherein said at least one alkali metal salt is derived from the C3 carboxylic acid (R—COOH), called glyceric acid, and are selected from the group consisting of: potassium glycerate; calcium glycerate; and sodium glycerate.

Another object of the present invention is to provide such an environmentally-clean liquid fire inhibiting composition, wherein said at least one alkali metal salt is derived from the C3 carboxylic acid (R—COOH), called pyruvic acid, and are selected from the group consisting of: potassium pyruvate; calcium pyruvate; sodium pyruvate; and magnesium pyruvate.

Another object of the present invention is to provide such an environmentally-clean liquid fire inhibiting composition, wherein said at least one alkali metal salt is derived from alkali metal salts produced from the C3 carboxylic acid (R—COOH), called tartaric acid C₃H₄₅, and are selected from the group consisting of: potassium tartrate (potassium bitartrate); calcium tartrate; sodium tartrate; and magnesium tartrate.

Another object of the present invention is to provide such an environmentally-clean liquid fire inhibiting composition, wherein said at least one alkali metal salt is derived from the C4 carboxylic acid (R—COOH), called butyric acid CH3(CH2)2COOH, and are selected from the group consisting of: potassium butyrate (or butanoate); calcium butyrate; sodium butyrate; and magnesium butyrate.

Another object of the present invention is to provide such an environmentally-clean liquid fire inhibiting composition, wherein said at least one alkali metal salt is derived from the C4 carboxylic acid (R—COOH), called malic acid, and are selected from the group consisting of: potassium malate; calcium malate; sodium malate; and magnesium malate.

Another object of the present invention is to provide such an environmentally-clean liquid fire inhibiting composition, wherein said at least one alkali metal salt is derived from the C4 carboxylic acid (R—COOH), called malonic acid, and are selected from the group consisting of: potassium malonate; calcium malonate; sodium malonate; and di-magnesium malonate.

Another object of the present invention is to provide such an environmentally-clean liquid fire inhibiting composition, wherein said at least one alkali metal salt is derived from the C5 carboxylic acid (R—COOH), called pivalic acid, and are selected from the group consisting of: potassium pivalate; calcium pivalate; sodium pivalate; and magnesium pivalate.

Another object of the present invention is to provide such an environmentally-clean liquid fire inhibiting composition, wherein said at least one alkali metal salt is derived from the C6 carboxylic acid (R—COOH), called caproic acid, and are selected from the group consisting of: potassium caproate (hexanoate); calcium caproate; sodium caproate; and magnesium caproate.

Another object of the present invention is to provide such an environmentally-clean liquid fire inhibiting composition, wherein said at least one alkali metal salt is derived from the C6 carboxylic acid (R—COOH), called adipic (hexanedioic) acid, and are selected from the group consisting of: potassium adipate; calcium adipate; sodium adipate; and magnesium adipate.

Another object of the present invention is to provide such an environmentally-clean liquid fire inhibiting composition, wherein said at least one alkali metal salt is derived from the C6 carboxylic acid (R—COOH), called citric acid, and are selected from the group consisting of: (tri)potassium citrate; calcium citrate; sodium citrate; and magnesium citrate.

Another object of the present invention is to provide such an environmentally-clean liquid fire inhibiting solution, wherein said at least one alkali metal salt is derived from the C6 carboxylic acid (R—COOH), called d-gluconic acid, and are selected from the group consisting of: potassium gluconate; calcium gluconate; sodium gluconate; and magnesium gluconate.

Another object of the present invention is to provide such an environmentally-clean liquid fire inhibiting composition, wherein said at least one alkali metal salt is derived from the C7 carboxylic acid (R—COOH), benzoic acid, and are selected from the group consisting of: potassium benzoate; calcium benzoate; sodium benzoate; and magnesium benzoate.

Another object of the present invention is to provide such an environmentally-clean liquid fire inhibiting composition, wherein said at least one alkali metal salt, derived from said nonpolymeric saturated carboxylic acid, is selected from the group consisting of: (i) Alkali metal salts produced from the C1 carboxylic acid (R—COOH) called formic acid (i.e. methanoic acid), including potassium formate, calcium formate, sodium formate, and magnesium formate; (ii) Alkali metal salts produced from the C1 carboxylic acid (R—COOH) called carbonic acid (i.e. hydroxymethanoic acid), including potassium carbonate, sodium bicarbonate, and magnesium carbonate; (iii) Alkali metal salts produced from the C2 carboxylic acid (R—COOH) called acetic acid (ethanoic acid), including potassium acetate, calcium acetate, sodium acetate, and magnesium acetate; (iv) Alkali metal salts produced from the C2 carboxylic acid (R—COOH) called glycolic acid (hydroxyacetic acid), including potassium glycolate, calcium glycolate, and sodium glycolate; (v) Alkali metal salts produced from the C2 carboxylic acid (R—COOH) called glyoxylic acid, including potassium glyoxylate, calcium glyoxylate, sodium glyoxylate (monohydrate); (vi) Alkali metal salts produced from the C3 carboxylic acid (R—COOH) called propionic acid, including potassium propionate, calcium propionate, sodium propionate, and magnesium propionate; (vii) Alkali metal salts produced from the C3 carboxylic acid (R—COOH) called lactic acid, including potassium lactate, calcium lactate, sodium lactate, and magnesium lactate; (viii) Alkali metal salts produced from the C3 carboxylic acid (R—COOH) called glyceric acid, including potassium glycerate, calcium glycerate, and sodium glycerate; (ix) Alkali metal salts produced from the C3 carboxylic acid (R—COOH), pyruvic acid, specifically: including potassium pyruvate, calcium pyruvate, sodium pyruvate, and magnesium pyruvate; (x) Alkali metal salts produced from the C3 carboxylic acid (R—COOH) called, tartaric acid C3H45, including potassium tartrate (potassium bitartrate), calcium tartrate, sodium tartrate, and magnesium tartrate; (xi) Alkali metal salts produced from the carboxylic acid (R—COOH) called butyric acid, including potassium butyrate (or butanoate), calcium butyrate, sodium butyrate C₄H₇NaO₂, and magnesium butyrate;_(xii) Alkali metal salts produced from the C4 carboxylic acid (R—COOH) called malic acid including potassium malate, calcium malate, sodium malate, and magnesium malate; (xiii) Alkali metal salts produced from the C4 carboxylic acid (R—COOH) called malonic acid, including potassium malonate, calcium malonate, sodium malonate, and di-magnesium malonate; (xiv) Alkali metal salts produced from the C5 carboxylic acid (R—COOH) called pivalic acid, including potassium pivalate, calcium pivalate, sodium pivalate, and magnesium pivalate; (xv) Alkali metal salts produced from the C6 carboxylic acid (R—COOH) called caproic acid, including potassium caproate (hexanoate), calcium caproate, sodium caproate, and magnesium caproate; (xvi) Alkali metal salts produced from the C6 carboxylic acid (R—COOH) called adipic (hexanedioic) acid, including potassium adipate, calcium adipate, sodium adipate, and magnesium adipate; (xvii) Alkali metal salts produced from the C6 carboxylic acid (R—COOH) called citric acid, including (tri)potassium citrate, calcium citrate, sodium citrate, and magnesium citrate; (xviii) Alkali metal salts produced from the C6 carboxylic acid (R—COOH) called d-gluconic acid, including, potassium gluconate, calcium gluconate, sodium gluconate, and magnesium gluconate; and (xix) Alkali metal salts produced from the C7 carboxylic acid (R—COOH) called benzoic acid, including potassium benzoate, calcium benzoate, sodium benzoate, and magnesium benzoate.

Another object of the present invention is to provide an environmentally-clean liquid fire inhibiting composition for spray application on combustible surfaces and air-drying to the ambient atmosphere, comprising: an aqueous mixture of an amount of alkali metal salt derived from a non-polymerized saturated carboxylic acid characterized by having less than 8 carbon atoms, and dissolved in an amount of water along with an amount of dispersing and coalescing agent, realized as an ester of a non-polymerized saturated carboxylic acid, so as to provide a liquid fire inhibiting solution that can be sprayed on combustible surfaces to form thin alkali metal salt crystalline coatings on the combustible surfaces when and as water molecules in the liquid fire inhibiting solution evaporate to the environment during drying operations, to inhibit fire ignition, flame spread and smoke development; wherein said alkali metal salt is selected from the group consisting of: (i) Alkali metal salts produced from the C1 carboxylic acid (R—COOH) called formic acid (i.e. methanoic acid), including potassium formate, calcium formate, sodium formate, and magnesium formate; (ii) Alkali metal salts produced from the C1 carboxylic acid (R—COOH) called carbonic acid (i.e. hydroxymethanoic acid), including potassium carbonate, sodium bicarbonate, and magnesium carbonate; (iii) Alkali metal salts produced from the C2 carboxylic acid (R—COOH) called acetic acid (ethanoic acid), including potassium acetate, calcium acetate, sodium acetate, and magnesium acetate; (iv) Alkali metal salts produced from the C2 carboxylic acid (R—COOH) called glycolic acid (hydroxyacetic acid), including potassium glycolate, calcium glycolate, and sodium glycolate; (v) Alkali metal salts produced from the C2 carboxylic acid (R—COOH) called glyoxylic acid, including potassium glyoxylate, calcium glyoxylate, sodium glyoxylate (monohydrate); (vi) Alkali metal salts produced from the C3 carboxylic acid (R—COOH) called propionic acid, including potassium propionate, calcium propionate, sodium propionate, and magnesium propionate; (vii) Alkali metal salts produced from the C3 carboxylic acid (R—COOH) called lactic acid, including potassium lactate, calcium lactate, sodium lactate, and magnesium lactate; (viii) Alkali metal salts produced from the C3 carboxylic acid (R—COOH) called glyceric acid, including potassium glycerate, calcium glycerate, and sodium glycerate; (ix) Alkali metal salts produced from the C3 carboxylic acid (R—COOH), pyruvic acid, specifically: including potassium pyruvate, calcium pyruvate, sodium pyruvate, and magnesium pyruvate; (x) Alkali metal salts produced from the C3 carboxylic acid (R—COOH) called, tartaric acid C3H45, including potassium tartrate (potassium bitartrate), calcium tartrate, sodium tartrate, and magnesium tartrate; (xi) Alkali metal salts produced from the carboxylic acid (R—COOH) called butyric acid, including potassium butyrate (or butanoate), calcium butyrate, sodium butyrate C₄H₇NaO₂, and magnesium butyrate;_(xii) Alkali metal salts produced from the C4 carboxylic acid (R—COOH) called malic acid including potassium malate, calcium malate, sodium malate, and magnesium malate; (xiii) Alkali metal salts produced from the C4 carboxylic acid (R—COOH) called malonic acid, including potassium malonate, calcium malonate, sodium malonate, and di-magnesium malonate; (xiv) Alkali metal salts produced from the C5 carboxylic acid (R—COOH) called pivalic acid, including potassium pivalate, calcium pivalate, sodium pivalate, and magnesium pivalate; (xv) Alkali metal salts produced from the C6 carboxylic acid (R—COOH) called caproic acid, including potassium caproate (hexanoate), calcium caproate, sodium caproate, and magnesium caproate; (xvi) Alkali metal salts produced from the C6 carboxylic acid (R—COOH) called adipic (hexanedioic) acid, including potassium adipate, calcium adipate, sodium adipate, and magnesium adipate; (xvii) Alkali metal salts produced from the C6 carboxylic acid (R—COOH) called citric acid, including (tri)potassium citrate, calcium citrate, sodium citrate, and magnesium citrate; (xviii) Alkali metal salts produced from the C6 carboxylic acid (R—COOH) called d-gluconic acid, including, potassium gluconate, calcium gluconate, sodium gluconate, and magnesium gluconate; and (xix) Alkali metal salts produced from the C7 carboxylic acid (R—COOH) called benzoic acid, including potassium benzoate, calcium benzoate, sodium benzoate, and magnesium benzoate.

Another object of the present invention is to provide an environmentally-clean aqueous-based fire inhibiting biochemical solution comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt derived from a nonpolymeric saturated carboxylic acid wherein the carbon chain length of the carboxylic acid is less than eight (C1-C7), and wherein the alkali metal salt is selected from the group consisting of potassium, calcium, sodium and/or magnesium, functioning as a fire inhibitor, and present in a major amount having a weight percent of about 10.00% to about 40.00% relative to the total weight of the aqueous-based fire inhibiting biochemical composition; and an ester of a saturated non-polymerized carboxylic acid having less than eight carbon atoms (C=8), functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight; wherein the resulting aqueous-based fire inhibiting biochemical composition is stable when mixed so that its chemical components do not precipitate in the aqueous solution when stored in a storage container, making the aqueous solution ready for use in diverse temperature environments ranging from as low as 32 F to as high as 130 F.

Another object of the present invention is to provide such an environmentally-clean aqueous-based fire inhibiting biochemical solution, wherein said at least one alkali metal salt derived from said nonpolymeric saturated carboxylic acid is selected from the group consisting of: (i) Alkali metal salts produced from the C1 carboxylic acid (R—COOH) called formic acid (i.e. methanoic acid), including potassium formate, calcium formate, sodium formate, and magnesium formate; (ii) Alkali metal salts produced from the C1 carboxylic acid (R—COOH) called carbonic acid (i.e. hydroxymethanoic acid), including potassium carbonate, sodium bicarbonate, and magnesium carbonate; (iii) Alkali metal salts produced from the C2 carboxylic acid (R—COOH) called acetic acid (ethanoic acid), including potassium acetate, calcium acetate, sodium acetate, and magnesium acetate; (iv) Alkali metal salts produced from the C2 carboxylic acid (R—COOH) called glycolic acid (hydroxyacetic acid), including potassium glycolate, calcium glycolate, and sodium glycolate; (v) Alkali metal salts produced from the C2 carboxylic acid (R—COOH) called glyoxylic acid, including potassium glyoxylate, calcium glyoxylate, sodium glyoxylate (monohydrate); (vi) Alkali metal salts produced from the C3 carboxylic acid (R—COOH) called propionic acid, including potassium propionate, calcium propionate, sodium propionate, and magnesium propionate; (vii) Alkali metal salts produced from the C3 carboxylic acid (R—COOH) called lactic acid, including potassium lactate, calcium lactate, sodium lactate, and magnesium lactate; (viii) Alkali metal salts produced from the C3 carboxylic acid (R—COOH) called glyceric acid, including potassium glycerate, calcium glycerate, and sodium glycerate; (ix) Alkali metal salts produced from the C3 carboxylic acid (R—COOH), pyruvic acid, specifically: including potassium pyruvate, calcium pyruvate, sodium pyruvate, and magnesium pyruvate; (x) Alkali metal salts produced from the C3 carboxylic acid (R—COOH) called, tartaric acid C3H45, including potassium tartrate (potassium bitartrate), calcium tartrate, sodium tartrate, and magnesium tartrate; (xi) Alkali metal salts produced from the carboxylic acid (R—COOH) called butyric acid, including potassium butyrate (or butanoate), calcium butyrate, sodium butyrate C₄H₇NaO₂, and magnesium butyrate; (xii) Alkali metal salts produced from the C4 carboxylic acid (R—COOH) called malic acid including potassium malate, calcium malate, sodium malate, and magnesium malate; (xiii) Alkali metal salts produced from the C4 carboxylic acid (R—COOH) called malonic acid, including potassium malonate, calcium malonate, sodium malonate, and di-magnesium malonate; (xiv) Alkali metal salts produced from the C5 carboxylic acid (R—COOH) called pivalic acid, including potassium pivalate, calcium pivalate, sodium pivalate, and magnesium pivalate; (xv) Alkali metal salts produced from the C6 carboxylic acid (R—COOH) called caproic acid, including potassium caproate (hexanoate), calcium caproate, sodium caproate, and magnesium caproate; (xvi) Alkali metal salts produced from the C6 carboxylic acid (R—COOH) called adipic (hexanedioic) acid, including potassium adipate, calcium adipate, sodium adipate, and magnesium adipate; (xvii) Alkali metal salts produced from the C6 carboxylic acid (R—COOH) called citric acid, including (tri)potassium citrate, calcium citrate, sodium citrate, and magnesium citrate; (xviii) Alkali metal salts produced from the C6 carboxylic acid (R—COOH) called d-gluconic acid, including, potassium gluconate, calcium gluconate, sodium gluconate, and magnesium gluconate; and (xix) Alkali metal salts produced from the C7 carboxylic acid (R—COOH) called benzoic acid, including potassium benzoate, calcium benzoate, sodium benzoate, and magnesium benzoate.

Another object of the present invention is to provide an environmentally-clean aqueous-based fire inhibiting biochemical solution for spraying on combustible surfaces and forming a thin alkali metal salt crystalline coating thereon as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely formic acid, selected from the group consisting of potassium formate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of formic acid, namely methyl formate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and a dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely carbonic acid, selected from the group consisting of potassium, calcium, sodium and/or magnesium carbonate, functioning as a fire inhibitor, and present in a major amount having a weight percent of about 10.00% to about 40.00% relative to the total weight of the aqueous-based fire inhibiting biochemical composition; and an ester of a saturated non-polymerized carboxylic acid, selected from the group consisting of an ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely acetic acid, selected from the group consisting of potassium, calcium, sodium and/or magnesium acetate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of acetic acid, namely ethyl acetate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely glycolic acid, selected from the group consisting of potassium, calcium, sodium and/or magnesium glycolate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of glycolic acid, namely ethyl glycolate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely glyoxylic acid, selected from the group consisting of potassium, calcium, sodium and/or magnesium glyoxylate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of citric acid, namely triethyl citrate, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely oxalic acid, selected from the group consisting of potassium, calcium, sodium and/or magnesium oxalate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of oxalic acid, namely dimethyl oxalate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely propionic acid, selected from the group consisting of potassium, calcium, sodium and/or magnesium propionate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of propionic acid, namely ethyl propionate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely lactic acid, selected from the group consisting of potassium, calcium, sodium and/or magnesium lactate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of lactic acid, namely ethyl lactate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely glyceric acid, selected from the group consisting of potassium, calcium, and/or sodium glycerate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of glyceric acid, namely dimethyl glycerate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an improved environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely pyruvic acid, selected from the group consisting of potassium, calcium, sodium and/or magnesium pyruvate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of pyruvic acid, namely ethyl pyruvate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely tartric acid, selected from the group consisting of potassium, calcium, sodium and/or magnesium tartrate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of tartric acid, namely diethyl tartrate (DET), or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely butyric acid, selected from the group consisting of potassium, calcium, sodium and/or magnesium butyrate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of butyric acid, namely ethyl butyrate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely malic acid, selected from the group consisting of potassium, calcium, sodium and/or magnesium malate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of malic acid, namely diethyl maleate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely malonic acid, selected from the group consisting of potassium, calcium, sodium and/or magnesium malonate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of malonic acid, namely diethyl malonate (DEM), or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the total weight of the aqueous-based fire inhibiting biochemical composition; at least one alkali metal salt of a nonpolymeric saturated carboxylic acid, namely pivalic acid, selected from the group consisting of potassium, calcium, sodium and/or magnesium pivalate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of pivalic acid, namely methyl pivalate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely capric acid, selected from the group consisting of potassium, calcium, sodium and/or magnesium caproate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of caproic acid, namely ethyl caproate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely adipic acid, selected from the group consisting of potassium, calcium, sodium and/or magnesium adipate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of adipic acid, namely dimethyl adipate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the total weight of the aqueous-based fire inhibiting biochemical composition; at least one alkali metal salt of a nonpolymeric saturated carboxylic acid, namely citric acid, selected from the group consisting of potassium, calcium, sodium and/or magnesium citrate, functioning as a fire inhibitor, and present in a major amount having a weight percent of about 10.00% to about 40.00% relative to the total weight of the aqueous-based fire inhibiting biochemical composition; and an ester of a saturated non-polymerized carboxylic acid, selected from the group consisting of an ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, comprising: water, functioning as a solvent, carrier and dispersant, present in a major amount having a weight percent of about 60.00% to about 90.00% relative to the to the total weight of the aqueous-based fire inhibiting biochemical composition; at least one alkali metal salt of a nonpolymeric saturated carboxylic acid, namely gluconic acid, selected from the group consisting of potassium, calcium, sodium and/or magnesium gluconate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of gluconic acid, namely methyl gluconate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide an environmentally-clean aqueous-based fire inhibiting biochemical solution for spraying on combustible surfaces and forming a thin alkali metal salt crystalline coating thereon, functioning as a fire inhibitor, as the water molecules evaporate to the environment, for spraying on combustible surfaces and forming a thin alkali metal salt crystalline coating thereon as the water molecules evaporate to the environment, comprising: water, functioning as a solvent, carrier and dispersant, present in a major amount having a weight percent of about 60.00% to about 90.00% relative to the total weight of the aqueous-based fire inhibiting biochemical composition; at least one alkali metal salt of a nonpolymeric saturated carboxylic acid, namely benzoic acid, selected from the group consisting of potassium, calcium, sodium and/or magnesium benzoate, functioning as a fire inhibitor, and present in a major amount having a weight percent of about 10.00% to about 40.00% relative to the total weight of the aqueous-based fire inhibiting biochemical composition; and an ester of saturated non-polymerized carboxylic acid, selected from the group consisting of an ester of benzoic acid, namely ethyl benzoate, or ester of citric acid, namely triethyl citrate, functioning as a dispersant/coalescent, and present in a minor amount having a weight percent of about 0.50% to about 5.00% relative to the total weight of the aqueous-based fire inhibiting biochemical composition; wherein the sum of the weight percent of the chemical components above does not exceed 100% by weight.

Another object of the present invention is to provide a fire inhibiting biochemical liquid composition for use in treating combustible material, comprising: a dispersing agent in the form of a quantity of water, for dispersing alkali metal ions dissolved in water; a fire inhibiting agent in the form of an alkali metal salt of a nonpolymeric saturated carboxylic acid, wherein the carbon chain length of the carboxylic acid is less than eight (C1-C7), ad wherein the alkali metal is selected from the group consisting of potassium, calcium, sodium and/or magnesium, and the alkali metal salt provides alkali metal ions dispersed in the water when said alkali metal salt is dissolved in the quantity of water; and a dispersing and coalescing agent in the form of an organic compound containing an ester of a nonpolymeric saturated carboxylic acid, for dispersing and coalescing the alkali metal ions when the fire inhibiting biochemical liquid composition is applied to treat combustible material to be protected against fire ignition and flame spread, while water molecules in the water evaporate and/or react within the treated combustible material, so that dispersed alkali metal ions cooperate to form alkali metal salt crystalline coatings on the treated combustible material, and/or inhibit fire ignition, flame spread and production of smoke by interrupting free radical chain reactions driving the combustible phase of the fire.

Another object of the present invention is to provide a property ground cover material including vegetation coated with said fire inhibiting biochemical liquid composition.

Another object of the present invention is to provide a building material coated with said fire inhibiting biochemical liquid composition.

Another object of the present invention is to provide an article of manufacture comprising said fire inhibiting biochemical liquid composition.

Another object of the present invention is to provide an article of manufacture selected from the group consisting of a stationary liquid spraying system and a mobile liquid spraying system, for spraying said fire inhibiting biochemical liquid composition, onto combustible surfaces to be protected against fire.

Another object of the present invention is to provide a method of proactively preventing fire comprising the steps of applying said fire inhibiting biochemical liquid composition according to Claim 48, onto combustible material to be proactively protected from fire.

Another object of the present invention is to provide such a method, wherein the fire is selected from the group consisting of a forest fire, a wildfire, a tire warehouse fire, a building fire, a house fire, a landfill fire, a coal stack fire, an oil field fire, a mine fire, and a fuel station fire.

Another object of the present invention is to provide a method of proactively imparting fire resistance to an article, comprising the steps of: (a) applying said fire inhibiting biochemical liquid composition, onto surfaces of the article; and (b) allowing the applied fire inhibiting biochemical liquid composition to dry on the article and form said ultra-thin potassium salt crystalline coatings on the surfaces of the article.

Another object of the present invention is to provide such a method, wherein the article is a textile material, a building material, a structural component, or property to be proactively defended from a wildfire.

Another object of the present invention is to provide such fire extinguishing and/or fire inhibiting biochemical compositions, wherein said coalescing agent is triethyl citrate, an ester of citric acid.

Another object of the present invention is to provide a new and improved fire extinguishing and/or fire inhibiting biochemical composition, wherein a building material is coated with the fire retarding biochemical composition.

Another object of the present invention is to provide a new and improved fire extinguishing and/or fire inhibiting biochemical composition, wherein the biochemical composition comprises a major amount of tripotassium citrate dissolved in a major quantity of water, along with a minor amount of a coalescing agent such as triethyl citrate, an ester of citric acid.

Another object of the present invention is to provide a new and improved fire extinguishing and/or fire inhibiting biochemical composition, wherein an article of manufacture contains the biochemical composition, and the article of manufacture is selected from the group consisting of an extinguisher, an extinguishing fitting, and an extinguishing system.

Another object of the present invention is to provide a new and improved method of proactively fighting a fire comprising the steps of applying improved liquid fire inhibiting biochemical composition to the surfaces to be proactively protected from a wildfire.

Another object of the present invention is to provide a new and improved method of proactively fighting a fire such as a forest fire, a tire warehouse fire, a landfill fire, a coal stack fire, an oil field fire, a mine fire, a battlefield fire, a battleship fire, a fuel truck accident fire, or oil spill fire.

Another object of the present invention is to provide a new and improved method of proactively imparting fire resistance to an article comprising: (a) applying a liquid biochemical composition to the article; and (b) allowing the applied biochemical composition to dry on the article and form a fire inhibiting metal salt crystal coating on the article, wherein the article is a textile material, a building material, a structural component, or property to be proactively defended from a wildfire.

Another object of the present invention is to provide a new and improved environmentally-clean aqueous-based fire inhibiting liquid biochemical composition comprising: a major amount of tripotassium citrate (TPC) and a minor amount of triethyl citrate (TEC) added to and mixed with a major amount of water functioning as a solvent, carrier and dispersant of potassium salt ions dissolved in the water with the tripotassium citrate.

Another object of the present invention is to provide a new and improved fire inhibiting biochemical composition kit comprising: a major amount of dry tripotassium citrate monohydrate (TPC) and a minor amount of triethyl citrate (TEC), as components for mixing with a predetermined major amount of water functioning as a solvent, carrier and dispersant, to make up a predetermined quantity of environmentally-clean liquid fire inhibiting biochemical composition for proactively protecting combustible property and wood products.

Another object of the present invention is to provide a new and improved environmentally-clean aqueous-based fire inhibiting liquid biochemical composition comprising: a major amount of tripotassium citrate (TPC), a minor amount of triethyl citrate monohydrate (TEC), and a minor amounts of biocidal agent, added to and mixed with a major amount of water functioning as a solvent, carrier, and dispersant.

Another object of the present invention is to provide a new and improved fire inhibiting biochemical composition kit comprising: a major amount of dry tripotassium citrate (TPC), a minor amount of triethyl citrate (TEC), and a minor amount of biocidal agent, as components for mixing with a predetermined major amount of water functioning as a solvent, carrier and dispersant, to make up a predetermined quantity of environmentally-clean liquid fire inhibiting biochemical composition for proactively protecting combustible property and wood products.

Another object of the present invention is to provide a new and improved environmentally-clean aqueous-based fire inhibiting liquid biochemical composition comprising: a major amount of tripotassium citrate monohydrate (TPC), a minor amount of triethyl citrate (TEC), and a minor amount of citric acid (CA) for adding to and mixing with a major quantity of water functioning as a solvent, carrier, and dispersant.

Another object of the present invention is to provide a new and improved fire inhibiting biochemical composition kit comprising: a major amount of dry tripotassium citrate (TPC), a minor amount of triethyl citrate (TEC), and a minor amount of citric acid (CA), as components for mixing with a predetermined major amount of water functioning as a solvent, carrier and dispersant, to make up a predetermined quantity of environmentally-clean liquid fire inhibiting biochemical composition for proactively protecting combustible property and wood products.

Another object of the present invention is to provide a new and improved environmentally-clean aqueous-based fire inhibiting biochemical composition for producing good immediate extinguishing effects when applied to extinguish a burning or smoldering fire, and very good long-term fire inhibiting effects when being proactively applied to protect combustible surfaces against the threat of fire, comprising: (a) a dispersing agent realized in the form of a quantity of water, for dispersing metal ions dissolved in water; (b) a fire inhibiting agent in the form of at least one alkali metal salt of a nonpolymeric saturated carboxylic acid, for providing metal ions dispersed in the water when the at least one alkali metal salt is dissolved in the water; (c) a coalescing agent in the form of an organic compound containing three carboxylic acid groups (or salt/ester derivatives thereof), such as triethyl citrate, an ester of citric acid, for dispersing and coalescing the metal ions when the fire inhibiting liquid composition is applied to a surface to be protected against fire, while water molecules in the water evaporate during drying, and the metal ions cooperate to form metal salt crystal structure on the surface; and (d) if appropriate at least one colorant.

Another object of the present invention is to provide a GPS-tracking, mapping, and recording techniques that enable a population to know where environmentally-clean-wildfire chemistry-based wildfire breaks and zones have been formed by whom, and when using the principles of the present invention.

Another object of the present invention is to provide a wildfire defense network supporting integrated GPS-tracking, mapping and recording techniques, that enable fire jurisdictions to plan and implement clean-chemistry wildfire breaks and zones (e.g. around telephone poles) to proactively protect property and life from raging wildfires—by spraying the liquid fire inhibitor of the present invention on combustible surfaces, and effectively inhibiting specific regions of combustible fuel from ignition and flame spread, along the path towards targeted property and life to be protected from the incidence of wildfire.

Another object of the present invention is to provide a method of spraying an ultra-thin layer of wildfire inhibiting liquid biochemical compositions onto combustible ground cover and surfaces to be proactively protected against the presence of wildfire, so that when the water molecules in the wildfire inhibiting liquid chemicals evaporate during drying operations, ultra-thin potassium salt crystal structures form on the surfaces, to provide potassium cations available to inhibit the wildfire along one or more pathways including, for example, interruption of free radical chain reactions driving the combustible phase of wildfire, taking the energy out of the wildfire, reducing the production of smoke, and protecting property that has been treated in advance of a wildfire incidence.

Another object of the present invention is to provide a new and improved environmentally-clean wildfire inhibiting liquid biochemical compositions formulated so that, when applied in hot dry climates, conditioned by hot dry prevailing winds, the relative humidity will be expectedly low, and in the absence of rain, the all-natural wild fire inhibiting liquid of the present invention sprayed over wild fire break and zone regions, will last for durations into weeks and months in many situations.

Another object of the present invention is to provide wireless network for GPS-tracking when and where the new and improved environmentally-clean wildfire inhibiting liquid biochemical composition is spray applied, and documenting the same in a wireless network database, so that, whenever rain occurs, the wireless network can inform and advise fire departments and homeowners using mobile phones or computing systems that certain GPS-specified environmentally-clean wildfire breaks and zones require maintenance by an additional spraying of the wildfire inhibitor liquid, while GPS-tracking, mapping and recording the spraying operations on the wireless network, for management purposes.

Another object of the present invention is to provide a new and improved methods for spraying environmentally-clean wildfire inhibiting liquid biochemical compositions to form GPS-tracked clean chemistry wildfire breaks—well in advance of the incidence of wild fires moving in the direction of prevailing winds.

Another object of the present invention is to provide a novel method of proactive wildfire defense in the WUI region using natural safe potassium mineral salts that pose zero to little threat to our natural environments or human beings and animals living in these WUI regions, where homes and businesses exist.

Another object of the present invention is to provide a new and improved methods of spraying utility poles and infrastructure with new and improved environmentally-clean wildfire inhibiting liquid biochemical compositions and tracking and documenting the same on a GPS-based wireless system network so that fire jurisdictions can plan and implement clean-chemistry wildfire breaks and zones (e.g. around telephone poles) to proactively protect property and life from a raging wildfire seeking combustible fuel by interrupting the combustible phase of the wildfire, reducing the production of smoke, and protecting property that has been treated in advance of a wildfire incidence.

Another object of the present invention is to provide a new and improved method of and apparatus for GPS-tracking and mapping operations involving the spraying of an environmentally-clean aqueous-based wildfire inhibiting biochemicals on property surfaces having native fuel, and other combustible structures, including wood buildings, decks, fences, etc. prior to the arrival or outbreak of a wildfire.

Another object of the present is to provide method of reducing the risks of damage to private property due to wild fires by centrally managed application of wildfire inhibiting biochemical liquid spray to ground cover and building surfaces prior to arrival of the wild fires.

Another object of the present is to provide method of reducing the risks of damage to private property due to wild fires using a global positioning satellite (GPS) system and mobile communication messaging techniques, to help direct the application of AF chemical liquid prior to the arrival of wild fires.

Another object of the present invention is to provide a new and improved system for wild fire suppression and neighborhood and home defense comprising a platoon of small planes, all-terrain vehicles (ATVs) and other mobile systems adapted for spraying an environmentally-clean anti-fire (AF) chemical liquid that clings to the ground cover, and buildings, where applied in regions of high wild fire risk, that operates in both wet and dry states of application.

Another object of the present invention is to provide a new and improved system for wild fire suppression and home defense system comprising (i) a plurality of home wild-fire defense systems assigned to each home or building in the strategic area, for spraying the outside of their homes and surrounding ground cover with the environmentally-clean anti-fire biochemical spray liquid, (ii) a command center for managing wild fire pre-defense operations in the region, involving the spray application of the environmentally-clean anti-fire biochemical spray liquid to create and maintain strategic fire breaks in the region in advance of the outbreak of wild fires, and protection of homes and property in the region against wild fires breaking out in the region, and sending messages and instructions to home owners in the region as well as operators of the small planes and ATVs deployed in the system, and (iii) a mobile application installed on the mobile phone of each home owner in the strategic region, and configured for receiving email and/or SMS messages from a command center managing the system, and instructing home owners to pre-defend their homes using the environmentally-clean anti-fire biochemical spray liquid.

Another object of the present invention is to provide a new and improved system for wild fire suppression and home defense spraying system, wherein each home defense spraying system includes a GPS-tracking and radio-controlled circuit board to remotely monitor the location of each location-deployed home defense spraying system and automatically monitor the liquid level of the fire inhibiting biochemical solution contained in its storage tank, and automatically generate electronic refill orders sent to a command center so that a third-party service can automatically replenish the tanks of such home-based systems with anti-fire biochemical liquid when the fluid level falls below a certain level in the GPS-tracked storage tank.

Another object of the present invention is to provide a new and improved system for wild fire suppression and home defense spraying system, wherein the mobile application supporting the following functions: (i) sends automatic notifications from the command center to home owners with the mobile application, instructing them to spray their property and home at certain times with anti-fire chemical liquid in their tanks; (ii) the system will automatically monitor consumption of sprayed fire inhibiting biochemical liquid and generate auto-replenish order via its onboard GSM-circuits so as to achieve compliance with the home spray-based wild-fire-defense program, and report fire inhibiting biochemical liquid levels in each home-owner storage tank; and (iii) show status of wild fire risk in the region, and actions to the taken before a wild fire outbreak.

Another object of the present invention is to provide a GPS-guided method of suppressing a wild fire raging towards a target region of land in a direction determined by currently blowing winds and other environmental and weather factors.

Another object of the present invention is to provide a method of reducing the risks of damage to public property due to wild fires by managed application of anti-fire biochemical liquid spray to ground cover and building surfaces prior to arrival of the wild fires.

Another object of the present invention is to provide a wireless system for managing the supply, delivery, and spray-application of environmentally-clean anti-fire biochemical liquid on private and public property to reduce the risks of damage and/or destruction caused by wild fires.

Another object of the present invention is to provide a new and improved system for spraying a defensive path around vulnerable neighborhoods out in front of wild fires to make sure that an environmentally-safe fire break, created by the spray application of anti-fire biochemical liquid, defends homes from the destructive forces of raging wild fires.

Another object of the present invention is to provide a new and improved system and method of mitigating the damaging effects of wild fires by spraying environmentally-clean anti-fire biochemical liquid in advance of wild fires, that do not depend on water to extinguish fire, such that, even after a month or two after spray application on dry brush around the neighborhood, the anti-fire chemical continues to work by stalling the ability of a fire to advance and consume homes.

Another object of the present invention is to provide new and improved methods of and apparatus for protecting wood-framed buildings from wild fires by automatically spraying water-based environmentally clean anti-fire chemical liquid over the exterior surfaces of the building, surrounding ground surfaces, shrubs, decking and the like, prior to wild fires reaching such buildings.

Another object of the present invention is to provide new and improved method of suppressing a wild fire raging across a region of land in the direction of the prevailing winds.

Another object of the present invention is to provide a method of and apparatus for applying fire and smoke inhibiting compositions on ground surfaces before the incidence of wild-fires, and thereafter, upon smoldering ambers and ashes to reduce smoke and suppress fire re-ignition.

Another object of the present invention is to provide a method of and apparatus applying by an aqueous-based fire and smoke inhibiting slurry formulation that can hydraulically sprayed around whole neighborhoods, as well as along service roads and exit/entry ramps, to create strategic chemical-type fire breaks that safely remove wild fire energy before such wildfire storms arrive at the doors of homes and businesses, and roadways and parkways.

Another object of the present invention is to provide a method of spraying a clean fire and smoke inhibiting slurry composition containing clean fire inhibiting chemicals, and cellulose or wood fiber, mixed with water and other additives, for application to combustible ground surfaces in advance of wild fire, to blanket grounds from wildfire ignition, and also for application over smoldering ambers and ashes to prevent resignation while saving millions of gallons of water, not producing considerable waste water, and reducing toxic run off while reducing toxic smoke.

Another object of the present invention is to provide equipment for applying such fire and smoke inhibiting slurry mixtures to ground surfaces, after the presence of wildfire, to prevent smoke smoldering and resignation of fires, without creating toxic water runoff which occurs using conventional methods based on the application of water by fire hoses.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a table listing conventional prior art methods for fighting and defending against wild fires including (i) aerial water drop methods using airplanes and helicopters, (ii) aerial fire retardant chemical (e.g. PhosChek® Fire Retardant) drop using airplanes and helicopters, (iii) physical fire breaks formed by bulldozing land and other landscaping methods to remove combustible vegetation from the land, (iv) physical fire breaks by pre-burning combustible material on the land, and (v) chemical fire break by fire retardant chemical drop;

FIG. 2A is a first image illustrating a prior art method of wild fire suppression involving an airplane dropping water on a wild fire from the sky;

FIG. 2B1 is a second image illustrating a prior art method of wild fire suppression involving an airplane dropping chemical fire retardant (e.g. PhosChek®) on a wild fire, from the sky;

FIG. 2B2 is third image showing a prior art ground-based tank containing the chemical fire retardant (e.g. PhosChek® fire retardant chemical) that is shown being contained in a storage tank in FIG. 2B2, and dropped from an airplane in FIG. 2B1;

FIG. 2B3 is a fourth image showing a prior art ground-based tank containing a supply of PhosChek® fire retardant chemical mixed in the tank shown in FIG. 2B3, and dropped from an airplane in FIG. 2B1;

FIG. 2B4 is a schematic representation illustrating the primary components of the PhosChek® fire retardant chemical, namely monoammonium phosphate (MAP), diammonium hydrogen phosphate (DAP) and water;

FIG. 3A is a schematic representation illustrating the primary active components of the fire-retardant chemical disclosed and claimed in BASF's U.S. Pat. No. 8,273,813 to Beck et al., namely tripotassium citrate (TPC), and a water-absorbing polymer dissolved in water;

FIG. 3B is a schematic representation illustrating the primary components of Hartidino's AF-31 fire retardant chemical, namely, potassium citrate and, a natural gum dissolved in water as described in the Material Safety Data Sheet for Hartindo AF31 (Eco Fire Break) dated Feb. 4, 2013 (File No. DWMS2013);

FIG. 4A is schematic representation of the wireless system network of the present invention designed for managing the supply, delivery and spray-application of the environmentally-clean anti-fire (AF) liquid composition of the present invention, on private and public property to reduce the risks of property damage and/or destruction and harm to life caused by wild fires, and shown comprising GPS-tracked anti-fire (AF) liquid spray ground vehicles, GPS-tracked anti-fire liquid spray air vehicles, GPS-tracked anti-fire liquid spray backpack systems for spraying houses and surrounding properties, GPS-tracked anti-fire liquid spraying systems for spraying private real property and buildings, GPS-tracked liquid spraying systems for spraying public real property and buildings, mobile computing systems running the mobile application of the present invention and used by property owners, residents, fire departments, insurance underwriters, government officials, medical personal and others, remote data sensing and capturing systems for remotely monitoring land and wild fires wherever they may break out, a GPS system for providing GPS-location services to each and every system components in the system network, and one or more data center containing clusters of web, application and database servers for supporting wire wild alert and notification systems, and microservices configured for monitoring and managing the system and network of GPS-tracking anti-fire liquid spraying systems and mobile computing and communication devices configured in accordance with the principles of the present invention;

FIG. 4B is a schematic representation illustrating exemplary multi-spectral imaging (MSI) and hyper-spectral imaging (HSI) based remote sensing technology platforms supported by the US Geological Survey (USGS) Agency including, for example, the MODIS (Moderate Resolution Imaging Spectroradiometer) satellite system, the World View 2 Satellite System, the Octocopter unmanned airborne system (UAS) (e.g. OnyxStar Hydra-12 heavy-lifting drone), and the SenseFly eBee SQ UAS, for use in supporting and practicing the system network of the present invention;

FIG. 4C is a perspective view of the OnyxStar Hyra-12 heavy lifter drone supporting MSI and HSI camera systems, and providing remove data sensing services that can be used to help carry out the GPS-directed methods of wild fire suppression disclosed herein in accordance with the principles of the present invention;

FIG. 5A is a perspective view of an exemplary mobile computing device deployed on the system network of the present invention, supporting (i) the mobile anti-fire spray management application of the present invention deployed as a component of the system network of the present invention as shown in FIGS. 4A and 4B, as well as (ii) conventional wildfire alert and notification systems as shown in FIGS. 3A through 3E;

FIG. 5B shows a system diagram for an exemplary mobile client computer system deployed on the system network of the present invention;

FIG. 6 is a schematic representation of a generic specification of the environmentally-clean fire inhibitor biochemical composition (i.e. solution) of the present invention for proactively fire-protecting combustible surfaces, comprising (i) a major amount of water, (ii) a major amount of metal alkali salt dissolved in the water, and derived from a saturated non-polymerized carboxylic acid, wherein the carbon chain length of the carboxylic acid is less than eight (C1-C7), and the resulting water-based liquid solution is stable when mixed so that its chemical components do not precipitate in the aqueous solution when stored in a storage container, making the aqueous solution ready for use in diverse temperature environments ranging from, for example, about 32 F to about 130 F, and (iii) a minor amount of one or more esters derived from the saturated non-polymerized carboxylic acid and/or another saturated non-polymerized carboxylic acid, promoting dispersing and coalescing properties of metal alkali ions in the aqueous solution and formation of thin alkali metal salt crystalline structures and coatings on combustible surfaces upon the evaporation of water molecules from applied aqueous solution;

FIG. 6A1 is a schematic representation illustrating the primary components of a first environmentally-clean aqueous-based fire inhibiting liquid biochemical composition of the present invention consisting of major amounts of tripotassium citrate (TPC) and minor amounts of triethyl citrate (TEC) formulated with water functioning as a solvent, carrier, and dispersant;

FIG. 6A2 is a schematic representation illustrating the primary components of a first fire inhibiting biochemical composition kit of the present invention, consisting of major amounts of dry tripotassium citrate monohydrate (TPC) and minor amounts of triethyl citrate (TEC), as components in a package prepared and ready for mixing with a predetermined quantity of water functioning as a solvent, carrier and dispersant, to make up a predetermined quantity of environmentally-clean liquid fire inhibiting biochemical composition for proactively treating and protecting wood products;

FIG. 6B1 is a schematic representation illustrating the primary components of a second environmentally-clean aqueous-based fire inhibiting liquid biochemical composition of the present invention consisting of major amounts of tripotassium citrate (TPC), minor amounts of triethyl citrate monohydrate (TEC), and minor amounts of biocidal agent (e.g. Polyphase® PW40 biocide), formulated with water functioning as a solvent, carrier, and dispersant;

FIG. 6B2 is a schematic representation illustrating the primary components of the second fire inhibiting biochemical composition kit of the present invention, consisting of a major amount of dry tripotassium citrate (TPC), a minor amount of triethyl citrate (TEC), and a minor amount of citric acid (CA) formulated with water functioning as a solvent, carrier and dispersant and/or a minor amount of biocidal agent (e.g. Polyphase® PW40 biocide), as components in a package prepared and ready for mixing with a predetermined quantity of water functioning as a solvent, carrier and dispersant, to make up a predetermined quantity of environmentally-clean liquid fire inhibiting biochemical composition for proactively treating and protecting wood products;

FIG. 6C1 is a schematic representation illustrating the primary components of an environmentally-clean aqueous-based fire inhibiting liquid biochemical composition of the present invention derived from the C1-Class of saturated non-polymerized carboxylic acid called formic acid, consisting of (i) a major amount of potassium formate, and (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid—for spraying on combustible surfaces and formation of thin potassium salt crystalline coatings providing protection against fire ignition, flame spread and smoke development;

FIG. 6C2 is a schematic representation illustrating the primary components of an environmentally-clean aqueous-based fire inhibiting liquid biochemical composition of the present invention derived from the C1-Class of saturated non-polymerized carboxylic acid called formic acid, consisting of (i) major amounts of calcium formate, and (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid—for spraying on combustible surfaces and formation of thin calcium salt crystalline coatings providing protection against fire ignition, flame spread and smoke development;

FIG. 6C3 is a schematic representation illustrating the primary components of an environmentally-clean aqueous-based fire inhibiting liquid biochemical composition of the present invention derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid—for spraying on combustible surfaces and formation of thin sodium salt crystalline coatings providing protection against fire ignition, flame spread and smoke development;

FIG. 6C4 is a schematic representation illustrating the primary components of an environmentally-clean aqueous-based fire inhibiting liquid biochemical composition of the present invention derived from the C1-Class of saturated non-polymerized carboxylic acid called formic acid, consisting of (i) major amounts of sodium formate, and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid—for spraying on combustible surfaces and formation of thin sodium salt crystalline coatings providing protection against fire ignition, flame spread and smoke development;

FIG. 6D1 is a schematic representation illustrating the primary components of an environmentally-clean aqueous-based fire inhibiting liquid biochemical composition of the present invention derived from the C1-Class of saturated non-polymerized carboxylic acid called carbonic acid, consisting of (i) a major amount of potassium carbonate, and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—carbonic acid—for spraying on combustible surfaces and formation of thin potassium salt crystalline coatings providing protection against fire ignition, flame spread and smoke development;

FIG. 6D2 is a schematic representation illustrating the primary components of an environmentally-clean aqueous-based fire inhibiting liquid biochemical composition of the present invention derived from the C1-Class of saturated non-polymerized carboxylic acid called carbonic acid, consisting of (i) a major amount of sodium (bi)carbonate, and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—carbonic acid—for spraying on combustible surfaces and formation of thin sodium salt crystalline coatings providing protection against fire ignition, flame spread and smoke development;

FIG. 6E1 is a schematic representation illustrating the primary components of an environmentally-clean aqueous-based fire inhibiting liquid biochemical composition of the present invention derived from the C2-Class of saturated non-polymerized carboxylic acid called acetic acid, consisting of (i) a major amount of potassium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid—for spraying on combustible surfaces and formation of thin potassium salt crystalline coatings providing protection against fire ignition, flame spread and smoke development;

FIG. 6E2 is a schematic representation illustrating the primary components of an environmentally-clean aqueous-based fire inhibiting liquid biochemical composition of the present invention derived from the C2-Class of saturated non-polymerized carboxylic acid called acetic acid, consisting of (i) a major amount of calcium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid—for spraying on combustible surfaces and formation of thin calcium salt crystalline coatings providing protection against fire ignition, flame spread and smoke development;

FIG. 6E3 is a schematic representation illustrating the primary components of an environmentally-clean aqueous-based fire inhibiting liquid biochemical composition of the present invention derived from the C2-Class of saturated non-polymerized carboxylic acid called acetic acid, consisting of (i) a major amount of sodium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C12-class of carboxylic acid—acetic acid—for spraying on combustible surfaces and formation of thin sodium salt crystalline coatings providing protection against fire ignition, flame spread and smoke development;

FIG. 6E4 is a schematic representation illustrating the primary components of an environmentally-clean aqueous-based fire inhibiting liquid biochemical composition of the present invention derived from the C2-Class of saturated non-polymerized carboxylic acid called acetic acid, consisting of (i) a major amount of magnesium acetate, and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid—for spraying on combustible surfaces and formation of thin magnesium salt crystalline coatings providing protection against fire ignition, flame spread and smoke development;

FIG. 6F1 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of potassium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid—for spraying on combustible surfaces and formation of thin potassium salt crystalline coatings providing protection against fire ignition, flame spread and smoke development;

FIG. 6F2 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of calcium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid—for spraying on combustible surfaces and formation of thin calcium salt crystalline coatings providing protection against fire ignition, flame spread and smoke development;

FIG. 6F3 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of sodium glycolate, and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid—for spraying on combustible surfaces and formation of thin sodium salt crystalline coatings providing protection against fire ignition, flame spread and smoke development;

FIG. 6G1 is a schematic representation illustrating the primary components of an environmentally-clean aqueous-based fire inhibiting liquid biochemical composition of the present invention derived from the C2-Class of saturated non-polymerized carboxylic acid called glyoxylic acid, consisting of (i) a major amount of potassium glyoxylate, and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glyoxylic acid—for spraying on combustible surfaces and formation of thin potassium salt crystalline coatings providing protection against fire ignition, flame spread and smoke development;

FIG. 6G2 is a schematic representation illustrating the primary components of an environmentally-clean aqueous-based fire inhibiting liquid biochemical composition of the present invention derived from the C2-Class of saturated non-polymerized carboxylic acid called glyoxylic acid, consisting of (i) a major amount of calcium glyoxylate, and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glyoxylic acid—for spraying on combustible surfaces and formation of thin calcium salt crystalline coatings providing protection against fire ignition, flame spread and smoke development;

FIG. 6G3 is a schematic representation illustrating the primary components of an environmentally-clean aqueous-based fire inhibiting liquid biochemical composition of the present invention derived from the C2-Class of saturated non-polymerized carboxylic acid called glyoxylic acid, consisting of (i) a major amount of sodium glyoxylate, and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glyoxylic acid—for spraying on combustible surfaces and formation of thin sodium salt crystalline coatings providing protection against fire ignition, flame spread and smoke development;

FIG. 6H1 is a schematic representation illustrating the primary components of an environmentally-clean aqueous-based fire inhibiting liquid biochemical composition of the present invention derived from the C2-Class of saturated non-polymerized carboxylic acid called oxalic acid, consisting of (i) a major amount of potassium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid—for spraying on combustible surfaces and formation of thin potassium salt crystalline coatings providing protection against fire ignition, flame spread and smoke development;

FIG. 6H2 is a schematic representation illustrating the primary components of an environmentally-clean aqueous-based fire inhibiting liquid biochemical composition of the present invention derived from the C2-Class of saturated non-polymerized carboxylic acid called oxalic acid, consisting of (i) a major amount of calcium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid—for spraying on combustible surfaces and formation of thin calcium salt crystalline coatings providing protection against fire ignition, flame spread and smoke development;

FIG. 6H3 is a schematic representation illustrating the primary components of an environmentally-clean aqueous-based fire inhibiting liquid biochemical composition of the present invention derived from the C2-Class of saturated non-polymerized carboxylic acid called oxalic acid, consisting of (i) a major amount of sodium oxalate, and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid—for spraying on combustible surfaces and formation of thin sodium salt crystalline coatings providing protection against fire ignition, flame spread and smoke development;

FIG. 6I1 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of potassium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid—for spraying on combustible surfaces and formation of thin potassium salt crystalline coatings providing protection against fire ignition, flame spread and smoke development;

FIG. 6I2 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of calcium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid—for spraying on combustible surfaces and formation of thin calcium salt crystalline coatings providing protection against fire ignition, flame spread and smoke development;

FIG. 6I3 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of sodium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid—for spraying on combustible surfaces and formation of thin calcium salt crystalline coatings providing protection against fire ignition, flame spread and smoke development;

FIG. 6I4 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of magnesium propionate, and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid—for spraying on combustible surfaces and formation of thin magnesium salt crystalline coatings providing protection against fire ignition, flame spread and smoke development;

FIG. 6J1 is a schematic representation illustrating the primary components of an environmentally-clean aqueous-based fire inhibiting liquid biochemical composition of the present invention derived from the C3-Class of saturated non-polymerized carboxylic acid called lactic acid, consisting of (i) a major amount of potassium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid—for spraying on combustible surfaces and formation of thin potassium salt crystalline coatings providing protection against fire ignition, flame spread and smoke development;

FIG. 6J2 is a schematic representation illustrating the primary components of an environmentally-clean aqueous-based fire inhibiting liquid biochemical composition of the present invention derived from the C3-Class of saturated non-polymerized carboxylic acid called lactic acid, consisting of (i) a major amount of calcium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid—for spraying on combustible surfaces and formation of thin calcium salt crystalline coatings providing protection against fire ignition, flame spread and smoke development;

FIG. 6J3 is a schematic representation illustrating the primary components of an environmentally-clean aqueous-based fire inhibiting liquid biochemical composition of the present invention derived from the C3-Class of saturated non-polymerized carboxylic acid called lactic acid, consisting of (i) a major amount of sodium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid—for spraying on combustible surfaces and formation of thin sodium salt crystalline coatings providing protection against fire ignition, flame spread and smoke development;

FIG. 6J4 is a schematic representation illustrating the primary components of an environmentally-clean aqueous-based fire inhibiting liquid biochemical composition of the present invention derived from the C3-Class of saturated non-polymerized carboxylic acid called lactic acid, consisting of (i) a major amount of magnesium lactate, and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid—for spraying on combustible surfaces and formation of thin magnesium salt crystalline coatings providing protection against fire ignition, flame spread and smoke development;

FIG. 6K1 is a schematic representation illustrating the primary components of an environmentally-clean aqueous-based fire inhibiting liquid biochemical composition of the present invention derived from the C3-Class of saturated non-polymerized carboxylic acid called glyceric acid, consisting of (i) a major amount of potassium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid—for spraying on combustible surfaces and formation of thin potassium salt crystalline coatings providing protection against fire ignition, flame spread and smoke development;

FIG. 6K2 is a schematic representation illustrating the primary components of an environmentally-clean aqueous-based fire inhibiting liquid biochemical composition of the present invention derived from the C3-Class of saturated non-polymerized carboxylic acid called glyceric acid, consisting of (i) a major amount of calcium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid—for spraying on combustible surfaces and formation of thin calcium salt crystalline coatings providing protection against fire ignition, flame spread and smoke development;

FIG. 6K3 is a schematic representation illustrating the primary components of an environmentally-clean aqueous-based fire inhibiting liquid biochemical composition of the present invention derived from the C3-Class of saturated non-polymerized carboxylic acid called glyceric acid, consisting of (i) a major amount of sodium glycerate, and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid—for spraying on combustible surfaces and formation of thin sodium salt crystalline coatings providing protection against fire ignition, flame spread and smoke development;

FIG. 6L1 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of (i) a major amount of potassium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid—for spraying on combustible surfaces and formation of thin potassium salt crystalline coatings providing protection against fire ignition, flame spread and smoke development;

FIG. 6L2 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of (i) a major amount of calcium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid—for spraying on combustible surfaces and formation of thin calcium salt crystalline coatings providing protection against fire ignition, flame spread and smoke development;

FIG. 6L3 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of (i) a major amount of sodium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid—for spraying on combustible surfaces and formation of thin sodium salt crystalline coatings providing protection against fire ignition, flame spread and smoke development;

FIG. 6L4 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of (i) a major amount of magnesium pyruvate, and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid—for spraying on combustible surfaces and formation of thin magnesium salt crystalline coatings providing protection against fire ignition, flame spread and smoke development;

FIG. 6M1 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of (i) a major amount of potassium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid—for spraying on combustible surfaces and formation of thin potassium salt crystalline coatings providing protection against fire ignition, flame spread and smoke development;

FIG. 6M2 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of (i) a major amount of calcium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid—for spraying on combustible surfaces and formation of thin calcium salt crystalline coatings providing protection against fire ignition, flame spread and smoke development;

FIG. 6M3 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of (i) a major amount of sodium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid—for spraying on combustible surfaces and formation of thin sodium salt crystalline coatings providing protection against fire ignition, flame spread and smoke development;

FIG. 6M4 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of (i) a major amount of magnesium tartrate, and (ii) a minor amount of diethyl tartrate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid—for spraying on combustible surfaces and formation of thin magnesium salt crystalline coatings providing protection against fire ignition, flame spread and smoke development;

FIG. 6N1 is a schematic representation illustrating the primary components of an environmentally-clean aqueous-based fire inhibiting liquid biochemical composition of the present invention derived from the C4-Class of saturated non-polymerized carboxylic acid called butyric acid, consisting of (i) a major amount of potassium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid—for spraying on combustible surfaces and formation of thin potassium salt crystalline coatings providing protection against fire ignition, flame spread and smoke development;

FIG. 6N2 is a schematic representation illustrating the primary components of an environmentally-clean aqueous-based fire inhibiting liquid biochemical composition of the present invention derived from the C4-Class of saturated non-polymerized carboxylic acid called butyric acid, consisting of (i) a major amount of calcium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid—for spraying on combustible surfaces and formation of thin calcium salt crystalline coatings providing protection against fire ignition, flame spread and smoke development;

FIG. 6N3 is a schematic representation illustrating the primary components of an environmentally-clean aqueous-based fire inhibiting liquid biochemical composition of the present invention derived from the C4-Class of saturated non-polymerized carboxylic acid called butyric acid, consisting of (i) a major amount of sodium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid—for spraying on combustible surfaces and formation of thin sodium salt crystalline coatings providing protection against fire ignition, flame spread and smoke development;

FIG. 6N4 is a schematic representation illustrating the primary components of an environmentally-clean aqueous-based fire inhibiting liquid biochemical composition of the present invention derived from the C4-Class of saturated non-polymerized carboxylic acid called butyric acid, consisting of (i) a major amount of magnesium butyrate, and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid—for spraying on combustible surfaces and formation of thin magnesium salt crystalline coatings providing protection against fire ignition, flame spread and smoke development;

FIG. 6O1 is a schematic representation illustrating the primary components of an environmentally-clean aqueous-based fire inhibiting liquid biochemical composition of the present invention derived from the C4-Class of saturated non-polymerized carboxylic acid called malic acid, consisting of (i) a major amount of potassium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid—for spraying on combustible surfaces and formation of thin potassium salt crystalline coatings providing protection against fire ignition, flame spread and smoke development;

FIG. 6O2 is a schematic representation illustrating the primary components of an environmentally-clean aqueous-based fire inhibiting liquid biochemical composition of the present invention derived from the C4-Class of saturated non-polymerized carboxylic acid called malic acid, consisting of (i) a major amount of calcium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid—for spraying on combustible surfaces and formation of thin calcium salt crystalline coatings providing protection against fire ignition, flame spread and smoke development;

FIG. 6O3 is a schematic representation illustrating the primary components of an environmentally-clean aqueous-based fire inhibiting liquid biochemical composition of the present invention derived from the C4-Class of saturated non-polymerized carboxylic acid called malic acid, consisting of (i) a major amount of sodium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid—for spraying on combustible surfaces and formation of thin sodium salt crystalline coatings providing protection against fire ignition, flame spread and smoke development;

FIG. 6O4 is a schematic representation illustrating the primary components of an environmentally-clean aqueous-based fire inhibiting liquid biochemical composition of the present invention derived from the C4-Class of saturated non-polymerized carboxylic acid called malic acid, consisting of (i) a major amount of magnesium maleate, and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid—for spraying on combustible surfaces and formation of thin magnesium salt crystalline coatings providing protection against fire ignition, flame spread and smoke development;

FIG. 6P1 is a schematic representation illustrating the primary components of an environmentally-clean aqueous-based fire inhibiting liquid biochemical composition of the present invention derived from the C4-Class of saturated non-polymerized carboxylic acid called malonic acid, consisting of (i) a major amount of potassium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid—for spraying on combustible surfaces and formation of thin potassium salt crystalline coatings providing protection against fire ignition, flame spread and smoke development;

FIG. 6P2 is a schematic representation illustrating the primary components of an environmentally-clean aqueous-based fire inhibiting liquid biochemical composition of the present invention derived from the C4-Class of saturated non-polymerized carboxylic acid called malonic acid, consisting of (i) a major amount of calcium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid—for spraying on combustible surfaces and formation of thin calcium salt crystalline coatings providing protection against fire ignition, flame spread and smoke development;

FIG. 6P3 is a schematic representation illustrating the primary components of an environmentally-clean aqueous-based fire inhibiting liquid biochemical composition of the present invention derived from the C4-Class of saturated non-polymerized carboxylic acid called malonic acid, consisting of (i) a major amount of sodium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid—for spraying on combustible surfaces and formation of thin sodium salt crystalline coatings providing protection against fire ignition, flame spread and smoke development;

FIG. 6P4 is a schematic representation illustrating the primary components of an environmentally-clean aqueous-based fire inhibiting liquid biochemical composition of the present invention derived from the C4-Class of saturated non-polymerized carboxylic acid called malonic acid, consisting of (i) a major amount of magnesium malonate, and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid—for spraying on combustible surfaces and formation of thin magnesium salt crystalline coatings providing protection against fire ignition, flame spread and smoke development;

FIG. 6Q1 is a schematic representation illustrating the primary components of an environmentally-clean aqueous-based fire inhibiting liquid biochemical composition of the present invention derived from the C5-Class of saturated non-polymerized carboxylic acid called pivalic acid, consisting of (i) a major amount of potassium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid—for spraying on combustible surfaces and formation of thin potassium salt crystalline coatings providing protection against fire ignition, flame spread and smoke development;

FIG. 6Q2 is a schematic representation illustrating the primary components of an environmentally-clean aqueous-based fire inhibiting liquid biochemical composition of the present invention derived from the C5-Class of saturated non-polymerized carboxylic acid called pivalic acid, consisting of (i) a major amount of calcium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid—for spraying on combustible surfaces and formation of thin calcium salt crystalline coatings providing protection against fire ignition, flame spread and smoke development;

FIG. 6Q3 is a schematic representation illustrating the primary components of an environmentally-clean aqueous-based fire inhibiting liquid biochemical composition of the present invention derived from the C5-Class of saturated non-polymerized carboxylic acid called pivalic acid, consisting of (i) a major amount of sodium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid—for spraying on combustible surfaces and formation of thin sodium salt crystalline coatings providing protection against fire ignition, flame spread and smoke development;

FIG. 6Q4 is a schematic representation illustrating the primary components of an environmentally-clean aqueous-based fire inhibiting liquid biochemical composition of the present invention derived from the C5-Class of saturated non-polymerized carboxylic acid called pivalic acid, consisting of (i) a major amount of magnesium pivalate, and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid—for spraying on combustible surfaces and formation of thin magnesium salt crystalline coatings providing protection against fire ignition, flame spread and smoke development;

FIG. 6R1 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of potassium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid—for spraying on combustible surfaces and formation of thin potassium salt crystalline coatings providing protection against fire ignition, flame spread and smoke development;

FIG. 6R2 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of calcium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid—for spraying on combustible surfaces and formation of thin calcium salt crystalline coatings providing protection against fire ignition, flame spread and smoke development;

FIG. 6R3 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of sodium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid—for spraying on combustible surfaces and formation of thin sodium salt crystalline coatings providing protection against fire ignition, flame spread and smoke development;

FIG. 6R4 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of magnesium caproate, and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid—for spraying on combustible surfaces and formation of thin magnesium salt crystalline coatings providing protection against fire ignition, flame spread and smoke development;

FIG. 6S1 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of potassium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid—for spraying on combustible surfaces and formation of thin potassium salt crystalline coatings providing protection against fire ignition, flame spread and smoke development;

FIG. 6S2 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of calcium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid—for spraying on combustible surfaces and formation of thin calcium salt crystalline coatings providing protection against fire ignition, flame spread and smoke development;

FIG. 6S3 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of sodium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid—for spraying on combustible surfaces and formation of thin sodium salt crystalline coatings providing protection against fire ignition, flame spread and smoke development;

FIG. 6S4 is a schematic representation illustrating the primary components of an environmentally-clean aqueous-based fire inhibiting liquid biochemical composition of the present invention derived from the C6-Class of saturated non-polymerized carboxylic acid called caproic acid, consisting of (i) a major amount of magnesium adipic, and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid—for spraying on combustible surfaces and formation of thin magnesium salt crystalline coatings providing protection against fire ignition, flame spread and smoke development;

FIG. 6T1 is a schematic representation illustrating the primary components of an environmentally-clean aqueous-based fire inhibiting liquid biochemical composition of the present invention derived from the C6-Class of saturated non-polymerized carboxylic acid called citric acid, consisting of (i) a major amount of tripotassium citrate (TPC), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid—for spraying on combustible surfaces and formation of thin potassium salt crystalline coatings providing protection against fire ignition, flame spread and smoke development;

FIG. 6T2 is a schematic representation illustrating the primary components of an environmentally-clean aqueous-based fire inhibiting liquid biochemical composition of the present invention derived from the C6-Class of saturated non-polymerized carboxylic acid called citric acid, consisting of (i) a major amount of calcium citrate, and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid—for spraying on combustible surfaces and formation of thin calcium salt crystalline coatings providing protection against fire ignition, flame spread and smoke development;

FIG. 6T3 is a schematic representation illustrating the primary components of an environmentally-clean aqueous-based fire inhibiting liquid biochemical composition of the present invention derived from the C6-Class of saturated non-polymerized carboxylic acid called citric acid, consisting of (i) a major amount of sodium citrate, and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid—for spraying on combustible surfaces and formation of thin sodium salt crystalline coatings providing protection against fire ignition, flame spread and smoke development;

FIG. 6T4 is a schematic representation illustrating the primary components of an environmentally-clean aqueous-based fire inhibiting liquid biochemical composition of the present invention derived from the C6-Class of saturated non-polymerized carboxylic acid called citric acid, consisting of (i) a major amount of magnesium citrate, and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid—for spraying on combustible surfaces and formation of thin magnesium salt crystalline coatings providing protection against fire ignition, flame spread and smoke development;

FIG. 6U1 is a schematic representation illustrating the primary components of an environmentally-clean aqueous-based fire inhibiting liquid biochemical composition of the present invention derived from the C6-Class of saturated non-polymerized carboxylic acid called d-gluconic acid, consisting of (i) a major amount of potassium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid—for spraying on combustible surfaces and formation of thin potassium salt crystalline coatings providing protection against fire ignition, flame spread and smoke development;

FIG. 6U2 is a schematic representation illustrating the primary components of an environmentally-clean aqueous-based fire inhibiting liquid biochemical composition of the present invention derived from the C6-Class of saturated non-polymerized carboxylic acid called d-gluconic acid, consisting of (i) a major amount of calcium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid—for spraying on combustible surfaces and formation of thin calcium salt crystalline coatings providing protection against fire ignition, flame spread and smoke development;

FIG. 6U3 is a schematic representation illustrating the primary components of an environmentally-clean aqueous-based fire inhibiting liquid biochemical composition of the present invention derived from the C6-Class of saturated non-polymerized carboxylic acid called d-gluconic acid, consisting of (i) a major amount of sodium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid—for spraying on combustible surfaces and formation of thin sodium salt crystalline coatings providing protection against fire ignition, flame spread and smoke development;

FIG. 6U4 is a schematic representation illustrating the primary components of an environmentally-clean aqueous-based fire inhibiting liquid biochemical composition of the present invention derived from the C6-Class of saturated non-polymerized carboxylic acid called d-gluconic acid, consisting of (i) a major amount of magnesium gluconate, and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid—for spraying on combustible surfaces and formation of thin magnesium salt crystalline coatings providing protection against fire ignition, flame spread and smoke development;

FIG. 6V1 is a schematic representation illustrating the primary components of an environmentally-clean aqueous-based fire inhibiting liquid biochemical composition of the present invention derived from the C6-Class of saturated non-polymerized carboxylic acid called benzoic acid, consisting of (i) a major amount of potassium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—benzoic acid—for spraying on combustible surfaces and formation of thin potassium salt crystalline coatings providing protection against fire ignition, flame spread and smoke development;

FIG. 6V2 is a schematic representation illustrating the primary components of an environmentally-clean aqueous-based fire inhibiting liquid biochemical composition of the present invention derived from the C6-Class of saturated non-polymerized carboxylic acid called benzoic acid, consisting of (i) a major amount of calcium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—benzoic acid—for spraying on combustible surfaces and formation of thin calcium salt crystalline coatings providing protection against fire ignition, flame spread and smoke development;

FIG. 6V3 is a schematic representation illustrating the primary components of an environmentally-clean aqueous-based fire inhibiting liquid biochemical composition of the present invention derived from the C6-Class of saturated non-polymerized carboxylic acid called benzoic acid, consisting of (i) a major amount of sodium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—benzoic acid—for spraying on combustible surfaces and formation of thin sodium salt crystalline coatings providing protection against fire ignition, flame spread and smoke development;

FIG. 6V4 is a schematic representation illustrating the primary components of an environmentally-clean aqueous-based fire inhibiting liquid biochemical composition of the present invention derived from the C6-Class of saturated non-polymerized carboxylic acid called benzoic acid, consisting of (i) a major amount of magnesium benzoate, and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—benzoic acid—for spraying on combustible surfaces and formation of thin magnesium salt crystalline coatings providing protection against fire ignition, flame spread and smoke development;

FIG. 7A is a schematic representation illustrating a process of forming a tripotassium citrate (TPC) crystalline structures on combustible surfaces, such as ground cover, native fuel, lumber, living plant tissue, tree bark, and other combustible tissue and like materials that are sprayed with atomized sprays, or otherwise coated, with the chemical material comprising the aqueous-based fire inhibiting solutions of the present invention, as illustrated in FIGS. 6A1, 6A2 and 6T1 and described herein;

FIG. 7B is a schematic representation illustrating the atoms and atom numbering in the crystal structure of the compound, tripotassium citrate (K₃C₆H₅O₇) formed on treated surfaces in accordance with the principles of the present invention;

FIG. 7C is a schematic representation of the atomic crystal structure of a small piece of the crystalline structure of tripotassium citrate (K₃C₆H₅O₇) salt structure formed on a substrate to be protected against fire by way of application of the fire inhibiting chemical solution of the present invention, graphically illustrated the stage C illustration of FIG. 7A when water molecules mixed therein have evaporated to the ambient environment during air-drying;

FIG. 8A is a perspective view of a mobile GPS-tracked anti-fire (AF) liquid spraying system supported on a set of wheels (or supported on a back-rack), with integrated supply tank and rechargeable-battery operated electric spray pump, for deployment at private and public properties having building structures, for spraying the same with environmentally-clean anti-fire (AF) liquid in accordance with the principles of the present invention;

FIG. 8B is a schematic representation of the GPS-tracked mobile anti-fire (AF) chemical liquid spraying system shown in FIG. 8A, comprising a GPS-tracked and remotely-monitored AF chemical liquid spray control subsystem interfaced with a micro-computing platform for monitoring the spraying of AF chemical liquid from the system when located at specific GPS-indexed location coordinates, and automatically logging and recording such AF spray application operations within the network database system;

FIG. 9A is a perspective view of a GPS-tracked manned or autonomous vehicle system for spraying AF chemical liquid on building and ground surfaces with environmentally-clean anti-fire (AF) chemical liquid in accordance with the principles of the present invention;

FIG. 9B is a schematic representation of the manned or autonomously-driven vehicle system shown in FIG. 9A, comprising a GPS-tracked and remotely-monitored AF chemical liquid spray control subsystem interfaced with a micro-computing platform for monitoring the spraying of AF chemical liquid from the vehicle when located at any specific GPS-indexed location coordinates, and automatically logging and recording such AF spray application operations within the network database system;

FIG. 10A is a perspective view of an autonomously-driven or remotely-controlled unmanned airborne system (i.e. UAS or “drone”) adapted for spraying AF chemical liquid on building and ground surfaces for spraying the same with environmentally-clean anti-fire (AF) liquid in accordance with the principles of the present invention;

FIG. 10B is a schematic representation of the autonomously-driven or remotely-controlled aircraft system (i.e. drone) shown in FIG. 10A, comprising a GPS-tracked and remotely monitored AF chemical liquid spray control subsystem interfaced with a micro-computing platform for monitoring the spraying of AF chemical liquid from the aircraft when located at specific GPS-indexed location coordinates, and automatically logging and recording such AF spray application operations within the network database system;

FIG. 11A is a perspective view of a GPS-tracked aircraft system (i.e. helicopter) adapted for spraying an environmentally-clean anti-fire biochemical liquid of the present invention, from the air onto ground and property surfaces in accordance with the principles of the present invention;

FIG. 11B is a schematic representation of the GPS-tracked aircraft system (i.e. helicopter) shown in FIG. 11A, comprising a GPS-tracked and remotely monitored AF chemical liquid spray control subsystem interfaced with a micro-computing platform for monitoring the spraying of AF chemical liquid from the aircraft when located at specific GPS-indexed location coordinates, and automatically logging and recording such AF spray application operations within the network database system;

FIG. 12A is a GPS-tracked all-terrain vehicle (ATV) system adapted for spraying ground surfaces with environmentally-clean anti-fire (AF) liquid in accordance with the principles of the present invention;

FIG. 12B is the GPS-tracked all-terrain vehicle (ATV) system shown in FIG. 12A, comprising a GPS-tracked and remotely-monitored AF chemical liquid spray control subsystem interfaced with a micro-computing platform for monitoring the spraying of AF chemical liquid from the system when located at specific GPS-indexed location coordinates, and automatically logging and recording such AF spray application operations within the network database system;

FIG. 13A is a GPS-tracked portable backpack-mounted atomizing spray “cannon” system adapted for spraying ground and building surfaces with an environmentally-clean anti-fire (AF) liquid formulated in accordance with the principles of the present invention;

FIG. 13B shows the GPS-tracked portable backpack-mounted atomizing spray “cannon” system of FIG. 13A being worn by a person who is using it with the system network GPS-track and record the spraying of ground and building surfaces with the environmentally-clean anti-fire (AF) (i.e. fire inhibiting) liquid biochemical composition formulated in accordance with the principles of the present invention;

FIG. 13C is the GPS-tracked backpack mounted atomizing spray cannon system shown in FIG. 13A, comprising a GPS-tracked and remotely-monitored AF chemical liquid spray control subsystem interfaced with a micro-computing platform for monitoring the spraying of environmentally-clean AF chemical liquid from the system when located at specific GPS-indexed location coordinates, and automatically logging and recording such AF spray application operations within the network database system;

FIG. 14A is a perspective view of a GPS-tracked mobile atomizing spray cannon vehicle (SCV) system adapted for spraying ground surfaces with environmentally-clean anti-fire (AF) biochemical liquid in accordance with the principles of the present invention;

FIG. 14B is perspective view of the GPS-tracked spray cannon vehicle system shown in FIG. 14A, adapted for spraying ground surfaces with anti-fire (AF) biochemical liquid in accordance with the principles of the present invention;

FIG. 14C is a perspective view of the atomizing spray cannon component of the GPS-tracked spray cannon vehicle system shown in FIGS. 14A and 14B, showing a ring of atomizing spray nozzles mounted in a ring disposed about the inner aperture of the spray cannon, through is driven high velocity air streaming past the nozzles during spray atomizing operations using the environmentally-clean anti-fire biochemical liquid of the present invention;

FIG. 14D is a schematic block diagram of the GPS-tracked spray cannon vehicle system shown in FIGS. 14A, 14B and 14C, comprising a GPS-tracked and remotely-monitored AF chemical liquid spray control subsystem interfaced with a micro-computing platform for monitoring the spraying of fire inhibiting biochemical liquid from the system when located at specific GPS-indexed location coordinates, and automatically logging and recording such AF spray application operations within the network database system;

FIG. 15A is a GPS-tracked portable wheel-mounted atomizing spray “cannon” system, configured as a trailer and adapted for towing behind a powered vehicle (e.g. truck), and supporting atomization spraying of ground and property surfaces with an environmentally-clean anti-fire biochemical liquid formulated in accordance with the principles of the present invention;

FIG. 15B is the GPS-tracked portable wheel-mounted atomizing spray cannon system shown in FIG. 15A, comprising a GPS-tracked and remotely-monitored AF chemical liquid spray control subsystem interfaced with a micro-computing platform for monitoring the spraying of environmentally-clean biochemical liquid from the system when located at specific GPS-indexed location coordinates, and automatically logging and recording such AF spray application operations within the network database system;

FIG. 16A is a GPS-tracked portable backpack-mounted atomizing spraying system adapted for spraying ground surfaces with environmentally-clean anti-fire biochemical liquid in accordance with the principles of the present invention;

FIG. 16B is the GPS-tracked backpack-mounted atomizing spraying system shown in FIG. 13A, comprising a GPS-tracked and remotely-monitored AF chemical liquid spray control subsystem interfaced with a micro-computing platform for monitoring the spraying of environmentally-clean biochemical liquid from the system when located at specific GPS-indexed location coordinates, and automatically logging and recording such AF spray application operations within the network database system;

FIG. 17A is a GPS-traced mobile remotely-controllable atomizing spray “cannon” system adapted for spraying ground surfaces with environmentally-clean anti-fire (AF) liquid in accordance with the principles of the present invention;

FIG. 17B is the GPS-tracked mobile remotely-controllable atomizing spray cannon system shown in FIG. 13A, comprising a GPS-tracked and remotely-monitored AF chemical liquid spray control subsystem interfaced with a micro-computing platform for monitoring the spraying of environmentally-clean AF chemical liquid from the system when located at specific GPS-indexed location coordinates, and automatically logging and recording such AF spray application operations within the network database system;

FIG. 18 is a schematic representation of a schema for the network database (RDBMS) supported by the system network of the present invention, showing the primary enterprise level objects supported in the database tables created in the network database using the schema, and the relationships that are specified or indicated, to support all the enterprise-level objects defined and managed on the system network;

FIG. 19 is an exemplary wire-frame model of a graphical user interface supported by mobile application configured for use by a first specific class of registered users (e.g. property parcel owners, contractors and/or agents, residents, government officials, and others) to request and receive services, including notices and orders, supported by the system network of the present invention;

FIG. 19A is an exemplary wire-frame model of a graphical user interface supported by the mobile application showing a user updating the registration profile as a task on the system network;

FIG. 19B is an exemplary wire-frame model of a graphical user interface supported by the mobile application showing a user receiving a message request (via email, SMS messaging and/or push-notifications) issued from the command center to spray GPS-specified private property parcel(s) with clean anti-fire biochemical liquid and registered equipment;

FIG. 19C is an exemplary wire-frame model of a graphical user interface supported by the mobile application showing a user receiving a request/notice of order (via email, SMS messaging and/or push-notifications) to wild-fire spray-protect GPS-specified public property parcel(s) with clean anti-fire biochemical liquid to create and maintain a GPS-specified public firebreak, maintained on public property;

FIG. 19D is an exemplary wire-frame model of a graphical user interface supported by the mobile application showing a user requesting a refill supply of clean anti-fire biochemical liquid for supply to GPS-specified spray equipment registered on the system network;

FIG. 20 is an exemplary wire-frame model of a graphical user interface supported by the mobile application configured for second specific class of registered users, namely, command center administrators, enabling such users to issue wild-fire protection orders, plan wild-fire protection tasks, generate wild-fire and protection reports, and send and receive messages to users on the system network;

FIG. 20A is an exemplary wire-frame model of a graphical user interface supported by the mobile application for use by command center administrators to issue wild-fire protection orders using the system network of the present invention;

FIG. 20B exemplary wire-frame model of a graphical user interface supported by the mobile application for use by command center administrators to issue wild-fire protection orders involving the creation and maintenance of a clean biochemical firebreak using the methods of the present invention, as illustrated in FIGS. 24 through 32B;

FIG. 20C is an exemplary wire-frame models of a graphical user interface supported by the mobile application for use by command center administrators to order the creation and/or maintenance of a GPS-specified environmentally-clean biochemical firebreak on one or more public/private property parcels, using the methods of the present invention;

FIG. 20D is an exemplary wire-frame models of a graphical user interface for the mobile application used by command center administrators to receive messages from users including property owners and contractors requesting refills for clean anti-fire biochemical liquid for GPS-specified spray system equipment;

FIG. 21 is a graphical representation of an exemplary fire hazard severity zone (FHSZ) map generated by the CAL FIRE™ System in state responsibility areas of the State of California, and accessible through the mobile application, for use while informing the strategic application of environmentally-clean anti-fire biochemical liquid spray onto specified regions of property prior to the arrival of wild fires, using the system network of the present invention;

FIG. 22 is an exemplary anti-fire (AF) spray protection map generated by the system network of the present invention, showing houses and buildings that have been sprayed, and not-sprayed, with state/county-issued clean anti-fire biochemical liquid as of the report date 15 Dec. 2017;

FIG. 23 is an exemplary anti-fire spray protection task report generated by the system of the present invention for state/county xxx on 15 Dec. 2017, indicating which properties on what streets, in what town, county, state, requires the reapplication of AF chemical liquid spray treatment in view of factors such as weather (e.g. rainfall, sunlight) and passage of time since last fire inhibiting biochemical spray application;

FIG. 24 is a schematic representation showing a plan view of a wild fire emerging from a forest region and approaching a neighboring town moving in the direction of prevailing winds;

FIG. 25 is a graphical representation illustrating a method of suppressing a wild fire raging across a region of land in the direction of the prevailing winds, by forming a multi-stage anti-fire biochemical fire-break system, by GPS-controlled application of anti-fire liquid mist and spray streams of the environmentally-clean fire inhibiting liquid of the present invention;

FIGS. 26A and 26B set forth a flow chart describing the high-level steps of the method of suppressing a wild fire raging towards a target region of land in a direction determined by prevailing winds and other environmental and weather factors, as schematically illustrated in FIG. 25;

FIG. 27 is a graphical representation illustrating a method of reducing the risks of damage to private property due to wild fires by GPS-controlled application of fire inhibiting biochemical liquid spray, using the system network of the present invention;

FIGS. 28A, 28B and 28C, taken together, set forth a flow chart describing the high-level steps carried out by the method of reducing the risks of damage to private property due to wild fires by managed application of fire inhibiting biochemical liquid spray, using the system network and methods of the present invention, as illustrated in FIG. 27;

FIG. 29 is a graphical illustration showing a method of reducing the risks of damage to public property due to wild fires, by GPS-controlled application of fire inhibiting biochemical liquid spray over ground cover and building surfaces prior to the arrival of wild fires, using the system network and methods of the present invention;

FIGS. 30A, 30B and 30C, taken together, set forth a flow chart describing the high-level steps carried out by the method of reducing the risks of damage to public property due to wild fires by GPS-controlled application of fire inhibiting biochemical liquid spray, using the system network and methods of the present invention, as illustrated in FIG. 29;

FIG. 31 is a graphical illustration showing a method of remotely managing the GPS-controlled application of environmentally-clean fire inhibiting biochemical liquid spray of the present invention to ground cover and buildings to reduce the risks of damage due to wild fires, using the system network and methods of the present invention;

FIGS. 32A and 32B, taken together, set forth a flow chart describing the high-level steps carried out by the method of GPS-controlled application of fire inhibiting biochemical liquid spray to ground cover and buildings to reduce the risks of damage due to wild fires, using the system network and methods of the present invention;

FIG. 33A is a perspective view of the environmentally-clean fire and smoke inhibiting slurry spray application vehicle of the present invention carrying a high-capacity (e.g. 3000 gallon) stainless steel mixing tank with an integrated agitator mechanism (e.g. motor driven mixing paddles) for mixing the fire and smoke inhibiting slurry spray mixture of the present invention, and a hydraulic pumping apparatus and spray nozzle for spraying the clean aqueous-based clean fire and smoke inhibiting slurry of the present invention, on ground surfaces to create environmentally-clean biochemical fire breaks around regions to be protected from wildfires, and also to cover smoldering ambers and ash after the present of wildfires to reduce toxic waste water runoff and smoke production;

FIG. 33B is a rear view of the vehicle shown in in FIG. 33A;

FIG. 33C is a side view of the vehicle shown in FIG. 33A;

FIG. 34 is a schematic system block diagram of the fire and smoke inhibiting slurry spray vehicle system shown in FIGS. 33A, 33B and 33C;

FIG. 35 is a flow chart describing the method of applying fire and smoke inhibiting slurry compositions of the present invention on ground surfaces before the incidence of wild-fires, and thereafter, upon smoldering ambers and ashes to reduce smoke and suppress fire re-ignition;

FIG. 36 is a base hydraulic mulch loading chart for making the fire and smoke inhibiting slurry mixture of the present invention, using Profile® brand mulch fiber, for several different application rates measured in lbs./acre (e.g. 1500 lbs./acre, 2000 lb./acre, and 2500 lb./acre);

FIG. 37 is a schematic representation of a neighborhood of houses surrounded by a high-risk wildfire region, wherein a clean biochemical wild-fire break region is hydraulically sprayed on the ground surface region all around the houses using the clean fire and smoke inhibiting slurry composition of the present invention;

FIG. 38 is a schematic representation of a highway surrounded by a high-risk wildfire region on both sides, wherein a clean biochemical wild-fire break region is hydraulically sprayed on both sides of the highway using the clean fire and smoke inhibiting slurry composition of the present invention;

FIG. 39 is a schematic representation of a highway off ramp that has been sprayed with the clean fire and smoke inhibiting slurry composition of the present invention, to provide a safe way to exit a wildfire burning region, while suppressing and preventing reignition of the fire, and reducing the production of smoke and creation of toxic water runoff during post fire management operations;

FIG. 40 is a schematic representation of a wood-framed or mass timber building that just burned to the ground after a wildfire passed through an unprotected neighborhood, wherein the clean fire and smoke inhibiting slurry composition is hydraulically sprayed over the glowing ambers and fire ash to suppress and prevent reignition of the fire, and reduce the production of smoke and creation of toxic water runoff during post fire management operations;

FIG. 41 is a schematic representation of a wood-framed or mass timber building that is burning due to a fire within the building, wherein the wet fire and smoke inhibiting slurry composition of the present invention is hydraulically sprayed on and over the fire to suppress it, while reducing the production of smoke during the fire suppression process;

FIG. 42A is a schematic representation of an automated wireless wildfire ember detection and suppression system of present invention, showing a wildfire ember detection module mounted on the top of each building in the wireless network receiving wildfire alerts and messages from neighboring modules which can scout for wildfires and alert other modules in the network in terms of GPS coordinates so that the individual properties can timely prepare for any such wildfire outbreaks in the vicinity, using the hybrid wildfire misting system of the present invention shown in FIGS. 42C and 42D;

FIG. 42B is a schematic block diagram showing the components used to construct the wireless GPS-tracked wildfire ember detection module of the present invention, shown in FIG. 42A;

FIGS. 42CA and 42D, taken together, set forth a schematic diagram showing the automated hybrid clean wildfire inhibitor misting system of the present invention, providing both an anti-fire chemical misting system for suppressing wildfire embers impacting a building as shown in FIG. 42C and a lawn and ground fire-inhibiting biochemical liquid misting system impacting the law and ground around the building as shown in FIG. 42C, both automatically controlled by an automated wildfire ember detection and notification network shown in FIGS. 42A and 42B, all being integrated into the system network shown in FIGS. 4A and 4B;

FIG. 42E shows several spray misting nozzles used in the system of the FIGS. 42A through 43D;

FIGS. 42F1 and 42F2 show side and front perspective views of 360-degree rotating sprinkler heads for mounting on building rooftops and integrated into the system of FIG. 42A, to spray anti-fire biochemical liquid according to the present invention, and treated combustible surfaces before wildfire embers arrival;

FIG. 42G is a schematic representation illustrating that the clean-biochemistry fire break sprayed by sprinkler-type head(s) shown in FIGS. 42F1 and 42F2, mounted on home building rooftops and driven by automated pumps, automatically creates and maintains a proactive fire defense coverage against an advancing wildfire, to help reduce risk of destruction of property and life by wildfire;

FIG. 43 is a perspective view of an exemplary mobile computing device deployed on the system network of the present invention, supporting (i) the mobile anti-fire biochemical spray management application of the present invention deployed as a component of the system network of the present invention, as well as (ii) conventional wildfire alert and notification systems, as shown in FIGS. 42A through 42D;

FIG. 44A is a schematic representation of a just-in-time wood-framed building factory system supporting multiple production lines for producing pre-fabricated Class-A fire-protected wood-framed components as needed to construct custom and pre-specified wood-framed buildings ordered by customers;

FIG. 44B is a schematic representation of a just-in-time (JIT) factory system with multiple production lines for producing prefabricated Class-A fire-protected wood-framed components (e.g. wood-framed walls, staircases, roof trusses, floor trusses, etc.) for use in constructing custom and pre-specified wood-framed buildings ordered by customers for production and delivery;

FIG. 45 is a schematic system network representation of the just-in-time factory system shown in FIGS. 44A and 44B, shown comprising (i) a just-in-time wood-framed building factory with multiple production lines for producing Class-A fire-protected building components, (ii) GPS-tracked ISO-shipping containers and code symbol/RFID tag reading mobile computing system, and (iii) a data center for factory system and supporting a network of mobile computing devices running a mobile application adapted to help track and manage orders, projects and supplies for prefabricating Class-A fire-protected wood-framed buildings, and Class-A fire-protected wood-framed building components for use in constructing the same;

FIG. 46 is a perspective view of a mobile computing system used in the system shown in FIG. 45, supporting a mobile application installed on the mobile computing system for the purpose of tracking and managing projects involving just-in-time fabrication of Class-A fire-protected wood-framed building components for ordered prefabricated wood-framed buildings in accordance with the principles of the present invention;

FIG. 47 is a schematic representation of an exemplary schema for the network database supported by the system the present invention shown in FIG. 45, wherein each primary enterprise object is schematically represented as an object in the schema and represented in the data records created and maintained in the network database;

FIG. 48 is an exemplary wire frame model of a graphical user interface of a mobile application of the present invention configured used by customers who place orders for prefabricated Class-A fire-protected wood-framed buildings, supported by the system of the present invention;

FIG. 49 is an exemplary wire frame model for a graphical user interface of a mobile application configured for use by project administrators, managers, fabricators, and technicians showing a high-level menu of services supported by the system network of the present invention, shown in FIGS. 44A, 44B and 45;

FIG. 50 is a perspective view of a bundle of Class-A fire-protected finger-jointed lumber produced along the production line in the automated fire-treated lumber factory illustrated in FIGS. 51A, and 51B;

FIG. 51A is a perspective view of an automated lumber factory supporting an automated process for continuously fabricating Class-A fire-protected finger-jointed lumber products which, after the planning and dimensioning stage, are automatically dip-coated in a bath or reservoir of clean fire inhibiting biochemical liquid of the present invention, and then automatically packaged, stack-dried and wrapped in a high-speed and economical manner;

FIG. 51B is a perspective view of the high-speed CFIC dip-coating stage depicted in FIG. 49A, showing the various components used to implement this subsystem along the production line of the automated lumber factory;

FIGS. 52A and 52B, taken together, set forth a flow chart describing the high-level steps carried out when practicing the method of producing Class-A fire-protected finger-jointed lumber pieces (e.g. studs or beams) in the automated fire-treated lumber factory shown in FIGS. 44A, 44B, and 45;

FIG. 53 is a perspective view of a Class-A fire-protected cross-laminated-timber (CLT) product (e.g. panel, stud, beam, etc.) fabricated along the production line of the automated lumber fabrication factory shown in FIGS. 44A and 44B;

FIG. 54A is a perspective view of an automated lumber fabrication factory supporting an automated process for continuously fabricating cross-laminated timber (CLT) products which, after the planning and dimensioning stage, are automatically dip-coated in a bath of clean fire inhibiting chemical (CFIC) liquid, and then stacked, packaged, and wrapped in a high-speed manner to produce Class-A fire-protected CLT products;

FIG. 54B is a perspective view of the automatic cross-laminated timber (CLT) dip-coating stage deployed along the production line of the automated lumber fabrication factory shown in FIGS. 44A, 44B and 45;

FIGS. 55A and 55B, taken together, set forth a flow chart describing the high-level steps carried out when practicing the method of producing Class-A fire-protected cross-laminated timber (CLT) products in the automated fire-treated lumber factory illustrated in FIGS. 44A, 44B and 45;

FIG. 56 is a perspective of a cut-away portion of a piece of Class-A fire-protected oriented strand board (OSB) sheathing produced using the method described in FIGS. 58A, 58B and 58C in the automated factory shown in FIGS. 44A and 44B;

FIG. 57 is a cross-sectional schematic diagram of a section of the Class-A fire-protected OSB sheathing shown in FIG. 56;

FIGS. 58A, 58B and 58C, taken together, set forth a flow chart describing the high-level steps carried out when practicing the method of producing clean Class-A fire-protected OSB sheathing in accordance with the present invention, as illustrated in FIGS. 56 and 57;

FIG. 59A is a schematic representation of the automated factory configured for producing Class-A fire-protected OSB sheathing in accordance with the principles of the present invention as described in FIGS. 58A, 58B and 58C;

FIG. 59B is a perspective view of the automatic OSB sheathing dip-coating stage deployed along the production line of the automated lumber fabrication factory shown in FIGS. 44A, 44B and 45; and

FIG. 59C is a perspective view of the automatic OSB sheathing spray-coating tunnel stage and drying tunnel stage deployed along the production line of the automated lumber fabrication factory shown in FIGS. 44A, 44B and 45.

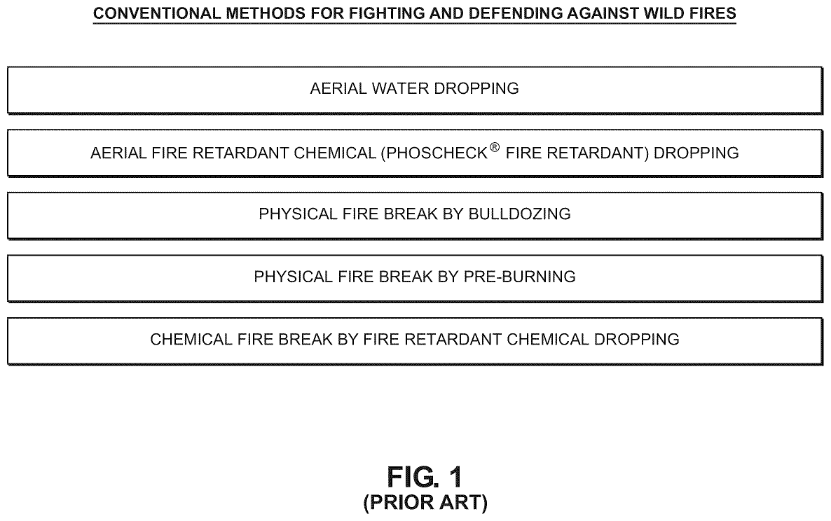

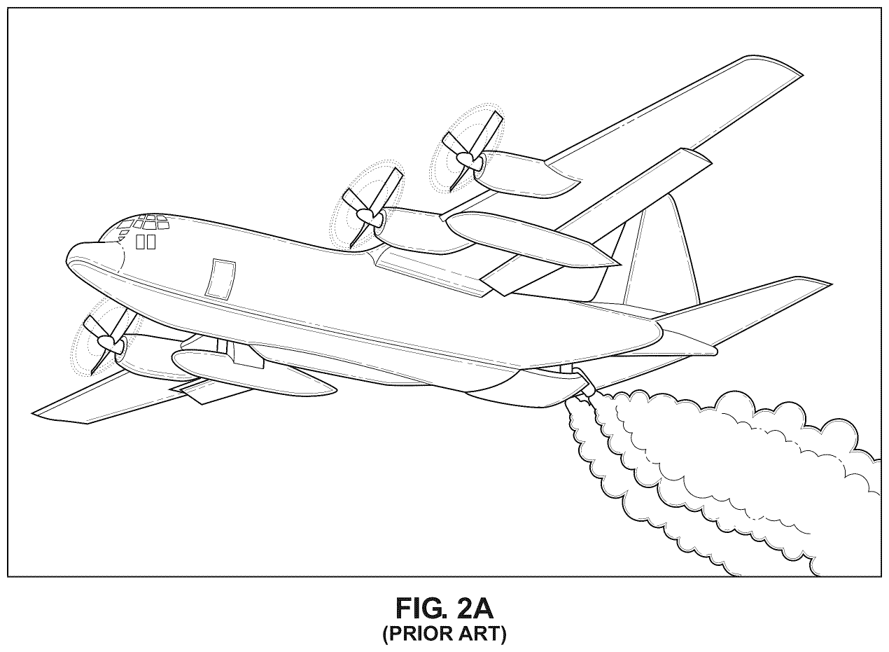

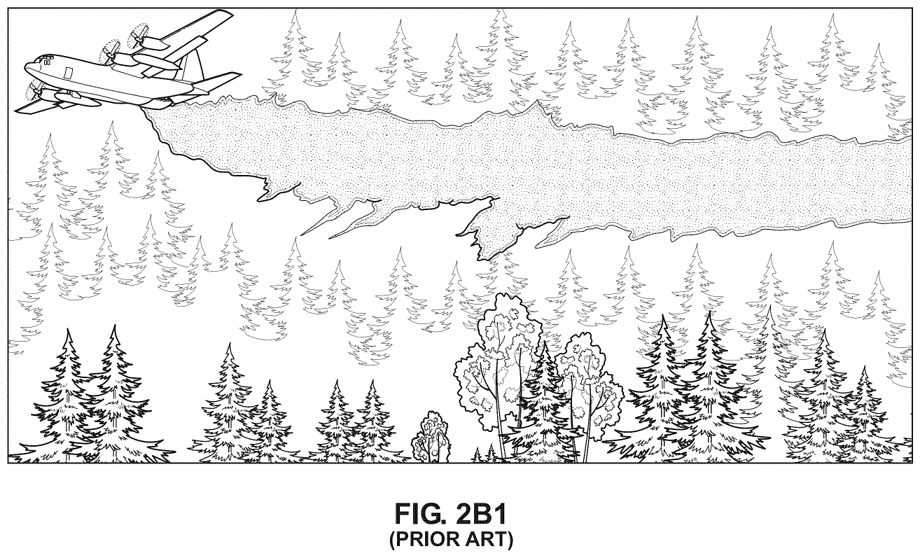

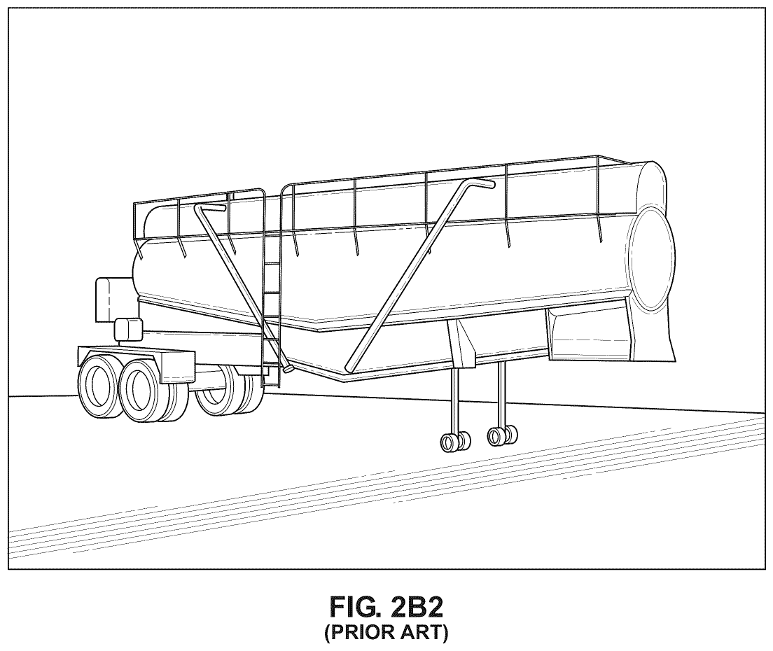

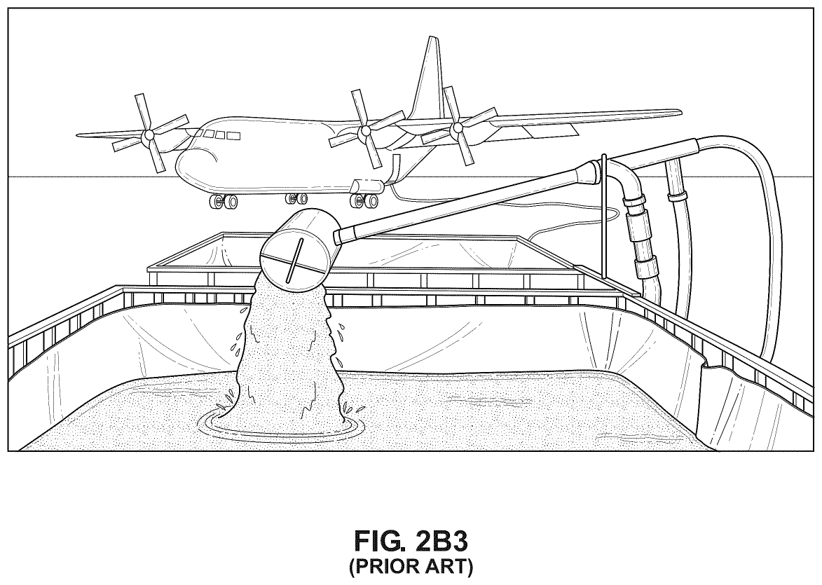

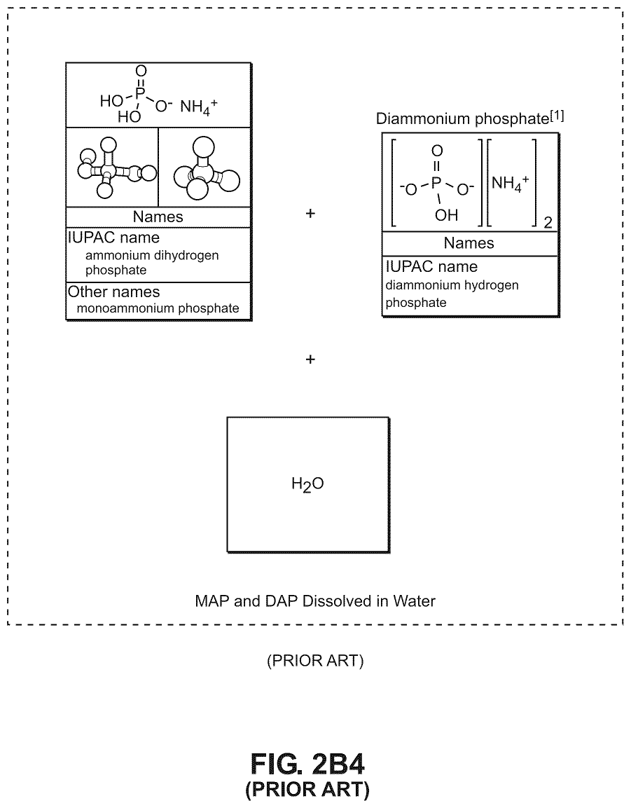

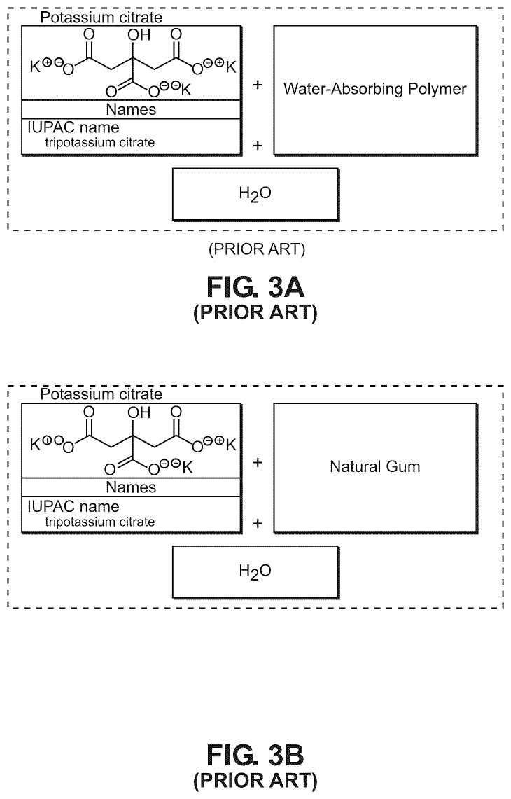

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Wireless System Network for Managing the Supply, Delivery and Spray-Application of Environmentally-Clean Anti-Fire/Fire-Inhibiting/Extinguishing Biochemical Liquid on Private and Public Property to Reduce the Risks of Damage and/or Destruction Caused by Wild Fires

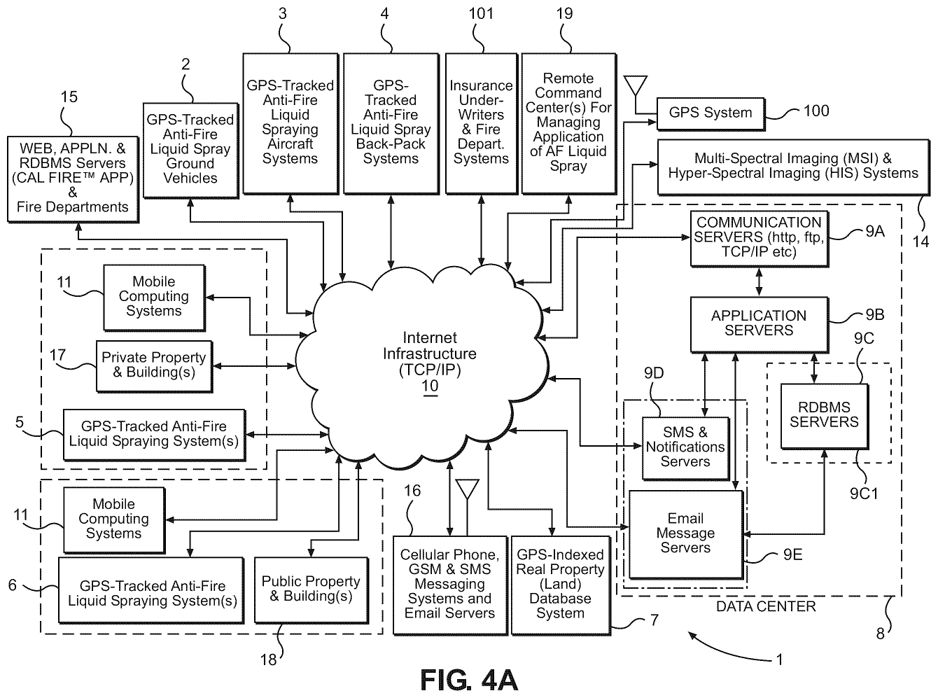

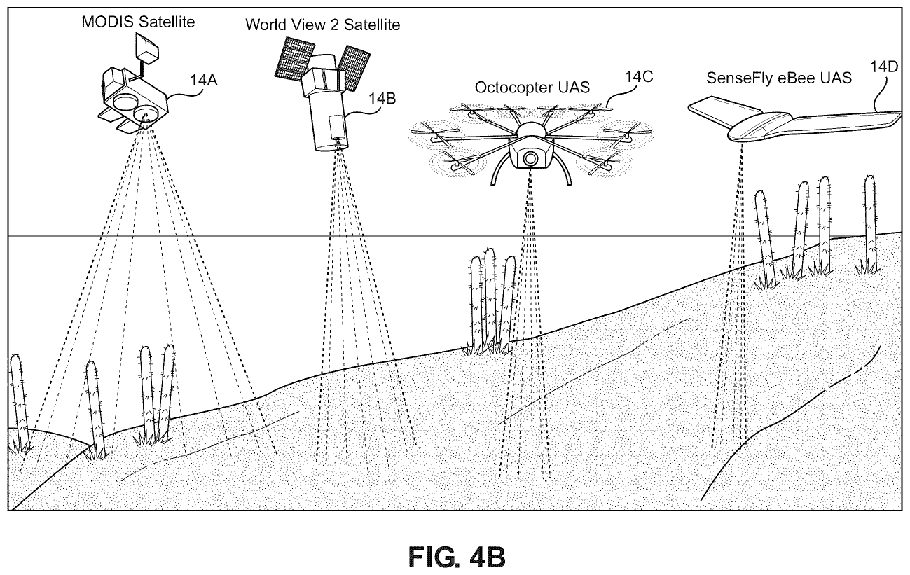

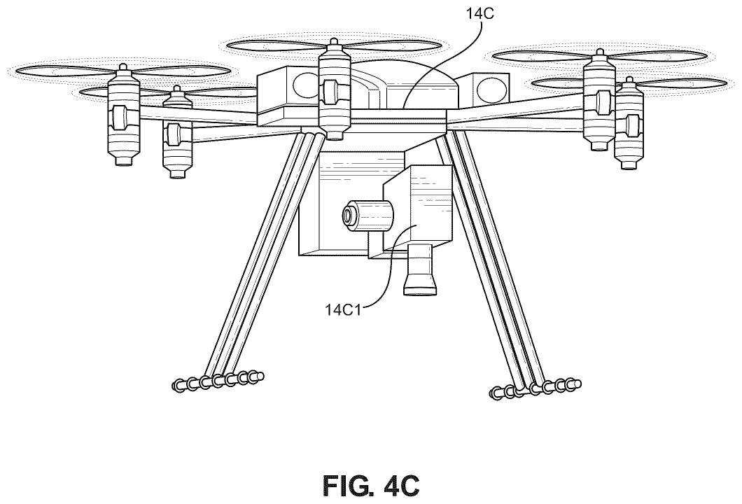

FIG. 4A shows the wireless system network of the present invention 1 designed for managing the supply, delivery, and spray-application of environmentally-clean anti-fire (AF) biochemical liquid composition of the present invention, on private and public property to reduce the risks of damage and/or destruction caused by wild fires.

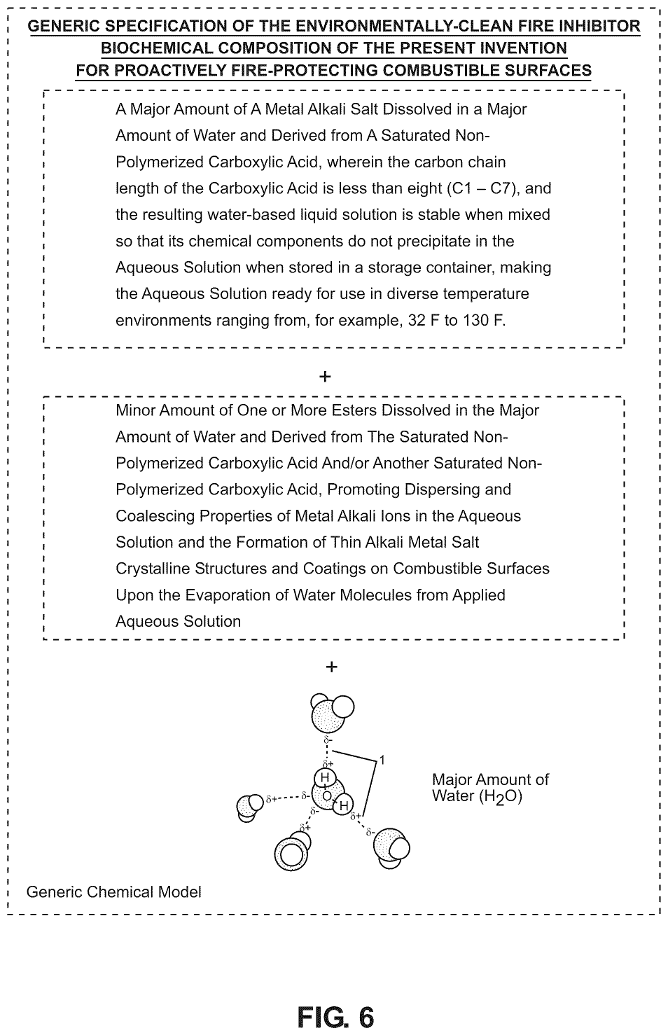

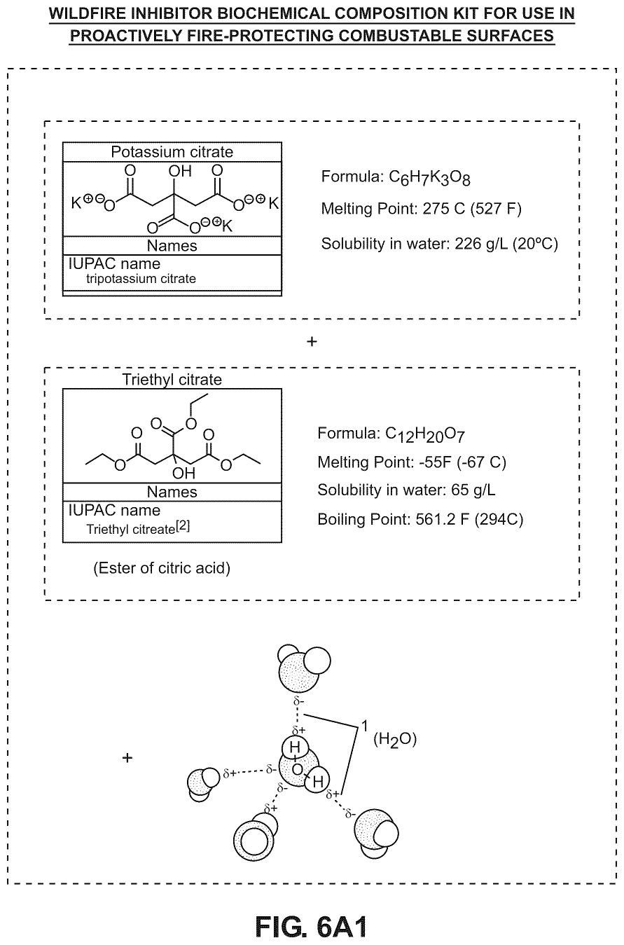

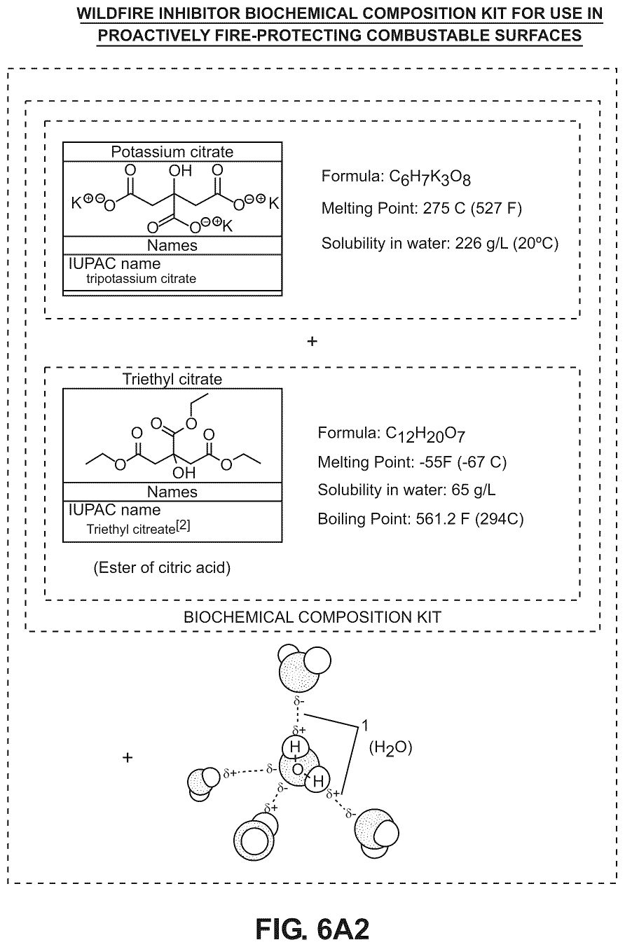

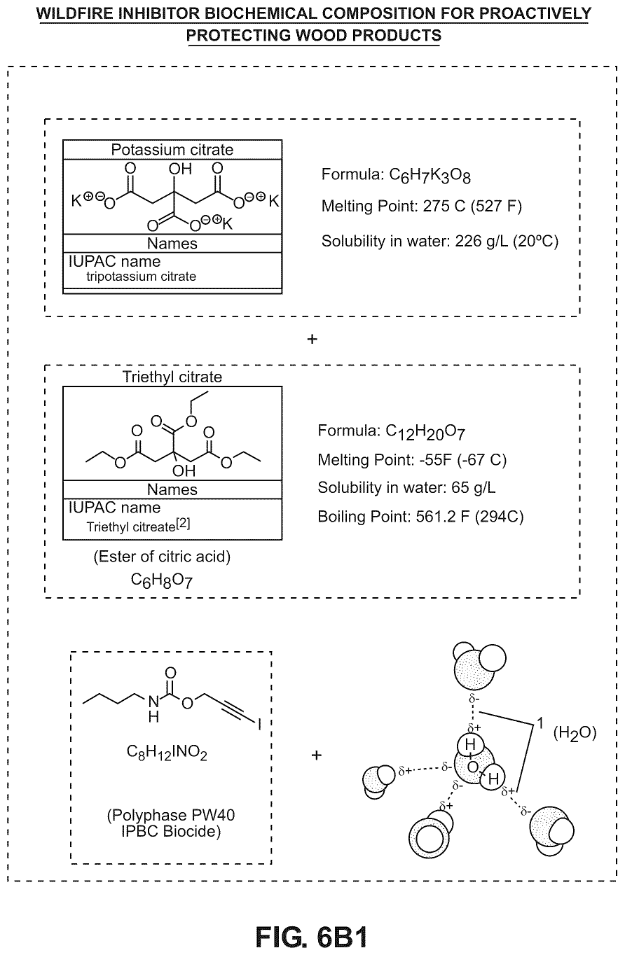

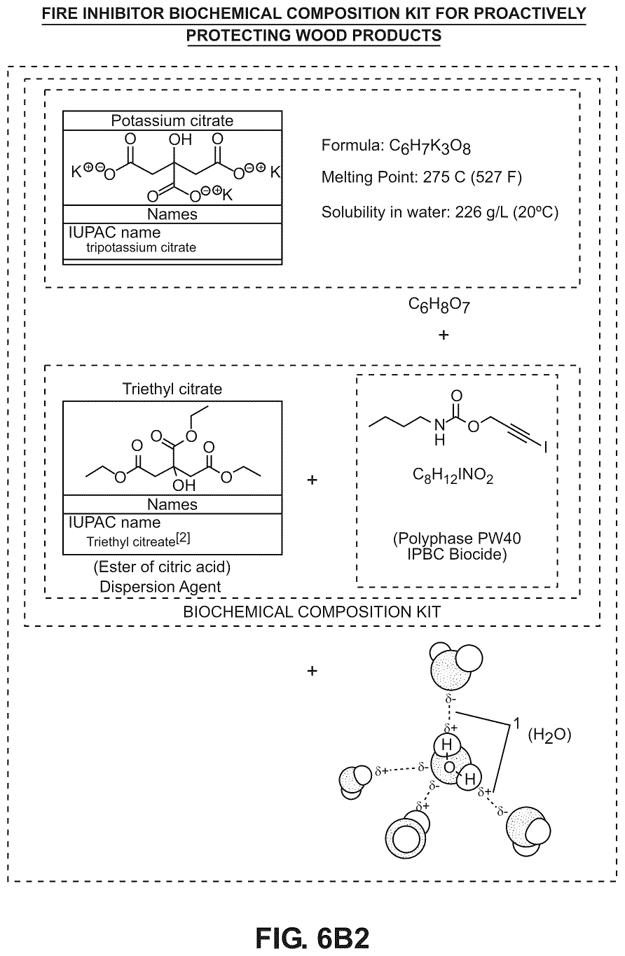

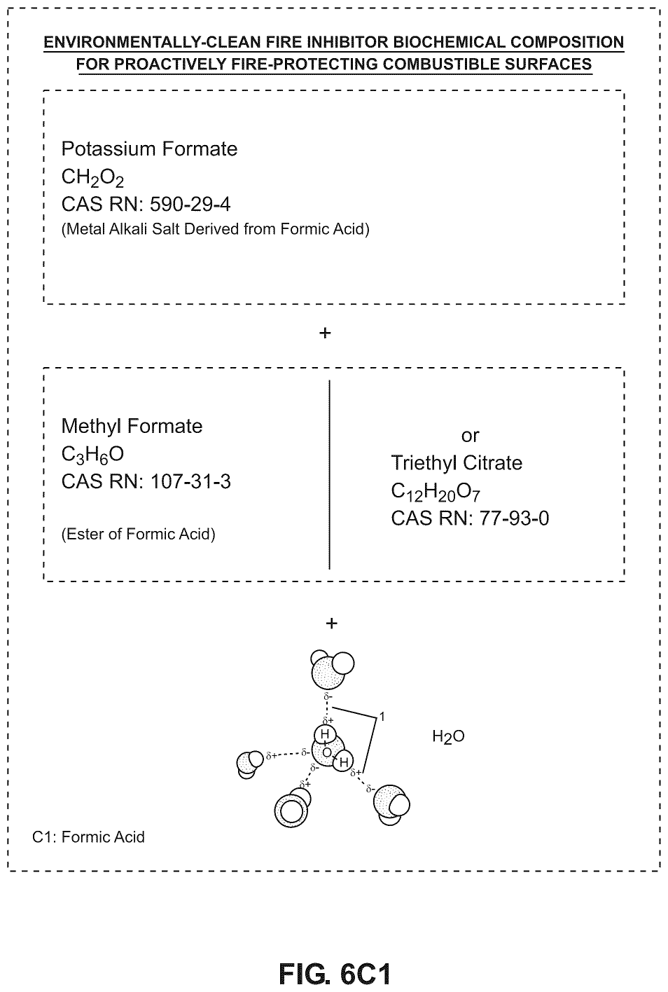

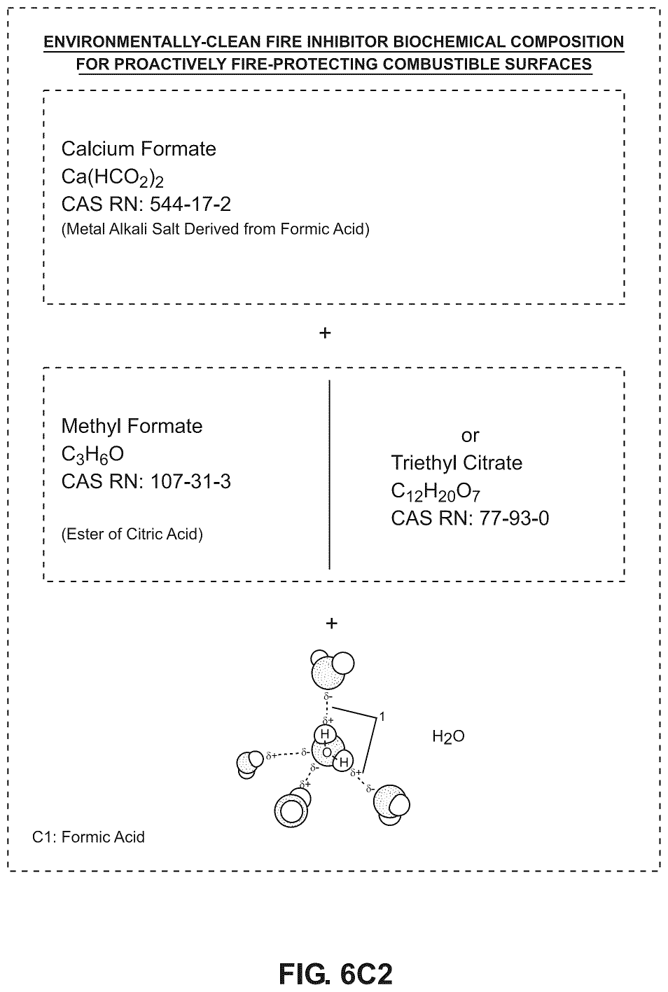

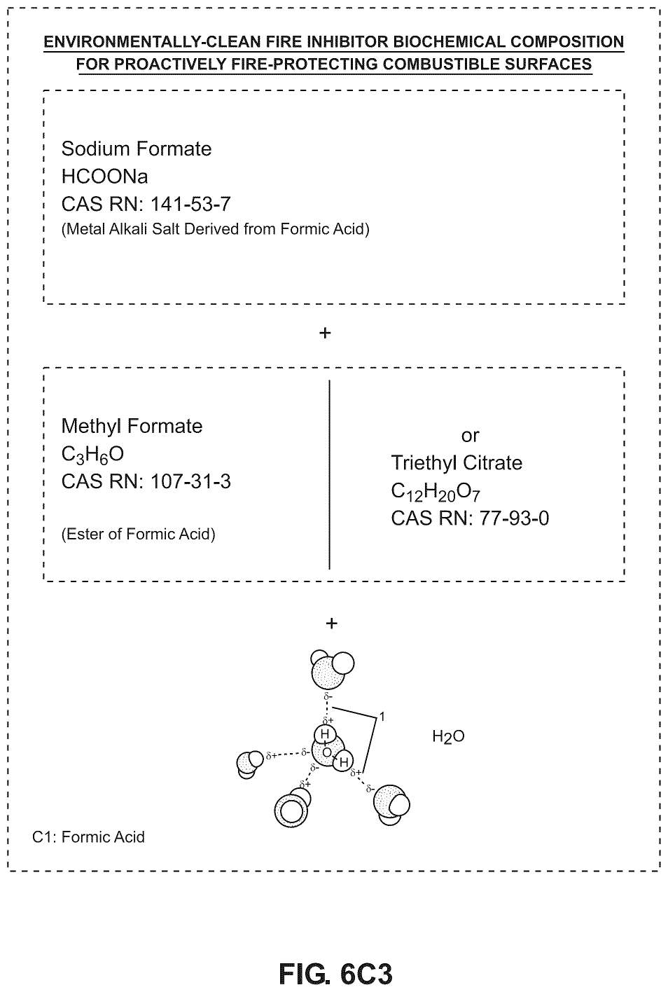

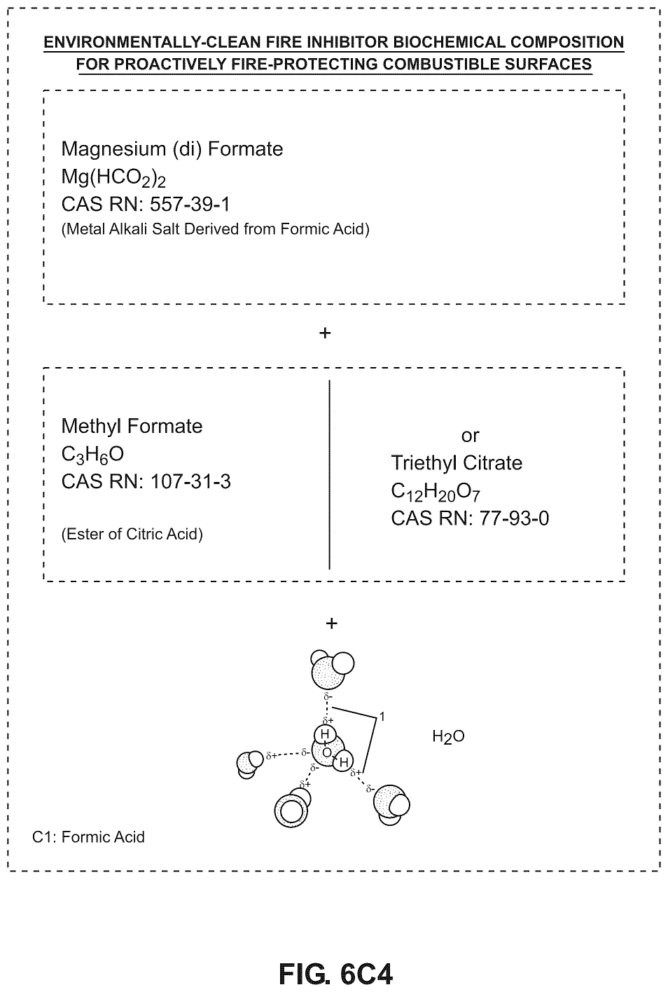

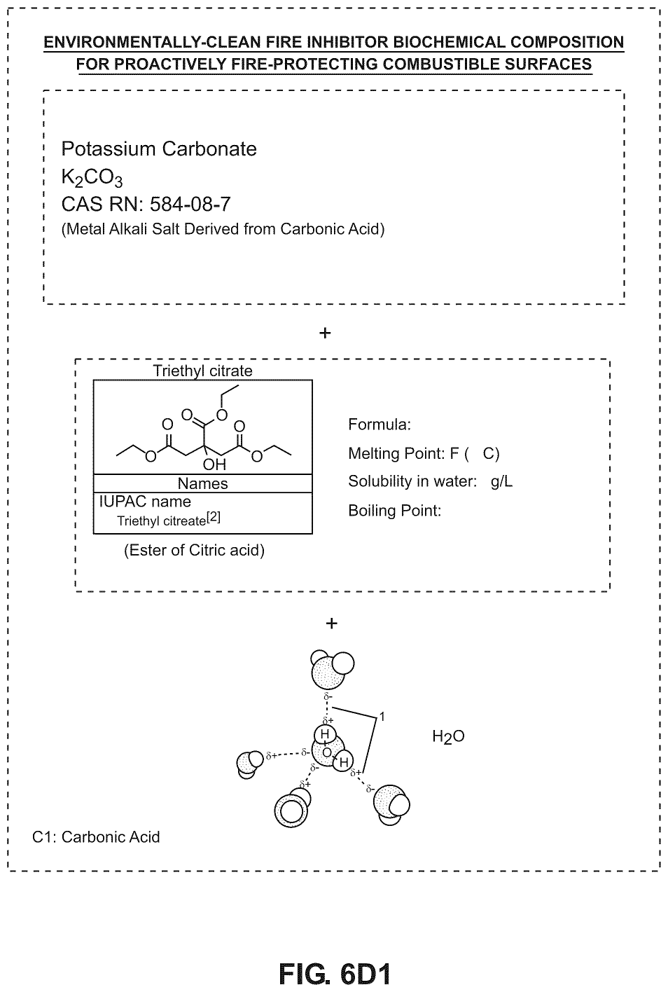

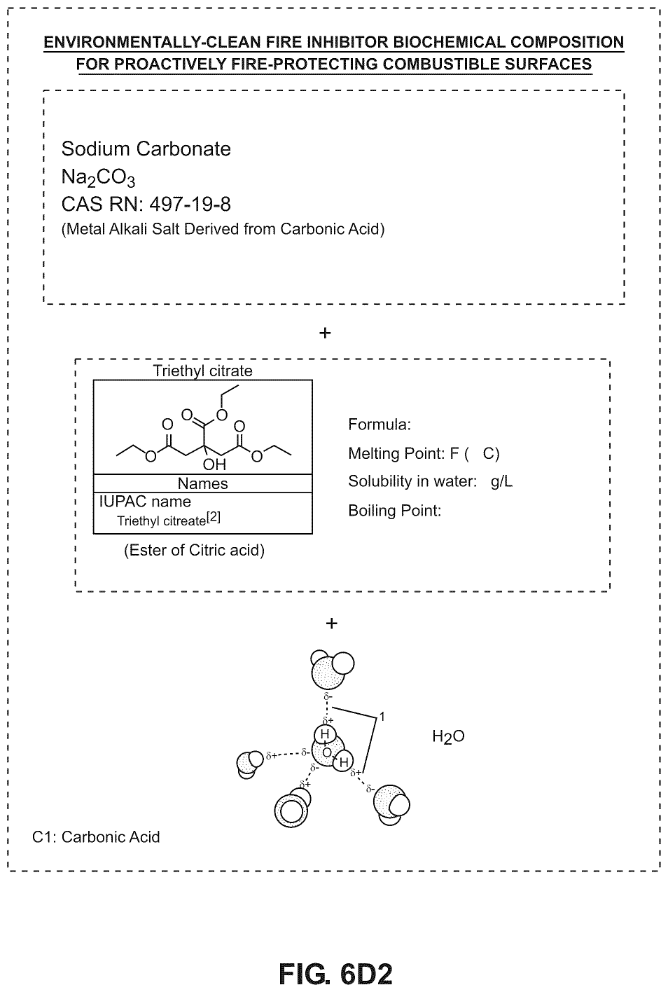

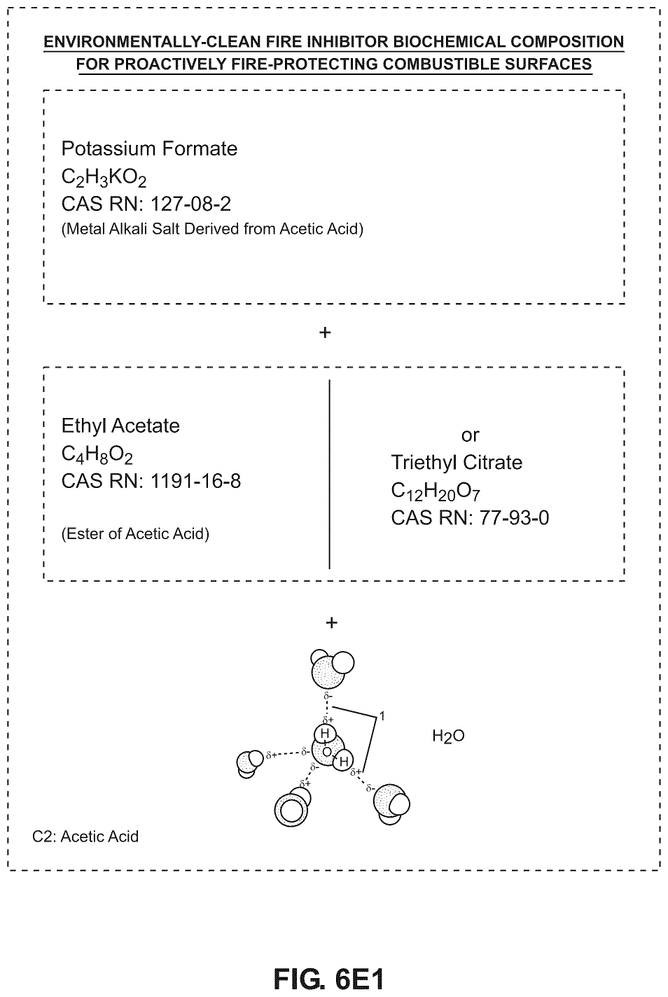

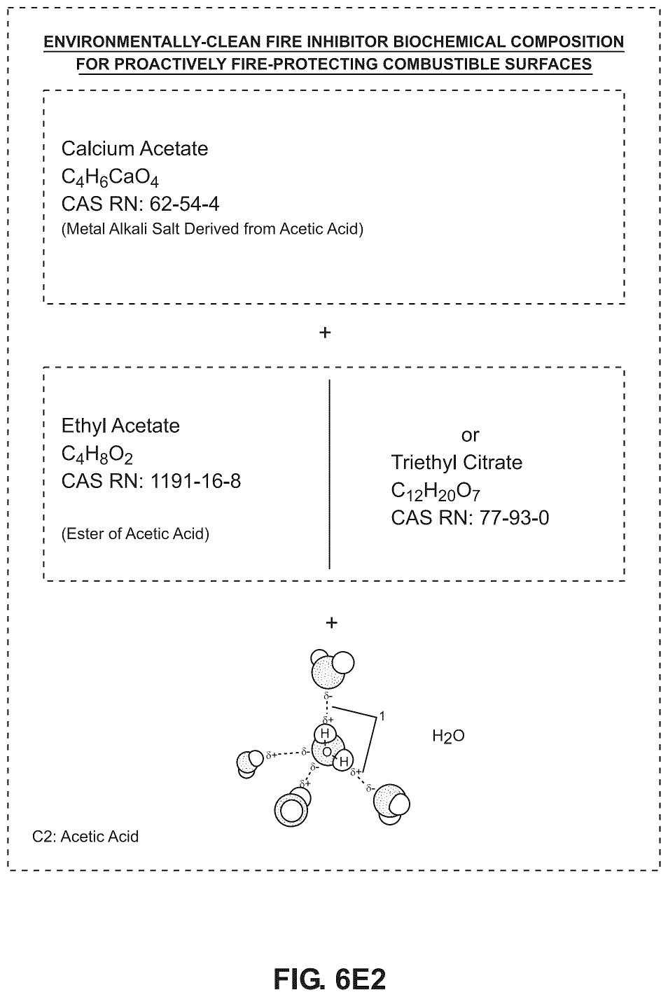

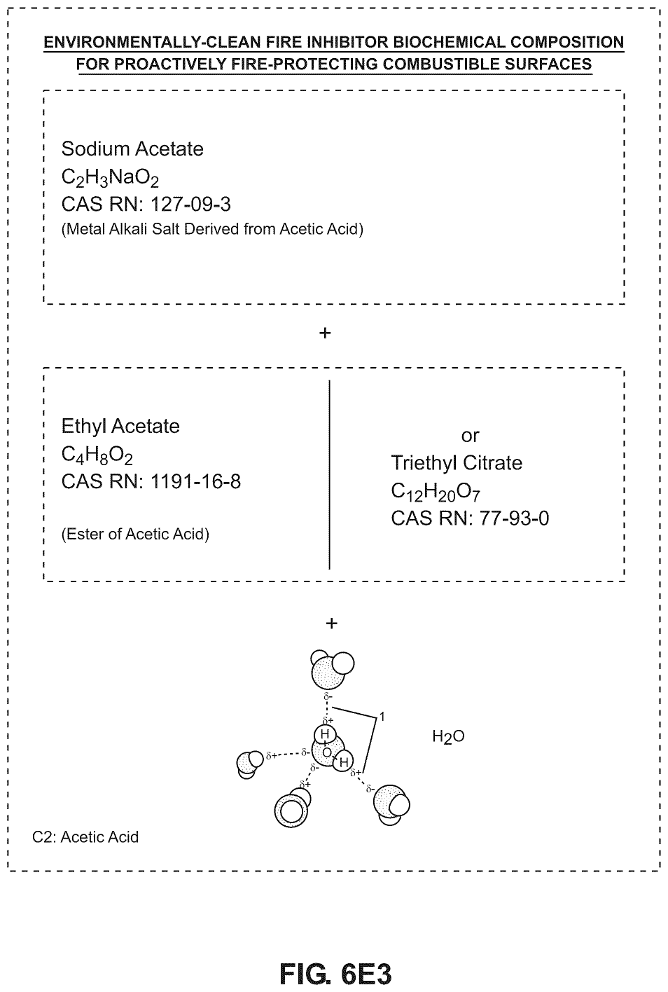

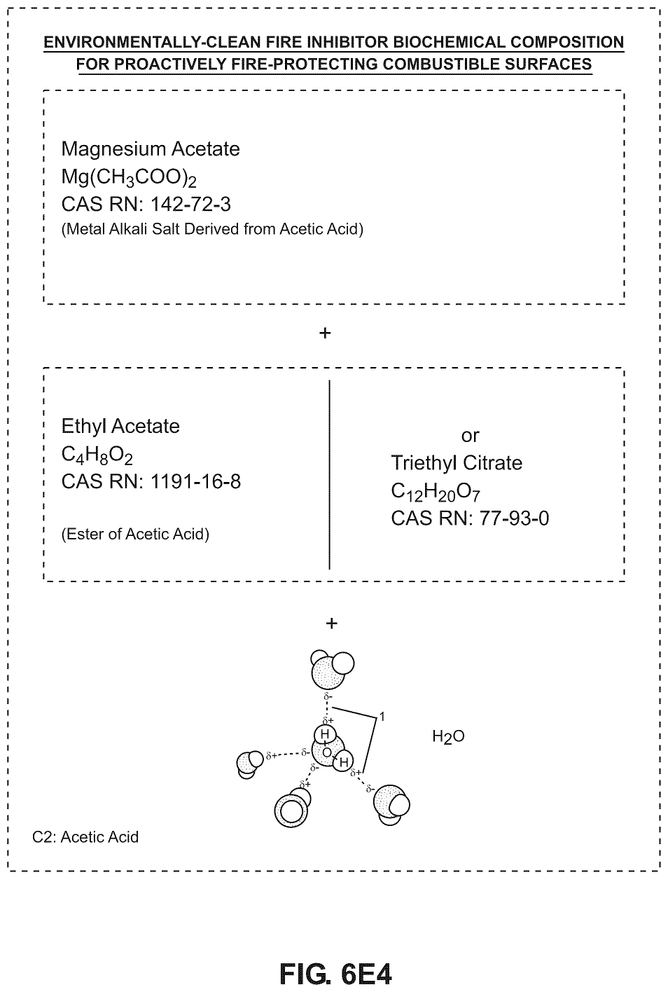

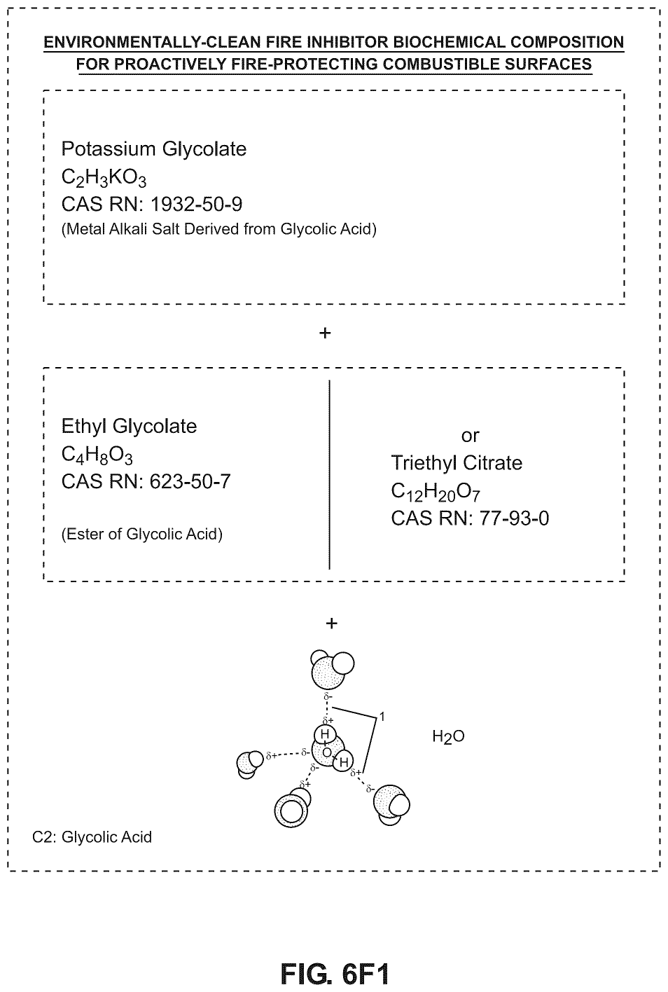

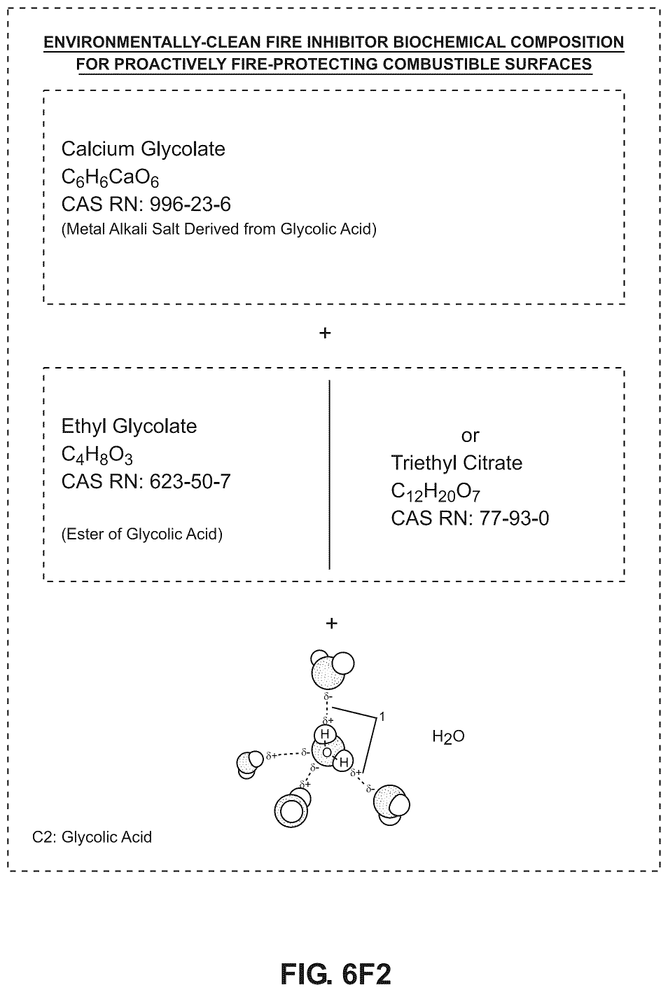

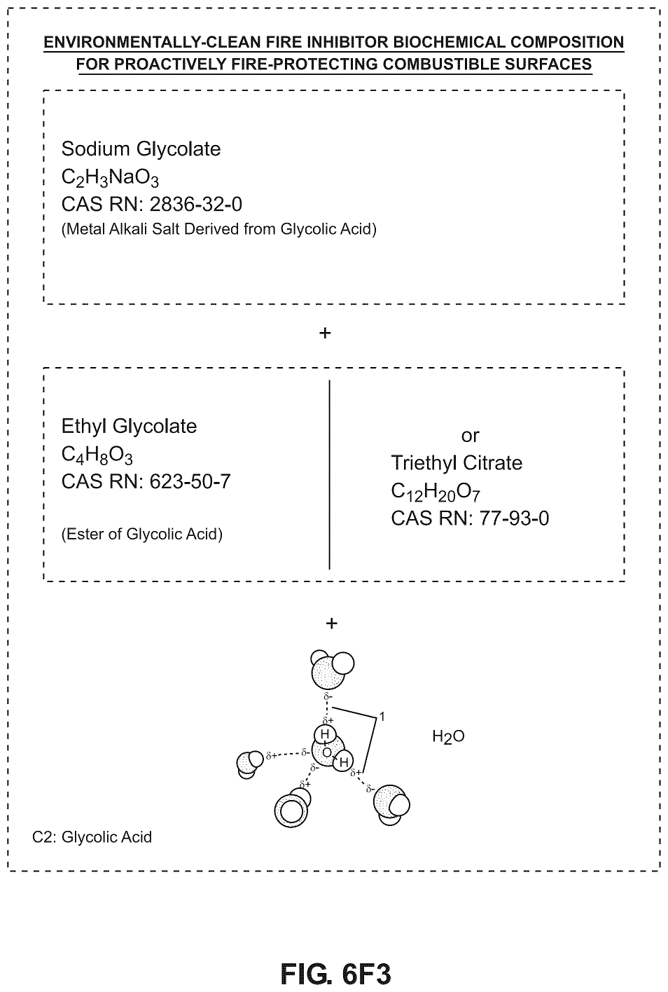

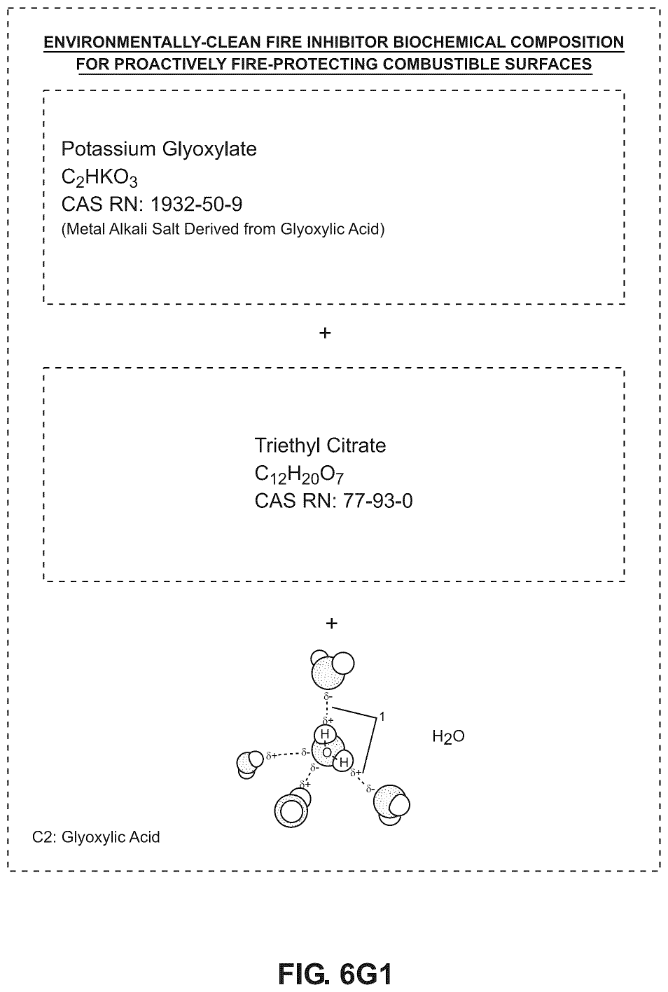

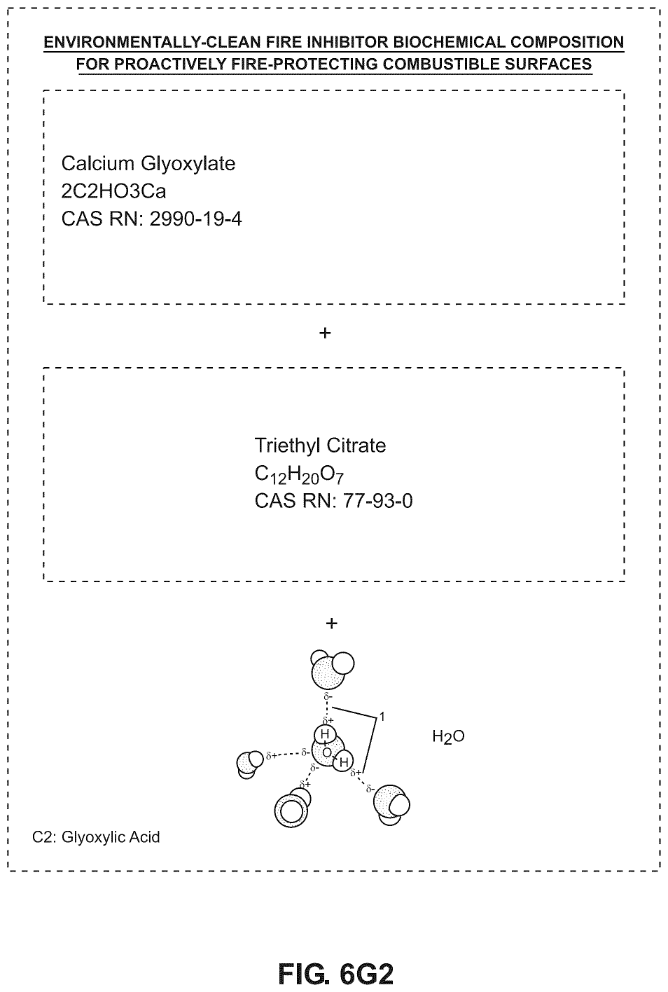

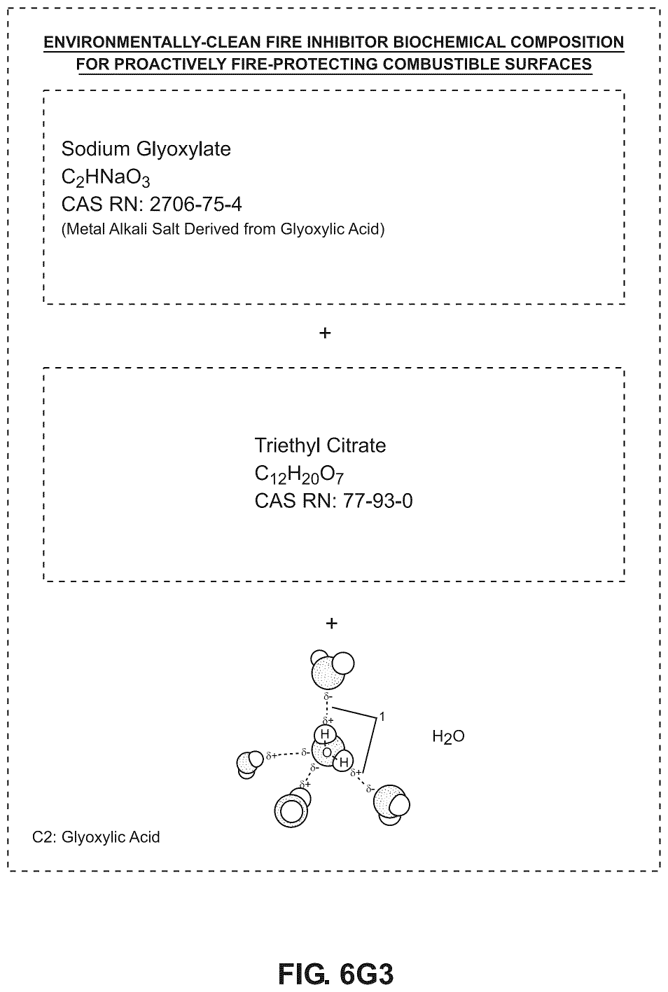

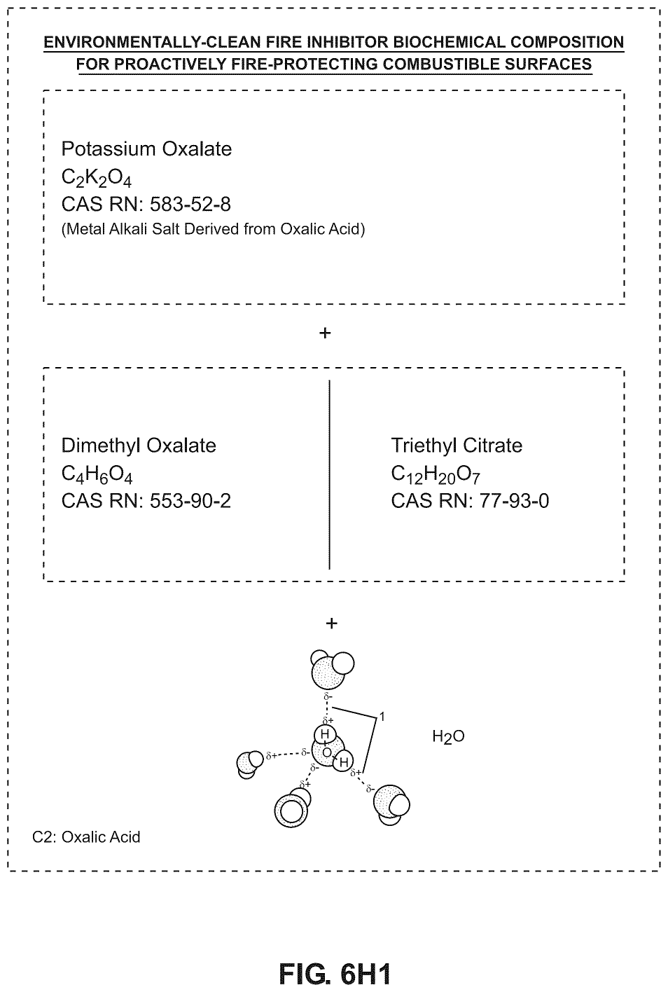

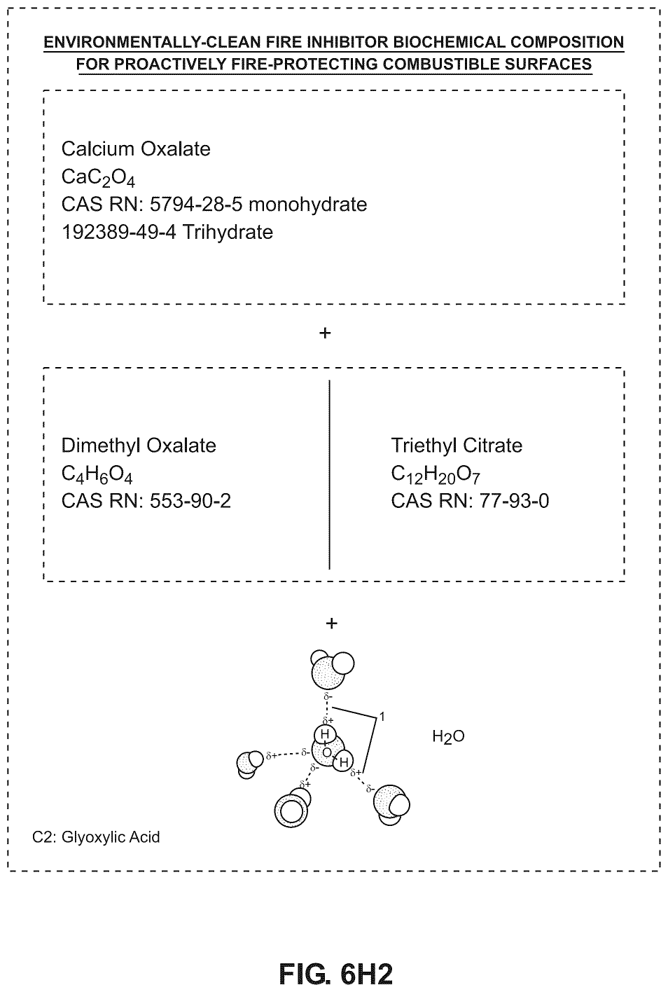

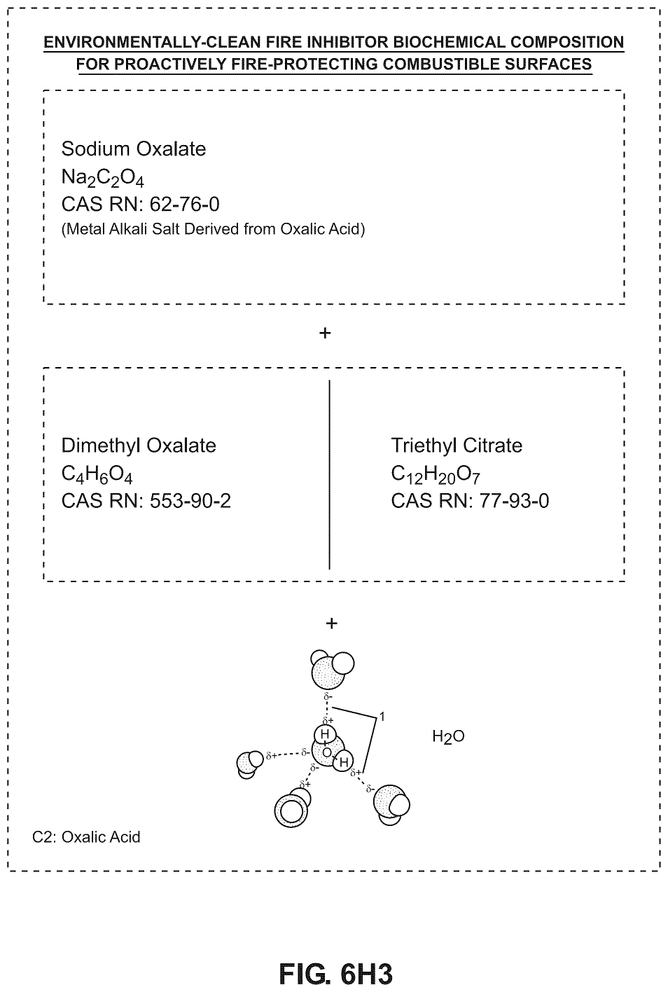

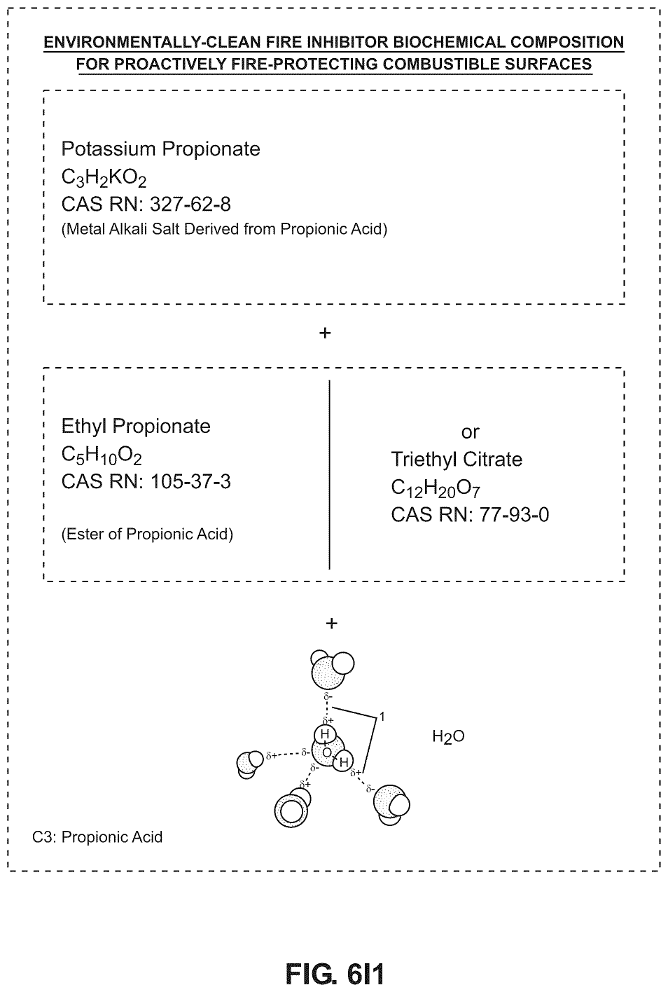

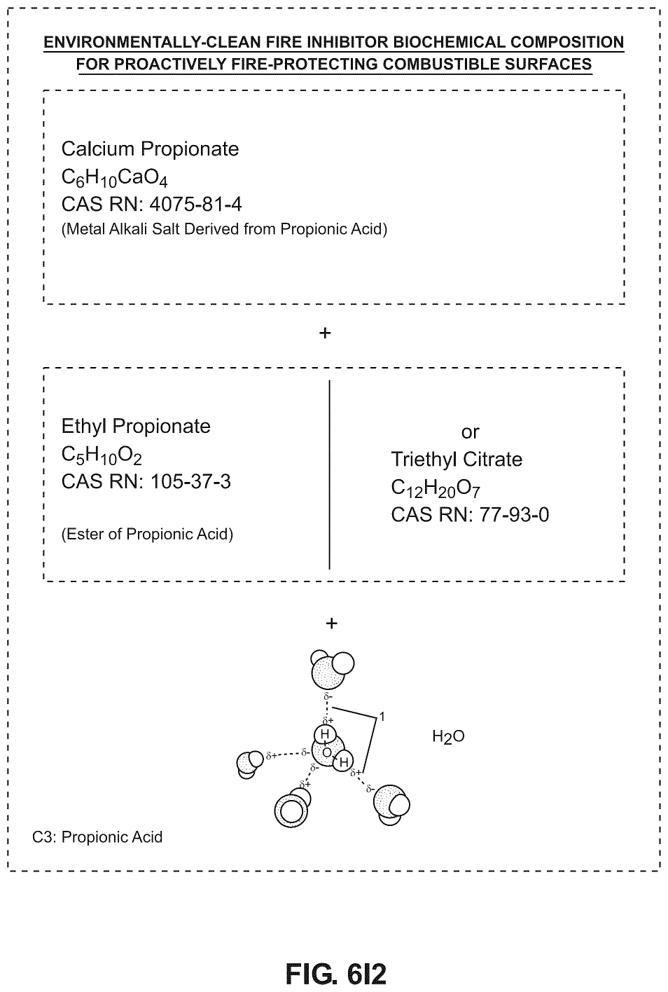

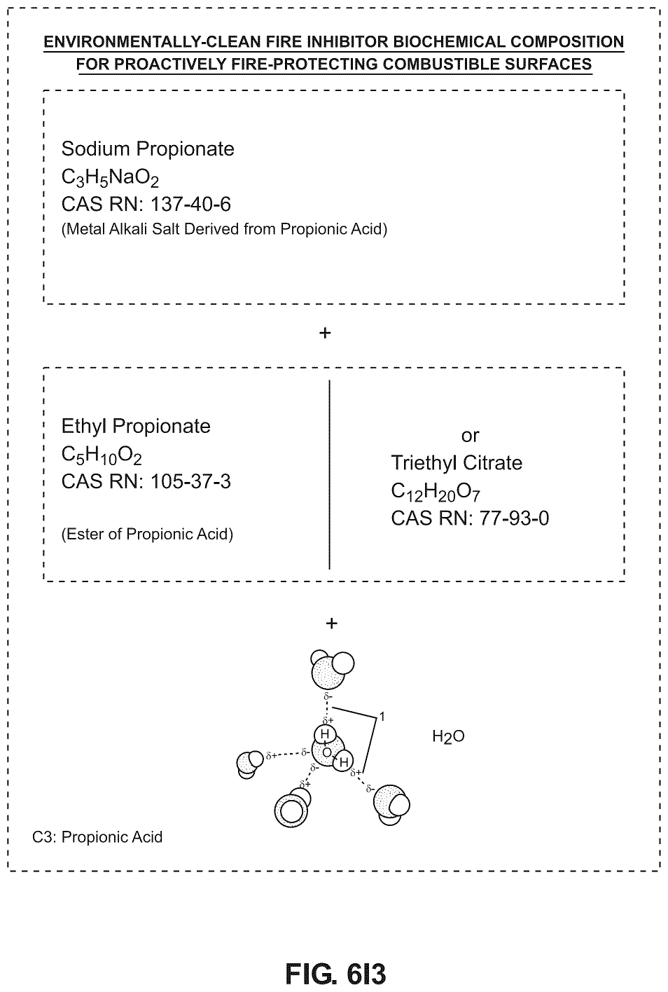

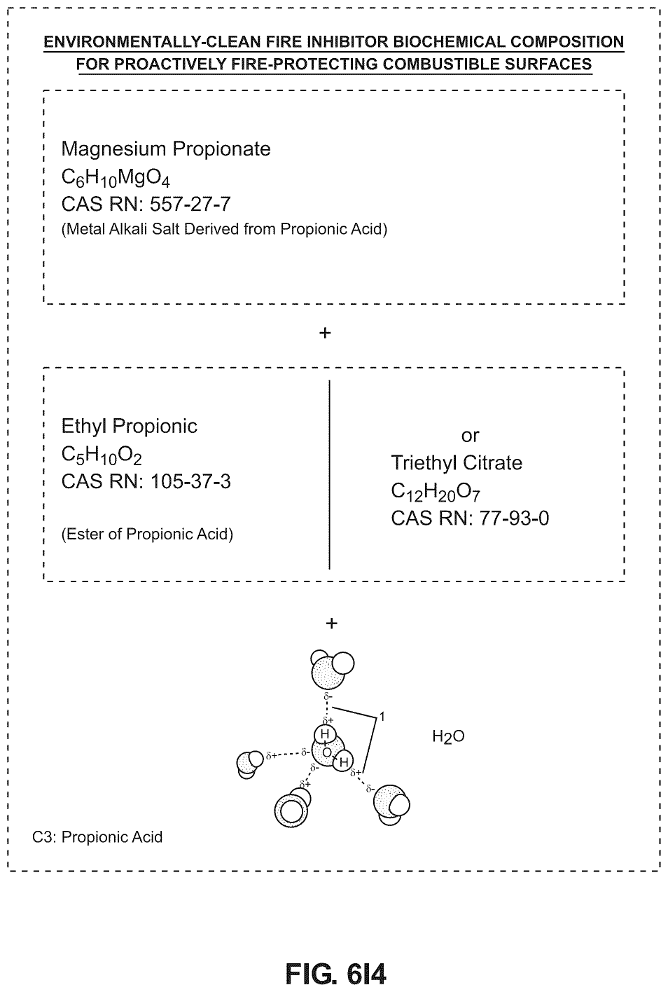

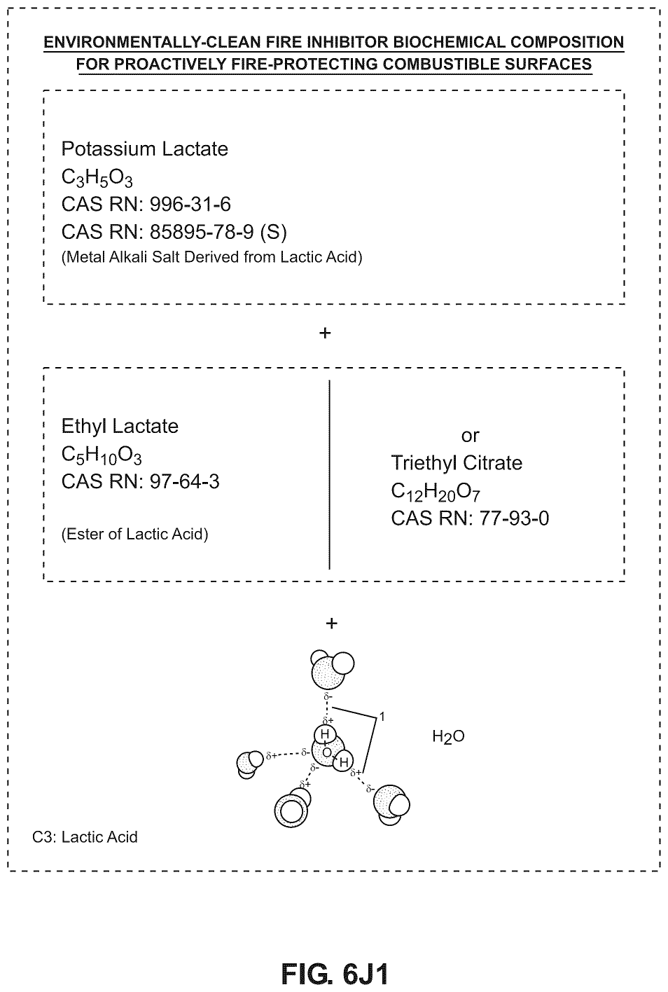

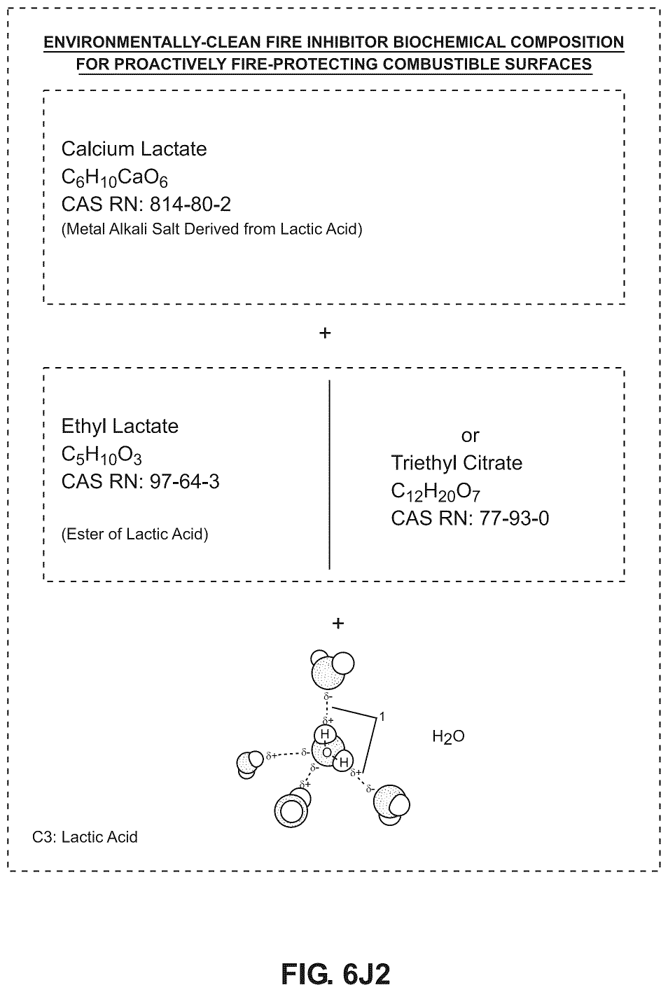

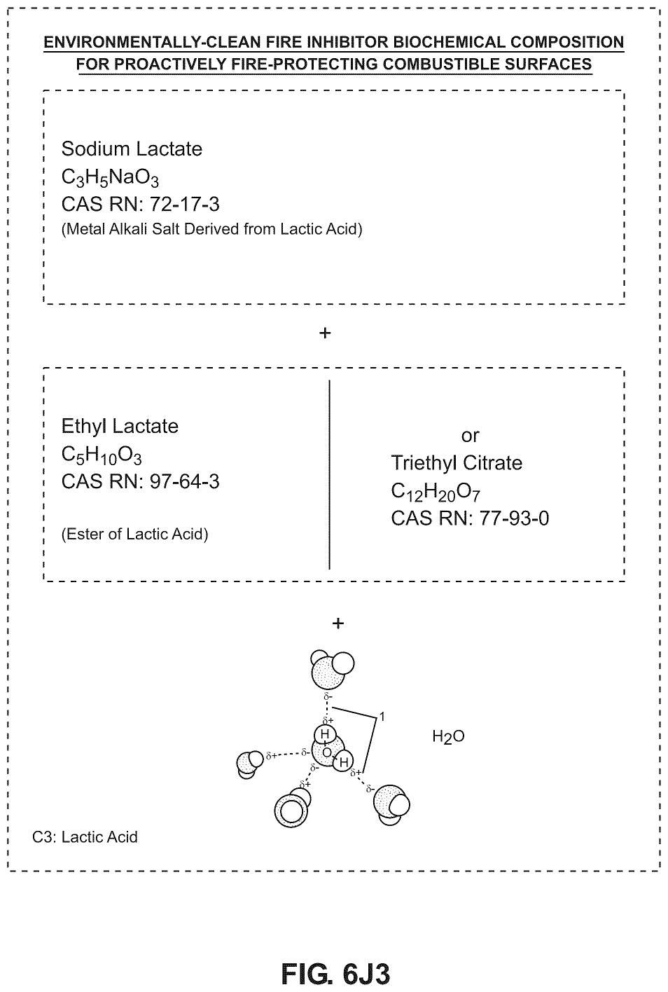

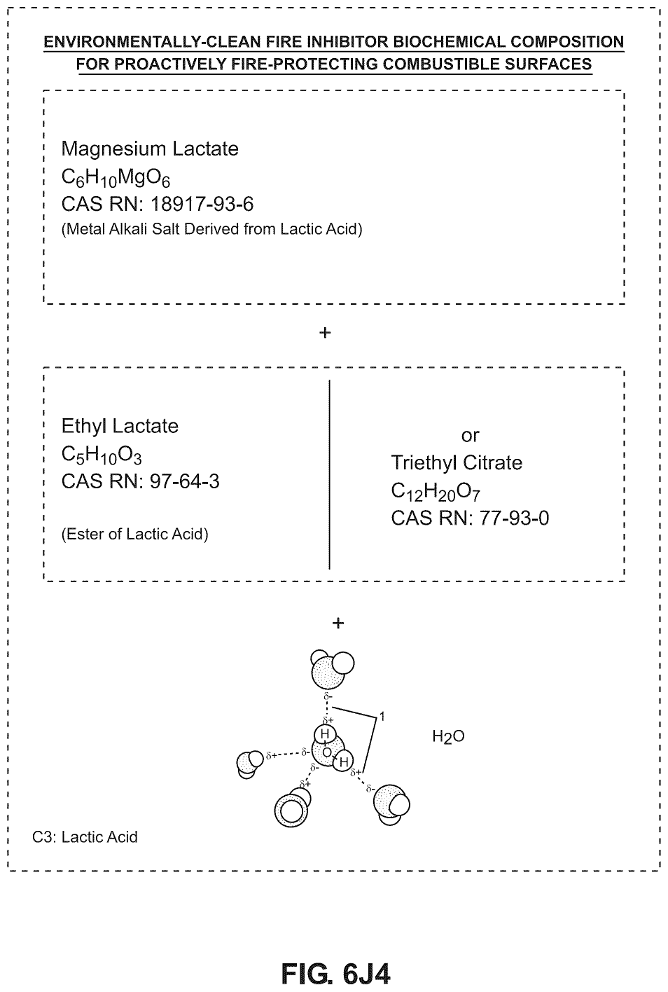

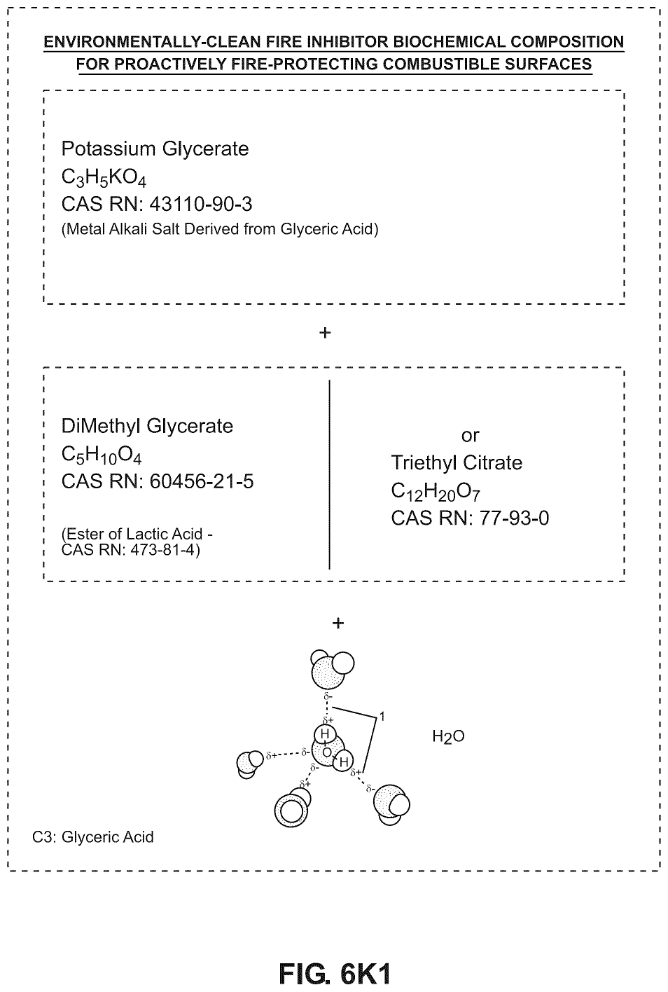

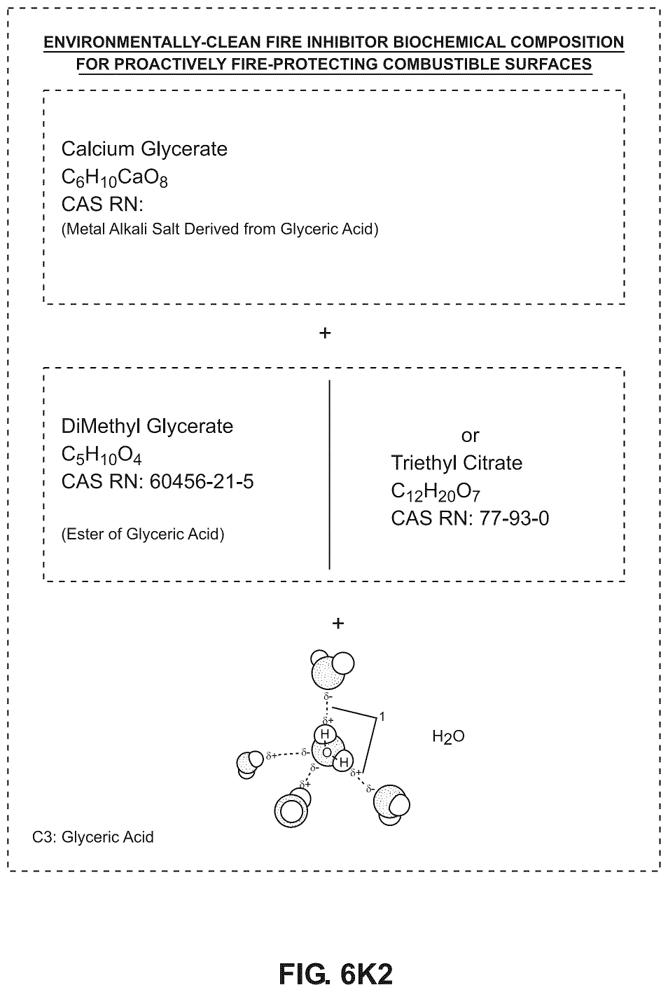

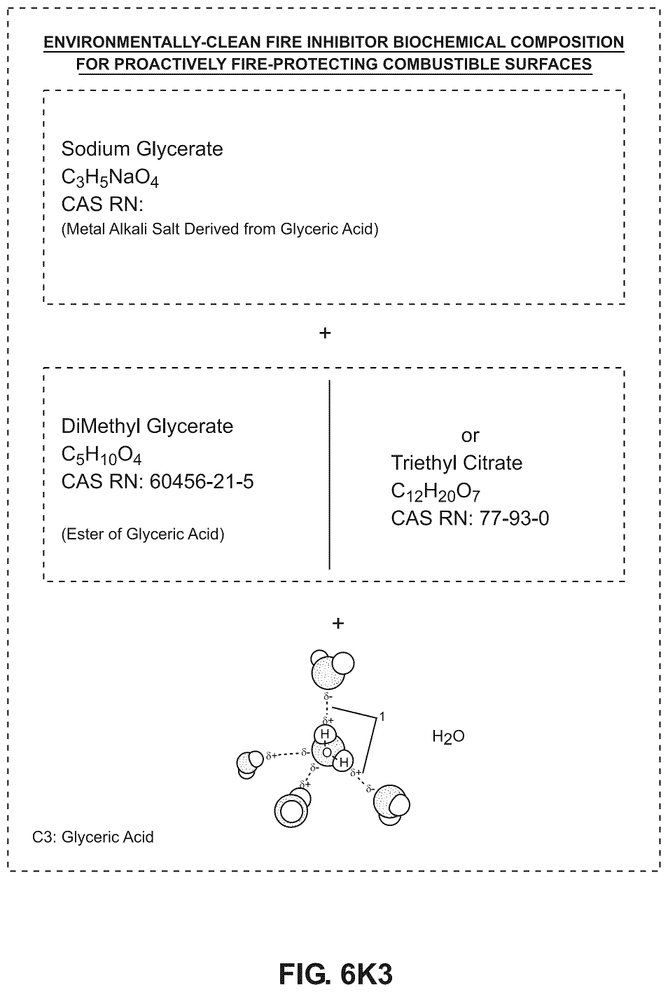

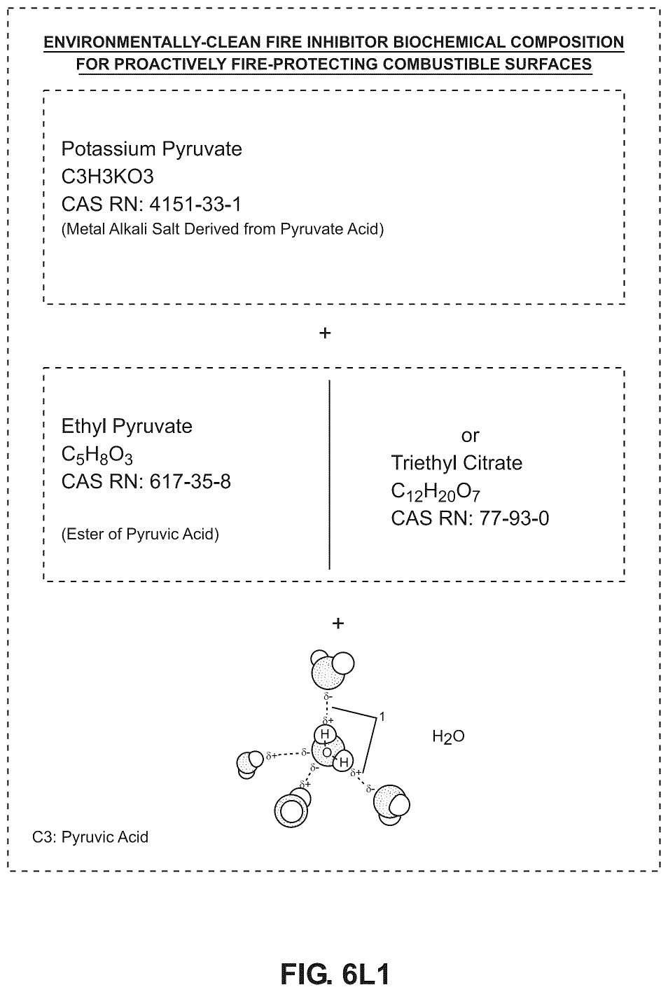

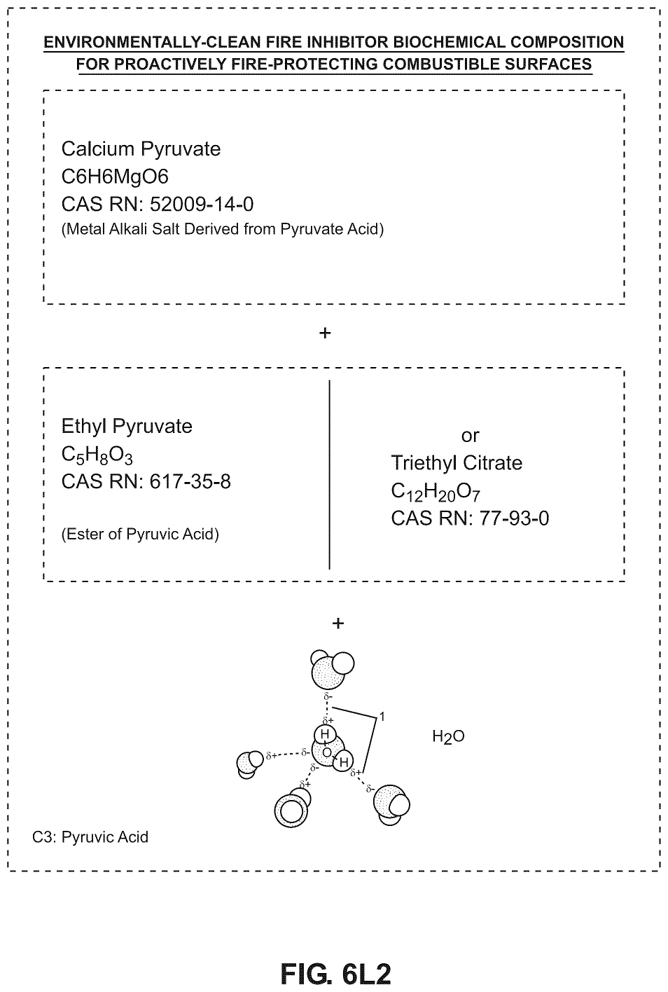

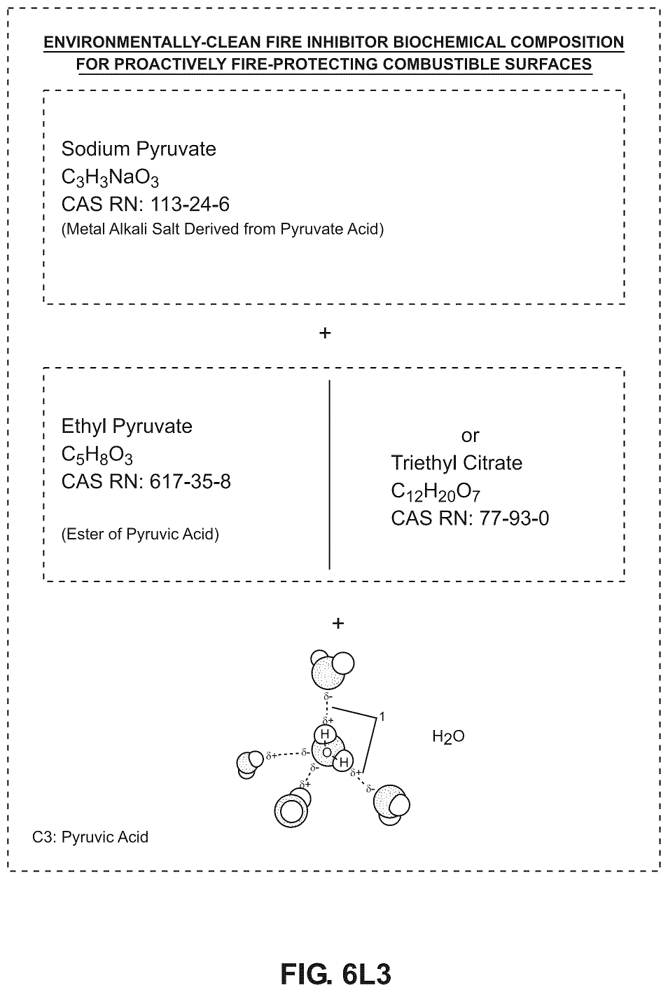

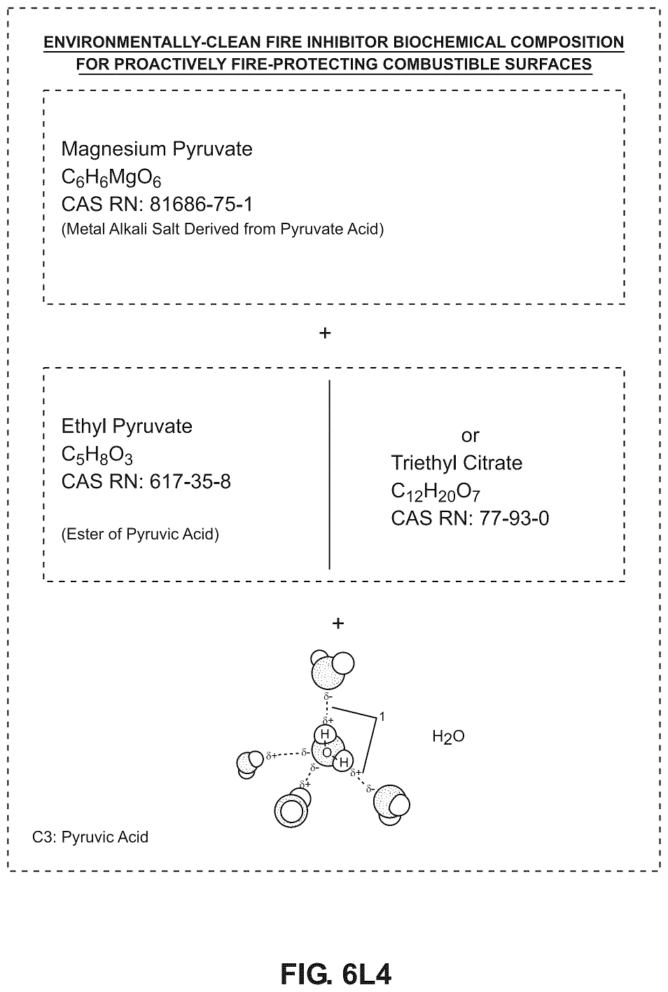

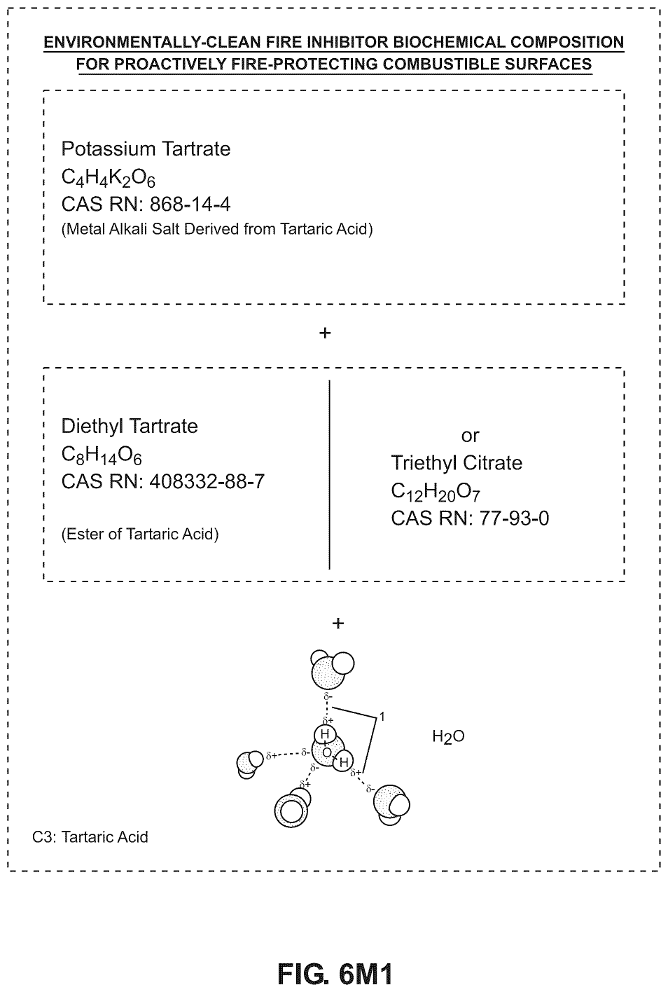

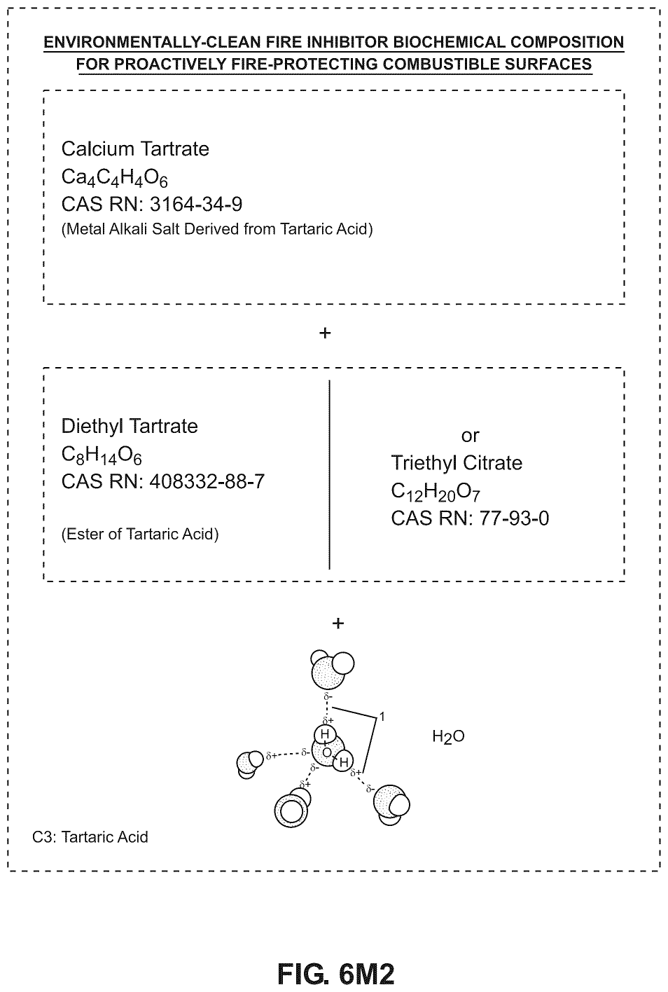

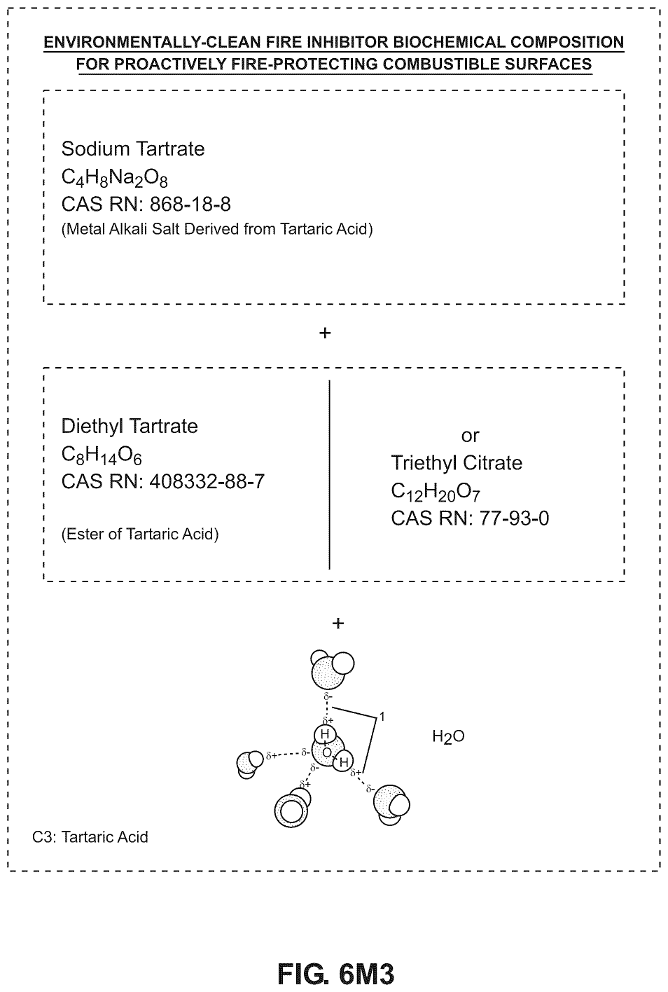

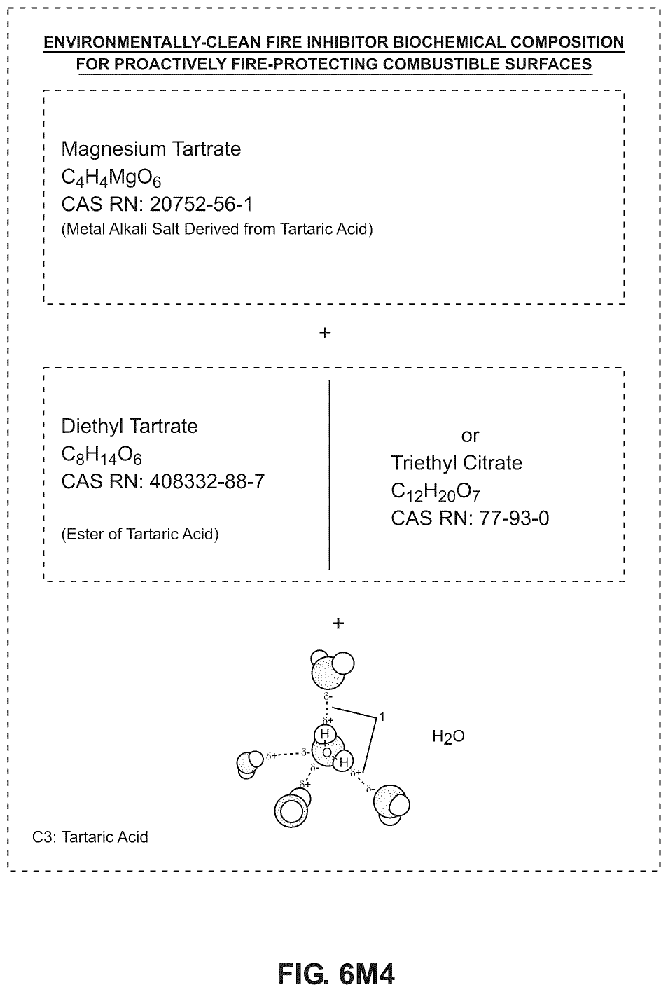

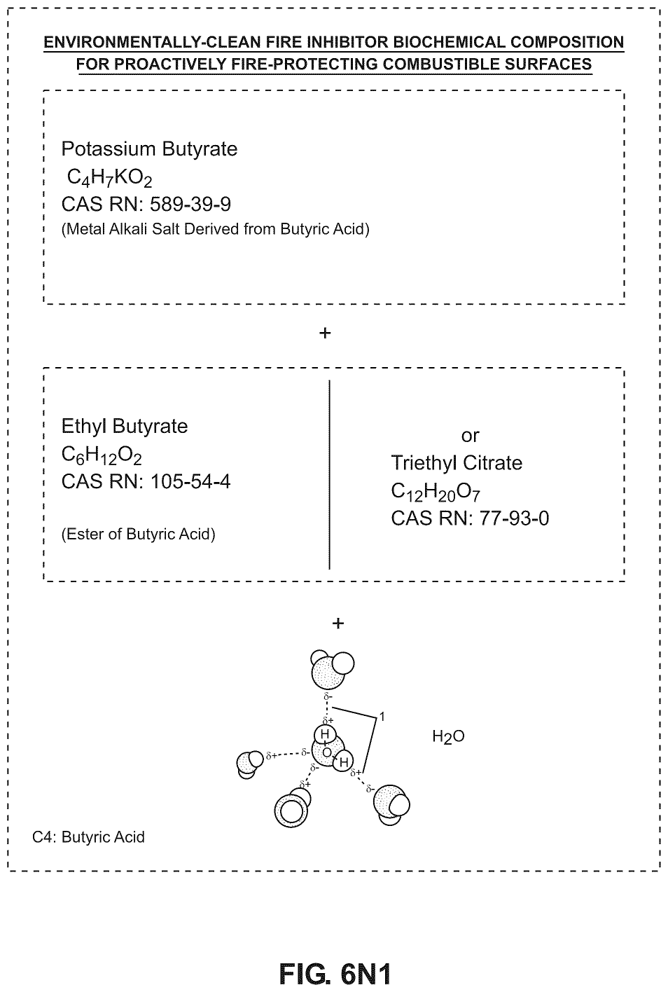

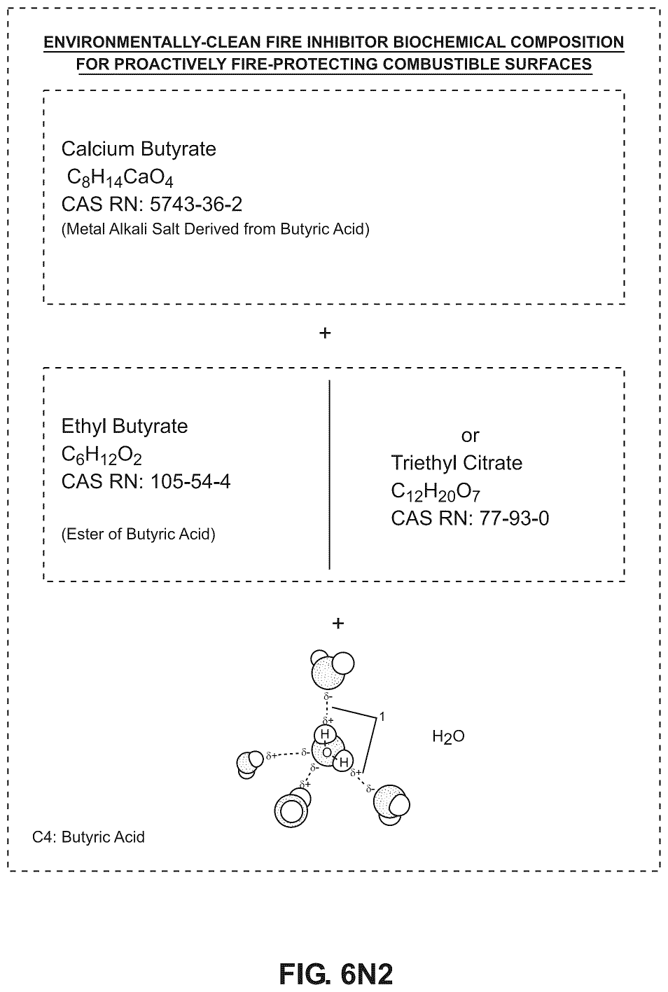

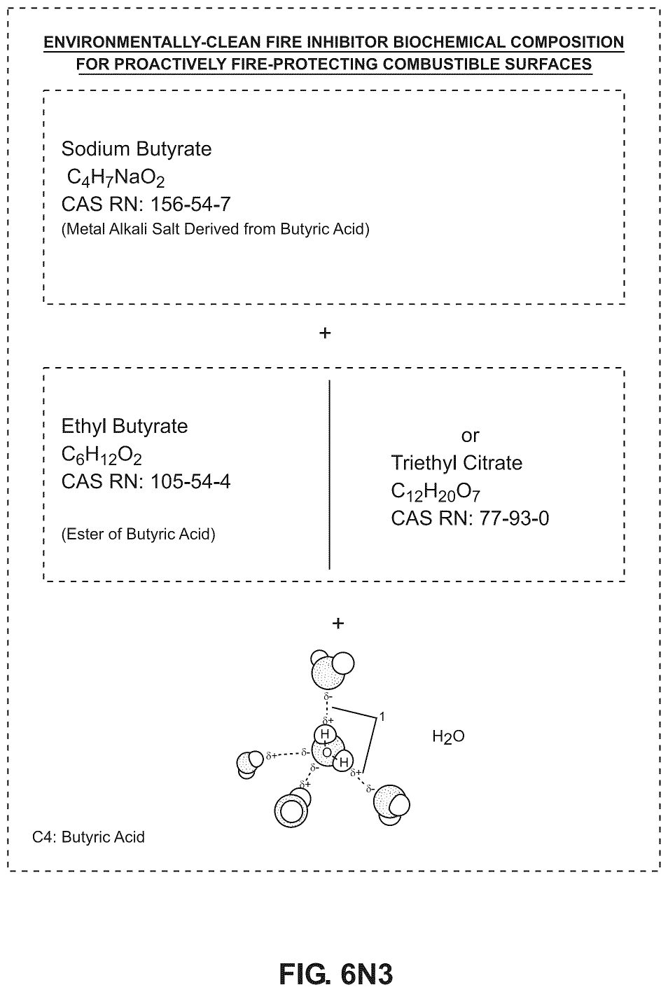

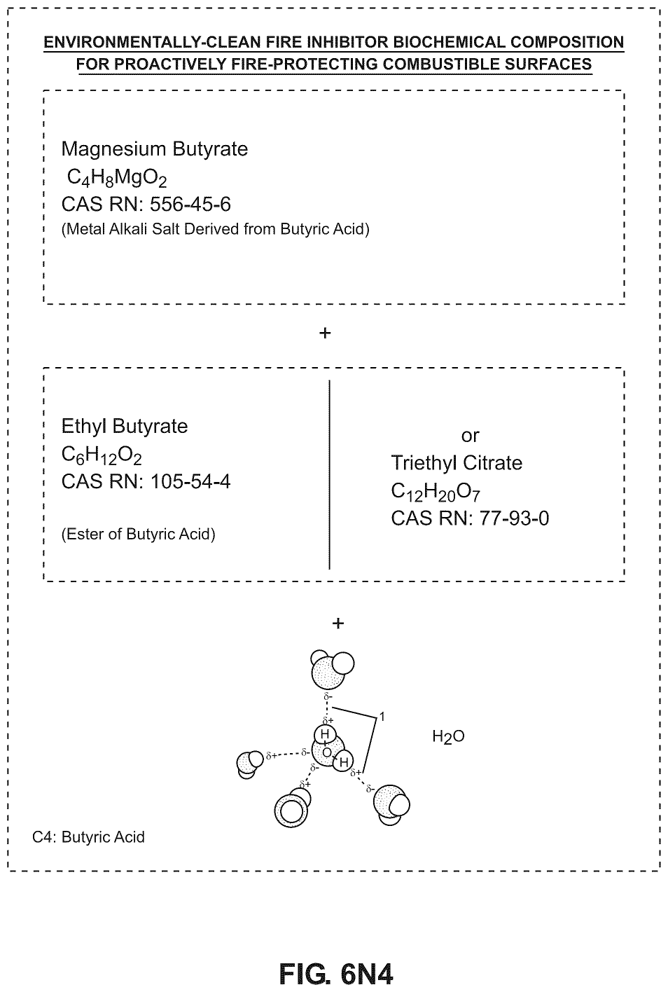

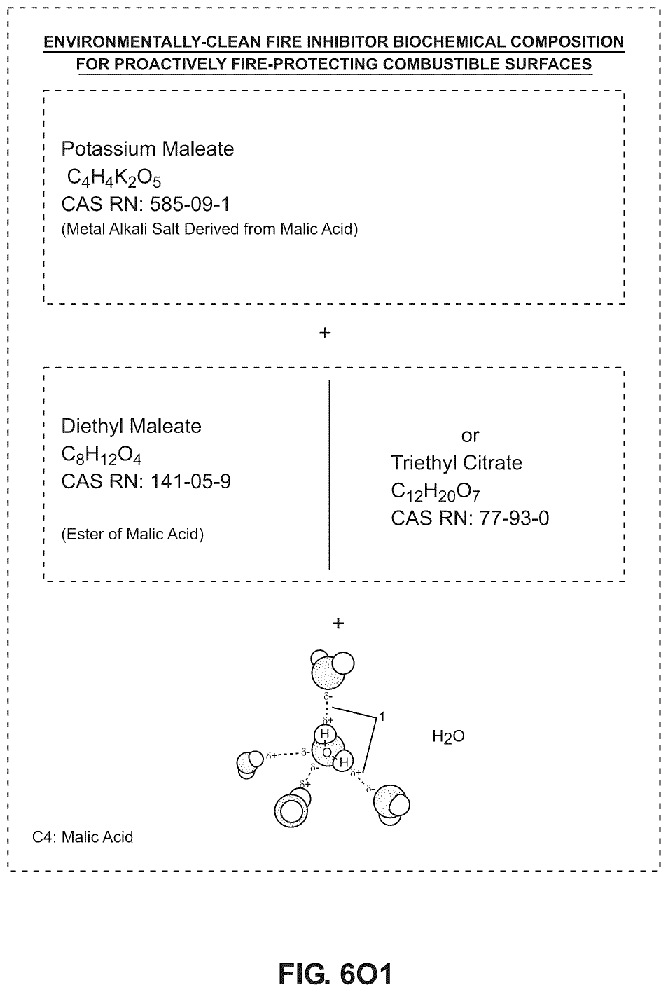

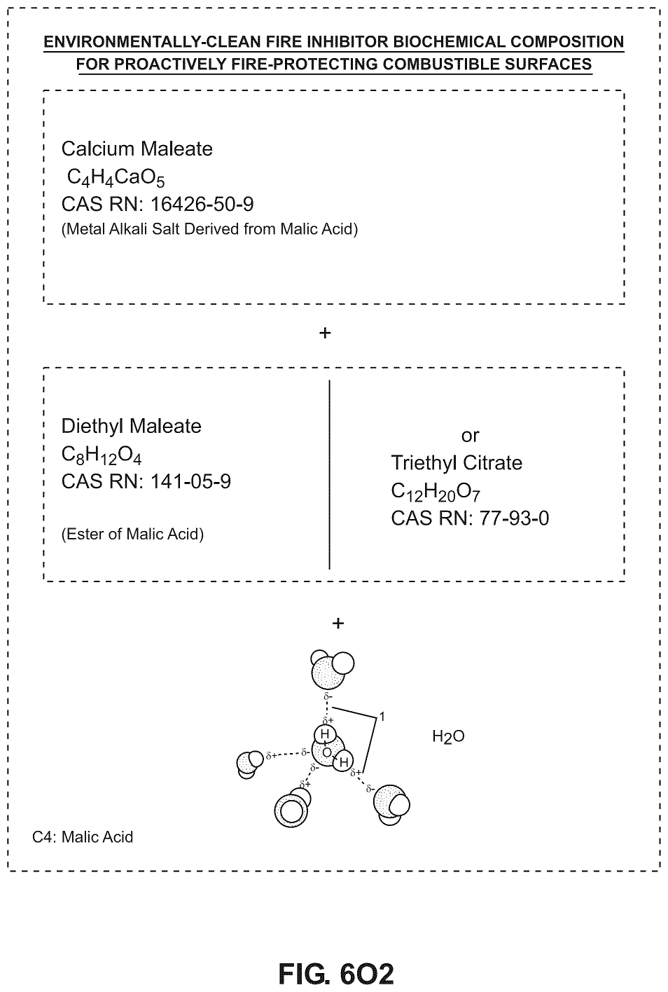

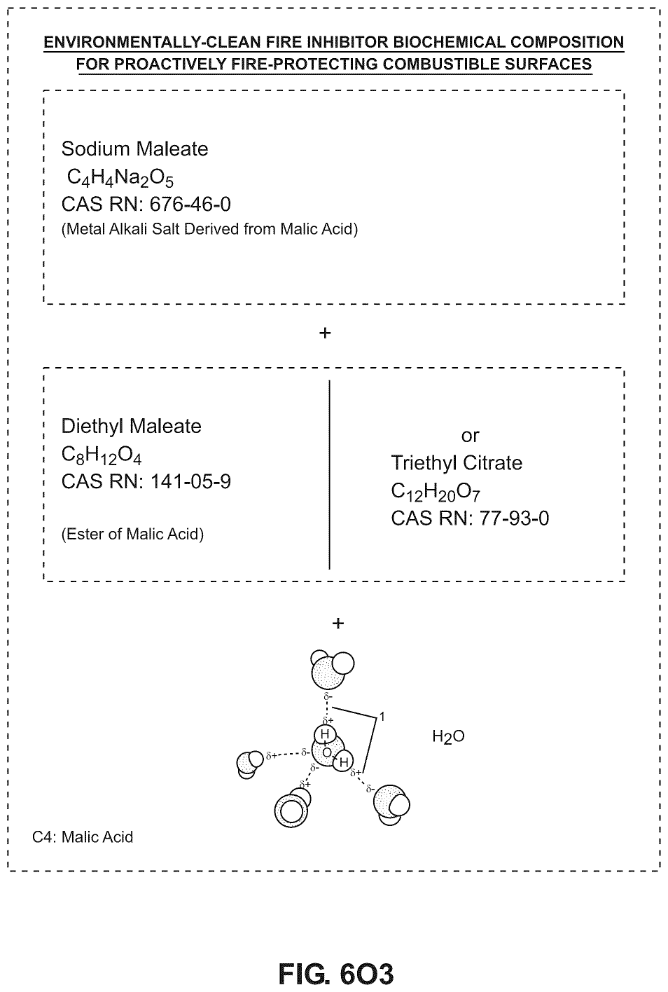

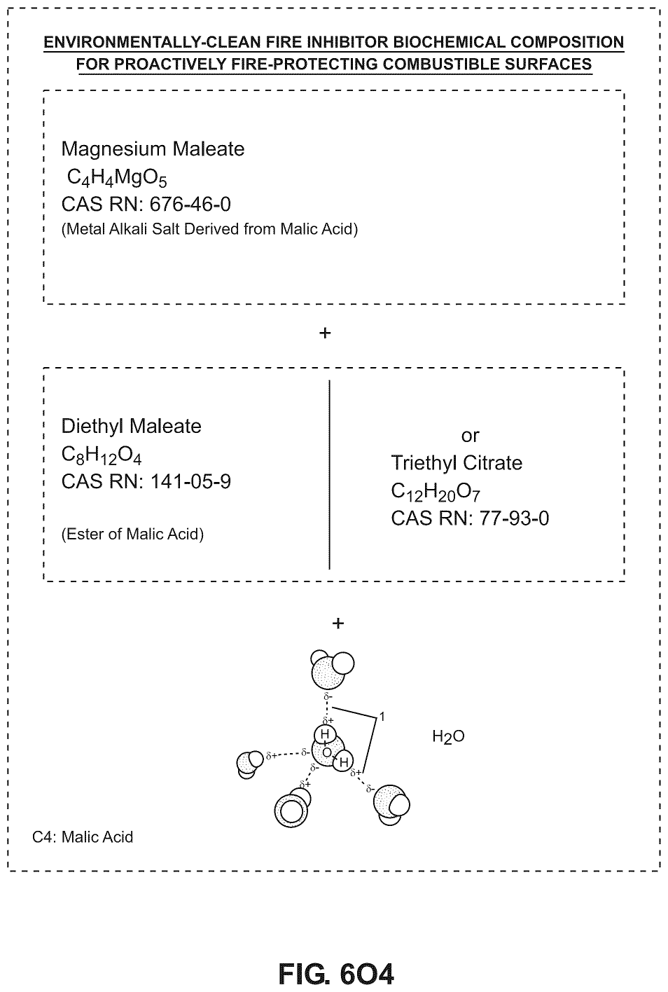

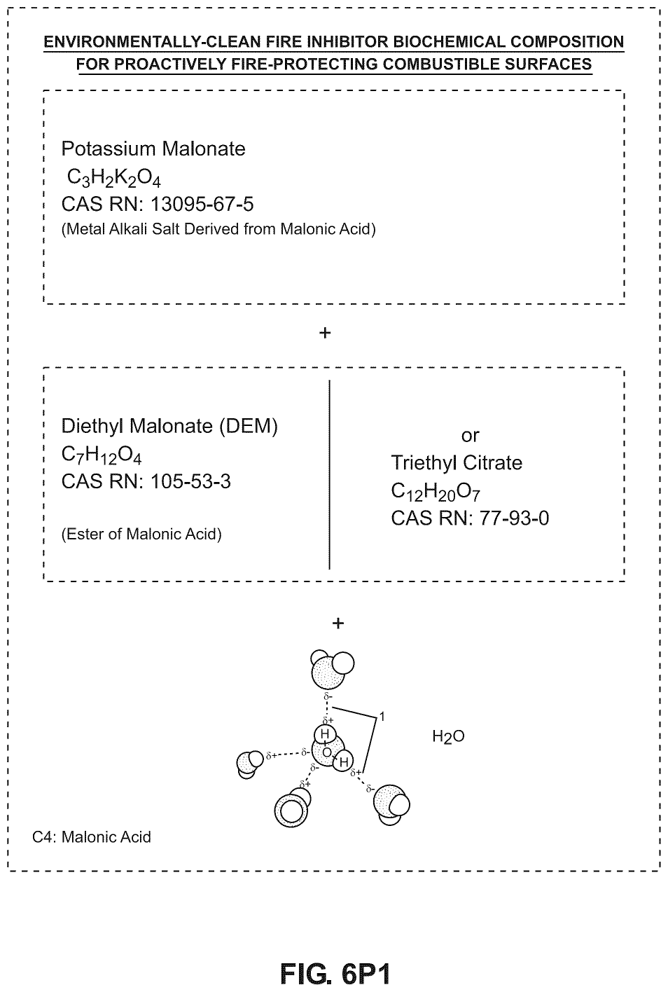

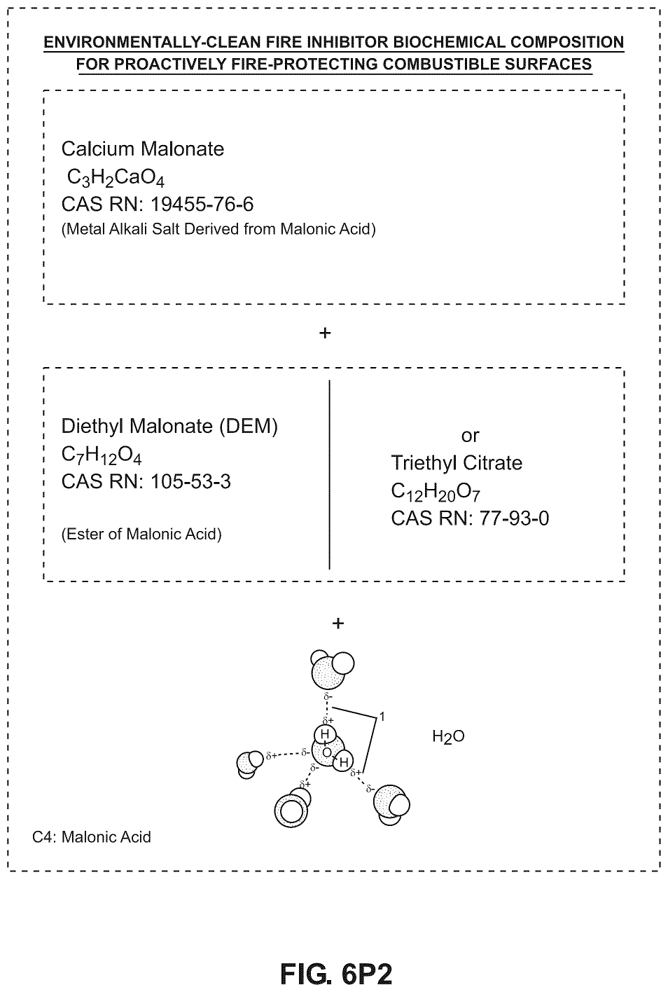

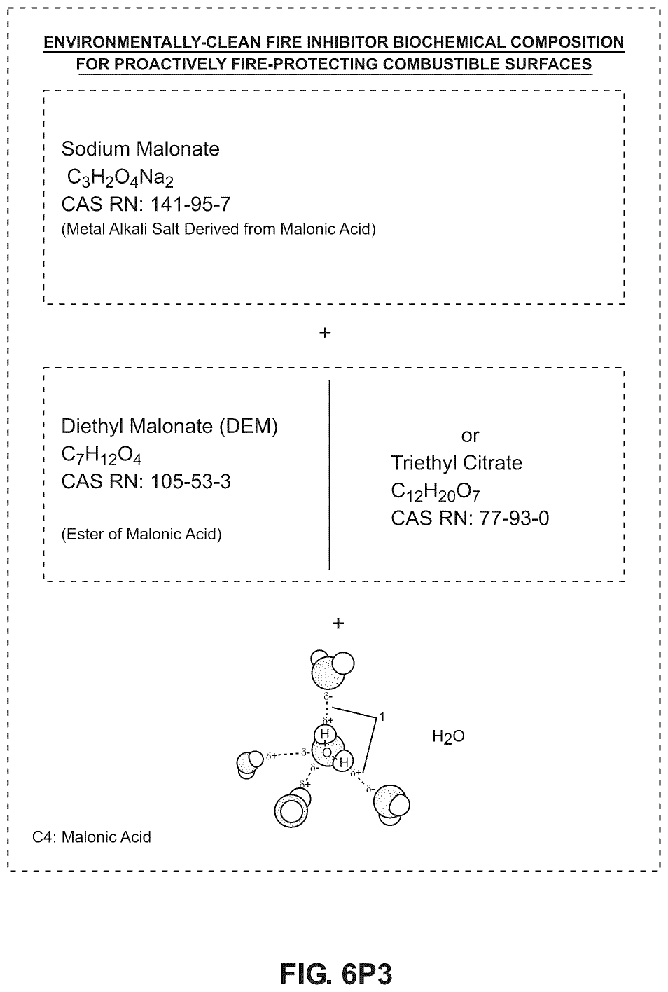

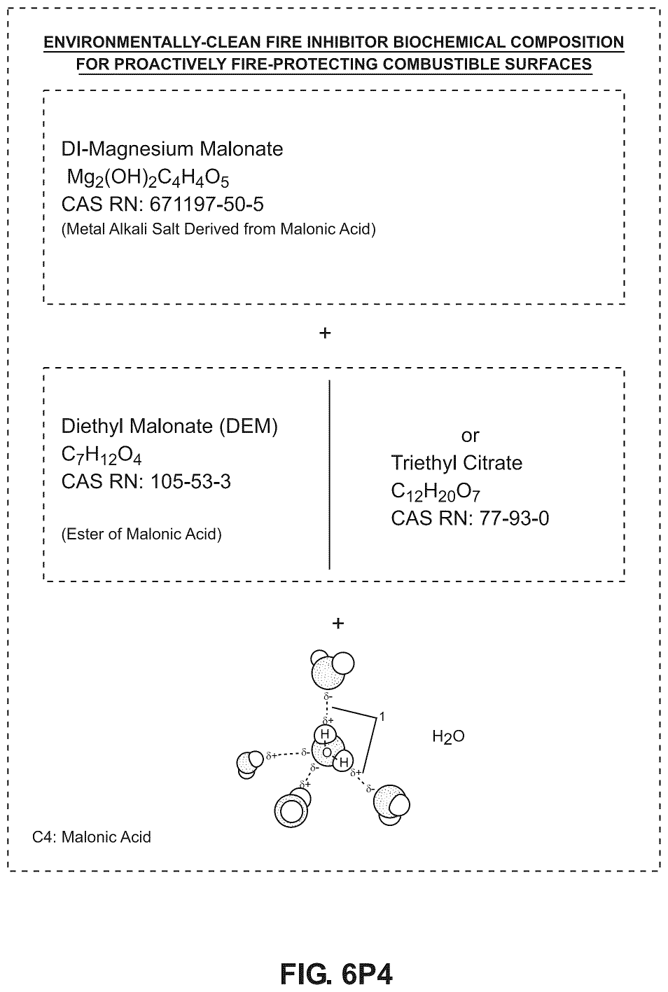

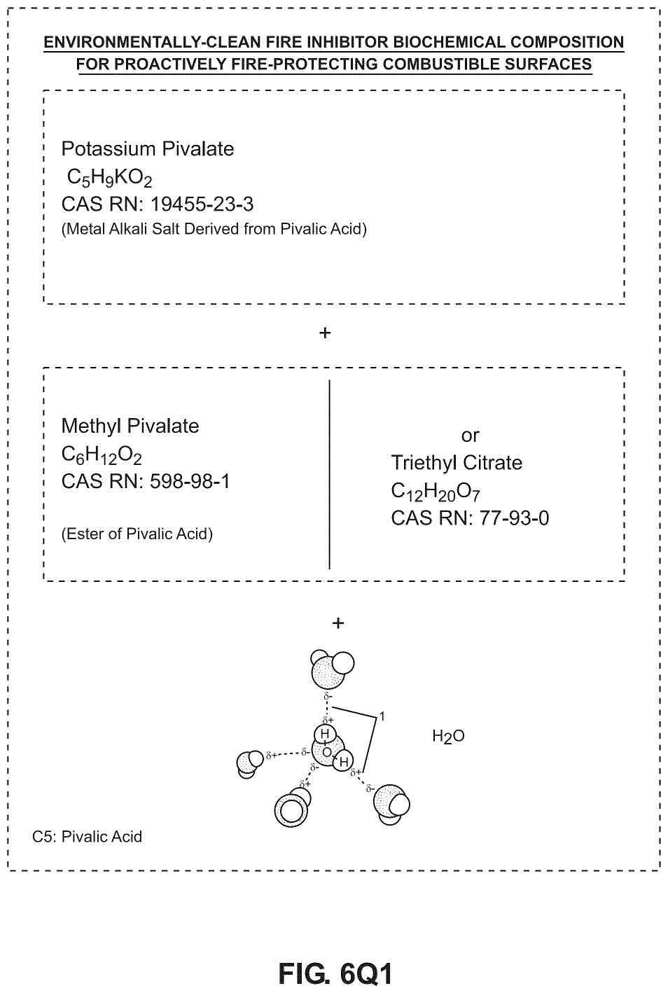

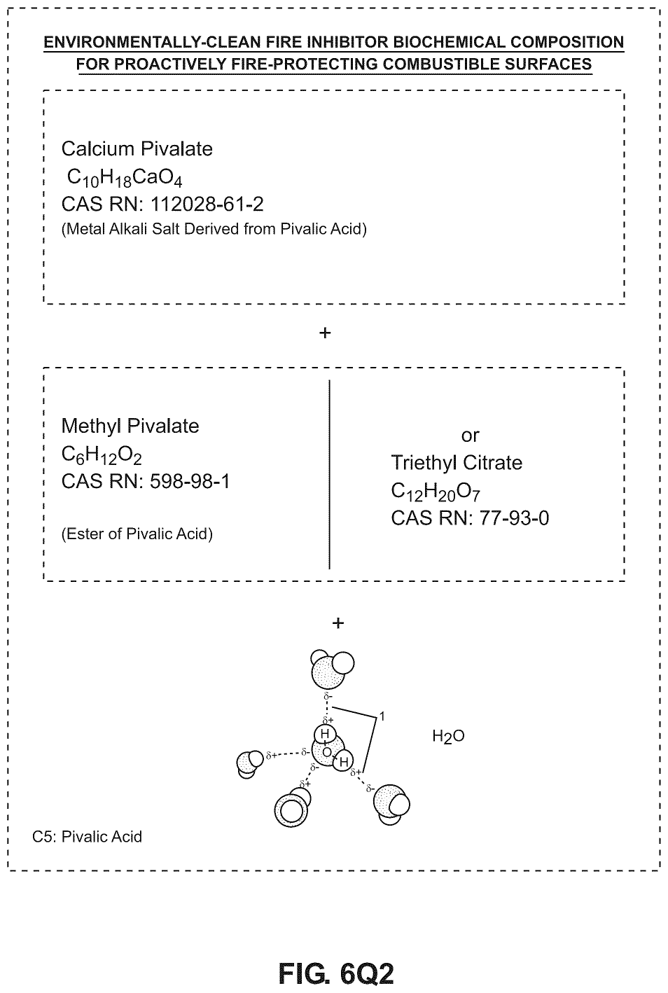

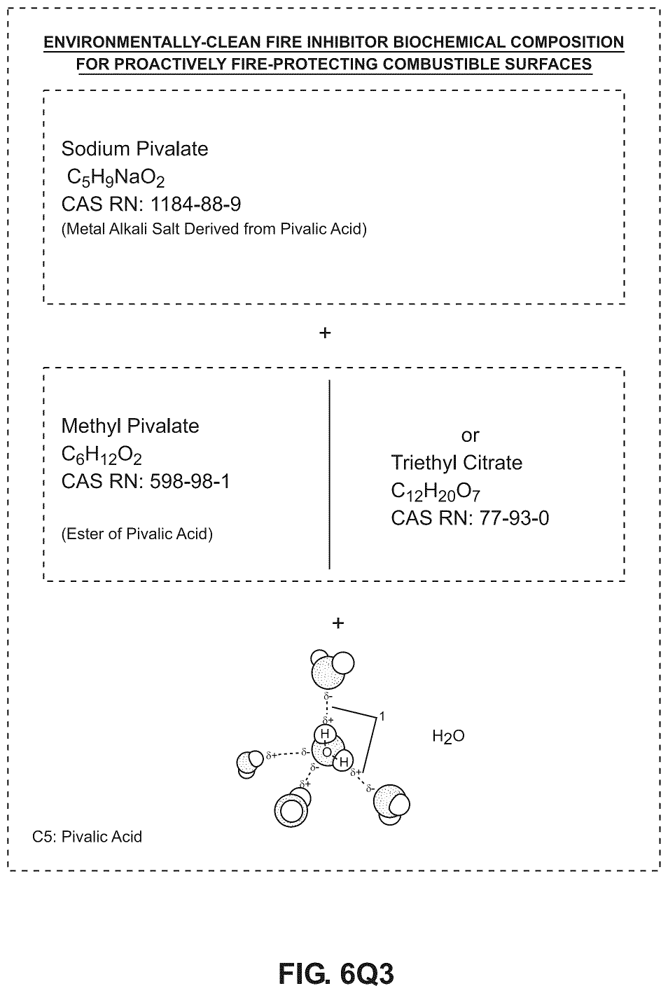

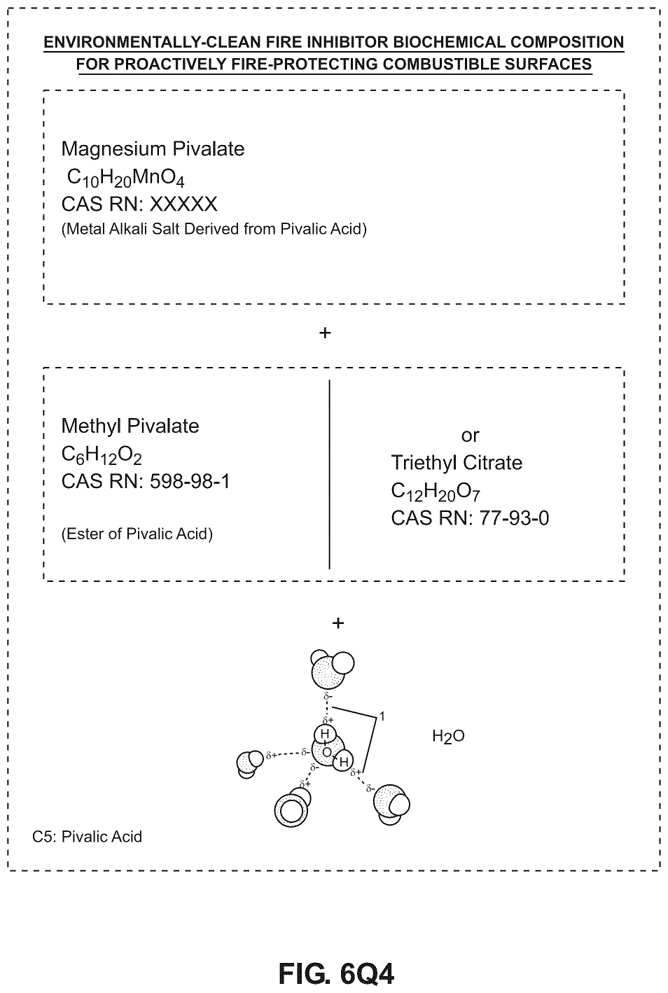

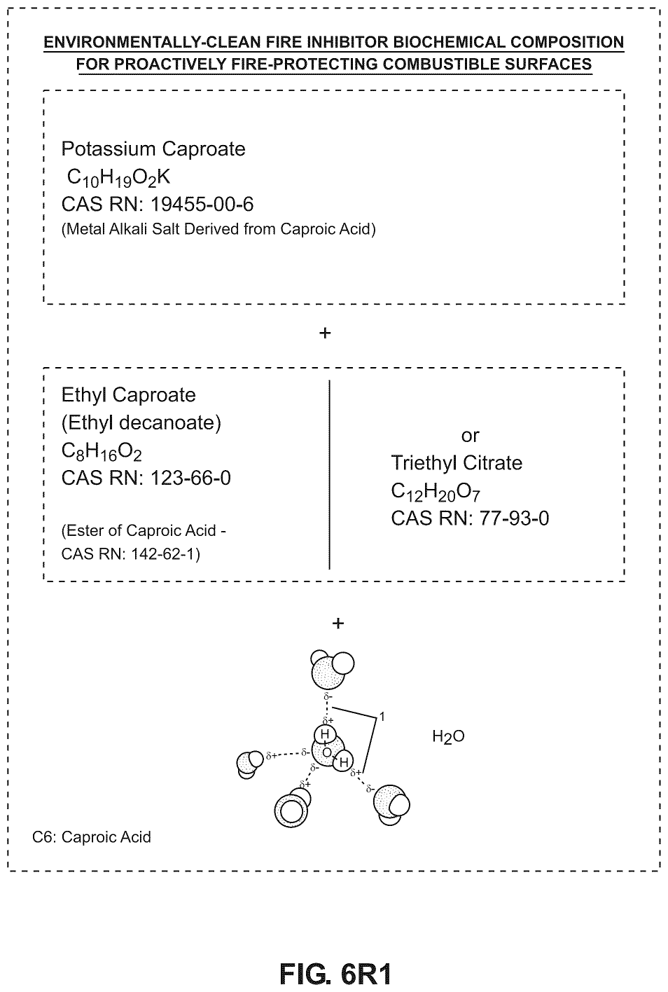

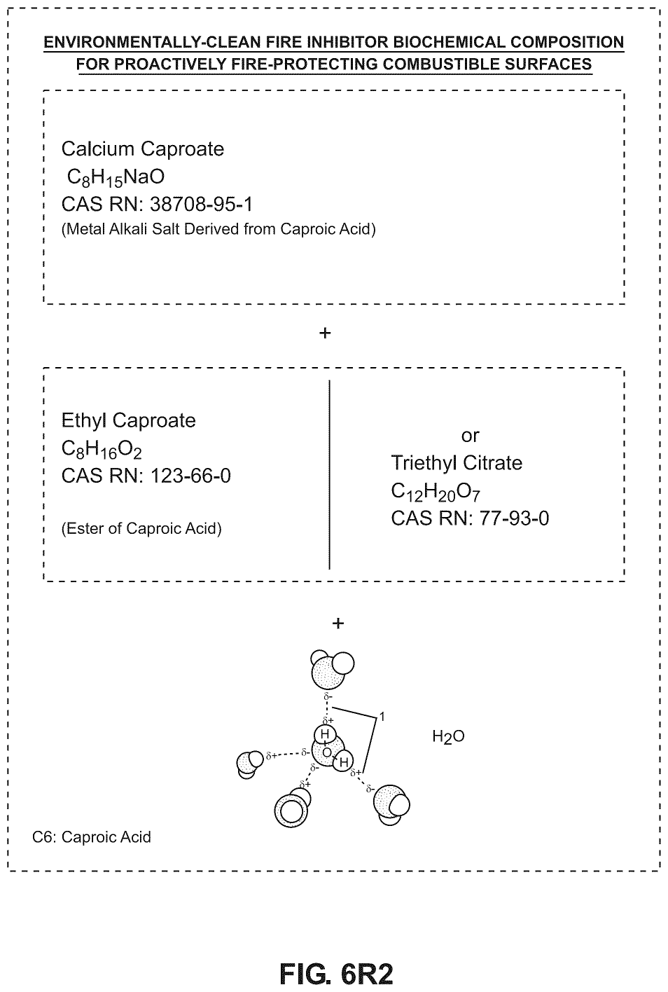

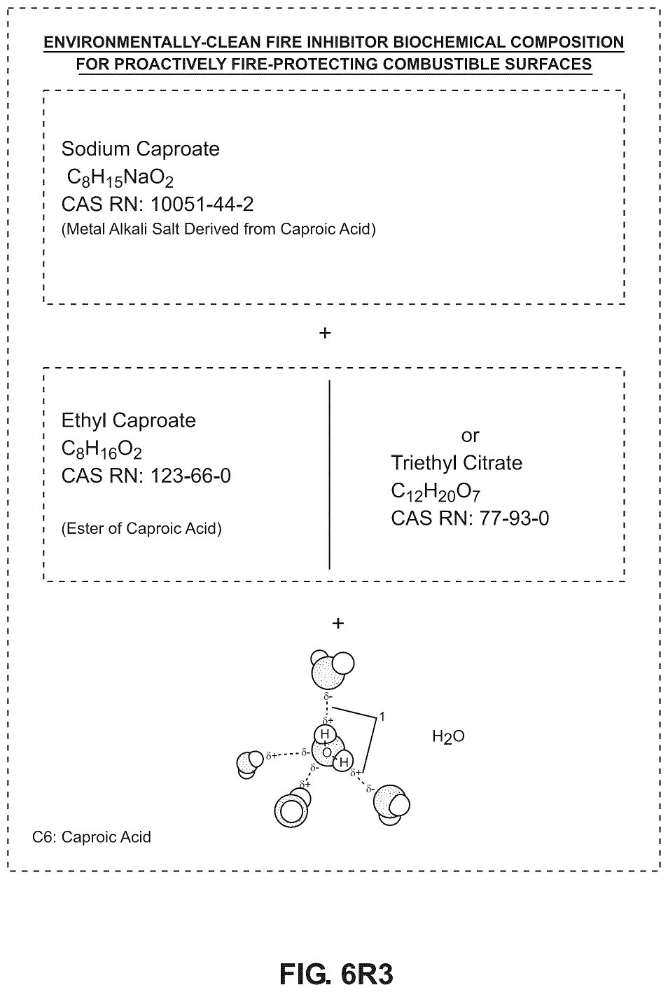

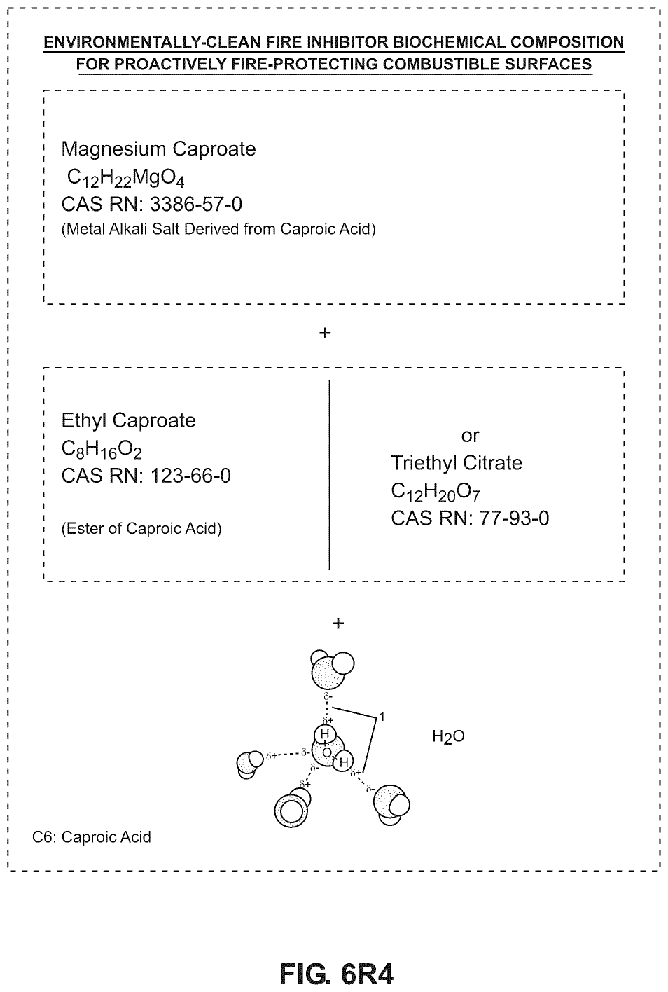

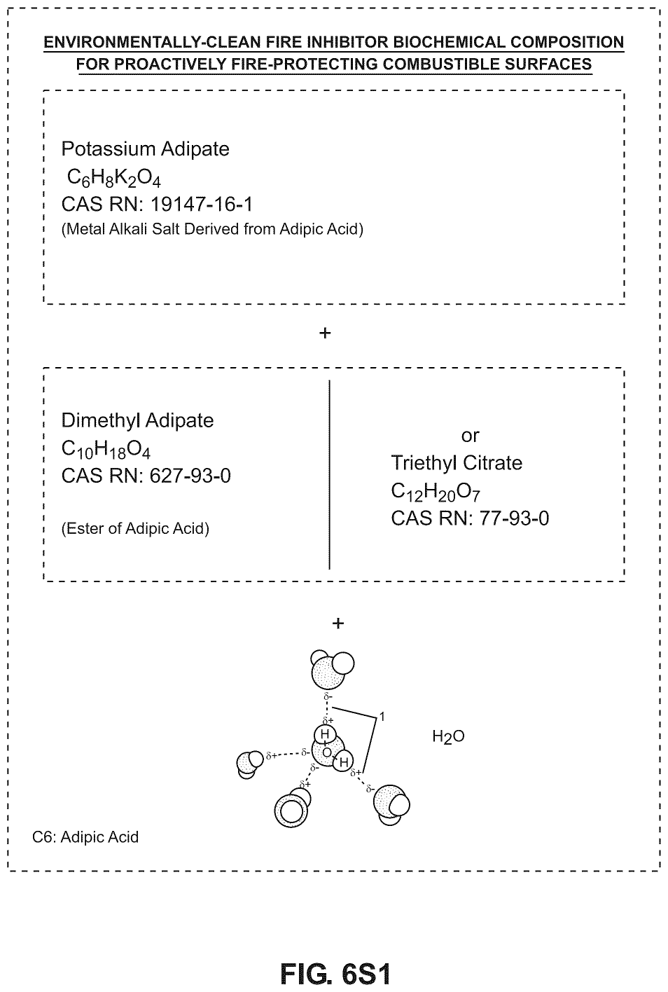

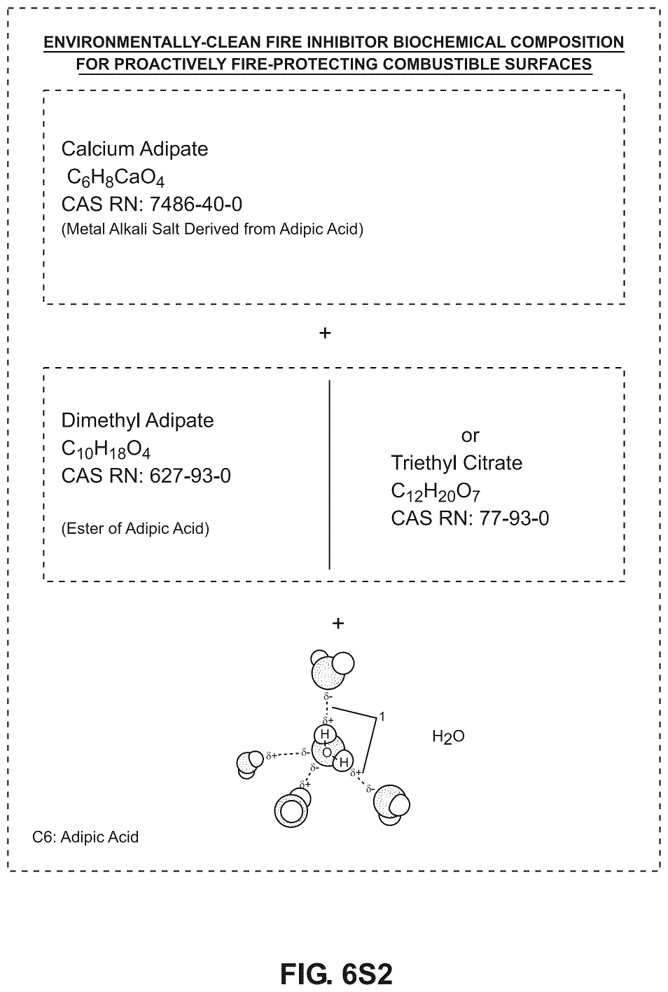

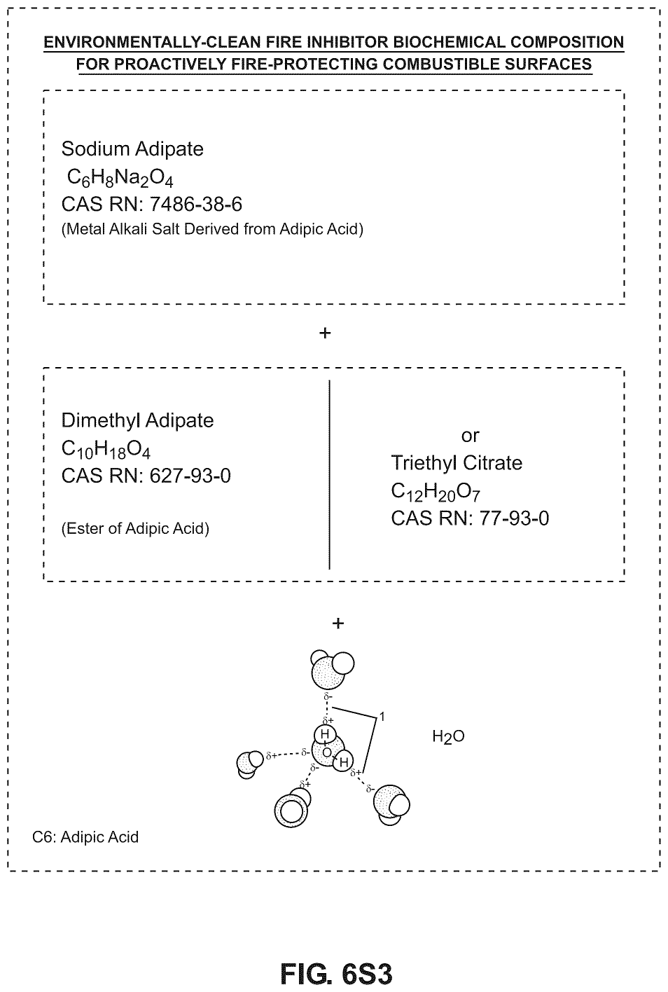

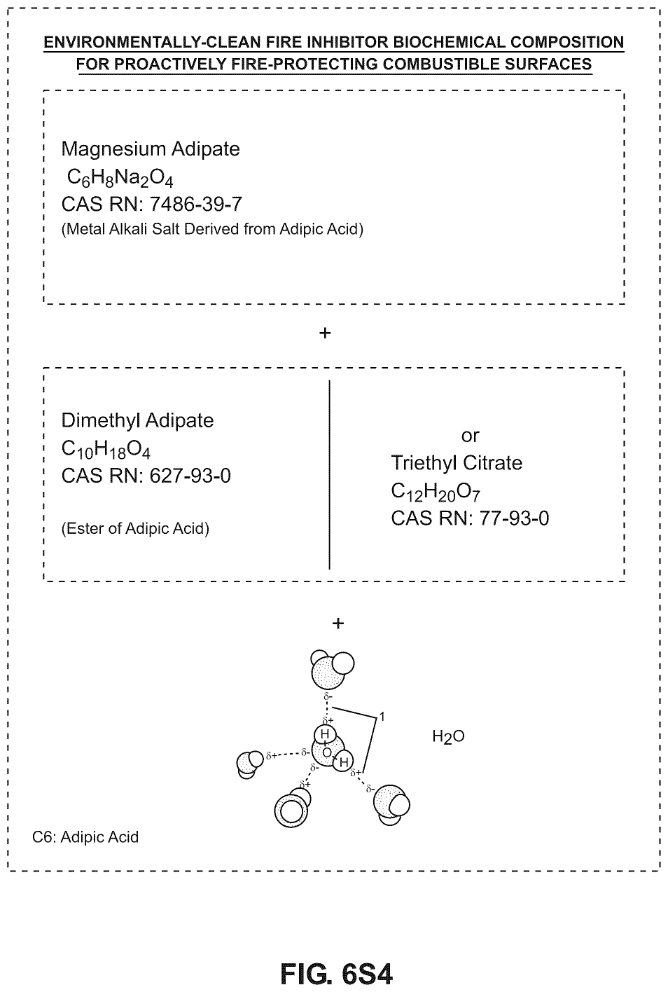

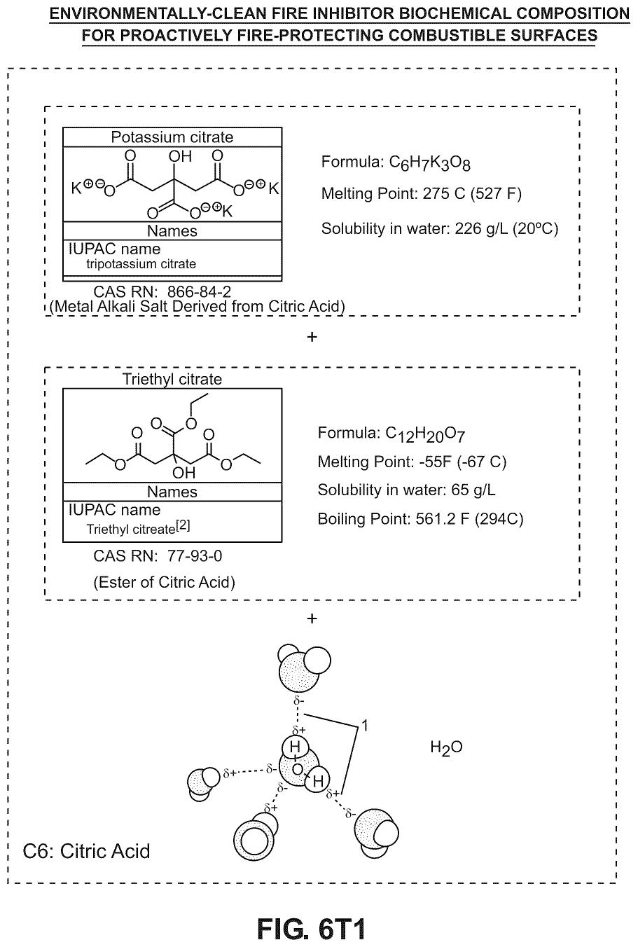

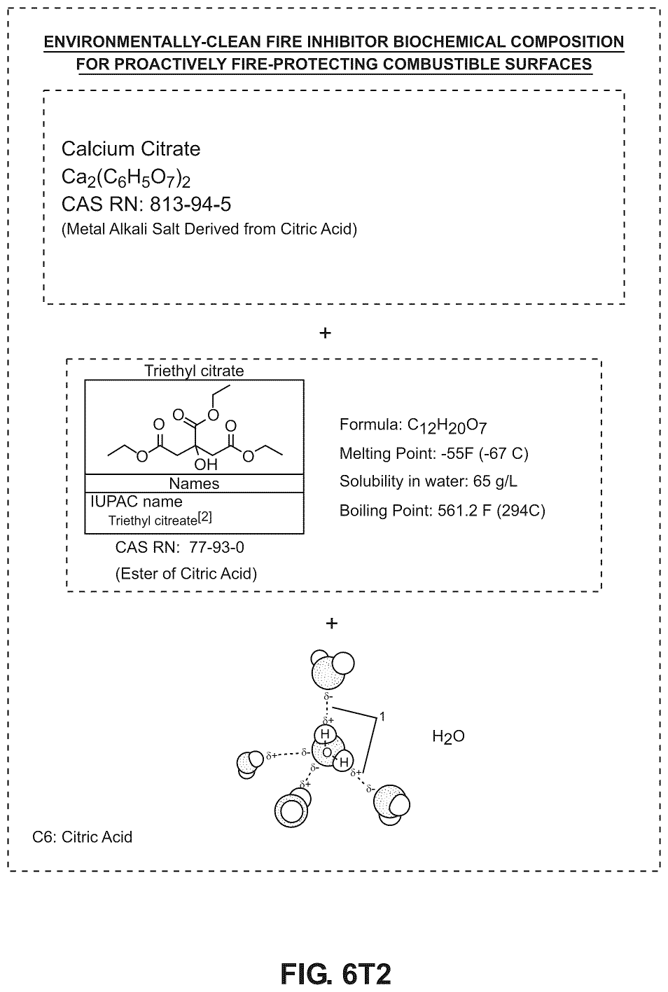

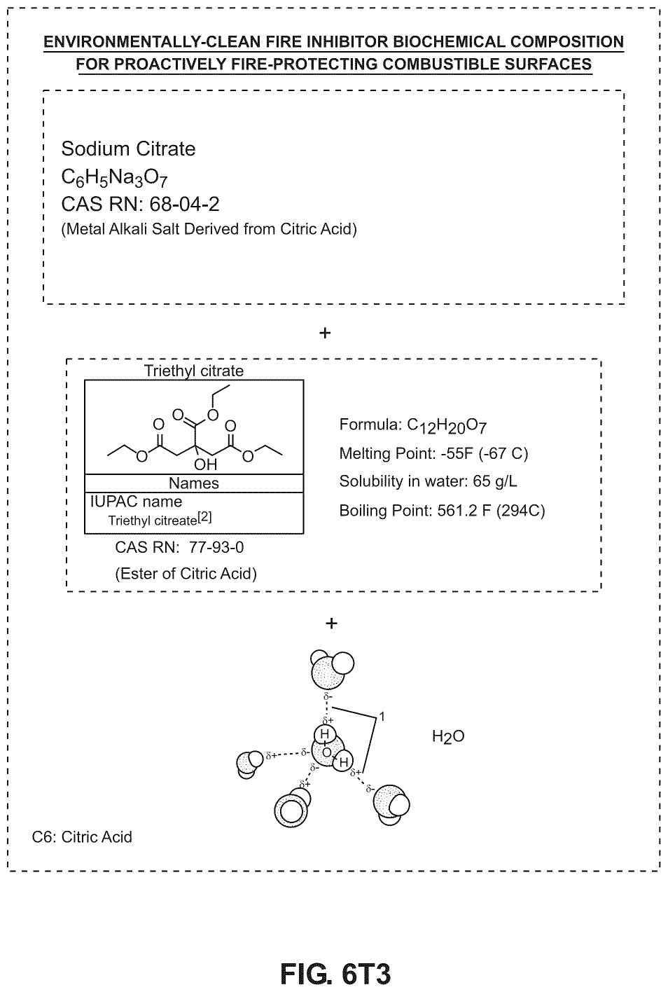

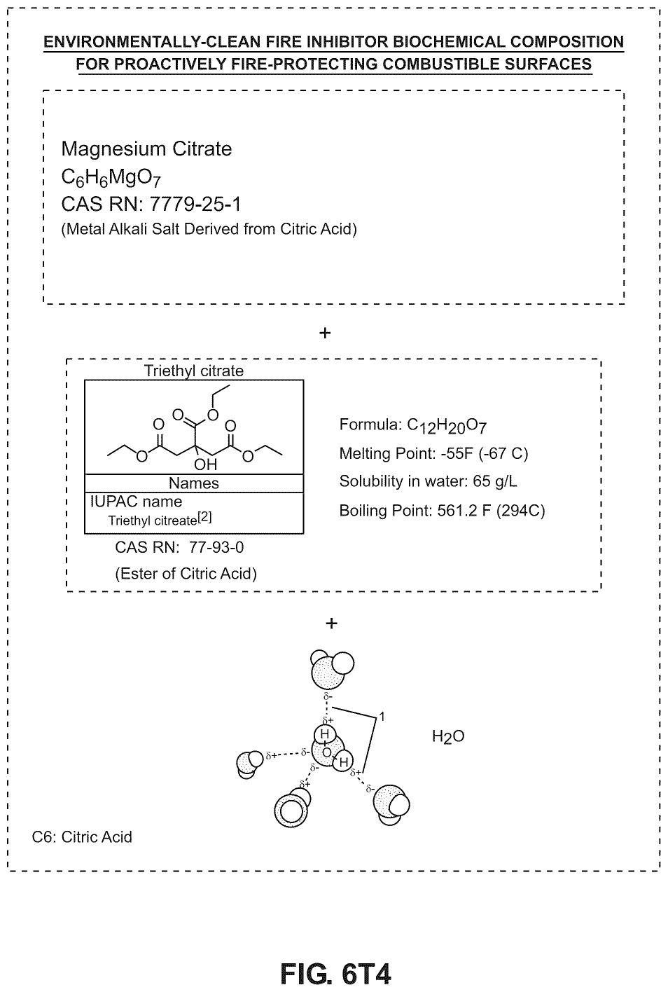

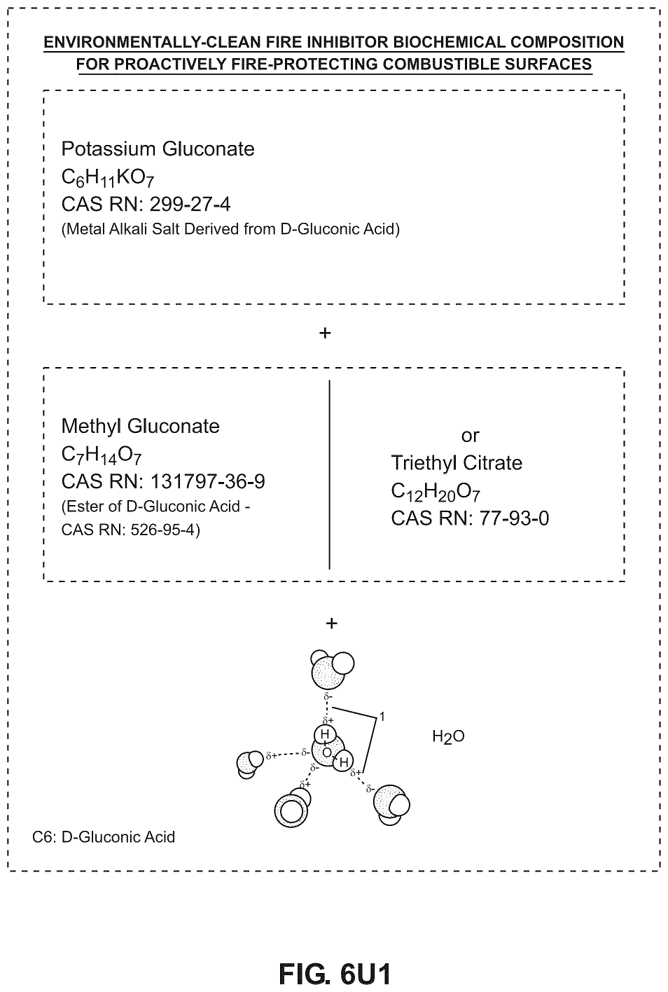

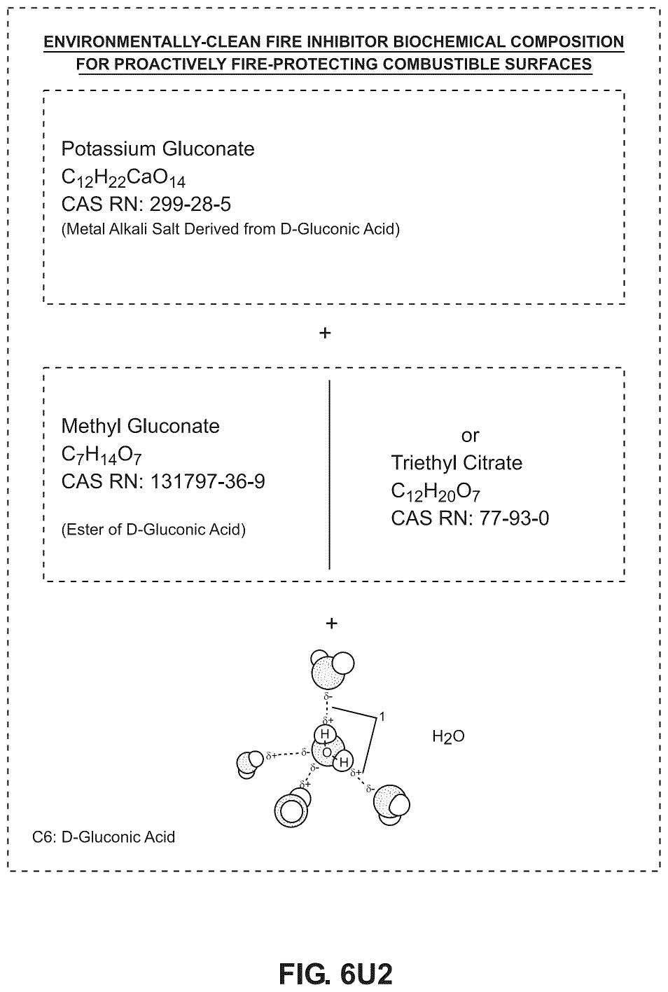

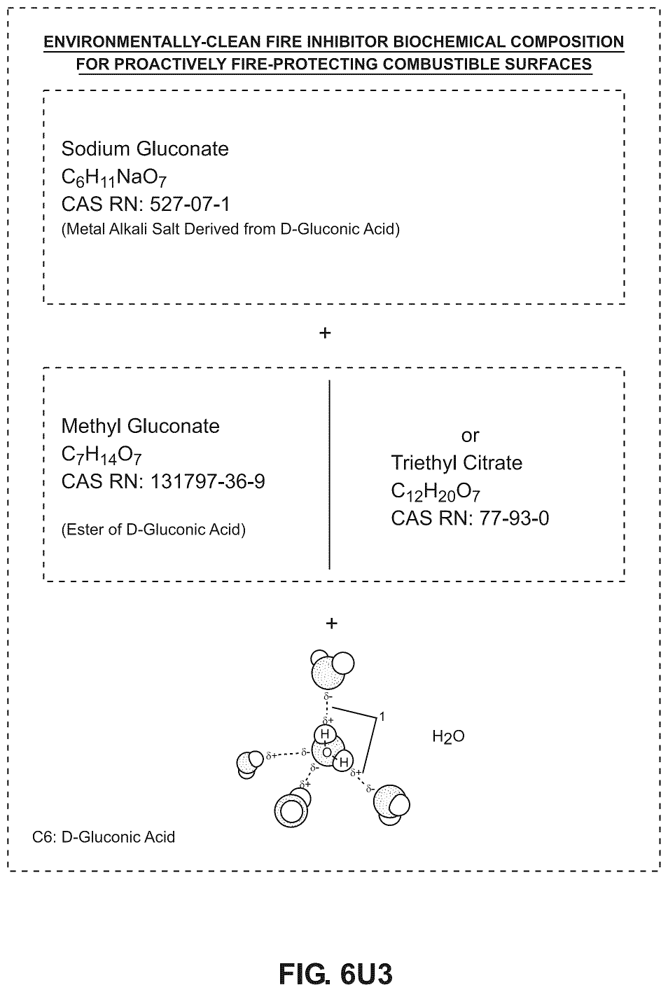

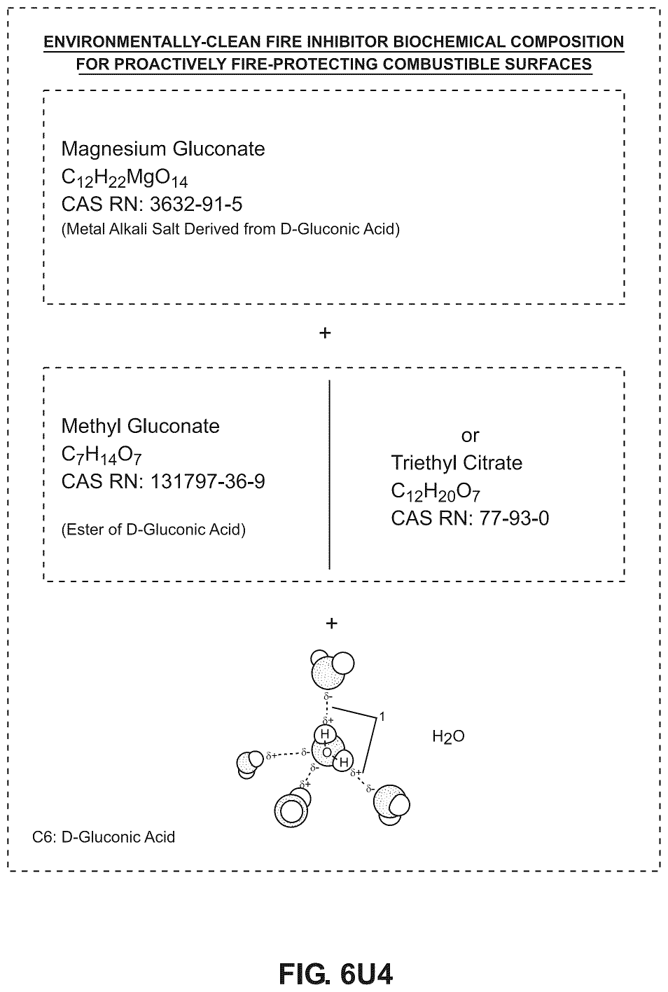

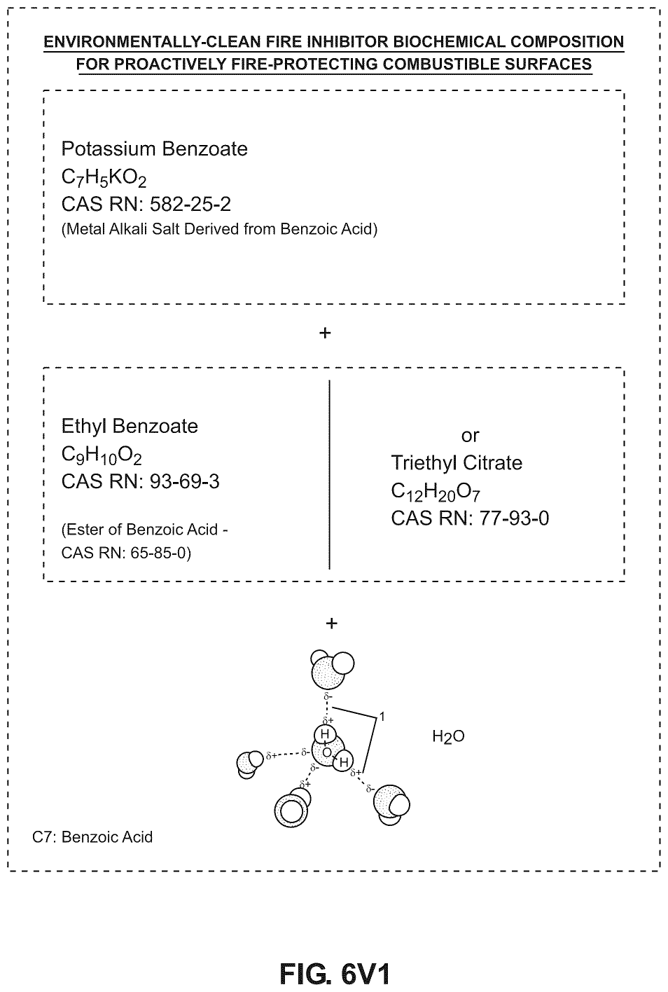

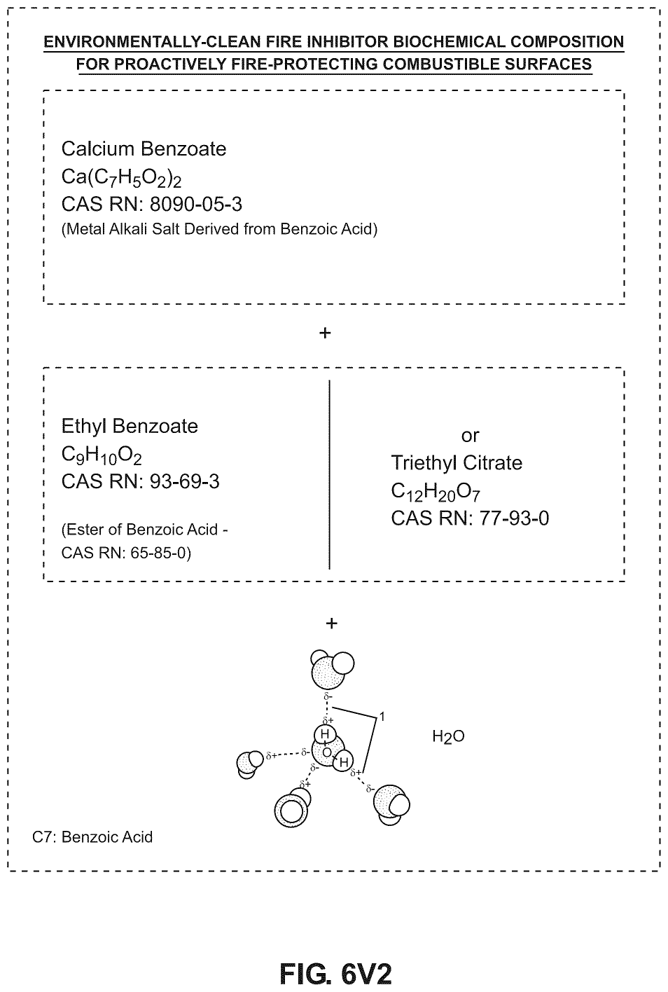

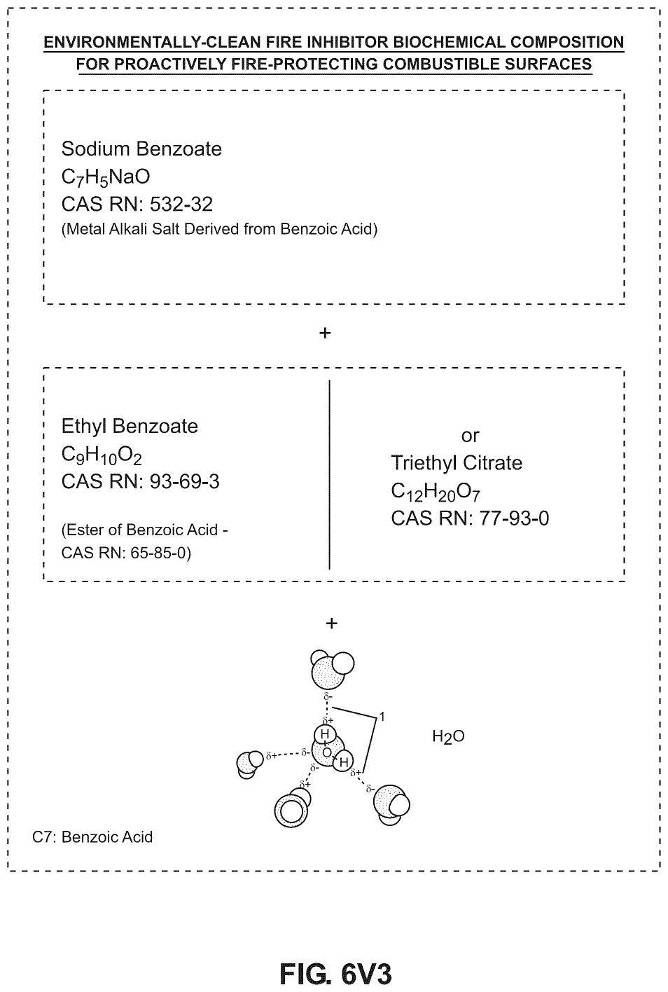

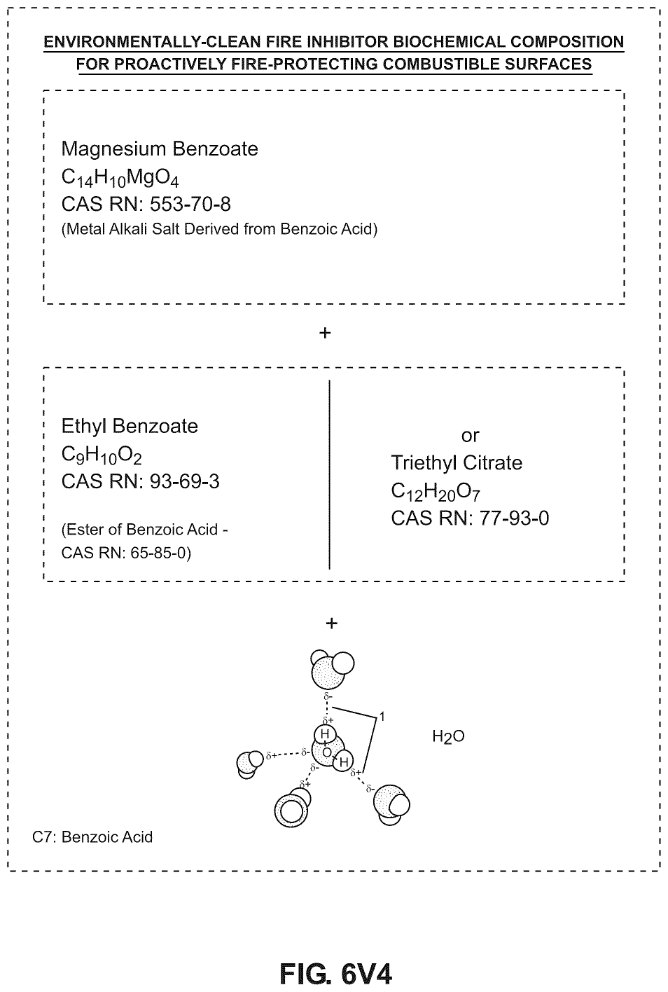

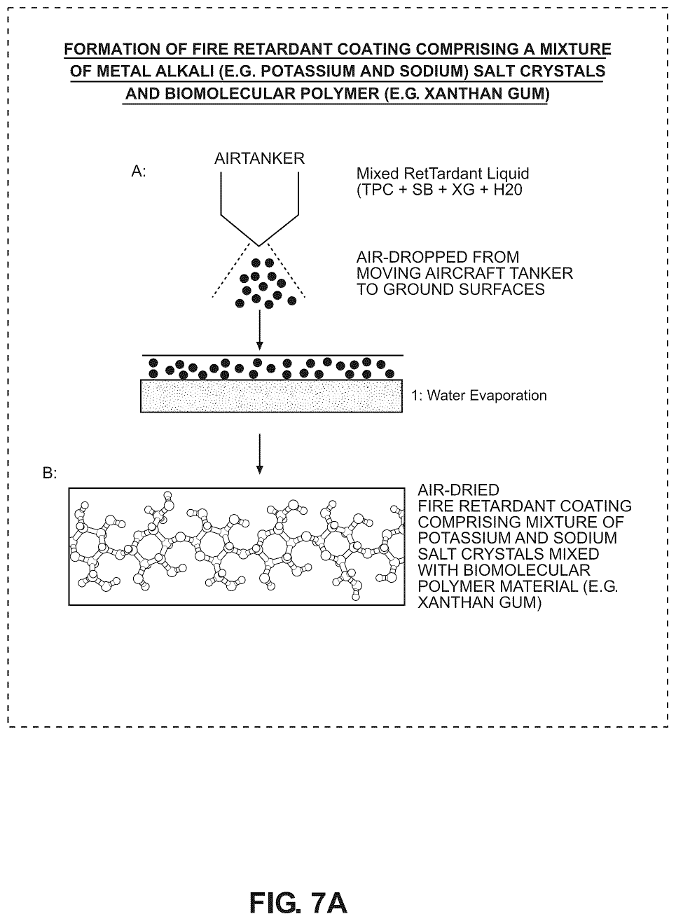

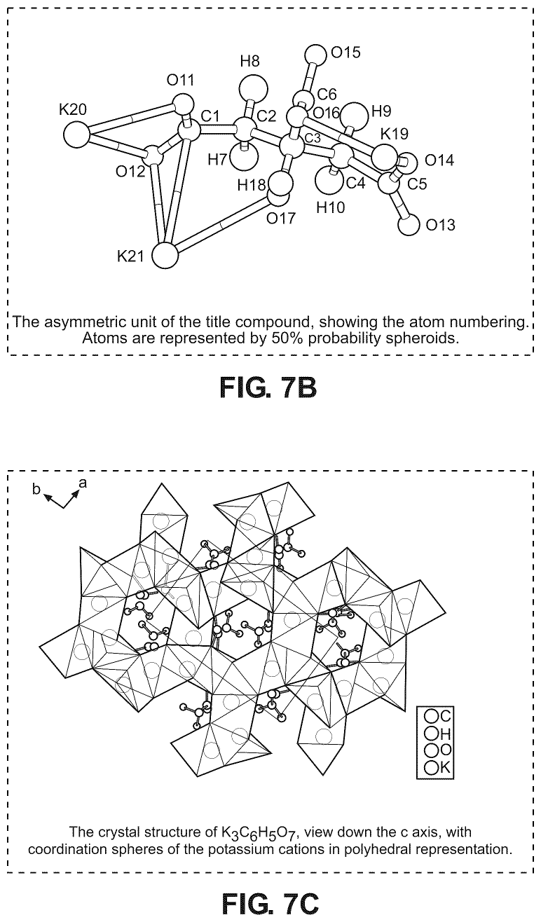

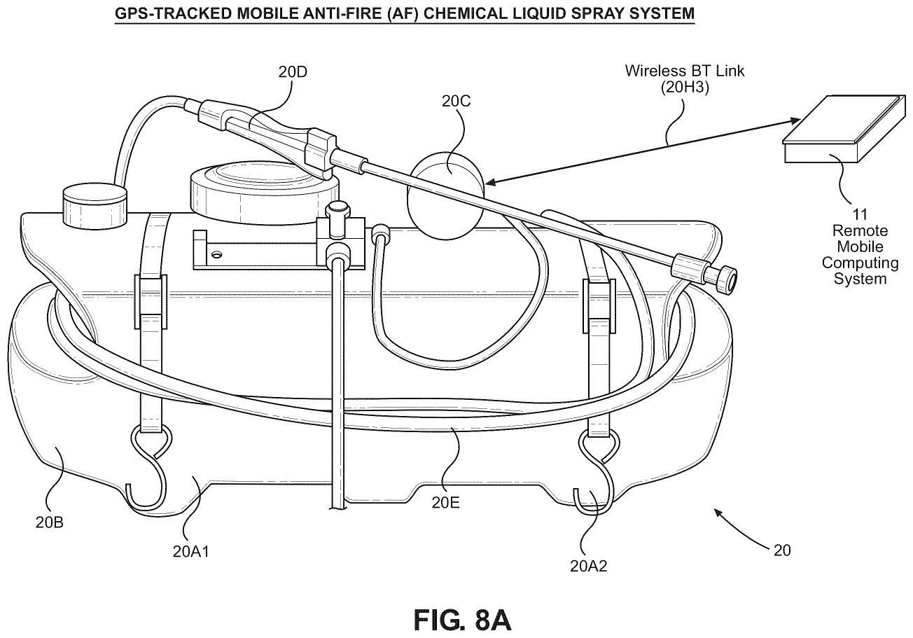

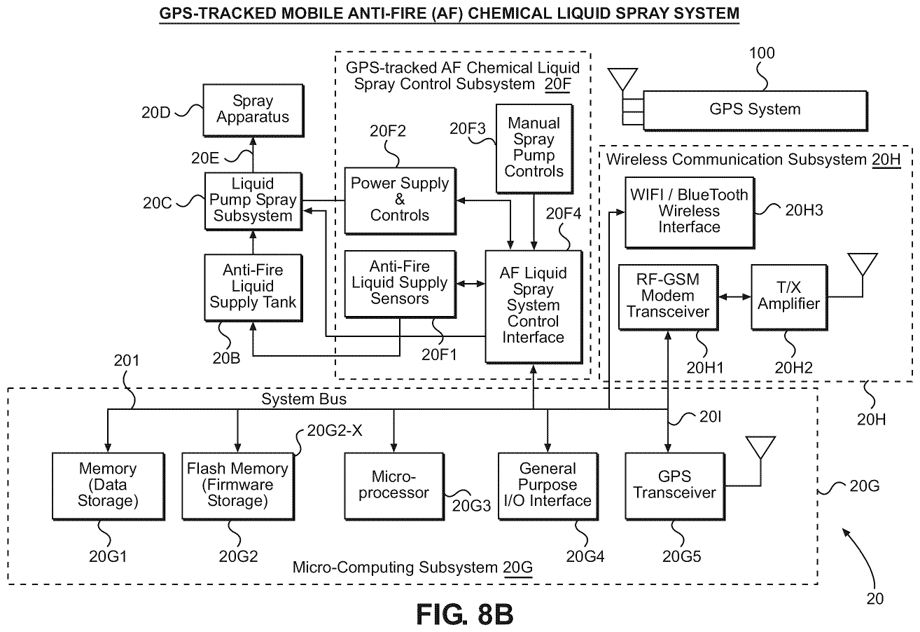

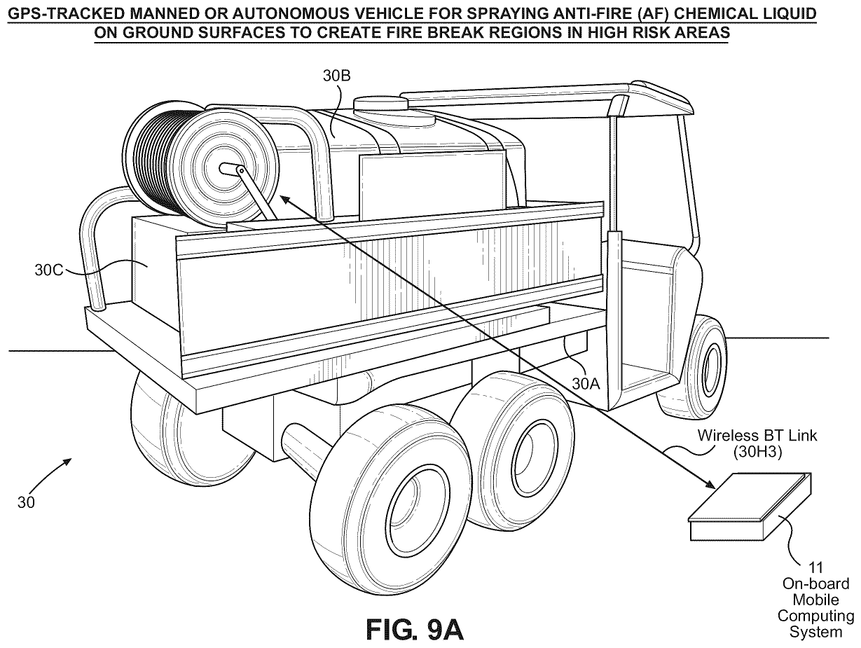

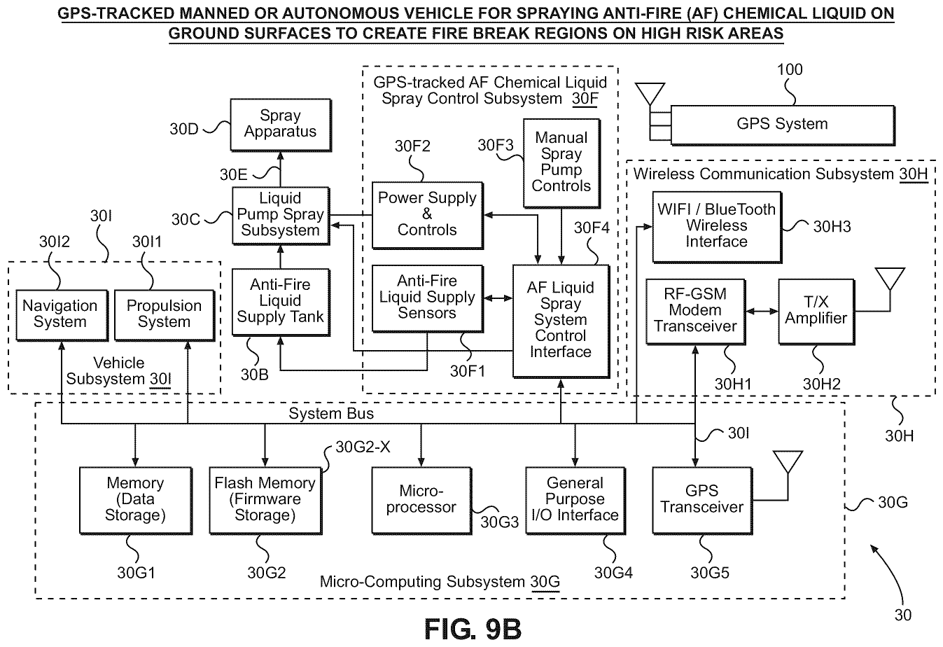

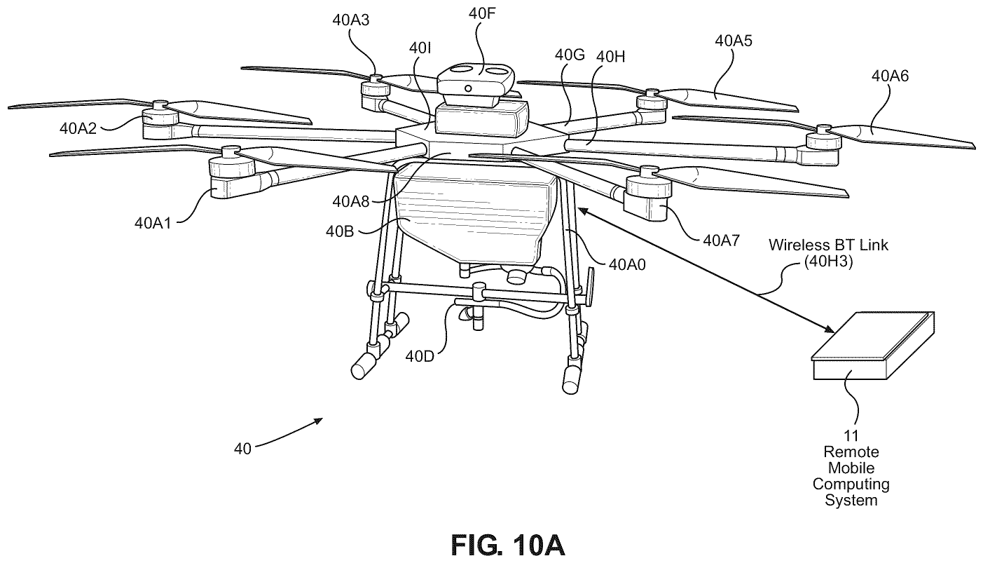

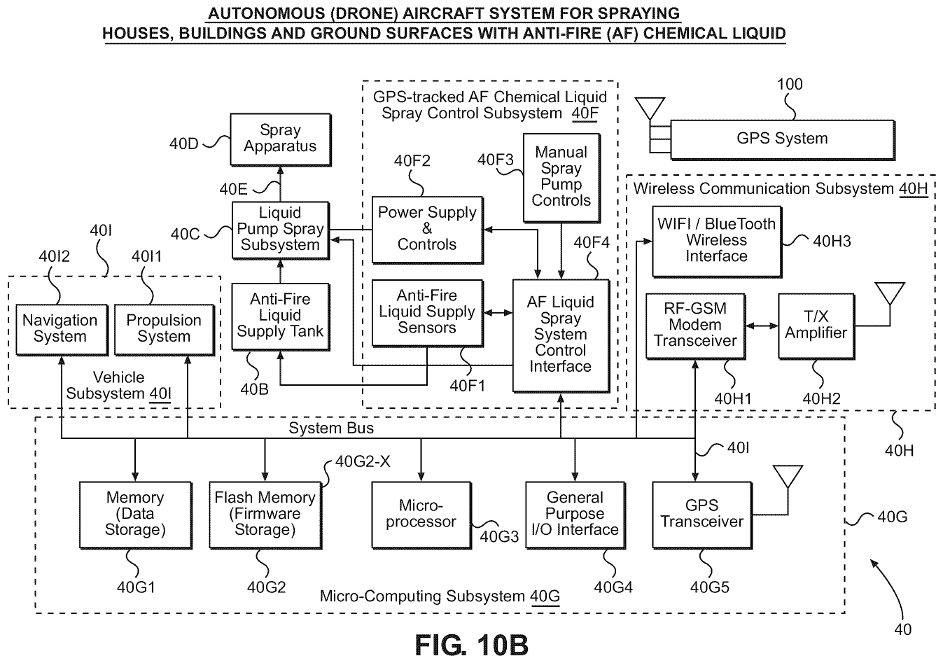

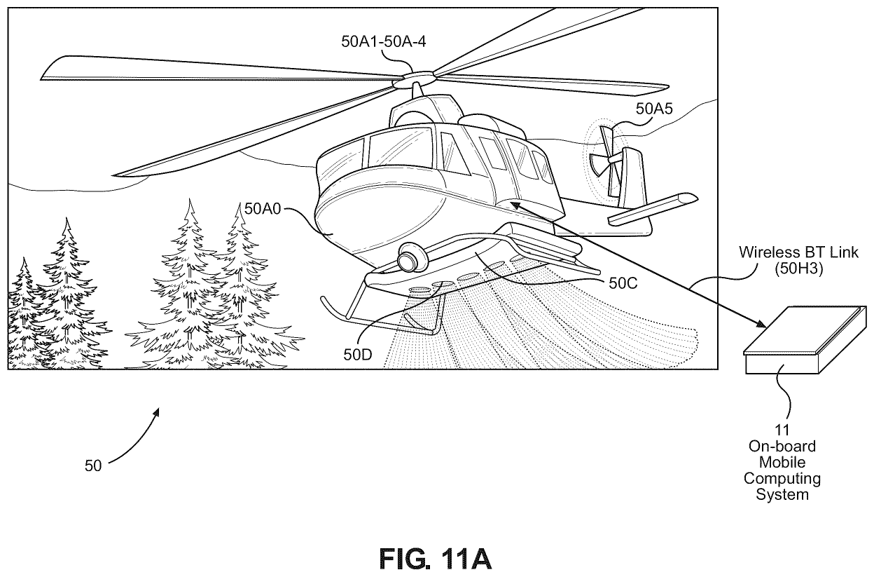

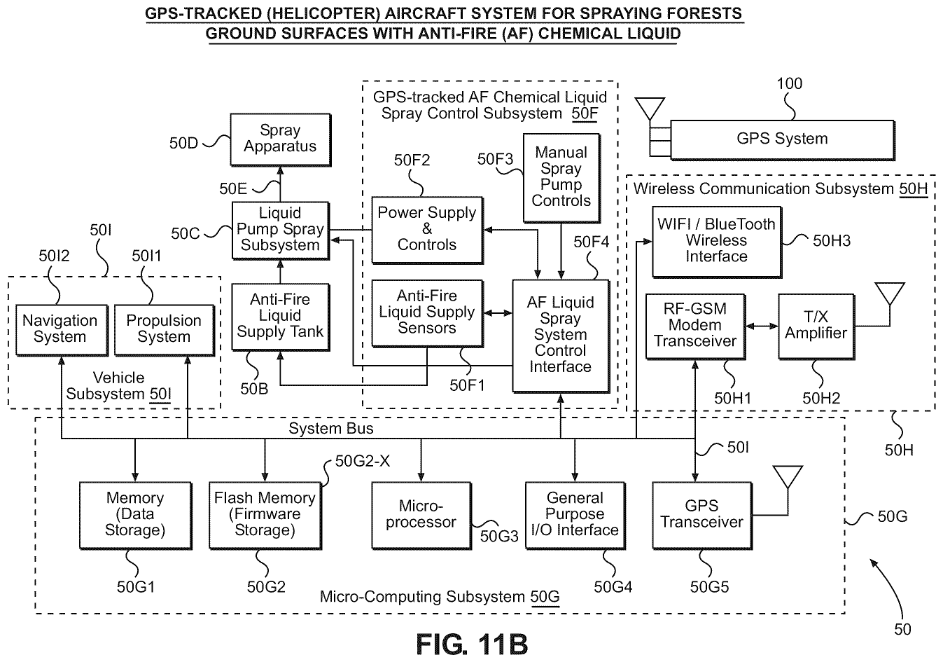

As shown, the wireless system network 1 comprises a distribution of system components, namely: GPS-tracked anti-fire (AF), or fire-inhibiting/extinguishing, liquid spray ground vehicles 2 (e.g. all-terrain vehicles or ATVs), as shown in FIGS. 9A, 9B, 12A, 12B, 14A, 14B, 14C, 14D, 15A, 15B, 17A and 17B, for applying AF chemical liquid spray fire inhibitor chemical, formulated according to the present invention, to ground surfaces, brush surfaces, and the surfaces of other forms of organic combustible material on property; GPS-tracked anti-fire liquid spray air-based vehicles 3, as shown in FIGS. 10A, 10B, 11A, and 11B, for applying AF chemical liquid spray of the present invention (formulated as illustrated in FIGS. 6 and 7 and specified herein) from the air to ground surfaces, brush, bushes and other forms of organic material; GPS-tracked mobile anti-fire liquid back-pack spraying systems 4 (e.g. including wheel supported, and backpack-carried systems), as shown in FIGS. 8A, 8B, 13A, 13B, 16A and 16B, for applying AF chemical liquid spray to combustible ground surfaces, brush, bushes, decks, houses, buildings, and other forms of organic material and property surrounding houses; GPS-tracked/GSM-linked anti-fire liquid spraying systems 5, as shown in FIGS. 8A through 17B, for applying AF chemical liquid spray to combustible surfaces on private real property, buildings and surrounding areas; GPS-tracked/GSM-linked liquid spraying systems 6, as shown in FIGS. 8A through 17B, for applying AF chemical liquid spray to combustible surfaces on public real property and buildings and surrounding properties; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked anti-fire (AF) liquid supply and spray systems, including web servers 9A, application servers 9B and database servers 9C (e.g. RDBMS) operably connected to the TCP/IP infrastructure of the Internet 10, and including a network database 9C1, for monitoring and managing the system and network of GPS-tracking anti-fire liquid spraying systems and various functions supported by the command center 19, including the management of wild fire suppression and the GPS-guided application of anti-fire (AF) chemical liquid over public and private property, as will be described in greater technical detail hereinafter. As shown, each data center 8 also includes an SMS server 9D and an email message server 9E for communicating with registered users on the system network 1 who use a mobile computing device (e.g. an Apple® iPhone or iPad tablet) 11 with the mobile application 12 installed thereon and configured for the purposes described herein. Such communication services will include SMS/text, email and push-notification services known in the mobile communications arts.

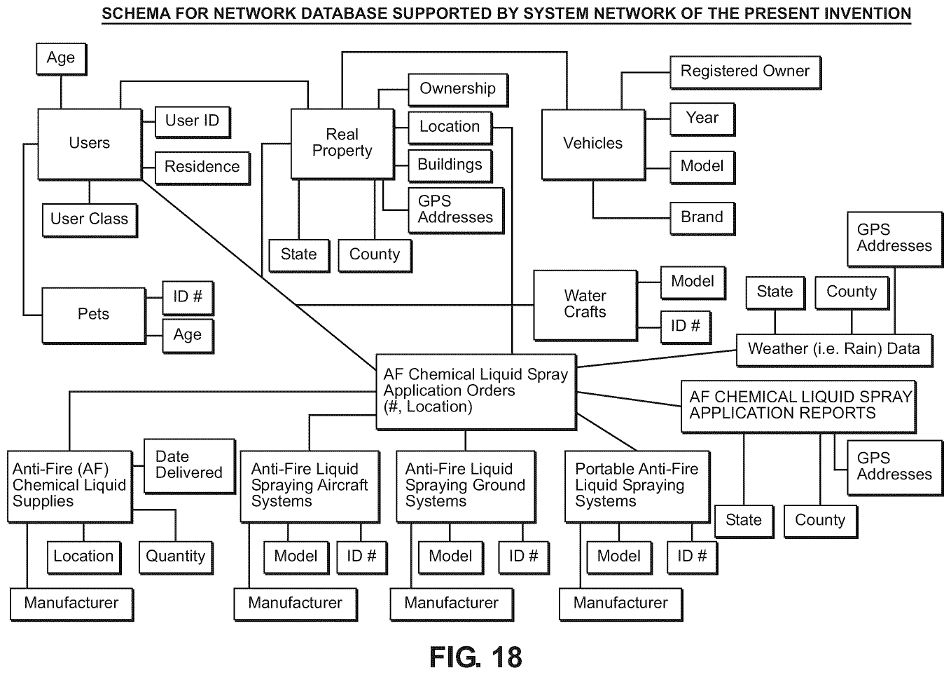

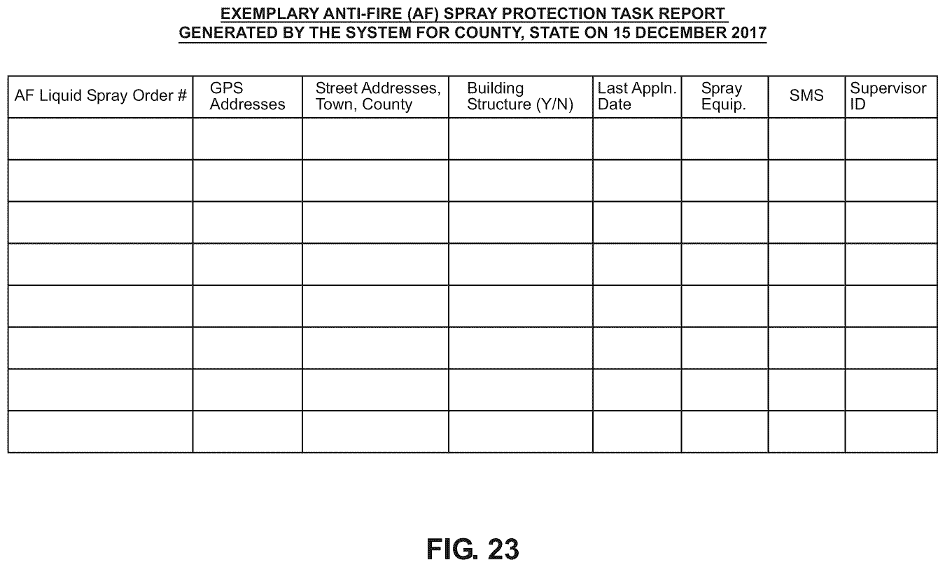

As shown in FIG. 4A, the GPS-indexed real-property (land) database system 7 will store the GPS coordinates of the vertices and maps of all land parcels contained in every town, county, and state of the region over which the system network is deployed and used to manage wild fires as they may occur. Typically, databases and data processing methods, equipment and services known in the GPS mapping art, will be used to construct and maintain such GPS-indexed databases 7 for use by the system network of the present invention, when managing GPS-controlled application of clean anti-fire (AF) chemical liquid spray and mist over GPS-specified parcels of land, at any given time and date, under the management of the system network of the present invention. Examples of such GPS-indexed maps of land parcels are reflected by the task report shown in FIG. 23, and examples of GPS-indexed maps are shown in the schematic illustrations depicted in FIGS. 18, 20, 22 and 24.

As shown in FIG. 4A, the system network 1 also includes a GPS system 100 for transmitting GPS reference signals transmitted from a constellation of GPS satellites deployed in orbit around the Earth, to GPS transceivers installed aboard each GPS-tracking ground-based or air-based anti-fire (AF) liquid misting/spraying system of the present invention, shown in FIGS. 6A through 10B, as part of the illustrative embodiments. From the GPS signals it receives, each GPS transceiver aboard such AF liquid spraying/misting systems is capable of computing in real-time the GPS location of its host system, in terms of longitude and latitude. In the case of the Empire State Building in NYC, NY, its GPS location is specified as: N40° 44.9064′, W073° 59.0735′; and in number only format, as: 40.748440, −73.984559, with the first number indicating latitude, and the second number representing longitude (the minus sign indicates “west”).

As shown in FIG. 4B, the system network 1 further includes multi-spectral imaging (MSI) systems and/or hyper-spectral-imaging (HSI) systems 14 for remotely data sensing and gathering data about wild fires and their progress. Such MSI and HSI systems may be space/satellite-based and/or drone-based (supported on an unmanned airborne vehicle or UAV). Drone-based systems can be remotely-controlled by a human operator, or guided under an artificial intelligence (AI) navigation system. Such AI-based navigation systems may be deployed anywhere, provided access is given to such remote navigation system the system network and its various systems. Typically, the flight time will be limited to under 1 hour using currently available battery technology, so there will be a need to provide provisions for recharging the batteries of such drones/UASs in the field, necessitating the presence of human field personnel to support the flight and remote data sensing and mapping missions of each such deployed drone, flying about raging wild fires, in connection with the system network of the present invention.

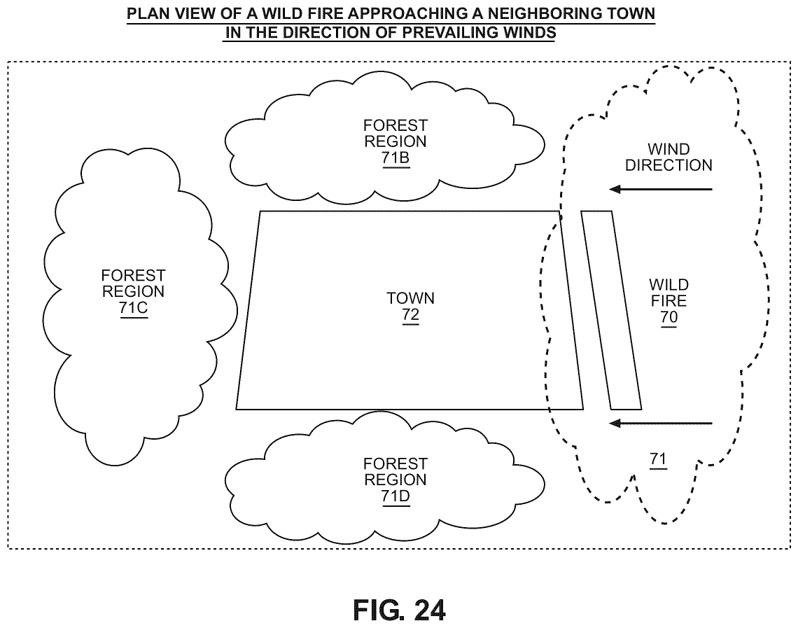

During each wild fire data sensing and mapping mission, carried out by such UAS, a series of MSI images and HSI images can be captured during a wild fire, and mapped to GPS-specific coordinates, and this mapped data can be transmitted back to the system network for storage, analysis and generation of GPS-specified flight plans for anti-fire (AF) chemical liquid spray and misting operations carried out using the methods illustrated in FIGS. 24, 25, 26A and 26B seeking to stall and suppress such wild fires, and mitigate risk of damage to property and harm to human and animal life.

FIG. 4B shows a suite of MSI and HSI remote sensing and mapping instruments and technology 14 that is currently being used by the US Geological Survey (USGS) Agency to collect, monitor, analyze, and provide science about natural resource conditions, issues, and problems on Earth. It is an object of the present invention to exploit such instruments and technology when carrying out and practicing the various methods of the present invention disclosed herein. As shown in FIG. 4B, these MSI/HSI remote sensing technologies 14 include: MODIS (Moderate Resolution Imaging Spectro-radiometer) satellite system 14A for generating MODIS imagery subsets from MODIS direct readout data acquired by the USDA Forest Service Remote Sensing Applications Center, to produce satellite fire detection data maps and the like https://fsapps.nwcg.gov/afm/activefiremaps.php; the World View 2 Satellite System 14B manufacture from the Ball Aerospace & Technologies and operated by DigitalGlobe, for providing commercially available panchromatic (B/W) imagery of 0.46 meter resolution, and eight-band multi-spectral imagery with 1.84 meter resolution; Octocopter UAS (e.g. OnyxStar Hyra-12 heavy lifting drone) 14C as shown in FIG. 4B supporting MSI and HSI camera systems for spectral imaging applications, http://www.onyxstar.net and http://www.genidrone.com; and SenseFly eBee SQ UAS 14D for capturing and mapping high-resolution aerial multi-spectral images https://www.sensefly.com/drones/ebee-sq.html.

Any one or more of these types of remote data sensing and capture instruments, tools and technologies can be integrated into and used by the system network 1 for the purpose of (i) determining GPS-specified flight/navigation plans for GPS-tracked anti-fire (AF) chemical liquid spraying and misting aircraft and ground-based vehicle systems, described above, and (ii) practicing the various GPS-guided methods of wild fire suppression illustrated in FIGS. 24 through 32B, and described in detail herein.

### Specification of the Network Architecture of the System Network of the Present Invention

FIG. 4A illustrates the network architecture of the system network 1 implemented as a stand-alone platform deployed on the Internet. As shown, the Internet-based system network comprises: cellular phone and SMS messaging systems and email servers 16 operably connected to the TCP/IP infrastructure of the Internet 10; a network of mobile computing systems 11 running enterprise-level mobile application software 12, operably connected to the TCP/IP infrastructure of the Internet 10; an array of mobile GPS-tracked anti-fire (AF) liquid spraying systems (20, 30, 40, 50), each provided with GPS-tracking and having wireless internet connectivity with the TCP/IP infrastructure of the Internet 10, using various communication technologies (e.g. GSM, Bluetooth, WIFI, and other wireless networking protocols well known in the wireless communications arts); and one or more industrial-strength data center(s) 8, preferably mirrored with each other and running Border Gateway Protocol (BGP) between its router gateways, and operably connected to the TCP/IP infrastructure of the Internet 10.

As shown in FIG. 4A, each data center 8 comprises: the cluster of communication servers 9A for supporting http and other TCP/IP based communication protocols on the Internet (and hosting Web sites); a cluster of application servers 9B; the cluster of RDBMS servers 9C configured within a distributed file storage and retrieval ecosystem/system, and interfaced around the TCP/IP infrastructure of the Internet well known in the art; the SMS gateway server 9D supporting integrated email and SMS messaging, handling and processing services that enable flexible messaging across the system network, supporting push notifications; and the cluster of email processing servers 9E.

Referring to FIG. 4A, the cluster of communication servers 9A is accessed by web-enabled mobile computing clients 11 (e.g. smart phones, wireless tablet computers, desktop computers, computer workstations, etc.) used by many stakeholders accessing services supported by the system network 1. The cluster of application servers 9A implement many core and compositional object-oriented software modules supporting the system network 1. Typically, the cluster of RDBMS servers 9C use SQL to query and manage datasets residing in its distributed data storage environment, although non-relational data storage methods and technologies such as Apache's Hadoop non-relational distributed data storage system may be used as well.

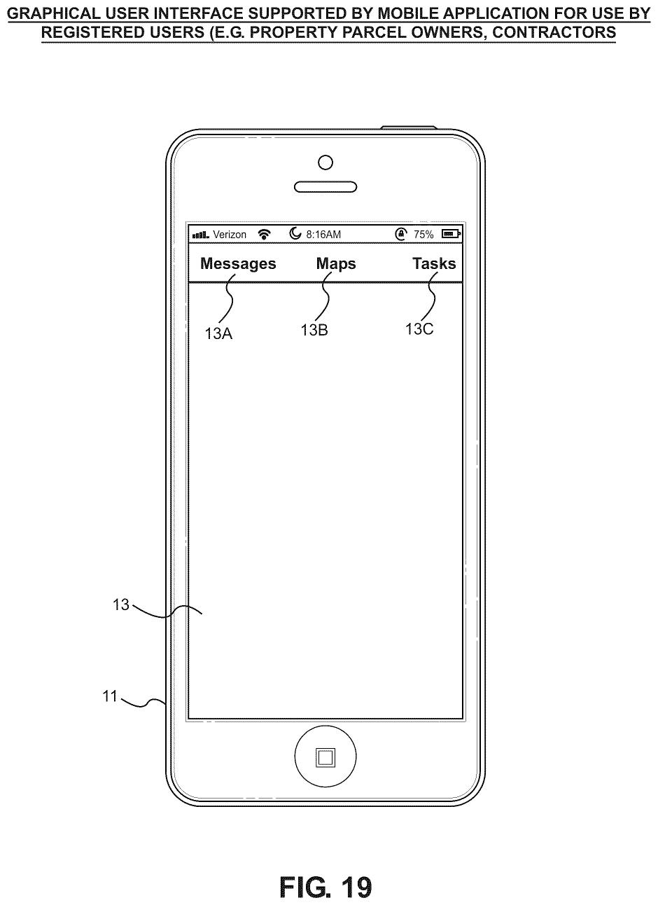

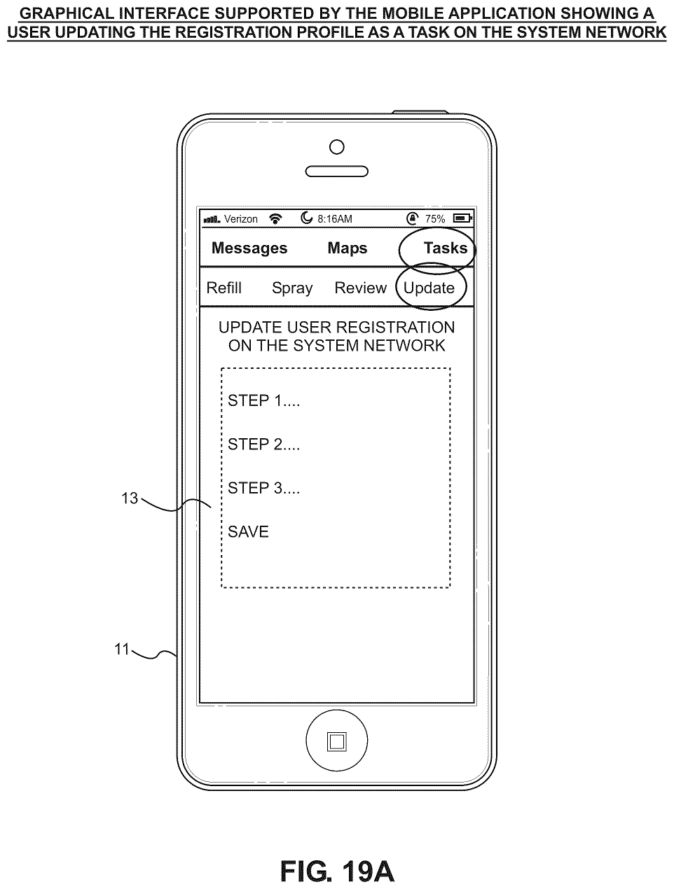

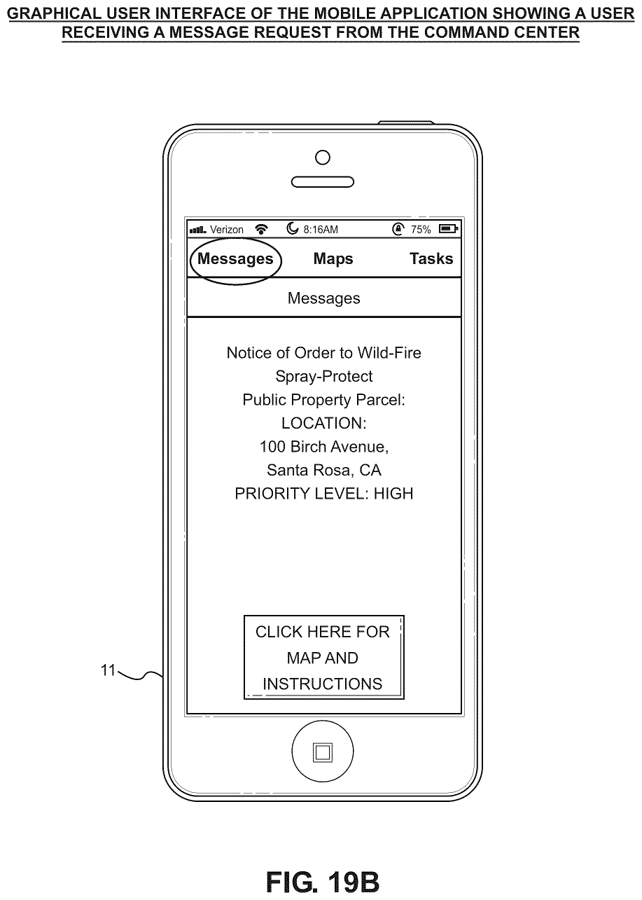

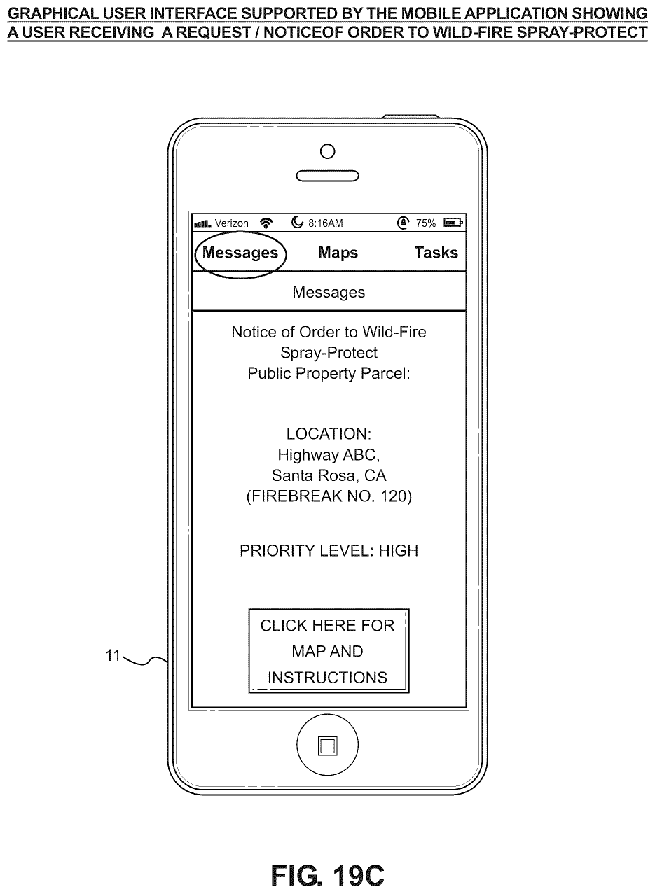

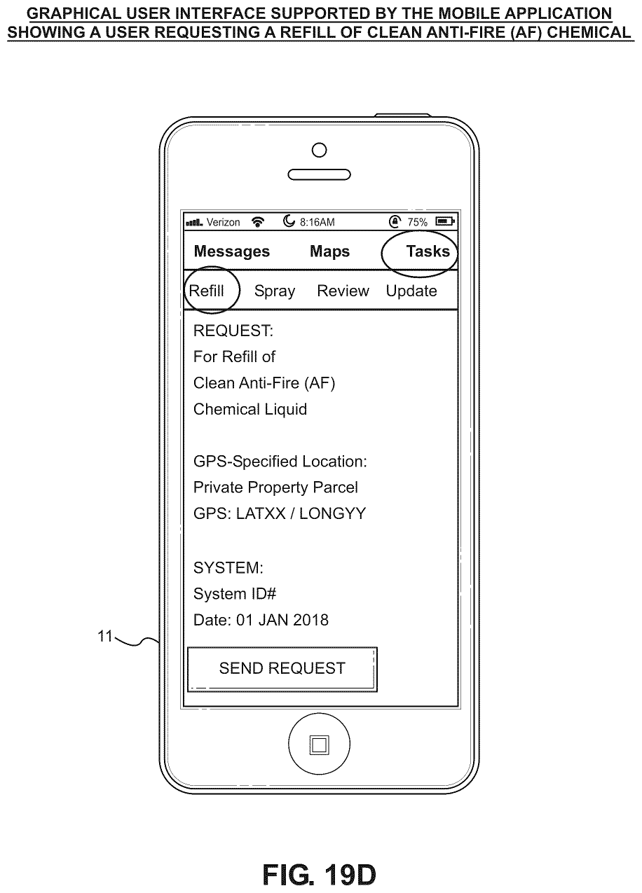

As shown in FIG. 4A, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc.) used by spray-project technicians and administrators, and running a native mobile application 12 supported by server-side modules, and the various illustrative GUIs shown in FIGS. 19 through 19D, supporting client-side and server-side processes on the system network of the present invention; and a GPS-tracked anti-fire (AF) liquid spraying systems 20, 30, 40 and 50 for spraying buildings and ground cover to provide protection and defense against wild-fires.

In general, the system network 1 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 12 of the present invention, described above.

### Specification of System Architecture of an Exemplary Mobile Smartphone System Deployed on the System Network of the Present Invention

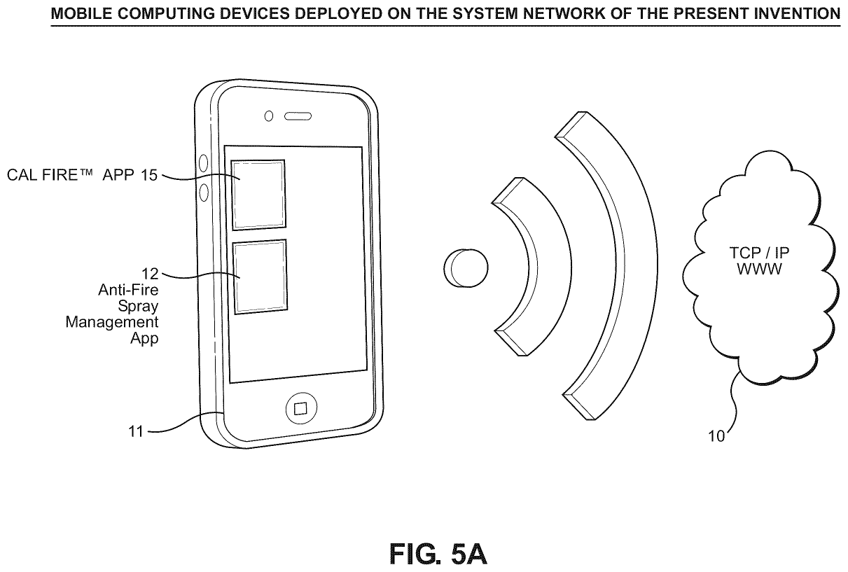

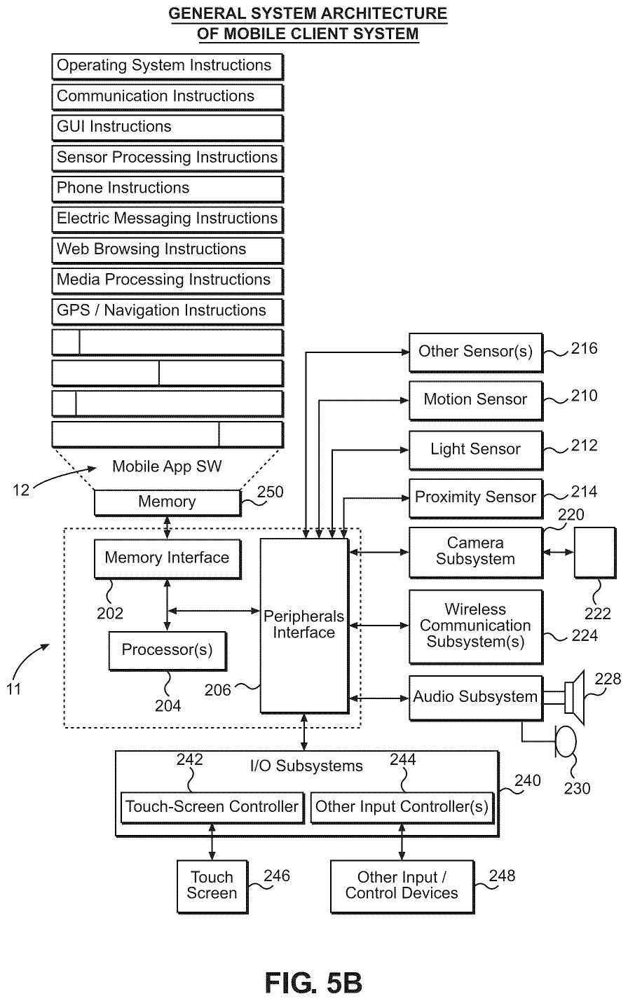

FIG. 5A shows an exemplary mobile computing device 11 deployed on the system network of the present invention, supporting conventional wildfire alert and notification systems (e.g. CAL FIRE® wild fire notification system 14), as well as the mobile anti-fire spray management application 12 of the present invention, that is deployed as a component of the system network 1.

FIG. 5B shows the system architecture of an exemplary mobile client computing system 11 that is deployed on the system network 1 and supporting the many services offered by system network servers 9A, 9B, 9C, 9D, 9E. As shown, the mobile smartphone device 11 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 11 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 11 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 11 can be found in U.S. Pat. No. 8,631,358 incorporated herein by reference in its entirety.

### Different Ways of Implementing the Mobile Client Machines and Devices on the System Network of the Present Invention

In one illustrative embodiment, the enterprise-level system network is realized as a robust suite of hosted services delivered to Web-based client subsystems 1 using an application service provider (ASP) model. In this embodiment, the Web-enabled mobile application 12 can be realized using a web-browser application running on the operating system (OS) (e.g. Linux, Application IOS, etc.) of a mobile computing device 11 to support online modes of system operation, only. However, it is understood that some or all the services provided by the system network 1 can be accessed using Java clients, or a native client application, running on the operating system of a client computing device, to support both online and limited off-line modes of system operation. In such embodiments, the native mobile application 12 would have access to local memory (e.g. a local RDBMS) on the client device 11, accessible during off-line modes of operation to enable consumers to use certain or many of the system functions supported by the system network during off-line/off-network modes of operation. It is also possible to store in the local RDBMS of the mobile computing device 11 most if not all relevant data collected by the mobile application for any fire-protection spray project, and to automatically synchronize the dataset for user's projects against the master datasets maintained in the system network database 9C1, within the data center 8 shown in FIG. 4A. This way, when using a native application, during off-line modes of operation, the user will be able to access and review relevant information regarding any building spray project, and make necessary decisions, even while off-line (i.e. not having access to the system network).

As shown and described herein, the system network 1 has been designed for several different kinds of user roles including, for example, but not limited to: (i) public and private property owners, residents, fire departments, local, county, state, and federal officials; and (ii) wild fire suppression administrators, contractors, technicians et al registered on the system network. Depending on which role, for which the user requests registration, the system network will request different sets of registration information, including name of user, address, contact information, etc. In the case of a web-based responsive application on the mobile computing device 11, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 1 can be realized as mobile web-browser application, or as a native application, each having a “responsive-design” and adapted to run on any client computing device (e.g. iPhone, iPad, Android, or other Web-enabled computing device) 11 and designed for use by anyone interested in managing, monitoring, and working to defend against the threat of wild fires.

Specification of Environmentally-Clean Aqueous-Based Liquid Fire Inhibiting Bio-Chemical Compositions and Formulations, and Methods of Making the Same in Accordance with the Principles of the Present Invention

Another object of the present invention is to provide new and improved family of environmentally-clean (“i.e. Green”) aqueous-based fire inhibiting biochemical solutions (i.e. wet liquid compositions and dry powder composition formulation kits) for producing (i) biochemical products that demonstrate good immediate extinguishing effects when applied to extinguish a burning or smoldering fire, and (ii) very good long-term fire inhibiting effects when proactively applied on combustible surfaces to protect against the threat of fire, by formation of thin clear alkali metal salt crystalline coatings that remain and persist after water molecules evaporate to the environment.

While the preferred formulation of the liquid fire inhibitor is “ready-to-use” not requiring the addition of water and/or mixing before use, the liquid fire inhibitor solution of the present invention can also be produced in a concentrated liquid form designed for mixing with water prior to application using a proportional mixing spray nozzle and/or other suitable apparatus disclosed in U.S. Pat. Nos. 11,865,390 and 11,865,394 incorporated herein by reference in its entirety.

In general, as illustrated in the generic chemical formulation model of FIG. 6, each new and improved environmentally-clean (“i.e. Green”) aqueous-based fire inhibiting biochemical solution of the present invention is made from a major amount of alkali metal salt (derived from a saturated non-polymerized carboxylic acid), dissolved in a major amount of water along with a minor amount of dispersing/coalescing agent suitable to disperse and coalesce alkali metal ions in solution to form ultra-thin alkali metal salt crystalline coatings on combustible surfaces, as water molecules evaporate to the atmosphere and crystalline structures form on the surfaces, to provide the combustible surface with proactive protection against fire ignition, flame spread and smoke development, without producing toxic and/or otherwise detrimental effects to human, animal, and plant/botanical life during and after spray application. More specifically, the ultra-thin potassium (i.e. alkali metal) salt crystalline coatings on the combustible surfaces (i) provide potassium ions to inhibit fire ignition and flame spread and reduce production of smoke by interrupting free radical chain reactions driving the combustible phase of the fire, and (ii) support transport of oxygen and carbon-dioxide gases across living plant tissue on leaves of trees, plants, flowers and grasses and other botanical lifeforms, without adversely affecting the vitality of said living plant tissue when said living plant tissue is sprayed with said fire inhibiting biochemical liquid composition.

The starting biochemicals, namely the non-polymerized saturated carboxylic acid, is an organic acid which contains a carboxyl group (C(═O)OH) attached to an R-group (R =alkyl or aryl). Carboxylic acids (denoted by R—COOH) are weak acids, meaning they are not 100% ionized in water. Generally, only about 1% of the molecules of a carboxylic acid dissolved in water are ionized at any given time. The remaining molecules are undissociated in solution. Being “saturated” means in this case, that each carbon (C) atom is bonded to four other atoms (hydrogen or carbon)—the most possible, and that there are no double or triple bonds in the molecules. The word saturated has the same meaning for hydrocarbons as it does for the dietary fats and oils: the molecule has no carbon-to-carbon double bonds (C=C).

The carbon-hydrogen bond (C—H bond) in the saturated non-polymerized carboxylic acid is a chemical bond between carbon and hydrogen atoms that can be found in many organic compounds. This bond is a covalent, single bond, meaning that carbon shares its outer valence electrons with up to four hydrogens. This completes both of their outer shells, making them stable. The C—H bond in general is very strong, so it is relatively unreactive.

The term “non-polymerized” means that carbon and hydrogen atoms in the saturated carboxylic acid have not undergone polymerization or any process of reaction in which relatively small molecules (monomer molecules) are reacted or combined chemically together in a chemical reaction to form very large chainlike or network molecule, called a polymer chains or three-dimensional network. In understanding that there are many forms of polymerization and different systems exist to categorize them.

A tricarboxylic acid, by the name itself, says that it is a category of carboxylic acid which has 3 C(═O)OH groups. In a carboxylic acid group, a carbon (C) atom is bonded to an oxygen (O) atom by a double bond, and to a hydroxyl group (—OH) by a single bond i.e., its functional group represented as C(═O)OH. Carboxylic acids occur widely in nature and its derivatives are of utmost importance in various chemical reactions. Tricarboxylic acids belong to the class of carboxylic acids which contains 3 carboxyl groups (C(═O)OH) attached to R-groups (R=alkyl or aryl).

At this juncture, it will be helpful to briefly identify a few kinds of carboxylic acids that are found in nature and which are of significance for purpose of the present invention, namely: the citric acid compound, a weak acid naturally occurring in citric fruits, which carries 3 carboxyl groups (C(═O)OH) attached to the parent chain, and hence is a tricarboxylic acid, a weak acid which naturally occurs in citric fruits; malonic acid, which carries only 2 carboxyl groups (C(═O)OH), and therefore is a dicarboxylic acid; succinic acid, which carries only 2 carboxyl groups (C(═O)OH), and therefore is a dicarboxylic acid; and malic acid, which also carries only 2 carboxyl groups (C(═O)OH), and therefore is a dicarboxylic acid. Since tricarboxylic acids have 3 carboxyl groups (C(═O)OH) attached to R-groups, it does have the ability to form strong hydrogen bonds, and this results in their high boiling points. Reference is made to the published organic chemistry textbook titled “MARCH'S ADVANCED ORGANIC CHEMISTRY: Reactions, Mechanisms, and Structures (Eighth Edition)”, Michael B. Smith, published by John Wiley & Sons, Inc., 2020, and incorporated herein by reference. Whenever available, all chemical substances and compounds disclosed herein have been provided with their CAS Registration Nos. as registered in the CAS Common Chemistry Database https:commonchemistry.cas.org/

In general, the novel environmentally-clean (i.e. “green”) fire inhibiting liquid biochemical solutions and compositions of the present invention comprise a number of core elements, namely: (a) a dispersing agent in the form of a major quantity of water, for dispersing metal ions dissolved in water; (b) a major amount of a fire inhibiting agent in the form of at least one alkali metal salt of a nonpolymeric saturated carboxylic acid, for providing metal ions dispersed in the water when the at least one alkali metal salt is dissolved in the water; (c) a minor amount of a coalescing agent in the form of an organic compound containing multiple (e.g. double or triple) carboxylic acid groups (or salt/ester derivatives thereof), such as triethyl citrate, an ester of citric acid, for dispersing and coalescing the metal ions when the fire inhibiting liquid composition is applied to a surface to be protected against fire, while water molecules in the water evaporate during drying, and the metal ions cooperate to form metal salt crystal structure on the surface.

Optionally, additional elements may be added to the environmentally-clean liquid fire inhibiting biochemical solutions of the present invention disclosed herein, namely: (d) at least one anti-corrosive agent (e.g. sodium silicate, Na₂O₃Si, CAS RN: 1344-09-8) dissolved in water to form a protective film on container and piping surfaces and prevent corrosion-producing chemical reactions from damaging the surfaces of such metallic materials, as may be required by the particular application; (e) if appropriate, in certain wood protection applications, at least one biocide (e.g. citric acid or Polyphase® PW40 Biocide from Troy Corporation) dissolved in water for inhibiting the growth and development of mold, fungus, mildew and microbial growth on treated wood surfaces for purposes of preventing rot and structural deterioration of the treated wood; and (f) if appropriate, at least one colorant dissolved in the water for adding color properties to the biochemical liquid composition when applied to a combustible surface to be protected against fire.

In the world of organic chemistry, there are many possible non-polymeric saturated carboxylic acids that can be used to derive and produce alkali metal salts thereof for use in producing environmentally-clean aqueous-based liquid fire inhibitor that can be sprayed on combustible surfaces and form thin alkali metal salt crystalline coatings that inhibit fire ignition, flame spread and smoke development. Such possible carboxylic acids include, but are not limited to, the following carboxylic acids organized according to the number of carbon atoms (Ci) contained therein, namely:
(C1) The C1 Class of Carboxylic Acids having 1 carbon atom (C=1), including formic acid (i.e. methanoic acid) CH₂O₂, and carbonic acid (i.e. hydroxymethanoic acid) H₂CO₃;
(C2) The C2 Class of Carboxylic Acids having 2 carbon atoms (C=2), including acetic acid (ethanoic acid) CH₃COOH, glycolic acid (hydroxyacetic acid) C₂H₄O₃, and glyoxylic acid C₂H₂O₃;
(C3) The C3 Class of Carboxylic Acids having 3 carbon atoms (C=3), including propionic acid C₃H₆O₂, lactic acid C₃H₆O₃, glyceric acid C₃H₆O₄, pyruvic acid C₃H₄O₃, and tartaric acid C₃H₆O₆;
(C4) The C4 Class of Carboxylic Acids having 4 carbon atoms (C=4), including butyric acid CH3(CH2)2COOH, malic acid C₄H₆O₅, and malonic acid C₃H₄O₄;
(C5) The C5 Class of Carboxylic Acids having 5 carbon atoms (C=5), including pivalic acid C₅H₁₀O₂;
(C6) The C6 Class of Carboxylic Acids having 6 Carbon Atoms (C=6), including caproic acid CH3(CH2)4COOH, adipic (hexanedioic) acid HOOC(CH2)4COOH, citric acid HOC(COOH)((CH2) COOH)2, and d-gluconic acid C₆H₁₂O₇; and
(C7) The C7 Class of Carboxylic Acids having 7 carbon atoms (C=7), including benzoic acid C₇H₆O.

While many alkali metal salts can be produced from these carboxylic acids listed above, as indicated in the models shown in FIGS. 6C1 through 6V2, the alkali metal salts of citric acid under Group C6 are particularly preferred, as will be further explained hereinbelow.

While the efficacy of the alkali metal salts increases in the order of lithium, sodium, potassium, cesium and rubidium, the salts of potassium and the salts of sodium preferred for cost of manufacturing reasons. Potassium carboxylates are very particularly preferred, but tripotassium citrate monohydrate (TPC) is the preferred alkali metal salt for use in formulating the environmentally-clean fire inhibiting biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported in the European Chemicals Agency (ECHA) handbook; and (iv) tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the preferred embodiments of the biochemical compositions and solutions of the present invention will be described in greater detail hereinafter.

Preferably, the water-soluble coalescing agent should have a melting point at least 32 F (0 C) or lower in temperature, and be soluble in water. The citric acid ester, triethyl citrate (TEC), is a preferred dispersing/coalescing agent when used in combination with tripotassium citrate (TPC) having excellent molecular and chemical compatibility given that both chemical compounds are derived from citric acid.

Ideally, the biocidal agent should help increase stability in storage, especially of the aqueous preparations, and prevent or inhibit growth of mildew, mold, and fungus when the biochemical liquid compositions are sprayed or otherwise applied to the surfaces of wood products that to be treated therewith, to produce Class-A fire-protected wood products with resistance to mold, mildew and fugus growth. This is important when wood products are shipped and stored in lumber yard and allowed to be exposed to the natural elements for months on a construction site, where moisture is present, and conditions are excellent for such microbial growth. Mold, mildew, and fungus growth not only detracts from the appearance of the wood product, but also can adversely decrease wood fiber strength and other mechanical properties for which wood products are used in specific construction applications.

In some applications, the use of colorants may be advantageous with or without opacifying assistants, to the fire inhibiting biochemical liquid compositions of the present invention. Opacifying assistants make the fire-retarding biochemical composition cloudy and prevent any interaction between the color of the added colorant used and the background color.

A preferred colorant is mica, especially natural mica, which acts as an opacifying assistant, so that a separate opacifying assistant can be omitted. Areas which have already been treated are easier to identify, for example, from the air. In addition, mica can reflect direct thermal radiation.

Coloring agents can be used as well to impart permanent or temporary (fugitive) coloring characteristics for the application at hand. Coloring agents can be realized as a dry powder (fluorescent) pigments, or liquid dispersions, available from the DayGlo Color Corp. of Cleveland, Ohio. Of advantage are dyes, food dyes for example, which fade as the fire-retarding composition dries and gradually decompose or are otherwise easily removable, for example, by flushing with water.

Preferably, the concentration of the dye, pigment powder or coloring agent in the fire-inhibiting biochemical composition is in the range from 0.005% to 10% by weight, more preferably in the range from 0.01% to 5% by weight, and most preferably in the range from 0.015% to 2% by weight, all based on the total weight of aqueous-based fire inhibiting biochemical composition.

Also, although not preferred and in many application undesired, however if appropriate for any fire inhibiting application at hand, an adhesion agent may be added to the aqueous-based biochemical compositions of the present invention, but this is likely to increase the viscosity of the aqueous-based biochemical compositions. In such instances, the adhesion agent may be realized in the form of a natural gum or starch in minor amounts to promote cling factor or adhesion properties between the alkali metal salt crystalline structures formed within liquid biochemical and the surface to which it has been applied, preferably by spraying, during proactive fire protection application. Preferably, the concentration of the adhesion agent in the fire-retarding biochemical composition is preferably in the range from 0.005% to 10% by weight, more preferably in the range from 0.01% to 5% by weight and most preferably in the range from 0.015% to 2% by weight.

The fire inhibiting liquid biochemical compositions of the present invention are producible and prepared by mixing the components in specified amounts with water to produce the fire inhibiting composition. The order of mixing is discretionary. It is advantageous to produce aqueous preparations by mixing the components other than water, into water.

The fire-retarding biochemical compositions of the present invention have a good fire inhibiting effect and, a good immediate fire extinguishing effect. This mixing of the constituent biochemical compounds can take place before or during their use. For example, an aqueous preparation may be set and kept in readiness for fire inhibiting use. However, it is also possible for the aqueous preparation not to be produced until it is produced, by diluting with water, during a fire defense deployment application.

The compositions of the present invention are also useful as a fire extinguishing agent for fighting fires of Class A, B, C and D. For example, an aqueous biochemical solution of the present invention may be prepared and deployed for firefighting uses in diverse applications. However, it is also possible for the aqueous biochemical composition to not to be produced until it is needed, and when so, by either (i) diluting and dissolving its dry and/or wet components with a prespecified quantity of water, during firefighting deployments, or (ii) by mixing concentrated solution with proportioned amounts of water, in a mixing nozzle, in a conventional manner.

### Specification of Preferred Embodiments of Aqueous-Based Fire Inhibiting Biochemical Compositions of Matter

As indicated above, while there are many species of Applicant's generic aqueous-based liquid fire inhibiting solution invention, based on different kinds of non-polymeric saturated carboxylic acids and alkali metal salts and esters dissolved in water, for forming thin fire-inhibiting life-supportive alkali metal salt crystalline coatings, Applicant's preferred solutions and compositions are based on (i) alkali metal potassium salts derived from the citric carboxylic acid, and (ii) esters of citric acid for superior dispersion of potassium and citrate ions, and the coalescing of salt crystalline molecules in aqueous solution during coating drying operations. These preferred embodiments will be summarized below, and thereafter, the other alternative species of invention will be specified in great technical detail.

In the first preferred embodiment of the fire inhibiting liquid biochemical composition/solution of the present invention, the components are realized as follows: (a) the dispersing agent is realized in the form of a quantity of water, for dispersing alkali metal ions dissolved in the water; (b) the fire inhibiting agent is realized in the form of an alkali metal salt of a nonpolymeric saturated carboxylic acid, specifically, tripotassium citrate, for providing metal (potassium) ions dispersed in the water when the at least one alkali metal salt is dissolved in the water; and (c) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid solution is applied to a surface to be protected against fire, and while water molecules in the water evaporate during drying, the metal potassium ions cooperate to form potassium citrate salt crystal structure on the treated surface.

In the second preferred embodiment of the fire inhibiting liquid biochemical solution of the present invention, the components are realized as follows: (a) the dispersing agent is realized in the form of a quantity of water, for dispersing metal ions dissolved in the water; (b) the fire inhibiting agent is realized in the form of an alkali metal salt of a nonpolymeric saturated carboxylic acid, specifically, tripotassium citrate, for providing metal (potassium) ions dispersed in the water when the at least one alkali metal salt is dissolved in the water; (c) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid solution is applied to a surface to be protected against fire, and while water molecules in the water evaporate during drying, the metal potassium ions cooperate to form potassium citrate salt crystal structure on the treated surface; and (d) at least one biocide agent dissolved in the quantity of water.

In the third preferred embodiment of the fire inhibiting liquid biochemical solution of the present invention, the components are realized as follows: (a) the dispersing agent is realized in the form of a quantity of water, for dispersing metal ions dissolved in the water; (b) the fire inhibiting agent is realized in the form of an alkali metal salt of a nonpolymeric saturated carboxylic acid, specifically, tripotassium citrate, for providing metal (potassium) ions dispersed in the water when the at least one alkali metal salt is dissolved in the water; (c) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid composition is applied to a surface to be protected against fire, and while water molecules in the water evaporate during drying, the metal potassium ions cooperate to form potassium citrate salt crystal structure on the treated surface; and (d) at least one biocide agent in the form of citric acid dissolved in the quantity of water.

In the fourth preferred embodiment of the fire inhibiting liquid biochemical solution of the present invention, the components are realized as follows: (a) the dispersing agent is realized in the form of a quantity of water, for dispersing metal ions dissolved in the water; (b) the fire inhibiting agent is realized in the form of an alkali metal salt of a nonpolymeric saturated carboxylic acid, specifically, tripotassium citrate, for providing metal (potassium) ions dispersed in the water when the at least one alkali metal salt is dissolved in the water; (c) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid composition is applied to a surface to be protected against fire, and while water molecules in the water evaporate during drying, the metal potassium ions cooperate to form potassium citrate salt crystal structure on the treated surface; (d) at least one biocide agent dissolved in the quantity of water; and (e) at least one colorant.

Once prepared using any of formulations specified above, the liquid biochemical solution is then stored in a container, bottle, or tote (i.e. its package) suitable for the end user application in mind. Then, the filled package should be sealed with appropriate sealing technology and immediately labeled with a specification of (i) its biochemical components, with weight percent measures where appropriate, and the date and time of manufacture, printed and recorded in accordance with good quality control (QC) practices well known in the art. Where necessary or desired, barcode symbols and/or barcode/RFID identification tags and labels can be produced and applied to the sealed package to efficiently track each barcoded package containing a specified quantity of clean fire inhibiting biochemical position. All product and QC information should be recorded in globally accessible network database, for use in tracking the movement of the package as it moves along the supply chain from its source of manufacture, toward it end use at a GPS specified location.

Specification of Preferred Embodiments of the Dry Fire Inhibiting Biochemical Compositions of Matter Assembled as a Fire Inhibiting Biochemical Composition Kit for Use with Specified Quantities of Water

In the fifth preferred embodiment of the fire inhibiting liquid biochemical solution of the present invention, the components are realized as follows: (a) the fire inhibiting agent is realized in the form of an alkali metal salt of a nonpolymeric saturated carboxylic acid, specifically, tripotassium citrate, for providing metal potassium ions to be dissolved and dispersed in a quantity of water; (b) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid solution is applied to a surface to be protected against fire, and while water molecules in the water evaporate during drying, the metal potassium ions cooperate to form potassium citrate salt crystal structure on the treated surface; (c) if appropriate, at least one biocide in the form of citric acid, dissolved in the quantity of water; and (d) if appropriate, at least one colorant.

In the sixth preferred embodiment of the fire inhibiting liquid biochemical solution of the present invention, the components are realized as follows: (a) the fire inhibiting agent is realized in the form of an alkali metal salt of a nonpolymeric saturated carboxylic acid, specifically, tripotassium citrate, for providing metal potassium ions to be dissolved and dispersed in a quantity of water; (b) a coalescing agent realized the form of an organic chemical compound containing three carboxylic acid groups (or salt/ester derivatives thereof), specifically triethyl citrate, an ester of citric acid, for dispersing and coalescing the metal potassium ions when the fire inhibiting liquid solution is applied to a surface to be protected against fire, and while water molecules in the water evaporate during drying, the metal potassium ions cooperate to form potassium citrate salt crystal structure on the treated surface; (c) at least one biocide in the form of citric acid, dissolved in the quantity of water; and (d) if appropriate, at least one colorant.

### Selecting Tripotassium Citrate (TCP) as a Preferred Fire Inhibiting Agent for Use in the Fire Inhibiting Biochemical Compositions of the Present Invention

In the preferred embodiments of the present invention, tripotassium citrate (TPC) is selected as active fire inhibiting chemical component in fire inhibiting biochemical solution. In dry form, TPC is known as tripotassium citrate monohydrate (C₆H₅K₃O₇·H₂O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Care should be taken not to expose tripotassium citrate monohydrate to high pressure during transport and storage as this may result in caking. Tripotassium citrate monohydrate is considered “GRAS” (Generally Recognized As Safe) by the United States Food and Drug Administration without restriction as to the quantity of use within good manufacturing practice. CAS Registry Number for tripotassium citrate monohydrate: [6100-05-6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

Selecting Triethyl Citrate (TEC) as a Preferred Dispersing/Coalescing Agent with Surface Tension Reducing and Surfactant Properties for Use in the Fire Inhibiting Biochemical Compositions of the Present Invention

In the preferred illustrative embodiments of the present invention, the coalescing agent used in the fire inhibitor biochemical compositions of the present invention is realized as a food-grade additive component, namely, triethyl citrate (TEC) which functions as a dispersing and coalescing agent with surface tension reducing properties and surfactant properties as well. Citric acid is a six-carbon tricarboxylic acid, first isolated from lemon juice, and used in the food and beverage industry for various purposes, as pharmaceuticals and for other industrial uses. Triethyl citrate belongs to the family of tricarboxylic acids (TCAs) and derivatives, organic chemical compounds containing three carboxylic acid groups (or salt/ester derivatives thereof).

In the aqueous-based fire inhibiting liquid composition, the coalescing agent functions as temporary dispersing agent for dispersing the metal ions dissolved and disassociated in aqueous solution. As water molecules evaporate from a coating of the biochemical composition, typically spray/atomized applied to a surface to be protected from fire, the coalescing agent allows the formation of thin metal (e.g. potassium citrate) salt crystal structure/films at ambient response temperature conditions of coating application. The coalescent agent promotes rapid metal salt crystal structure formation on surfaces to be protected against wildfire, and have a hardness evolution that promotes durability against rain and ambient moisture, while apparently allowing vital oxygen and CO2 gas transport to occur, without causing detrimental effects to the vitality of living plant tissue surfaces sought to be protected against wildfire.

A relatively minor quantity of triethyl citrate (TEC) liquid is blended with a major quantity of TCP powder in specific quantities by weight and dissolved in a major quantity of water to produce a clear, completely-dissolved liquid biochemical formulation consisting of food-grade biochemicals mixed with water and having highly effective fire inhibiting properties, as proven by testing. The resulting aqueous biochemical solution remains stable without the formation of solids at expected operating temperatures (e.g. 34 F to 120 F).

Jungbunzlauer (JBL) also manufactures and distributes its CITROFOL® A1 branded bio-based citrate esters for food-grade, healthcare, pharmaceutical and over the counter (OTC) applications around the world. CITROFOL® A1 triethyl citrate (TEC) esters have an excellent toxicological and eco-toxicological profile, and provide good versatility and compatibility with the tripotassium citrate (TPC) component of the biochemical compositions of the present invention. CITROFOL® A1 branded citrate esters are particularly characterized by highly efficient solvation, low migration, and non-VOC (volatile organic compound) attributes. As an ester of citric acid, triethyl citrate is a colorless, odorless liquid which historically has found use as a food additive (E number E1505) to stabilize foams, especially as a whipping aid for egg whites.

Broadly described, the fire inhibiting biochemical liquid coatings of the present invention consist of an aqueous dispersion medium such as water which carries dissolved metal salt cations that eventually form a thin metal salt crystalline structure layer on the surface substrate to be protected from ignition of fire. The aqueous dispersion medium may be an organic solvent, although the preferred option is water when practicing the present invention. After the application of a coating onto the combustible surface to be protected against fire ignition and flame spread and smoke development, the aqueous dispersion medium evaporates, causing the metal salt (i.e. potassium salt) cations to draw together. When these metal salt particles come into contact, the coalescing agent, triethyl citrate, takes effect, uniformly dispersing the same while reducing liquid surface tension, and giving rise to the formation of a relatively homogeneous metal salt crystalline structure layer over the surface. In practice, this interaction is more complex and is influenced by various factors, in particular, the molecular interaction of the potassium salt cations and the coalescing agent, triethyl citrate, as the water molecules are evaporating during the drying process.

While offering some surface tension reducing effects, the main function of the coalescing agent in the biochemical composition of the present invention is to ensure a relatively uniform and optimal formation of the salt crystalline structure layers on the combustible surfaces to be protected, as well as desired mechanical performance (e.g. offering scrub resistance and crystal coating hardness) and aesthetic values (e.g. gloss and haze effects).

The fact that CITROFOL® A1 triethyl citrate (TEC) esters are bio-based, odorless, biodegradable, and label-free, represents a great advantage over most other coalescing agents, and fully satisfies the toxicological and environmental safety requirements desired when practicing the biochemical compositions of the present invention.

In the preferred embodiments of the present invention, the use of CITROFOL® AI triethyl citrate (TEC) esters with tripotassium citrate monohydrate (TPC) dissolved in water as a dispersion solvent, produce fire inhibiting biochemical formulations that demonstrate excellent adhesion, gloss, and hardness properties. The chemical and colloidal nature of potassium salt ions (which are mineral salt dispersions) present in TPC dissolved in water, is highly compatible with the CITROFOL® A1 triethyl citrate (TEC) ester used as the coalescing agent in the preferred embodiments of the present invention. Also, CITROFOL® A1 triethyl citrate esters are REACH registered and are safe, if not ideal, for use in environmentally sensitive products such as fire and wildfire inhibitors which must not adversely impact human, animal and plant life, ecological systems, or the natural environment.

CITROFOL® triethyl citrate esters were selected because they are biodegradable, and exhibit an excellent toxicological and eco-toxicological profile for the applications of the present invention. These esters are also versatile and demonstrate very good compatibility with the TPC solution, and are characterized by a high solvating efficiency.

### Selecting Citric Acid as a Natural and Safe Biocidal Agent for Use in the Fire Inhibiting Biochemical Compositions of the Present Invention

Polyphase® PW40 water-based biocidal agent from Troy Chemical can be added to the biochemical compositions of the present invention, as described, and specified herein, to control and inhibit the growth of mold, mildew and fungus on wood products treated with the biochemical of the present invention. This biocidal agent (i.e. biocide) has shown to be effective in the applications described herein. However, the water-based Polyphase® PW40 biocide includes compounds (i.e. C₈H₁₂INO₂ or IPBC) as active ingredients that have been shown to have a toxicity profile that is not as safe as common organic acids such as citric acid, which is ubiquitous in nature and all of nature's life processes. Thus, it would be highly desirable to use organic food grade compounds to provide effective biocidal properties to the biochemical compositions of the present invention, to control and inhibit the growth of mold, mildew and fungus on wood surfaces that are (i) proactively treated with the biochemical compositions of the present invention, and (ii) later exposed to rain, moisture and natural elements while in storage at lumber yards, and/or on wet damp building construction sites where projects may last for at least 3-6 or more months before the buildings under construction are closed in and protected from the natural elements.

As an alternative biocidal agent, an object of the present invention is to add a minor amount of citric acid to the biochemical compositions of the present invention to effectively realize a natural and safe biocidal agent in the fire inhibitor biochemical compositions of the present invention, based on a food-grade additive component, namely, citric acid, which functions to control and inhibit the growth of mold, mildew and fugus on the surface coated with the fire inhibiting biochemical composition of the present invention.

It is well known that citric acid also belongs to the family of tricarboxylic acids (TCA) and derivatives, organic compounds containing three carboxylic acid groups (or salt/ester derivatives thereof). Citric acid is a weak organic acid found in citrus fruits. In biochemistry, citric acid is important as an intermediate in the citric acid cycle (i.e. tricarboxylic acid (TCA) cycle), and therefore occurs in the metabolism of almost all living things. The tricarboxylic acid (TCA) cycle is also called the Krebs cycle which functions in the second stage of cellular respiration, a three-stage process by which living cells break down organic fuel molecules in the presence of oxygen to harvest the energy they need to grow and divide and maintain cellular vitality. TCA cycle is the predominant source in all aerobic organisms to generate NADH and FADH2 from acetyl CoA, a product obtained by the decarboxylation of pyruvate. In addition, TCA cycle is also a major pathway for interconversion of metabolites and provides substrates for amino acid synthesis by transamination as well as for fatty acid synthesis and gluconeogenesis. The cycle starts with the condensation of acetyl-CoA with oxaloacetate to form citrate, a reaction catalyzed by citrate synthase. The entire cycle can be divided into two stages: (a) a decarboxylating stage involving conversion of citrate to succinyl-CoA; and (b) a reductive stage involving successive oxidation of succinate to fumarate, fumarate to malate, and then malate to oxaloacetate.

Through control of PH and oxidation in the biochemical compositions of the present invention, the citric acid is used in minor amounts in these biochemical compositions of matter for the purpose of controlling, inhibiting, and preventing the grow of mold, mildew, and fungus without the use of toxic chemical compounds known to pose health effects to humans and animals alike.

### Specification of Preferred Formulations for the Fire Inhibiting Biochemical Compositions of Matter According to the Present Invention

### Example #1: Liquid-Based Fire Inhibiting Biochemical Composition

FIG. 6A1 illustrates the primary components of a first environmentally-clean aqueous-based fire inhibiting liquid biochemical composition of the present invention (i.e. a fire inhibiting solution) consisting of tripotassium citrate (TPC) and triethyl citrate (TEC) formulated with water functioning as a solvent, carrier, and dispersant in the biochemical composition.

Example 1: Schematically illustrated in FIG. 6A1: A fire-extinguishing and/or fire-retarding biochemical composition was produced by stirring the components into water. The composition comprises: 21.25 [Lbs.] by weight of triethyl citrate as coalescing agent, 2.5 [Gallons] and 588.94 [Lbs.] by weight of tripotassium citrate as a fire-inhibiting salt of citric acid dissolved in 2007.16 [lbs.] by weight of water (241 [gallons] by volume), in a 275 [Gallon] tote container or package to produce a resultant mixed solution having 272.5 [gallons] of volume with a total weight of 2641 pounds. The % by weight of each major and minor component in this aqueous-based solution is given as follows: water—76.68% by weight; tripotassium citrate-22.50% by weight; and triethyl citrate-0.81% by weight; =100%.

### Example #2: Dry-Powder Fire Inhibiting Biochemical Composition

FIG. 6A2 illustrates the primary components of a first fire inhibiting biochemical composition kit of the present invention, consisting of dry tripotassium citrate (TPC) and triethyl citrate (TEC) components for mixing with a predetermined quantity of water functioning as a solvent, carrier, and dispersant, to make up a predetermined quantity of environmentally-clean liquid fire inhibiting biochemical composition for proactively protecting wood products.

Example 2: Schematically Illustrated in FIG. 6A2: A fire-extinguishing and/or fire-retarding biochemical composition was produced by blending the following components, in amounts proportional to the formulation comprising: 21.25 [Lbs.] by weight of triethyl citrate as coalescing agent, 2.5 [Gallons]; and 588.94 [Lbs.] by weight of tripotassium citrate, blended together in a 275 [Gallon] tote container or package, for mixing with 2007.16 [lbs.] by weight of water (240 [gallons] by volume), so as to produce a resultant mixed solution having 272.5 [gallons] of volume with a total weight of 2641 pounds. The % by weight of each major and minor components in this dry-powder biochemical composition is given as follows: water tripotassium citrate—96.53% by weight; and triethyl citrate—3.48% by weight=100%.

### Example #3: Liquid-Based Fire Inhibiting Biochemical Composition with Mold/Mildew/Fugus-Resistance

FIG. 6B1 illustrates the primary components of a second environmentally-clean aqueous-based fire inhibiting liquid biochemical composition of the present invention consisting of tripotassium citrate (TPC), triethyl citrate (TEC) and citric acid (CA) formulated with water functioning as a solvent, carrier, and dispersant in the biochemical composition.

Example 3: Schematically Illustrated in FIG. 6B1: A fire-extinguishing and/or fire-retarding biochemical composition was produced by stirring the components into water. The composition comprises:

21.25 [Lbs.] by weight of triethyl citrate as dispersing/coalescing agent, 2.5 [Gallons]; 564.94 [Lbs.] by weight of tripotassium citrate; 24 [Lbs.] of Polyphase PW40 biocidal agent, blended together in a 275 [Gallon] tote container or package, for mixing with 2007.16 [lbs.] by weight of water (240 [gallons] by volume), so as to produce a resultant mixed solution having 272.5 [gallons] of volume with a total weight of 2641 pounds. The % by weight of each major and minor component in this aqueous-based solution is given as follows: water—76.7% by weight; tripotassium citrate—21.58% by weight; triethyl citrate—0.81% by weight; polyphasePW40 biocidal agent—0.91% by weight=100%.

### Example #4: Dry-Powder Fire Inhibiting Biochemical Composition with Mold/Mildew/Fugus-Resistance

FIG. 6B2 illustrates the primary components of the second fire inhibiting biochemical composition kit of the present invention, consisting of dry tripotassium citrate (TPC), triethyl citrate (TEC) and citric acid (CA) components for mixing with a predetermined quantity of water functioning as a solvent, carrier, and dispersant, to make up a predetermined quantity of environmentally-clean liquid fire inhibiting biochemical composition for spray application over and proactively protecting combustible wood products.

Example 4: Schematically Illustrated in FIG. 6B2: A fire-extinguishing and/or fire-retarding biochemical composition was produced by blending the following components in amounts proportional to the formulation comprising: 21.25 [Lbs.] by weight of triethyl citrate as coalescing agent, 2.5 [Gallons]; 588.94 [Lbs.] by weight of tripotassium citrate;
60.0 [Lbs.] of citric acid as biocidal agent, blended together in a 275 [Gallon] tote container or package, for mixing with 2007.16 [lbs.] by weight of water (240 [gallons] by volume), so as to produce a resultant mixed solution having 272.5 [gallons] of volume with a total weight of 2641 pounds. The % by weight of each major and minor component in this dry-powder biochemical composition is given as follows: water tripotassium citrate—87.8% by weight; triethyl citrate—3.8% by weight; and citric acid as biocidal agent—8.87% by weight=100%.

### Example #5: Liquid-Based Fire Inhibiting Biochemical Composition with Mold/Mildew/Fugus-Resistance

The primary components of a second environmentally-clean aqueous-based fire inhibiting liquid biochemical composition of the present invention consist of tripotassium citrate (TPC), triethyl citrate (TEC) and citric acid (CA) formulated with water functioning as a solvent, carrier, and dispersant in the biochemical composition.

Example 5: A fire-extinguishing and/or fire-retarding biochemical composition was produced by stirring the components into water. The composition comprises: 21.25 [Lbs.] by weight of triethyl citrate as coalescing agent, 2.5 [Gallons]; 528.94 [Lbs.] by weight of tripotassium citrate; and 60 [Lbs.] of citric acid as biocidal agent; blended together in a 275 [Gallon] tote container or package, for mixing with 2007.16 [lbs.] by weight of water (240 [gallons] by volume), so as to produce a resultant mixed solution having 272.5 [gallons] of volume with a total weight of 2641 pounds. The % by weight of each major and minor component in this aqueous-based solution is given as follows: water—76.69% by weight; tripotassium citrate—20.2% by weight; triethyl citrate—0.82% by weight; and citric acid as biocidal agent—2.3% by weight=100%.

### Preferred Weights Percentages of the Components of the Aqueous-Based Fire Inhibiting Biochemical Formulation of the Present Invention

In the biochemical compositions of the present invention, the ratio of the ester of a nonpolymeric saturated carboxylic acid, such as citric acid (i.e. triethyl citrate) to the alkali metal salt of the nonpolymeric saturated carboxylic acid (e.g. tripotassium citrate) may be major amount between 1:100: to 1:1000 and is typically in the range from 1:1 to 1:100, preferably in the range from 1:2 to 1:50, more preferably in the range from 1:4 to 1:25.

A preferred aqueous-based biochemical composition according to the present invention comprises: a major amount from 1% to 60% by weight, preferably from 20% to 50% by weight and more preferably from 25% to 40% by weight, of at least one alkali metal salt of a nonpolymeric saturated carboxylic acid (e.g. tripotassium citrate monohydrate or TPC); a major amount from 1% to 90% by weight, preferably from 40% to 85% by weight and more preferably from 60% to 80% by weight, of water as a dissolving and dispersing agent; and a minor amount from 0.08% to 5% by weight, preferably from 0.5% to 2% by weight, and more preferably from 0.1% to 1.5% by weight, of a dispersing/coalescing agent such as triethyl citrate (i.e. an ester of citric acid); and wherein the % by weight is based on the total weight of the aqueous-based fire inhibiting biochemical composition, and wherein the sum by % weight of all the components should not exceed 100% measured by weight.

In a preferred embodiment, the aqueous-based fire inhibiting liquid composition (i.e. solution) further comprises water. The water content is present in a major amount and is typically not less than 40% by weight, preferably not less than 50% by weight, more preferably not less than 60% by weight and most preferably not less than 70% by weight and preferably not more than 80% by weight and more preferably not more than 90% by weight, all based on the total weight of aqueous-based fire inhibiting biochemical composition.

In a preferred embodiment, the fire inhibiting liquid composition (i.e. solution) further comprises citric acid biocidal agent. The citric acid biocidal agent is present in a minor amount and is typically not less than 2.0% by weight, preferably not less than 1.8% by weight, more preferably not less than 1.5% by weight and most preferably not less than 2.0% by weight and preferably not more than 3.0% by weight and more preferably not more than 4.0% by weight, all based on the total weight of fire inhibiting biochemical composition.

The Polyphase PW40 biocidal agent is present in a minor amount and is typically not less than 0.4% by weight, preferably not less than 0.5% by weight, more preferably not less than 0.7% by weight and most preferably not less than 0.9% by weight and preferably not more than 1.0% by weight and more preferably not more than 1.2% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely citric acid (e.g. potassium, calcium, sodium and/or magnesium citrate), functioning as a fire inhibitor, is present in a major amount having a weight percent of about 10.00% to about 40.00% relative to the weight of total weight of the aqueous-based fire inhibiting biochemical composition; and (iii) an ester of a saturated non-polymerized carboxylic acid (e.g. ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, when used in diverse temperature environments ranging from as low as 32 F to as high as 130 F. Such viscosity characteristics will facilitate spray-atomization methods when using the aqueous-based solutions of the present invention, and promote the formation of thin alkali metal salt crystalline structures and coatings on the combustible surfaces upon evaporation of water molecules from the applied aqueous solution, wherein the thin alkali metal salt crystalline coatings formed on the combustible surfaces contain alkali metal ions that inhibit fire ignition, flame spread and production of smoke.

Specification of Various Species of Environmentally-Clean Aqueous-Based Liquid Fire Inhibitor Solutions Containing Dissolved Alkali Metal Salts Derived from Different Kinds of Non-Polymerized Saturated Carboxylic Acids Having Carbon-Atom Chain Lengths Less Than Eight (8) (C1-C7)

Hereinbelow methods will be described how to formulate and produce various species of environmentally-clean aqueous-based liquid fire inhibitor solutions in accordance with the principles of the present invention, wherein each liquid solution contains dissolved alkali metal salts derived from different kinds of non-polymerized saturated carboxylic acids having carbon-atom chain lengths less than eight (8), which contribute solubility of alkali metal ions in water, as an essential requirement of the present invention.

When sprayed onto combustible surfaces, the new and improved liquid fire inhibitor solution forms thin fire inhibiting alkali metal salt crystalline coatings, produced from alkali metal salts derived from a carboxylic acid (R—COOH) selected from the group consisting of: formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

A wide variety of alkali metal salts are produced from these nonpolymeric saturated carboxylic acids for inclusion in the biochemical composition, including, but not limited to: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid; (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Referring to FIGS. 6D1 through 6V2, chemical model illustrations are disclosed for the carboxylic acids, alkali metal salts and esters, and liquid fire inhibitor solutions of the present invention that are formulated therewith, as captured, and described under the generic chemical model shown in FIG. 6. The details of each formulated species of liquid fire inhibitor solution of the present invention, and its underlying carboxylic acid and alkali metal salt(s) and ester(s), will be specified in great technical detail below.

For purposes of simplicity and clarity, the species of liquid fire inhibitor formulation are organized and classified according to the Carbon Atom Chain Length (Ci) of the underlying Non-Polymerized Saturated Carboxylic Acid, from which the corresponding alkali metal salts and ester are derived.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C1 Carboxylic Acid (R—COOH), Called Formic Acid (i.e. Methanoic Acid)

In FIGS. 6C1, 6C2, 6C3 and 6C4, schematic chemical models are provided for making liquid fire inhibitor solutions containing alkali metal salts derived from a C1 Class of Carboxylic Acid having 1 carbon atom, specifically, the C1 carboxylic acid (R—COOH) called formic acid (i.e. methanoic acid), CH₂O₂(CAS RN: 4-18-6). The exemplary alkali metal salts derived from this C1 Class of Carboxylic Acid are: potassium formate CHKO₂; calcium formate Ca(HCO₂)₂; sodium formate HCOONa; and magnesium formate (dihydrate) Mg(HCO₂)₂. As shown in FIGS. 6C31 through 6C4, an exemplary ester of formic acid is methyl formate characterized by chemical formula C₃H₆O₂ and CAS RN: 107-31-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C1 Class of Carboxylic Acid.

FIG. 6C1 illustrates the primary components of an environmentally-clean aqueous-based fire inhibiting liquid biochemical composition of the present invention derived from the C1-Class of saturated non-polymerized carboxylic acid called formic acid, consisting of: (i) a major amount of potassium formate (CAS RN: 590-29-4), and (ii) a minor amount of methyl formate (CAS RN: 107-31-3) or triethyl citrate (TEC) (CAS RN: 77-93-0) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6C2 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of calcium formate (CAS RN:107-31-3), and (ii) a minor amount of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6C3 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of sodium formate (CAS RN: 141-53-7), and (ii) minor amounts of methyl formate or triethyl citrate (TEC) formulated with and dissolved in (iii) major amount of water functioning as a solvent, carrier and dispersant to produce an environmentally-clean aqueous-based fire inhibiting liquid biochemical solution based on the C1-class of carboxylic acid—formic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6C4 illustrates the primary components of an environmentally-clean aqueous-based fire inhibiting liquid biochemical composition of the present invention derived from the C1-Class of saturated non-polymerized carboxylic acid called formic acid, consisting of: (i) major amounts of magnesium formate (CAS RN: 557-39-1/6150-82-9 (dihydrate)), and (ii) minor amounts of methyl formate or triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—formic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds [Lbs.] by weight of an ester of saturated non-polymerized carboxylic acid (e.g. ester of formic acid, namely methyl formate, or ester of citric acid, namely triethyl citrate as coalescing agent;
588.94 pounds by weight of at least one alkali metal salt of a nonpolymeric saturated carboxylic acid (e.g. potassium formate, calcium formate, sodium formate, or magnesium formate) as fire inhibiting agent; and
2007.16 pounds by weight of water to produce a resultant solution of 272 [gallons] having a total weight of about 2641 pounds.

Also, the above liquid fire inhibiting solutions, the weights and measures of the constituents may be specified generally as follows:
at least (e.g. potassium formate, calcium formate, sodium formate, or magnesium formate) one alkali metal salt of a nonpolymeric saturated carboxylic acid (e.g. potassium formate) in a major amount from 1% to 65% by weight, preferably from 20% to 50% by weight and more preferably from 25% to 40% by weight;
an ester of saturated non-polymerized carboxylic acid (e.g. ester of formic acid, namely methyl formate, or ester of citric acid, namely triethyl citrate) in a minor amount from 0.08% to 5% by weight, preferably from 0.5% to 2% by weight and more preferably from 0.1% to 1.5% by weight; and
water as a dissolving and dispersing agent in a major amount from 1% to 90% by weight, preferably from 40% to 85% by weight and more preferably from 60% to 80% by weight;
wherein the sum by % weight of the components above should not exceed 100% by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely formic acid (e.g. potassium formate) functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of formic acid, namely methyl formate, or ester of citric acid, namely triethyl citrate) functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C1 Carboxylic Acid (R—COOH), Called Carbonic Acid (i.e. Hydroxymethanoic Acid)

In FIGS. 6D1 and 6D2, schematic chemical models are provided for making liquid fire inhibitor solutions containing alkali metal salts derived from a C1 Class of Carboxylic Acid having 1 carbon atom, specifically, the C1 carboxylic acid (R—COOH) called carbonic acid, (i.e. hydroxymethanoic acid), CH₂O₃(CAS RN: 463-79-6). The exemplary alkali metal salts derived from this C1 Class Carboxylic Acid are: potassium carbonate K₂CO₃; sodium carbonate Na₂CO₃; and magnesium carbonate MgCO₃.

As shown in FIGS. 6D1 and 6D2, the ester of citric acid called triethyl citrate, can be used as a dispersing/coalescing agent with the alkali metal salt dissolved in water, to produce these aqueous-based liquid fire inhibiting solutions of the present invention, based on the above-referenced C1 Class of Carboxylic Acid.

FIG. 6D1 illustrates the primary components of an environmentally-clean aqueous-based fire inhibiting liquid biochemical composition of the present invention derived from the C1 Class of saturated non-polymerized carboxylic acid called carbonic acid, consisting of: (i) a major amount of potassium carbonate (CAS RN: 584-08-7/6381-79-9 sesquihydrate) and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—carbonic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6D2 illustrates the primary components of an environmentally-clean aqueous-based fire inhibiting liquid biochemical composition of the present invention derived from the C1-Class of saturated non-polymerized carboxylic acid called carbonic acid, consisting of: (i) a major amount of sodium carbonate (CAS RNs: 497-19-8/5968-11-6 monohydrate/6132-02-1 decahydrate), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C1-class of carboxylic acid—carbonic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of citric acid, namely triethyl citrate) as coalescing agent;
588.94 pounds by weight of at least one alkali metal salt of a nonpolymeric saturated carboxylic acid (e.g. potassium carbonate or sodium (bi)carbonate) as fire inhibiting agent; and
2007.16 pounds by weight of water to produce a resultant solution of 272 [gallons] having a total weight of about 2641 pounds.

Also, in the above liquid fire inhibiting solutions, the weights and measures of the constituents may be specified generally as follows:
at least one alkali metal salt of a nonpolymeric saturated carboxylic acid (e.g. potassium carbonate or sodium carbonate) in a major amount from 1% to 65% by weight, preferably from 20% to 50% by weight and more preferably from 30% to 55% by weight;
an ester of saturated non-polymerized carboxylic acid (e.g. ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and a dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely carbonic acid (e.g. potassium, calcium, sodium and/or magnesium carbonate) functioning as a fire inhibitor, is present in a major amount having a weight percent of about 10.00% to about 40.00% relative to the weight of total weight of the aqueous-based fire inhibiting biochemical composition; and (iii) an ester of a saturated non-polymerized carboxylic acid (e.g. ester of citric acid, namely triethyl citrate) functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C2 Carboxylic Acid (R—COOH), Called Acetic Acid (i.e. Ethanoic Acid)

In FIGS. 6E1, 6E2, 6E3, and 6E4, schematic chemical models are provided for making liquid fire inhibitor solutions containing alkali metal salts derived from a C2 Class of Carboxylic Acid having two (2) carbon atoms, specifically, the C2 carboxylic acid (R—COOH) called acetic acid, C₄H₈O₂ (CAS RN: 64-19-7) The exemplary alkali metal salts derived from this C2 Class of Carboxylic Acid are: potassium acetate C₂H₃KO₂; calcium acetate C₄H₆CaO₄; sodium acetate C₂H₃NaO₂; and magnesium acetate Mg(CH₃COO)₂.

As shown in FIGS. 6E1 through 6E4, an exemplary ester of acetic acid (i.e. ethyl acetate or ethyl ethanoate) is characterized by chemical formula C₄H₈O₂ and CAS RN: 141-78-6. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6E1 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of potassium acetate (CAS RN: 127-08-2), and (ii) a minor amount of ethyl acetate (ethyl ethanoate) C₄H₈O₂ (CAS RN: 141-78-6) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6E2 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of calcium acetate (CAS RN: 62-54-4/5743-26-0 monohydrate), and (ii) a minor amount of ethyl acetate (CAS RN: 1191-16-8) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6E3 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of sodium acetate (CAS RN: 127-09-3), and (ii) a minor amount of ethyl acetate (CAS RN: 141-78-6) or triethyl citrate (TEC) formulated with and dissolved in (iii) a major amount of water functioning as a solvent, carrier and dispersant to produce an environmentally-clean aqueous-based fire inhibiting liquid biochemical solution based on the C12-class of carboxylic acid—acetic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6E4 illustrates the primary components of an environmentally-clean aqueous-based fire inhibiting liquid biochemical composition of the present invention derived from the C2-Class of saturated non-polymerized carboxylic acid called acetic acid, consisting of: (i) a major amount of magnesium acetate (CAS RN: 142-72-3), and (ii) a minor amount of ethyl acetate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—acetic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of acetic acid, namely ethyl acetate, or ester of citric acid, namely triethyl citrate) as coalescing agent;
588.94 pounds by weight of at least one alkali metal salt of a nonpolymeric saturated carboxylic acid (e.g. potassium, calcium, sodium and/or magnesium acetate) as fire inhibiting agent; and
2007.16 pounds by weight of water to produce a resultant solution of 272 [gallons] having a total weight of 2641 pounds.

Also, in the above liquid fire inhibiting solutions, the weights and measures of the constituents may be specified generally as follows:
at least one alkali metal salt of a nonpolymeric saturated carboxylic acid (e.g. e.g. potassium, calcium, sodium and/or magnesium acetate) in a major amount from 1% to 65% by weight, preferably from 20% to 50% by weight and more preferably from 30% to 55% by weight;
an ester of saturated non-polymerized carboxylic acid (e.g. ester of acetic acid, namely ethyl acetate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely acetic acid (e.g. potassium, calcium, sodium and/or magnesium acetate) functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of acetic acid, namely ethyl acetate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C2 Carboxylic Acid (R—COOH), Called Glycolic Acid (i.e. Hydroxyacetic Acid)

In FIGS. 6F1, 6F2, 6F3 and 6F4, schematic chemical models are provided for making liquid fire inhibitor solutions containing alkali metal salts derived from a C2 Class of Carboxylic Acid having two carbon atoms, specifically, the C2 carboxylic acid (R—COOH) called glycolic acid (hydroxyacetic acid), C₂H₄O₃ (CAS RN: 79-14-1). The exemplary alkali metal salts derived from this C2 Class of Carboxylic Acid are: potassium glycolate C2H3KO3; calcium glycolate C₄H₆CaO₆; and sodium glycolate C₂H₃NaO₃.

As shown in FIGS. 6F1 through 6F4, an exemplary ester of glycolic acid is ethyl glycolate characterized by chemical formula C₄HsO₃ and CAS RN: 623-50-7. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6F1 illustrates the primary components of an environmentally-clean aqueous-based fire inhibiting liquid biochemical composition of the present invention derived from the C2-Class of saturated non-polymerized carboxylic acid called glycolic acid, consisting of (i) a major amount of potassium glycolate (CAS RN: 1932-50-9), and (ii) a minor amount of ethyl glycolate (CAS RN: 623-50-7) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6F2 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of calcium glycolate (CAS RN: 996-23-6), and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6F3 is a schematic representation illustrating the primary components of an environmentally-clean aqueous-based fire inhibiting liquid biochemical composition of the present invention derived from the C2-Class of saturated non-polymerized carboxylic acid called glycolic acid, consisting of (i) a major amount of sodium glycolate (CAS RN: 2836-32-0), and (ii) a minor amount of ethyl glycolate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glycolic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of glycolic acid, namely ethyl glycolate, or ester of citric acid, namely triethyl citrate as coalescing agent;
588.94 pounds by weight of at least one alkali metal salt of a nonpolymeric saturated carboxylic acid (e.g. potassium, calcium and/or sodium glycolate) as fire inhibiting agent; and
2007.16 pounds by weight of water to produce a resultant solution of 272 [gallons] having a total weight of about 2641 pounds [Lbs.].

In the above liquid fire inhibiting solutions, the weights and measures of the constituents may be specified generally as follows:
at least one alkali metal salt of a nonpolymeric saturated carboxylic acid (e.g. potassium, calcium and/or sodium glycolate) in a major amount from 1% to 65% by weight, preferably from 20% to 50% by weight and more preferably from 30% to 55% by weight;
an ester of saturated non-polymerized carboxylic acid (e.g. ester of glycolic acid, namely ethyl glycolate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely glycolic acid (e.g. potassium, calcium, sodium and/or magnesium glycolate) functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of glycolic acid, namely ethyl glycolate, or ester of citric acid, namely triethyl citrate) functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C2 Carboxylic Acid (R—COOH), Called Glyoxylic Acid

In FIGS. 6G1, 6G2, 6G3 and 6G4, schematic chemical models are provided for making liquid fire inhibitor solutions containing alkali metal salts derived from a C2 Class of Carboxylic Acid having two (2) carbon atoms, specifically, the C2 carboxylic acid (R—COOH) called glyoxylic acid (i.e. oxoacetic acid), C₂H₂O₃ (CAS RN: 298-12-4). The exemplary alkali metal salts derived from this C2 Class of Carboxylic Acid are: potassium glyoxylate C₂H₃KO₃; calcium glyoxylate C₄H₂CaO₆; and sodium glyoxylate (monohydrate) C2HNaO₃.

As shown in FIGS. 6G1 through 6G4, an exemplary ester of glyoxylic acid is ethyl glyoxylate, and characterized by chemical formula C₄H₆O₃ and CAS RN: 924-44-7. Because esters of glyoxylic acid are immiscible with water, the preferred alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6G1 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of potassium glyoxylate (Compound CID: 23669142/CAS RN 1932-50-9), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glyoxylic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6G2 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of calcium glyoxylate (CAS RN 2990-19-4), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—glyoxylic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6G3 illustrates the primary components of an environmentally-clean aqueous-based fire inhibiting liquid biochemical composition of the present invention derived from the C2-Class of saturated non-polymerized carboxylic acid called glyoxylic acid, consisting of (i) a major amount of sodium glyoxylate (CAS RN 2706-75-4), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of citric acid, namely triethyl citrate) as coalescing agent;
588.94 pounds by weight of at least one alkali metal salt of a nonpolymeric saturated carboxylic acid (e.g. tripotassium citrate monohydrate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. tripotassium citrate monohydrate) in a major amount from 1% to 65% by weight, preferably from 20% to 50% by weight and more preferably from 30% to 55% by weight;
an ester of saturated non-polymerized carboxylic acid (e.g. ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely glyoxylic acid (e.g. potassium, calcium, sodium and/or magnesium glyoxylate) is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of citric acid, namely triethyl citrate) present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C2 Carboxylic Acid (R—COOH), Called Oxalic Acid

In FIGS. 6H1, 6H2, 6H3 and 6H4, schematic chemical models are provided for making liquid fire inhibitor solutions containing alkali metal salts derived from a C2 Class of Carboxylic Acid having 2 carbon atoms, specifically, the C2 Carboxylic Acid (R—COOH) called oxalic acid, with molecular formula H₂C₂O₄ and CAS RN: 144-62-7 anhydrous/6153-56-6 dihydrate. The exemplary alkali metal salts derived from this C2 Class of Carboxylic Acid are: potassium oxalate C₂H₂K₂O₅; calcium oxalate monohydrate CaC₂O₄; and (di)sodium oxalate (monohydrate) Na₂C₂O₄.

As shown in FIGS. 6H1 through 6H4, an exemplary ester of oxalic acid. dimethyl oxalate, is characterized by chemical formula: C₄H₆O₄ and CAS RN: 553-90-2. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C2 Class of Carboxylic Acid.

FIG. 6H1 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of potassium oxalate monohydrate (CAS RN: 6487-48-5), and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6H2 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of calcium oxalate monohydrate (CAS RN: 5794-28-5 monohydrate), and (ii) a minor amount of dimethyl oxalate or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6H3 illustrates the primary components of an environmentally-clean aqueous-based fire inhibiting liquid biochemical composition of the present invention derived from the C2-Class of saturated non-polymerized carboxylic acid called oxalic acid, consisting of (i) a major amount of sodium oxalate (CAS RN:62-76-0), and (ii) a minor amount of dimethyl oxalate (CAS RN: 553-90-2) or triethyl citrate (TEC) formulated with and dissolved in (iii) a major amount of water functioning as a solvent, carrier and dispersant to produce an environmentally-clean aqueous-based fire inhibiting liquid biochemical solution based on the C2-class of carboxylic acid—oxalic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of oxalic acid, namely dimethyl oxalate, or ester of citric acid, namely triethyl citrate) as coalescing agent; and
588.94 pounds by weight of at least one alkali metal salt of a nonpolymeric saturated carboxylic acid (e.g. tripotassium citrate monohydrate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. tripotassium citrate monohydrate) in a major amount from 1% to 65% by weight, preferably from 20% to 50% by weight and more preferably from 30% to 55% by weight;
an ester of saturated non-polymerized carboxylic acid (e.g. ester of oxalic acid, namely dimethyl oxalate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely oxalic acid (e.g. potassium, calcium, sodium and/or magnesium oxalate) functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of oxalic acid, namely dimethyl oxalate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C3 Carboxylic Acid (R—COOH), Called Propionic Acid

In FIGS. 6I1, 6I2, 6I3 and 6I4, schematic chemical models are provided for making liquid fire inhibitor solutions containing alkali metal salts derived from a C1 Class of Carboxylic Acid having 3 carbon atoms, specifically, the C3 carboxylic acid (R—COOH) called propionic acid (i.e. propanoic acid, or ethanecarboxylic acid), C₃H₆O₂ with CAS RN: 79-09-04. The exemplary alkali metal salts derived from this C2 Class of Carboxylic Acid are: potassium propionate C₃H₅KO; calcium propionate C₆H₁₀CaO₄; sodium propionate C₃H₅NaO₂; and magnesium propionate C6H₁₀MgO₄.

As shown in FIGS. 6I1 through 6I4, an exemplary ester of propionic acid is ethyl propionate characterized by chemical formula C₅H₁₀O₂ and CAS RN: 105-37-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6I1 illustrates the primary components of an environmentally-clean aqueous-based fire inhibiting liquid biochemical composition of the present invention derived from the C3-Class of saturated non-polymerized carboxylic acid called propionic acid, consisting of: (i) a major amount of potassium propionate (CAS RN:327-62-8), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6I2 illustrates the primary components of an environmentally-clean aqueous-based fire inhibiting liquid biochemical composition of the present invention derived from the C3-Class of saturated non-polymerized carboxylic acid called propionic acid, consisting of: (i) a major amount of calcium propionate (CAS RN: 4075-81-4), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6I3 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of sodium propionate (CAS RN: 137-40-6), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6I4 is a schematic representation illustrating the primary components of an environmentally-clean aqueous-based fire inhibiting liquid biochemical composition of the present invention derived from the C3-Class of saturated non-polymerized carboxylic acid called propionic acid, consisting of (i) a major amount of magnesium propionate (CAS RN:105-37-), and (ii) a minor amount of ethyl propionate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—propionic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of propionic acid, namely ethyl propionate (CAS RN: 105-37-3), or ester of citric acid, namely triethyl citrate) as coalescing agent;
588.94 pounds by weight of at least one alkali metal salt of a nonpolymeric saturated carboxylic acid (e.g. potassium, calcium, sodium and/or magnesium propionate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium propionate) in a major amount from 1% to 65% by weight, preferably from 20% to 50% by weight and more preferably from 30% to 55% by weight;
an ester of saturated non-polymerized carboxylic acid (e.g. ester of propionic acid, namely ethyl propionate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely propionic acid (e.g. potassium, calcium, sodium and/or magnesium propionate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of propionic acid, namely ethyl propionate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C3 Carboxylic Acid (R—COOH), Called Lactic Acid

In FIGS. 6J1, 6J2, 6J3 and 6J4, schematic chemical models are provided for making liquid fire inhibitor solutions containing alkali metal salts derived from a C3 Class of Carboxylic Acid having 3 carbon atoms, specifically, the C3 carboxylic acid (R—COOH) called lactic acid, having a molecular formula C₃H₆O₃ with CAS RNs: 50-21-5/79-33-4 (L)/10326-41-7 (D), and being miscible in water. The exemplary alkali metal salts derived from this C3 Class of Carboxylic Acid are: potassium lactate C₃HsKO₃; calcium lactate C6H₁₀CaO₆; sodium lactate C3H₅NaO₃; and magnesium lactate C6H₁₀MgO₆.

As shown in FIGS. 6J1 through 6J4, an exemplary ester of lactic acid is ethyl lactate characterized by chemical formula C₅H₁₀O₃ and CAS RN: CAS RN: 97-64-3. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6J1 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of potassium lactate (CAS RN: 996-31-6/85895-78-9 (S)), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6J2 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of calcium lactate (CAS RN:814-80-2), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6J3 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of sodium lactate(CAS RN:72-17-3), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6J4 illustrates the primary components of an environmentally-clean aqueous-based fire inhibiting liquid biochemical composition of the present invention derived from the C3-Class of saturated non-polymerized carboxylic acid called lactic acid, consisting of: (i) a major amount of magnesium lactate (CAS RN:18917-93-6), and (ii) a minor amount of ethyl lactate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—lactic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of lactic acid, namely ethyl lactate, or ester of citric acid, namely triethyl citrate) as coalescing agent;
588.94 pounds by weight of at least one alkali metal salt of a nonpolymeric saturated carboxylic acid (e.g. potassium, calcium, sodium and/or magnesium lactate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium lactate) in a major amount from 1% to 65% by weight, preferably from 20% to 50% by weight and more preferably from 30% to 55% by weight;
an ester of saturated non-polymerized carboxylic acid (e.g. ester of lactic acid, namely ethyl lactate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely lactic acid (e.g. potassium, calcium, sodium and/or magnesium lactate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of lactic acid, namely ethyl lactate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C3 Carboxylic Acid (R—COOH), Called Glyceric Acid

In FIGS. 6K1, 6K2, 6K3 and 6K4, schematic chemical models are provided for making liquid fire inhibitor solutions containing alkali metal salts derived from a C3 Class of Carboxylic Acid having 3 carbon atoms, specifically, the C3 carboxylic acid (R—COOH) called glyceric acid, having a molecular formula C₃H₆O₄ and CAS RNs: 473-81-4/6000-40-4 D-glyceric acid/28305-26-2-L-glyceric acid. The exemplary alkali metal salts derived from this C3-Class of Carboxylic Acid are: potassium glycerate C₃H₅KO₄; calcium glycerate C₆H₁₀CaO₈; and sodium glycerate C₃H₅NaO₄.

As shown in FIGS. 6K1 through 6K4, an exemplary ester of glyceric acid is ethyl glycerate characterized by chemical formula C₅H₁₀O₄ and CAS RN: 615-51-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6K1 illustrating the primary components of an environmentally-clean aqueous-based fire inhibiting liquid biochemical composition of the present invention derived from the C3-Class of saturated non-polymerized carboxylic acid called glyceric acid, consisting of: (i) a major amount of potassium glycerate (CAS RN: 43110-90-3), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6K2 illustrates the primary components of an environmentally-clean aqueous-based fire inhibiting liquid biochemical composition of the present invention derived from the C3-Class of saturated non-polymerized carboxylic acid called glyceric acid, consisting of: (i) a major amount of calcium glycerate (CAS RN: 65644-56-6), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6K3 illustrates the primary components of an environmentally-clean aqueous-based fire inhibiting liquid biochemical composition of the present invention derived from the C3-Class of saturated non-polymerized carboxylic acid called glyceric acid, consisting of: (i) a major amount of sodium glycerate (CAS RN: 383=86-8), and (ii) a minor amount of dimethyl glycerate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—glyceric acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of glyceric acid, namely dimethyl glycerate, or ester of citric acid, namely triethyl citrate) as coalescing agent;
588.94 pounds by weight of at least one alkali metal salt of a nonpolymeric saturated carboxylic acid (e.g. potassium, calcium and/or sodium glycerate) as fire inhibiting agent; and
2007.16 pounds by weight of water to produce a resultant solution of 272 [gallons] having a total weight of 2641 pounds.

In the above liquid fire inhibiting solutions, the weights and measures of the constituents may be specified generally as follows:
at least one alkali metal salt of a nonpolymeric saturated carboxylic acid (e.g. potassium, calcium and/or sodium glycerate) in a major amount from 1% to 65% by weight, preferably from 20% to 50% by weight and more preferably from 30% to 55% by weight;
an ester of saturated non-polymerized carboxylic acid (e.g. ester of glyceric acid, namely dimethyl glycerate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely glyceric acid (e.g. potassium, calcium, and/or sodium glycerate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of glyceric acid, namely dimethyl glycerate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C3 Carboxylic Acid (R—COOH), Called Pyruvic Acid

In FIGS. 6L1, 6L2, 6L3 AND 6L4, schematic chemical models are provided for making liquid fire inhibitor solutions containing alkali metal salts derived from a C3 Class of Carboxylic Acid having 3 carbon atoms, specifically, the C3 carboxylic acid (R—COOH) called pyruvic acid, (i.e. 2-oxopropanoic acid) having the molecular formula C₃H₄O₃ and CAS RN: 127-17-3, a smell similar to that of acetic acid, and miscible with water. The exemplary alkali metal salts derived from this C3 Class of Carboxylic Acid are: potassium pyruvate C3H3KO3; calcium pyruvate C3H6CaO3; sodium pyruvate C₃H₃NaO₃; and magnesium pyruvate C6H₆MgO₆.

As shown in FIGS. 6L1 through 6L4, an exemplary ester of pyruvic acid is ethyl pyruvate characterized by chemical formula C₅H₈O₃ and CAS RN: 617-35-6, and water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3-Class of Carboxylic Acid.

FIG. 6L1 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of potassium pyruvate (CAS RN: 4151-33-1), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-Class of carboxylic acid—pyruvic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6L2 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of calcium pyruvate (CAS RN: 52009-14-0), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6L3 illustrates the primary components of an environmentally-clean aqueous-based fire inhibiting liquid biochemical composition of the present invention derived from the C3-Class of saturated non-polymerized carboxylic acid called pyruvic acid, consisting of: (i) a major amount of sodium pyruvate (CAS RN:113-24-6), and (ii) a minor amount of ethyl pyruvate or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6L4 is a schematic representation illustrating the primary components of an environmentally-clean aqueous-based fire inhibiting liquid biochemical composition of the present invention derived from the C3-Class of saturated non-polymerized carboxylic acid called pyruvic acid, consisting of: (i) a major amount of magnesium pyruvate (CAS RN:81686-75-1), and (ii) a minor amount of triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—pyruvic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of pyruvic acid, namely ethyl pyruvate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium pyruvate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium pyruvate) in a major amount from 1% to 65% by weight, preferably from 20% to 50% by weight and more preferably from 30% to 55% by weight;
an ester of saturated non-polymerized carboxylic acid (e.g. ester of pyruvic acid, namely ethyl pyruvate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely pyruvic acid (e.g. potassium, calcium, sodium and/or magnesium pyruvate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of pyruvic acid, namely ethyl pyruvate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C3 Carboxylic Acid (R—COOH), Called Tartaric Acid

In FIGS. 6M1, 6M3, 6M3 and 6M4, schematic chemical models are provided for making liquid fire inhibitor solutions containing alkali metal salts derived from a C3_Class of Carboxylic Acid having 3 carbon atoms, specifically, the C3 carboxylic acid (R—COOH) called tartaric acid having a molecular formula C₄H₆O₆ and CAS RNs: 87-89-4 R, R isomer/S,S isomer 147-71-7/racemic 133-37-9/meso-isomer 147/73-9, and soluble in water. The exemplary alkali metal salts derived from this C3 Class of Carboxylic Acid are: potassium tartrate (potassium bitartrate) C₄H₄K₂O₆; calcium tartrate CaC₄H₄O₆; sodium tartrate C₄H₈Na₂O₈; and magnesium tartrate C4H₄MgO₆.

As shown in FIGS. 6M1 through 6M4, an exemplary ester of tartaric acid is diethyl tartrate (DET) characterized by chemical formula C₈H₁₄O₆ and CAS RN: 408332-88-7). This ester (i.e. group of stereo-isomers), and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C3 Class of Carboxylic Acid.

FIG. 6M1 illustrates the primary components of an environmentally-clean aqueous-based fire inhibiting liquid biochemical composition of the present invention derived from the C3-Class of saturated non-polymerized carboxylic acid called tartaric acid, consisting of (i) a major amount of potassium tartrate (CAS RN:589-39-1), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6M2 illustrates the primary components of an environmentally-clean aqueous-based fire inhibiting liquid biochemical composition of the present invention derived from the C3-Class of saturated non-polymerized carboxylic acid called tartaric acid, consisting of: (i) a major amount of calcium tartrate (CAS RN: 5743-36-2), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6M3 is a schematic representation illustrating the primary components of an environmentally-clean aqueous-based fire inhibiting liquid biochemical composition of the present invention derived from the C3-Class of saturated non-polymerized carboxylic acid called tartaric acid, consisting of: (i) a major amount of sodium tartrate (CAS RN:156-54-7), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6M4 illustrates the primary components of an environmentally-clean aqueous-based fire inhibiting liquid biochemical composition of the present invention derived from the C3-Class of saturated non-polymerized carboxylic acid called tartaric acid, consisting of: (i) a major amount of magnesium tartrate (CAS RN:20752-56-1), and (ii) a minor amount of diethyl tartrate (DET) or triethyl citrate (TEC) formulated with and dissolved in (iii) a major amount of water functioning as a solvent, carrier and dispersant to produce an environmentally-clean aqueous-based fire inhibiting liquid biochemical solution based on the C3-class of carboxylic acid—tartaric acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of tartaric acid, namely diethyl tartrate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium tartrate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium tartrate) in a major amount from 1% to 65% by weight, preferably from 20% to 50% by weight and more preferably from 30% to 55% by weight;
an ester of saturated non-polymerized carboxylic acid (e.g. ester of tartaric acid, namely diethyl tartrate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely tartric acid (e.g. potassium, calcium, sodium and/or magnesium tartrate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of tartric acid, namely diethyl tartrate (DET), or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C4 Carboxylic Acid (R—COOH), Called Butyric Acid

In FIGS. 6N1, 6N2, 6N3, and 6N4, schematic chemical models are provided for making liquid fire inhibitor solutions containing alkali metal salts derived from a C4 Class of Carboxylic Acid having 4 carbon atoms, specifically, the C4 carboxylic acid (R—COOH) called butyric acid, having a molecular formula C₃HCOOH and CAS RN: 107-92-6. The exemplary alkali metal salts derived from this C4 Class of Carboxylic Acid are: potassium butyrate (or butanoate) C₄H₇KO₂; calcium butyrate C8H14CaO4; sodium butyrate C₄H₇NaO₂; and magnesium butyrate C4H₈MgO₂.

As shown in FIGS. 6N1 through 6N4, an exemplary ester of butyric acid is ethyl butyrate characterized by chemical formula C₆H₁₂O₂, CAS RN: 105-54-4, a fruity odor, and being water soluble. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C4 Class of Carboxylic Acid.

FIG. 6N1 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of potassium butyrate (CAS RN:589-39-9), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6N2 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of calcium butyrate (CAS RN:5743-36-2), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6N3 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of sodium butyrate (CAS RN:156-54-7), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6N4 illustrates the primary components of an environmentally-clean aqueous-based fire inhibiting liquid biochemical composition of the present invention derived from the C4-Class of saturated non-polymerized carboxylic acid called butyric acid, consisting of: (i) a major amount of magnesium butyrate (CAS RN:556-45-6), and (ii) a minor amount of ethyl butyrate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—butyric acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of butyric acid, namely ethyl butyrate, or ester of citric acid, namely triethyl citrate) as coalescing agent;
588.94 pounds by weight of at least one alkali metal salt of a nonpolymeric saturated carboxylic acid (e.g. potassium, calcium, sodium and/or magnesium butyrate) as fire inhibiting agent; and
2007.16 pounds by weight of water to produce a resultant solution of 272 [gallons] having a total weight of 2641 pounds.

In the above liquid fire inhibiting solutions, the weights and measures of the constituents are specified generally as follows:
at least one alkali metal salt of a nonpolymeric saturated carboxylic acid (e.g. potassium, calcium, sodium and/or magnesium butyrate) in a major amount from 1% to 65% by weight, preferably from 20% to 50% by weight and more preferably from 30% to 55% by weight;
an ester of saturated non-polymerized carboxylic acid (e.g. ester of butyric acid, namely ethyl butyrate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely butyric acid (e.g. potassium, calcium, sodium and/or magnesium butyrate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of butyric acid, namely ethyl butyrate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C4 Carboxylic Acid (R—COOH), Called Malic Acid

In FIGS. 6O1, 6O2, 6O3 and 6O4, schematic chemical models are provided for making liquid fire inhibitor solutions containing alkali metal salts derived from a C4 Class of Carboxylic Acid having 4 carbon atoms, specifically, the C4 carboxylic acid (R—COOH) called malic acid, having a molecular formula C₄H₆O₅ and CAS RN: 6915-15-7), and highly water soluble. The exemplary alkali metal salts derived from this C4 Class of Carboxylic Acid are: potassium malate C₄H₄K₂O₅; calcium malate C₄H₄CaO₅; sodium malate C₄H₄Na₂O₅; and magnesium malate C4H₄MgO₅.

As shown in FIGS. 6O1 through 6O4, an exemplary ester of malic acid is diethyl maleate characterized by chemical formula C₈H₁₂O₄ and CAS RN: 141-05-9. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C4 Class of Carboxylic Acid.

FIG. 6O1 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of potassium maleate (CAS RN: 585-09-1), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6O2 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of calcium maleate (CAS RN: 16426-50-9), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6O3 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of sodium maleate (CAS RN: 676-46-0), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6O4 illustrates the primary components of an environmentally-clean aqueous-based fire inhibiting liquid biochemical composition of the present invention derived from the C4-Class of saturated non-polymerized carboxylic acid called malic acid, consisting of: (i) a major amount of magnesium maleate (CAS RN: 141-05-9), and (ii) a minor amount of diethyl maleate or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of malic acid, namely diethyl maleate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium maleate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium maleate) in a major amount from 1% to 65% by weight, preferably from 20% to 50% by weight and more preferably from 30% to 55% by weight;
an ester of saturated non-polymerized carboxylic acid (e.g. ester of malic acid, namely diethyl maleate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely malic acid (e.g. potassium, calcium, sodium and/or magnesium malate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of malic acid, namely diethyl maleate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C4 Carboxylic Acid (R—COOH), Called Malonic Acid

In FIGS. 6P1, 6P2, 6P3 and 6P4, schematic chemical models are provided for making liquid fire inhibitor solutions containing alkali metal salts derived from a C4 Class of Carboxylic Acid having 4 carbon atoms, specifically, the C4 carboxylic acid (R—COOH) called malonic acid, C₃H₄O₄ (CAS RN: 55514-11-19). The exemplary alkali metal salts derived from this C4\ Class of Carboxylic Acid are: potassium malonate; calcium malonate C₃H₂CaO₄; sodium malonate C₃H₂O₄Na₂; and di-magnesium malonate Mg2(OH)2C4H4O5.

As shown in FIGS. 6P1 through 6P4, an exemplary ester of malonic acid is diethyl malonate (DEM) characterized by chemical formula C₇H₁₂O₄ and CAS RN: 105-53-3. As this ester has negligible or low water solubility, and is most commonly used in the fragrance industry, its use and performance as a surface-chemistry coalescing agent may not be as desirable as the surface chemistry performance by the ester of citric acid, called triethyl citrate (TEC) described hereinabove, which may be used as a dispersing/coalescing agent with the alkali metal salts dissolved in water to produce these aqueous-based liquid fire inhibiting solutions of the present invention, based on the above-referenced C4-Class of Carboxylic Acid called Malonic Acid.

FIG. 6P1 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of potassium malonate (CAS RN: 13095-67-5), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-Class of carboxylic acid—malonic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6P2 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of calcium malonate (CAS RN: 19455-76-6), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-Class of carboxylic acid—malonic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6P3 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of sodium malonate (CAS RN: 141-95-7), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6P4 illustrates the primary components of an environmentally-clean aqueous-based fire inhibiting liquid biochemical composition of the present invention derived from the C4-Class of saturated non-polymerized carboxylic acid called malonic acid, consisting of: (i) a major amount of magnesium malonate (CAS RN: 671197-50-5), and (ii) a minor amount of diethyl malonate (DEM) or triethyl citrate (TEC) formulated with and dissolved in (iii) a major amount of water functioning as a solvent, carrier and dispersant to produce an environmentally-clean aqueous-based fire inhibiting liquid biochemical solution based on the C4-class of carboxylic acid—malonic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of malonic acid, namely diethyl malonate (DEM), or ester of citric acid, namely triethyl citrate as coalescing agent;
588.94 pounds by weight of at least one alkali metal salt of a nonpolymeric saturated carboxylic acid (e.g. potassium, calcium, sodium, and magnesium malonate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium, and magnesium malonate) in a major amount from 1% to 65% by weight, preferably from 20% to 50% by weight and more preferably from 30% to 55% by weight;
an ester of saturated non-polymerized carboxylic acid (e.g. ester of malonic acid, namely diethyl malonate (DEM), or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely malonic acid (e.g. potassium, calcium, sodium and/or magnesium malonate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of malonic acid, namely diethyl malonate (DEM), or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C5 Carboxylic Acid (R—COOH), Called Pivalic Acid

In FIGS. 6Q1, 6Q2, 6Q3 and 6Q4, schematic chemical models are provided for making liquid fire inhibitor solutions containing alkali metal salts derived from a C5 Class of Carboxylic Acid having 5 carbon atoms, specifically, the C5 carboxylic acid (R—COOH) called pivalic acid, (i.e. trimethylacetic acid; neopentanoic acid), C₅H₁₀O₂(CAS RN: 75-98-9). The exemplary alkali metal salts derived from this C5 Class of Carboxylic Acid are: potassium pivalate C₅H₉KO₂; calcium pivalate C₁₀H₁₈CaO₄; sodium pivalate C₅H₉NaO₂; and magnesium pivalate C₁₀H₂₀MnO₄

As shown in FIGS. 6Q1 through 6Q4, an exemplary ester of pivalic acid is methyl pivalate characterized by chemical formula C₆H₁₂O₂ and CAS RN: 598-98-1. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C5 Class of Carboxylic Acid.

FIG. 6Q1 illustrates the primary components of an environmentally-clean aqueous-based fire inhibiting liquid biochemical composition of the present invention derived from the C5-Class of saturated non-polymerized carboxylic acid called pivalic acid, consisting of (i) a major amount of potassium pivalate (CAS RN:19455-23-3), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6Q2 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of calcium pivalate (CAS RN:598-98-1), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6Q3 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of sodium pivalate (CAS RN:1184-88-9), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6Q4 illustrates the primary components of an environmentally-clean aqueous-based fire inhibiting liquid biochemical composition of the present invention derived from the C5-Class of saturated non-polymerized carboxylic acid called pivalic acid, consisting of: (i) a major amount of magnesium pivalate (CAS RN: ______), and (ii) a minor amount of methyl pivalate or triethyl citrate (TEC) formulated with and dissolved in (iii) a major amount of water functioning as a solvent, carrier and dispersant to produce an environmentally-clean aqueous-based fire inhibiting liquid biochemical solution based on the C5-class of carboxylic acid—pivalic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of pivalic acid, namely methyl pivalate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium pivalate) as fire inhibiting agent; and
2007.16 pounds by weight of water to produce a resultant solution of 272 [gallons] having a total weight of 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium pivalate) in a major amount from 1% to 65% by weight, preferably from 20% to 50% by weight and more preferably from 30% to 55% by weight;
an ester of saturated non-polymerized carboxylic acid (e.g. ester of pivalic acid, namely methyl pivalate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely pivalic acid (e.g. potassium, calcium, sodium and/or magnesium pivalate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of pivalic acid, namely methyl pivalate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C6 Carboxylic Acid (R—COOH), Called Caproic Acid

In FIGS. 6R1, 6R2, 6R3, and 6R4 schematic chemical models are provided for making liquid fire inhibitor solutions containing alkali metal salts derived from a C6 Class of Carboxylic Acid having 6 carbon atoms, specifically, the C6 carboxylic acid (R—COOH) called caproic acid, CH3(CH2)4COOH (CAS RN:142-62-1). The exemplary alkali metal salts derived from this C6 Class of Carboxylic Acid are: potassium caproate (hexanoate) C₁₀H₁₉O₂·K; calcium caproate C₈H₁₅NaO; sodium caproate C₈H₁₅NaO₂;and magnesium caproate C12H₂₂MgO₄.

As shown in FIGS. 6R1 through 6R4, an exemplary ester of caproic acid is ethyl caprocate characterized by chemical formula C₈H₁₆O₂ and CAS RN: 123-66-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6R1 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of potassium caproate (CAS RN:19455-00-6), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6R2 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of calcium caproate (CAS RN:38708-95-1), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6R3 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of sodium caproate (CAS RN:10051-44-2), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6R4 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of magnesium caproate (CAS RN:3386-57-0), and (ii) a minor amount of ethyl caproate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—caproic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development;

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of caproic acid, namely ethyl caproate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium caprocate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium caprocate) in a major amount from 1% to 65% by weight, preferably from 20% to 50% by weight and more preferably from 30% to 55% by weight;
an ester of saturated non-polymerized carboxylic acid (e.g. ester of caproic acid, namely ethyl caproate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely capric acid (e.g. potassium, calcium, sodium and/or magnesium caproate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of caproic acid, namely ethyl caproate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C6 Carboxylic Acid (R—COOH), Called Adipic (Hexanedioic) Acid

In FIGS. 6S1, 6S2, 6S3 and 6S4, schematic chemical models are provided for making liquid fire inhibitor solutions containing alkali metal salts derived from a C6 Class of Carboxylic Acid having 6 carbon atoms, specifically, the C6 carboxylic acid (R—COOH) called adipic (hexanedioic) acid having a molecular formula C₆H₁₀O₄, and CAS RN: 124-04-9 and being soluble in water. The exemplary alkali metal salts derived from this C6 Class of Carboxylic Acid are: potassium adipate C₆H₈K₂O₄; calcium adipate C₆H₈CaO₄; sodium adipate C₆H₈Na₂O₄; and magnesium adipate C6H₈MgO₄.

As shown in FIGS. 6S1 through 6S4, an exemplary ester of adipic acid is dimethyl adipate characterized by chemical formula C₈H₁₄O₄ and CAS RN: 627-93-0 and low water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid called Adipic (i.e. Hexanedioic) Acid.

FIG. 6S1 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of potassium adipate (CAS RN: 19147-16-1), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6S2 illustrates the primary components of an environmentally-clean aqueous-based fire inhibiting liquid biochemical composition of the present invention derived from the C6-Class of saturated non-polymerized carboxylic acid called caproic acid, consisting of: (i) a major amount of calcium adipate (CAS RN: 7486-40-0), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6S3 illustrates the primary components of an environmentally-clean aqueous-based fire inhibiting liquid biochemical composition of the present invention derived from the C6-Class of saturated non-polymerized carboxylic acid called caproic acid, consisting of (i) a major amount of sodium adipate (CAS RN: 23311-84-4), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6S4 illustrates the primary components of an environmentally-clean aqueous-based fire inhibiting liquid biochemical composition of the present invention derived from the C6-Class of saturated non-polymerized carboxylic acid called caproic acid, consisting of (i) a major amount of magnesium adipate (CAS RN:7486-39-7), and (ii) a minor amount of dimethyl adipate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—adipic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of adipic acid, namely dimethyl adipate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium adipate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium adipate) in a major amount from 1% to 65% by weight, preferably from 20% to 50% by weight and more preferably from 30% to 55% by weight;
an ester of saturated non-polymerized carboxylic acid (e.g. ester of adipic acid, namely dimethyl adipate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely adipic acid (e.g. potassium, calcium, sodium and/or magnesium adipate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of adipic acid, namely dimethyl adipate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C6 Carboxylic Acid (R—COOH), Citric Acid

In FIGS. 6T1, 6T2, 6T3 AND 6T4, schematic chemical models are provided for making liquid fire inhibitor solutions containing alkali metal salts derived from a C6 Class of Carboxylic Acid having 6 carbon atoms, specifically, the C6 carboxylic acid (R—COOH) called citric acid, having a molecular formula HOC(CO₂H)(CH₂CO₂H)₂ and CAS RN: 77-92-9 anhydrous/5949-29-1 monohydrate, and being highly soluble in water. The exemplary alkali metal salts derived from this C6 Class of Carboxylic Acid are: (tri)potassium citrate C₆H₅K₃O₇; calcium citrate Ca₃(C₆H₅O₇)₂; sodium citrate C₆H₅Na₃O₇; and magnesium citrate C₆H₆MgO₇.

As shown in FIGS. 6T1 through 6T4, an exemplary ester of citric acid is triethyl citrate (TEC) characterized by chemical formula C₁₂H₂₀O₇ and CAS RN: 77-93-0. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6T1 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of tripotassium citrate (TPC) (CAS RN:866-84-2), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6T2 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of calcium citrate (CAS RN: 813-94-5), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6T3 illustrates the primary components of an environmentally-clean aqueous-based fire inhibiting liquid biochemical composition of the present invention derived from the C6-Class of saturated non-polymerized carboxylic acid called citric acid, consisting of: (i) a major amount of sodium citrate (CAS RN:68-04-2), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6T4 is a schematic representation illustrating the primary components of an environmentally-clean aqueous-based fire inhibiting liquid biochemical composition of the present invention derived from the C6-Class of saturated non-polymerized carboxylic acid called citric acid, consisting of: (i) a major amount of magnesium citrate (CAS RN:779-25-1), and (ii) a minor amount triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—citric acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of citric acid, namely triethyl citrate) as coalescing agent;
588.94 pounds by weight of at least one alkali metal salt of a nonpolymeric saturated carboxylic acid (e.g. potassium citrate, calcium citrate, sodium citrate, and/or magnesium citrate) as fire inhibiting agent; and
2007.16 pounds by weight of water to produce a resultant solution of 272 [gallons] having a total weight of 2641 pounds.

In the above liquid fire inhibiting solutions, the weights and measures of the constituents may be specified generally as follows:
at least one alkali metal salt of a nonpolymeric saturated carboxylic acid (e.g. potassium citrate, calcium citrate, sodium citrate, and/or magnesium citrate) in a major amount from 1% to 65% by weight, preferably from 20% to 50% by weight and more preferably from 30% to 55% by weight;
an ester of saturated non-polymerized carboxylic acid (e.g. ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely citric acid (e.g. potassium, calcium, sodium and/or magnesium citrate), functioning as a fire inhibitor, is present in a major amount having a weight percent of about 10.00% to about 40.00% relative to the weight of total weight of the aqueous-based fire inhibiting biochemical composition; and (iii) an ester of a saturated non-polymerized carboxylic acid (e.g. ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C6 Carboxylic Acid (R—COOH), D-Gluconic Acid

In FIGS. 6U1, 6U2, 6U3 and 6U4, schematic chemical models are provided for making liquid fire inhibitor solutions containing alkali metal salts derived from a C6 Class of Carboxylic Acid having 6 carbon atoms, specifically, the C6 carboxylic acid (R—COOH) called D-Gluconic Acid, having a molecular formula C₆H₁₂O₇ and CAS RN: 526-95-4) and highly soluble in water. The exemplary alkali metal salts derived from this C6 Class of Carboxylic Acid are: potassium gluconate C₆H₁₁KO₇; calcium gluconate C₁₂H₂₂CaO₁₄; sodium gluconate C₆H₁₁NaO₇; and magnesium gluconate C12H₂₂MgO₁₄.

As shown in FIGS. 6U1 through 6U4, an exemplary ester of d-gluconic acid is methyl gluconate characterized by the chemical/molecular formula C₇H₁₄O and CAS RN: 131797-36-9. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C6 Class of Carboxylic Acid.

FIG. 6U1 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of potassium gluconate (CAS RN: 299-27-4), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6U2 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of calcium gluconate (CAS RN: 299-28-5), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6U3 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of sodium gluconate (CAS RN: 527-07-1), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6U14 illustrates the primary components of an environmentally-clean aqueous-based fire inhibiting liquid biochemical composition of the present invention derived from the C6-Class of saturated non-polymerized carboxylic acid called d-gluconic acid, consisting of: (i) a major amount of magnesium gluconate (CAS RE: 3632-91-5), and (ii) a minor amount methyl gluconate or triethyl citrate (TEC) formulated with and dissolved in (iii) a major amount of water functioning as a solvent, carrier and dispersant to produce an environmentally-clean aqueous-based fire inhibiting liquid biochemical solution based on the C6-class of carboxylic acid—d-gluconic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of d-gluconic acid, namely methyl gluconate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium gluconate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium gluconate) in a major amount from 1% to 65% by weight, preferably from 20% to 50% by weight and more preferably from 30% to 55% by weight;
an ester of saturated non-polymerized carboxylic acid (e.g. ester of d-gluconic acid, namely methyl gluconate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely gluconic acid (e.g. potassium, calcium, sodium and/or magnesium gluconate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of gluconic acid, namely methyl gluconate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

Specification of New and Improved Liquid Fire Inhibitor Formulations for Forming Thin Fire Inhibiting Alkali Metal Salt Crystalline Coatings Sprayed onto Combustible Surfaces, and Produced from Alkali Metal Salts Derived from the C7 Carboxylic Acid (R—COOH), Benzoic Acid

In FIGS. 6V1, 6V2, 6V3 and 6V4, schematic chemical models are provided for making liquid fire inhibitor solutions containing alkali metal salts derived from a C7 Class of Carboxylic Acid having 7 carbon atoms, specifically, the C7 carboxylic acid (R—COOH) called benzoic acid, (benzenecarboxylic acid), having a molecular formula C₇H₆O₂, CAS RN: 65-85-0 and high water solubility. The exemplary alkali metal salts derived from this C7 Class of Carboxylic Acid are: potassium benzoate C₇H₅KO₂; calcium benzoate Ca(C₇H₅O₂)₂; sodium benzoate C₇H₅NaO₂; and magnesium benzoate C14H₁₀MgO₄.

As shown in FIGS. 6V1 through 6V4, an exemplary ester of benzoic acid is ethyl benzoate characterized by chemical formula C₉H₁₀O₂, CAS RN: 93-89-0 and poor water solubility. This ester, and/or the alternative ester of citric acid called triethyl citrate, can be used as a dispersing/coalescing agent with the alkali metal salt dissolved in water, to produce these aqueous-based liquid fire inhibiting solutions of the present invention, based on the above-referenced C7 Class of Carboxylic Acid.

FIG. 6V1 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of potassium benzoate (CAS RN: 582-25-2), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid—benzoic acid. Once produced according to the principles of the present invention, and sprayed on combustible surfaces, water molecules in the spray-applied solution evaporate to the environment, forming thin potassium salt crystalline coatings providing protection against fire ignition, flame spread and smoke development.

FIG. 6V2 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of calcium benzoate (CAS RN:2090-05-3), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid—benzoic acid. Once produced according to the principles of the present invention, and sprayed on combustible surfaces, water molecules in the spray-applied solution evaporate to the environment, forming thin calcium salt crystalline coatings providing protection against fire ignition, flame spread and smoke development.

FIG. 6V3 illustrates the primary components of an environmentally-clean aqueous-based fire inhibiting liquid biochemical composition of the present invention derived from the C7-Class of saturated non-polymerized carboxylic acid called benzoic acid, consisting of: (i) a major amount of sodium benzoate (CAS RN:532-32-1), and (ii) a minor amount ethyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid—benzoic acid. Once produced according to the principles of the present invention, and sprayed on combustible surfaces, water molecules in the spray-applied solution evaporate to the environment, forming thin sodium salt crystalline coatings providing protection against fire ignition, flame spread and smoke development.

FIG. 6V4 illustrates the primary components of an environmentally-clean aqueous-based fire inhibiting liquid biochemical composition of the present invention derived from the C7-Class of saturated non-polymerized carboxylic acid called benzoic acid, consisting of (i) a major amount of magnesium benzoate (CAS RN: 553-70-8), and (ii) a minor amount methyl benzoate or triethyl citrate (TEC) formulated with and dissolved in (iii) a major amount of water functioning as a solvent, carrier and dispersant to produce an environmentally-clean aqueous-based fire inhibiting liquid biochemical solution based on the C7-class of carboxylic acid—benzoic acid. Once produced according to the principles of the present invention, and sprayed on combustible surfaces, water molecules in the spray-applied solution evaporate to the environment, forming thin magnesium salt crystalline coatings providing protection against fire ignition, flame spread and smoke development.

In the above liquid fire inhibiting solutions, the weights and measures of the constituents are specified generally in terms of major and minor mass amounts which, in preferred embodiments, may be substantially proportional to:
21.25 pounds by weight of an ester of saturated non-polymerized carboxylic acid (e.g. ester of benzoic acid, namely ethyl benzoate, or ester of citric acid, namely triethyl citrate as coalescing agent;
588.94 pounds by weight of at least one alkali metal salt of a nonpolymeric saturated carboxylic acid (e.g. potassium, calcium, sodium and/or magnesium benzoate) as fire inhibiting agent; and
2007.16 pounds by weight of water to produce a resultant solution of 272 [gallons] having a total weight of about 2641 pounds.

In the above liquid fire inhibiting solutions, the weights and measures of the constituents may be specified generally as follows:
at least one alkali metal salt of a nonpolymeric saturated carboxylic acid (e.g. potassium, calcium, sodium and/or magnesium benzoate) in a major amount from 1% to 65% by weight, preferably from 20% to 50% by weight and more preferably from 30% to 55% by weight;
an ester of saturated non-polymerized carboxylic acid (e.g. ester of benzoic acid, namely ethyl benzoate, or ester of citric acid, namely triethyl citrate) in a minor amount from 0.08% to 5% by weight, preferably from 0.5% to 2% by weight and more preferably from 0.1% to 1.5% by weight; and
a major amount of water as a dissolving and dispersing agent, from 1% to 90% by weight, preferably from 40% to 85% by weight, and more preferably from 60% to 80% by weight;
wherein the % by weight is based on the total weight of the aqueous-based fire inhibiting biochemical composition, and wherein the sum by % weight of all the components should not exceed 100% measured by weight.

Preferably, the water content in a major amount is typically not less than 50% by weight, preferably not less than 60% by weight and most preferably not less than 70% by weight, and preferably not more than 80% by weight and more preferably not more than 90% by weight, all based on the total weight of aqueous-based fire inhibiting biochemical composition.

Preferably, the above environmentally-clean aqueous-based fire inhibiting biochemical solution comprises: (i) water, functioning as a solvent, carrier and dispersant, present in a major amount having a weight percent of about 60.00% to about 90.00% relative to the to the weight of total weight of the aqueous-based fire inhibiting biochemical composition; (i) at least one alkali metal salt of a nonpolymeric saturated carboxylic acid, namely benzoic acid (e.g. potassium, calcium, sodium and/or magnesium benzoate), functioning as a fire inhibitor, is present in a major amount having a weight percent of about 10.00% to about 40.00% relative to the weight of total weight of the aqueous-based fire inhibiting biochemical composition; and (iii) an ester of saturated non-polymerized carboxylic acid (e.g. ester of benzoic acid, namely ethyl benzoate, or ester of citric acid, namely triethyl citrate), functioning as a dispersant/coalescent, present in a minor amount having a weight percent of about 0.50% to about 5.00% relative to the weight of total weight of the aqueous-based fire inhibiting biochemical composition; wherein the sum of the weight percent of the chemical components above does not exceed 100% by weight.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications, so as to facilitate the use of spray-atomization and other suitable methods using the aqueous-based biochemical compositions/solutions of the present invention to form thin to ultra-thin layers of alkali-metal salt crystalline coatings on combustible surfaces that inhibit fire ignition, flame spread and smoke development in accordance with the principles of the present invention.

### Physical Examination and Fire-Performance Testing of the Thin Metal Salt Crystalline Structures Formed Using the Biochemical Compositions and Methods and Apparatus of the Present Invention

One method of viewing the resulting metal salt crystal structures formed upon a surface substrate to be protected against fire, using the liquid solution of the present invention, as illustrated in FIG. 7A, would be by using atomic force microscope to form atomic force microscopy (AFM) images of the biochemical coatings safely applied to the combustible surfaces in accordance with the principles of the present invention. Another method of viewing the resulting metal salt crystal structures would be to use a scanning electron microscope to form scanning electron microscopy (SEM) images. Expectedly, using either instrument, such images of alkali metal salt crystalline structures formed using a greater wt % of coalescent agent (e.g. triethyl citrate dissolved in water with tripotassium citrate) will show that the coalescent agent resulted in metal salt crystal structures that are more coalesced and smoother, and demonstrating higher hardness evolution and better water repulsion, than when the metal salt crystal structures are formed using a lower wt % coalescent agent in the aqueous-based fire inhibiting liquid composition.

FIG. 7A illustrates the primary steps involved during the formation of tripotassium citrate salt crystalline structure coatings on spray treated surfaces to be proactively protected against ignition and flame spread of incident fire.

At Step A, a spray nozzle is used to spray a liquid coating of a biochemical solution of the present invention as shown in FIGS. 6A1, 6A2 and 6T1, and once applied, the water molecules being to evaporate at a rate determined by ambient temperature and wind currents, if any. When the minimum film formation temperature (MFT) is reached for the biochemical composition, the potassium cations can inter diffuse within the triethyl citrate (TEC) coalescent agent and water molecule matrix that is supported on the surface that has been sprayed and to be proactively treated with fire inhibiting properties by virtue of a thin film deposition of potassium salt crystalline structure, modeled and illustrated in FIGS. 7B and 7C.

As understood herein, a thin (or ultra-thin) film or coating of liquid biochemical solution of the present invention is a layer of wet liquid material (illustrated in FIGS. 6 through 6V4) ranging in thickness from (i) about 10 micrometers [μm] to (ii) about 2 millimeters [mm], and which, when dried during water molecule evaporation, will form a thin (or ultra-thin) dried fire-inhibiting alkali metal salt crystalline coating having a dry coating thickness significantly less than the applied wet coating thickness, and dependent on (i) various biochemical parameters of the fire inhibiting liquid solution, as well as (ii) environmental and atmospheric parameters (e.g. temperature, relative humidity, pressure, etc.) present at the time of the spray-atomization and coating formation process.

At Step B, potassium cations diffuse, and potassium salt crystalline structure deforms. During the coalescence of potassium cations, interparticle potassium cation diffusion (PCD) occurs within the TEC coalescing agent to produce a semi-homogenous tripotassium citrate salt crystalline structure (i.e. coating).

At Step C, coalescence occurs to form the TPC salt crystalline structure. The mechanical properties of potassium citrate crystalline structures are highly dependent on the extent of PCD within the TEC coalescent agent.

Upon complete evaporation of water molecules from the biochemical liquid coating, the resulting fire inhibiting coating that is believed to be formed on the sprayed and dried surface comprises a thin film of potassium citrate salt crystalline structures formed on the structure, with substantially no water molecules present. The nature and character of such tripotassium citrate salt crystalline structures are believed to be reflected in models provided in FIGS. 7B and 7C, which were first reported in 2016 in a published research paper by Alagappa Rammahon and James A. Kaduk, titled “Crystal Structure of Anhydrous Tripotassium Citrate From Laboratory X-Ray Diffraction Data and DFT Comparison” cited in ACTA CRYSTL (2016) Vol. E72, Pages 1159-1162, and published by Crystallographic Communications.

To determine and confirm that the fire inhibiting liquid compositions of the present invention produce potassium citrate salt crystalline structures on treated surfaces that have attained certain standards of fire inhibiting protection, it is necessary to test such treated surface specimens according to specific fire protection standards. In the USA, ASTM E84 Flame Spread and Smoke Development Testing can be used to test how well surfaces made of wood, cellulose and other combustible materials perform during E84 testing, and then compared against industry benchmarks. The environmentally-clean fire inhibiting chemical liquid solutions disclosed herein are currently being tested according to ASTM E84 testing standards and procedures, and it is expected that these ASTM test will show that fire-protected surfaces made of Douglas Fir (DF) will demonstrate Flame Spread Indices and Smoke Development Index to qualify for Class-A fire protected certification, when treated by the fire inhibiting biochemical compositions of the present invention disclosed and taught herein.

### Methods of Blending, Making and Producing the Biochemical Liquid Formulations

The fire inhibiting liquid chemical compositions illustrated in FIGS. 6A1, 6A2, 6B1, 6B2, 6C1 and 6C2 are reproducible by mixing the components described above. The order of mixing is discretionary. However, it is advantageous to produce aqueous preparations by mixing the components other than water, into the quantity of water.

### Specification of the Methods of Preparing and Applying the Fire Inhibiting Biochemical Compositions of the Present Invention

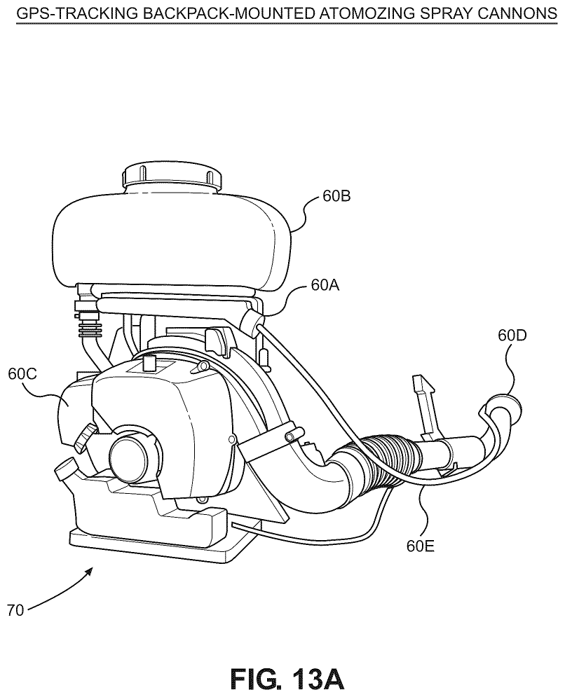

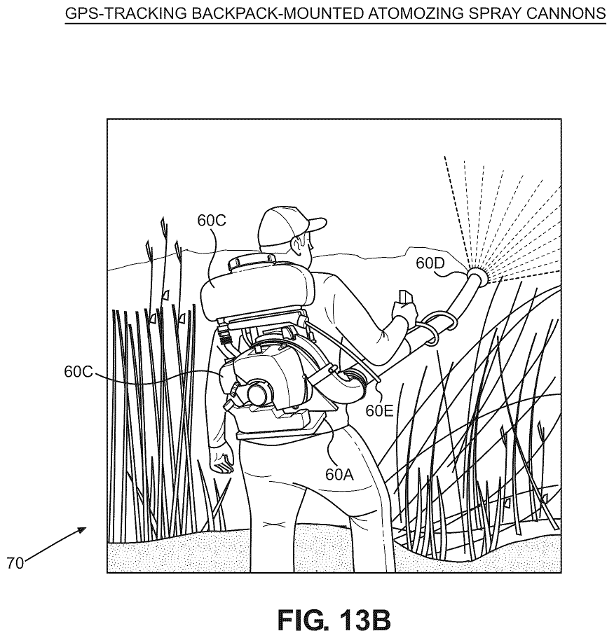

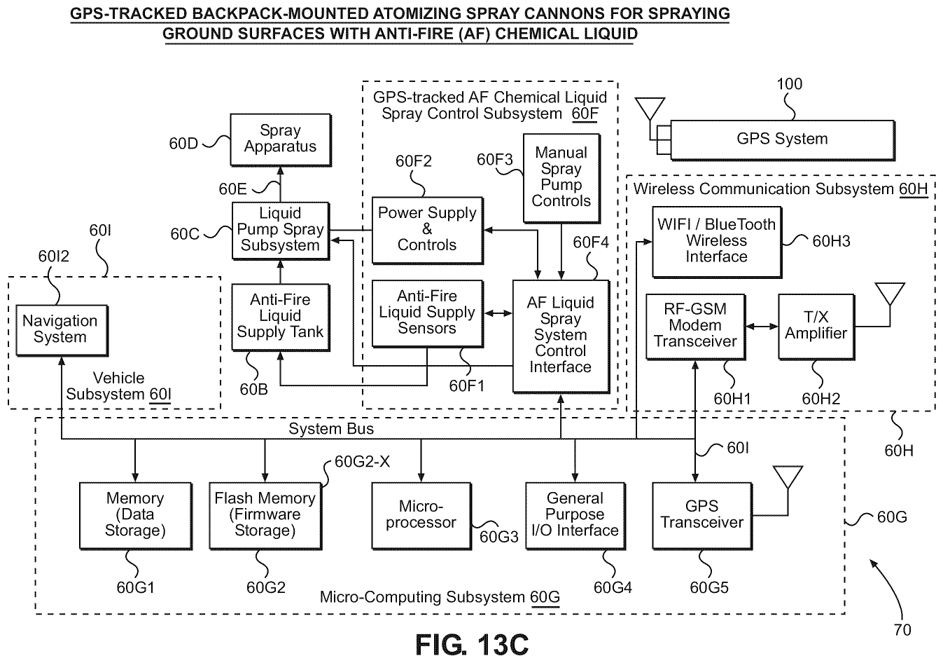

Once the fire inhibiting biochemical compositions are prepared in accordance with the formations described above, the mixture is then stirred for several minutes at room temperature, and subsequently, the mixture is then packaged, barcoded with chain of custody information and then either stored, or shipped to its intended destination for use and application in accordance with present invention. As described herein, preferred method of surface coating application is using, for example, an atomizing sprayer having a backpack form factor suitable and adapted for rapidly spraying the fire inhibiting biochemical compositions on property surfaces as shown in FIGS. 13A and 13B, and form ultra-thin potassium salt crystal structure coatings to treated surfaces of combustible material on a specific parcels of property. Any of the other methods of and apparatus for spraying and GPS-tracking of fire inhibiting biochemicals of the present invention taught herein, as shown in FIGS. 8A through 17B, can be used with excellent results.

During examination and testing protocols, all fire inhibiting biochemical formulations of the present invention are proactively applied to combustible wood surfaces, allowed to dry, and are then analyzed tested for hardness, gloss, and adhesion properties in a conventional manner, as well as subjected to strict ASTM E84 fire protection testing to ensure the fire inhibiting metal salt crystal coatings meet Class A Fire Protection Standards.

### Useful Applications for the Fire Inhibiting Biochemical Liquid Compositions of the Present Invention

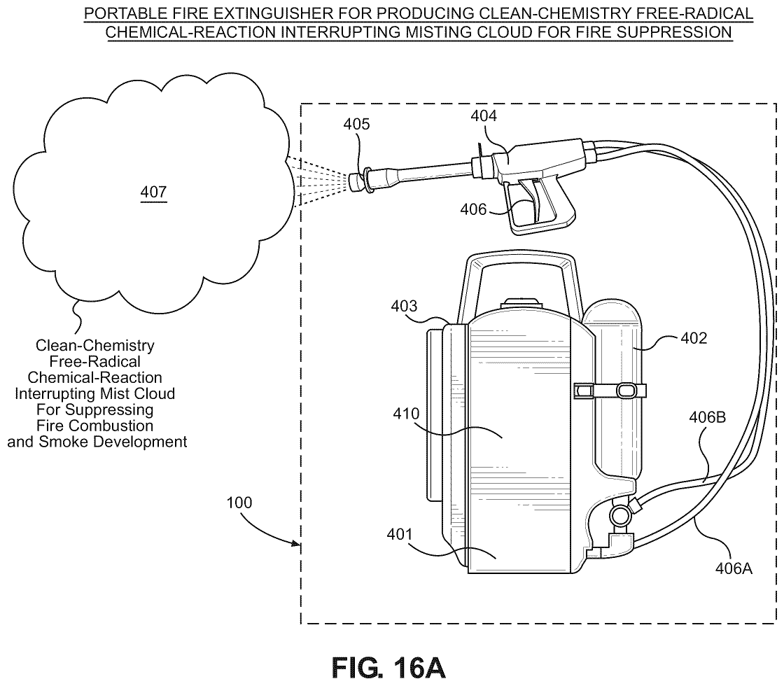

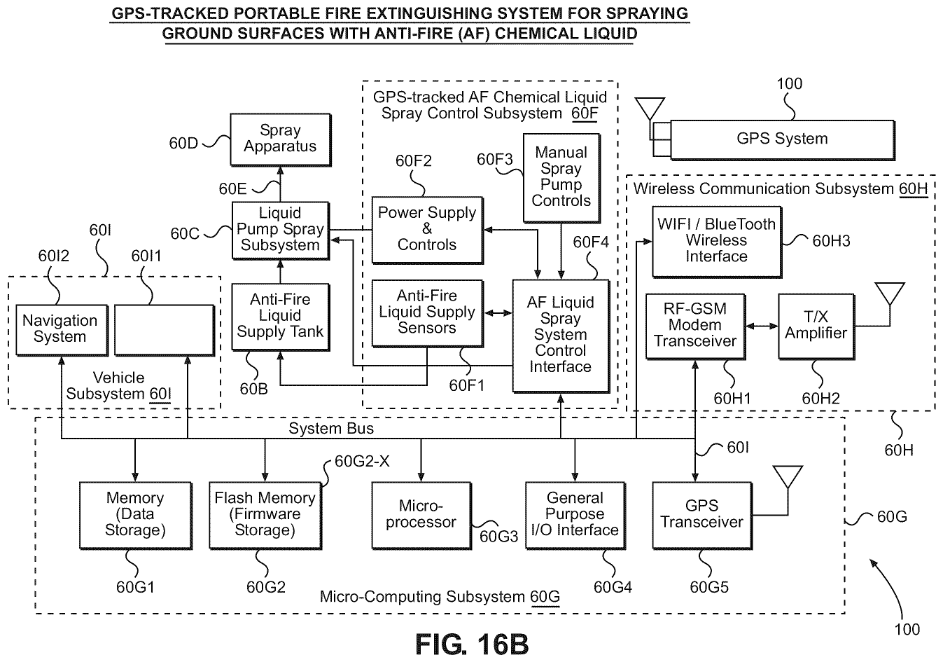

As disclosed, the fire inhibiting biochemical compositions of the present invention are very useful in two ways: (i) producing fire inhibiting (i.e. retarding) coatings formed by ultra-thin alkali metal (potassium citrate) salt crystal structures on surfaces to be protected against fire as illustrated in FIGS. 8A, 8B, 9A, 9B, 10A, 10B, 11A, 11B, 12A, 12B, 13A, 13B, 14A, 14B, 14C, 14D, 15A, 15B, 16A, 16B, 17A and 17B; and (ii) extinguishing active fires by application of the fire inhibiting biochemical composition of the present invention onto the fire to suppress and extinguish the fire, as illustrated in FIGS. 16A and 16B.

The biochemical compositions of the present invention can be used for example for firefighting in forests, tire warehouses, landfill sites, coal stocks, oil fields, timberyards, and mines, for proactively fighting wildfires from the air, by airplanes and helicopters and drone, as illustrated in FIGS. 10A, 10B, 11A and 11B.

The biochemical compositions of the present invention can be used as a fire extinguishing agent dispensed from a hand-held device or automated dispensing system under real-time sensor control. For example, an aqueous solution may be prepared and filled in a hand-operated fire extinguisher, and configured for readiness during firefighting use. However, the aqueous composition of the present invention need not be prepared in aqueous solution until it is produced by diluting with water, during a firefighting deployment operation.

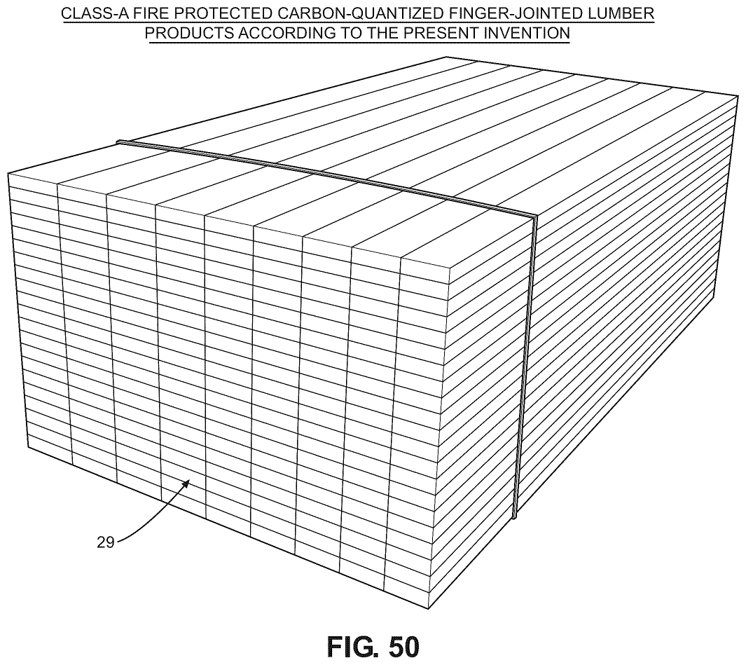

The fire inhibiting biochemical compositions of the present invention can be used to treat and protect combustible wood building materials and/or structural components, such as wood products and engineered wood products (EWPs) including panels and structural members, using the fire inhibiting biochemical compositions of the present invention as disclosed and taught herein, and as illustrated in FIGS. 50 through 59C.

When coated with the biochemical liquid compositions of the present invention, and allowed to dry and form ultra-thin fire inhibiting potassium salt crystal coatings over treated wood surfaces, these wood products remarkably demonstrate Class-A fire protection characteristics that can be reliably proven using the ASTM E84 Testing Standards, having ultra-low flame spread and smoke development indices, as illustrated in FIGS. 50 through 59C.

The fire inhibiting biochemical compositions of the present invention are effective even in the dry state (long-term action) in giving a distinctly delayed ignition on the surface of a flammable material (ignition time), an appreciably reduced smoke evolution and development, and almost no afterglow (anti-smoldering effect).

The fire inhibiting biochemical compositions of the present invention are useful in extinguishing Class A, B, C and D fires. Also, an aqueous preparation of the biochemical composition may be prepared and stationed as ready for firefighting use when the occasion calls. However, it is also possible for the aqueous preparation not to be produced until it is needed, and then by diluting and dissolving the biochemical components in water, during a firefighting deployment.

The fire inhibiting biochemical compositions of the present invention are further useful as an extinguishing agent in fire extinguishers and/or fire extinguishing systems, and via existing fire extinguishing pumps and fittings. Such fire extinguishers include, for example, portable and/or mobile fire extinguishers, as well as fixed installations, such as sprinkler systems disclosed in Applicant's US Patent Application Publication No. US2019/168047, incorporated herein by reference.

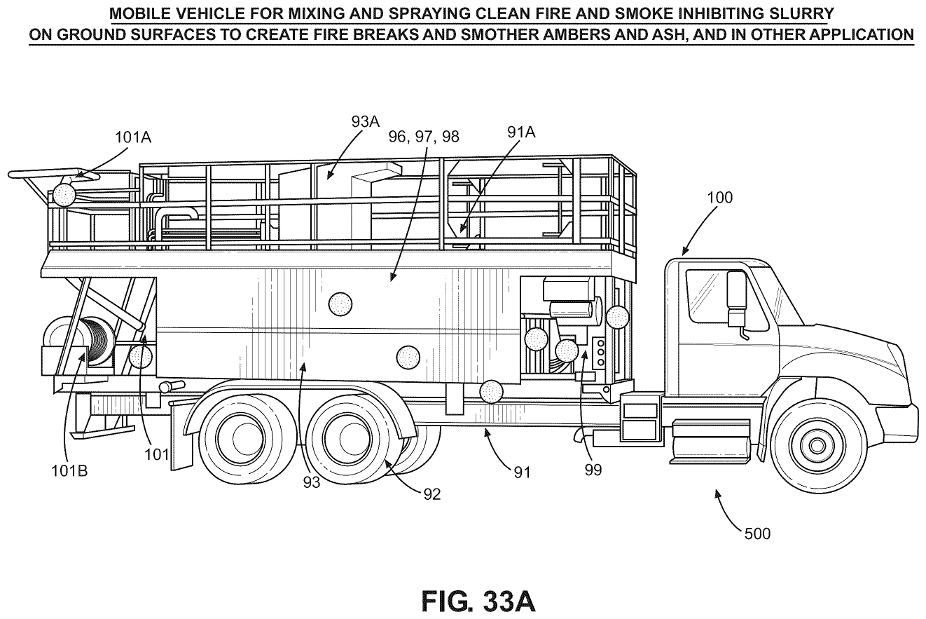

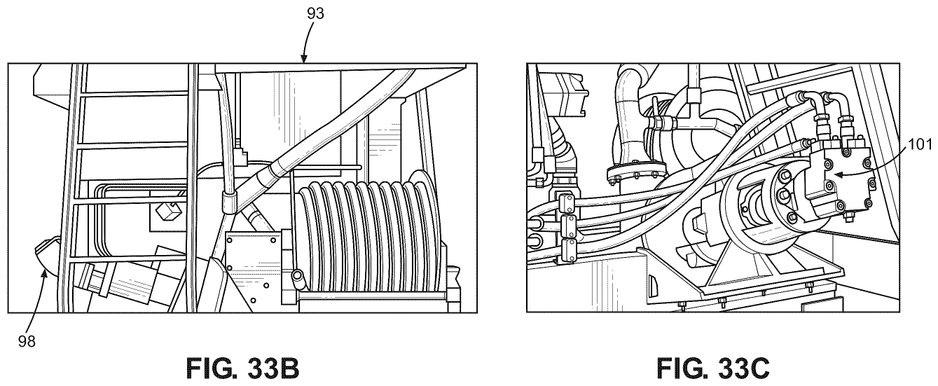

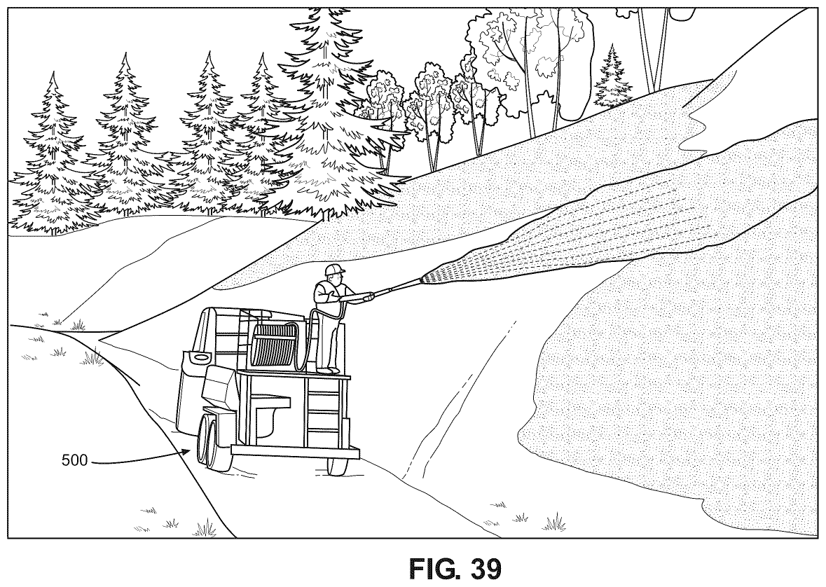

The fire inhibiting liquid biochemical compositions of the present invention can be used to produce an aqueous-based fire and smoke inhibiting slurry mixture that can sprayed on ground cover surfaces and allowed to dry to form Class-A fire-protected wildfire protected mulch to form wildfire breaks, barriers and protective zones around property, buildings and like structures, as illustrated in FIGS. 33A through 41.

In the preferred embodiments of the biochemical compositions of the present invention, potassium citrate salts are utilized in the biochemical formulations and are very readily biodegradable without harm or impact to the natural environment. This is highly advantageous especially in relation to the proactive defense of towns, communities, home owner associations (HOAs), homes, business buildings and other forms of public and private property, from the destructive impact of raging wildfires, using the systematic and organized application, tracking and mapping of fire inhibiting biochemical compositions of the present invention, over large property.

In such planned deployments of the present invention involving the proactive defense of a state, towns, communities and homes and property against the destructive effects of wildfires, as disclosed in FIGS. 9 through 32B, and FIGS. 33A through 43, various methods and apparatus will be used to proactively spray and GPS-track and map, the formation of ultra-thin coatings of potassium citrate salt crystal structures on treated surfaces of property (e.g. in the form of clean chemistry wildfire breaks and barriers) to be proactively protected against wildfires whenever they break out and arrive at and threaten a state, town, county, community, and/or homes and businesses. At the same time, these potassium citrate salt crystal structures of the present invention favorably allow and support the transport of oxygen and CO2 gases across the fire protected surfaces (e.g. which may include living plant tissue on leaves of trees in orchard and on vines in vineyards), without adversely affecting the vitality of such living plant tissue present and covering the ground of property. Also, the clean wildfire chemistry of the present invention can be used around animal such as horses, dogs, cats, and other pets without posing any health risk to such creatures, while mitigating the risks that raging wildfires will present to their lives.

Also, and most significantly, the fire inhibiting biochemical compositions of the present invention are substantially free of the many disadvantages and dangers associated with the use of ammonium-based compounds historically used in forest fire fighting, and which may at the same time have an adverse effect as fertilizers in watercourses.

Furthermore, the biochemical compositions of the present invention are very resistant to freezing when used or applied in sub-zero temperatures (e.g. less than 32 F). Thus, it is possible to obtain an aqueous biochemical composition according to the present invention which is still sprayable at temperatures below 0 C.

Notably, the liquid biochemical compositions of the present invention are non-corrosive, especially not regarding aluminum and other metals that may be used as containers for the biochemical solutions of the present invention, especially during mixing, storage, and application operations. This feature is of particular importance in relation to the proactive defense of wild fires from both the ground using GPS-tracked ground-based spraying vehicles of the present invention, and from the air using GPS-tracked aircraft-based spraying vehicles of the present invention, as disclosed in FIGS. 8 through 32B.

The liquid biochemical compositions of the present invention can be used for proactively firefighting wildfires and fires that may break out in many places including, but not limited to, forests, WUI regions, tire warehouses, landfill sites, coal stocks, timberyards and even mines, as illustrated in FIGS. 24 through 32B.

The liquid biochemical compositions of the present invention can also be used to proactively fight wildfire fires from the air, for example by airplanes and helicopters and drones, applying and GPS-tracking the spray application of environmentally-clean fire inhibiting biochemical liquid over ground and property surfaces to create and maintain clean-chemistry fire breaks and barriers where wildfire are not to be permitted to targeted property to be protected, in accordance with the principles of the present invention.

The liquid biochemical compositions of the present invention can also be used to proactively protect, in factory environments, carbon-storing building materials and/or structural components, such wood panel and engineering wood products (EWPs), from fire outbreaks caused by nature, accident, arson or terrorism, by applying Class-A fire-protected metal salt crystalline coatings using the biochemical compositions and methods of the present invention, as illustrated in FIGS. 50 through 59C. The building materials and/or structural components coated with the biochemical compositions of the present invention are distinctly less flammable than uncoated building materials and/or structural components.

The liquid biochemical compositions of the present invention will also be useful as a rapid-fire extinguishing agent, an illustrated in FIGS. 16A and 16B, showing GPS-tracking apparatus for hand spraying atomized clouds of the solution to rapidly extinguish, preferably, fires of classes A, B, C and D, more preferably for fires of classes A, B and C and most preferably for fires of classes A and B. For example, an aqueous preparation may be set and kept in readiness for firefighting use. However, it is also possible for the aqueous preparation not to be produced until it is produced, by diluting with water, during a firefighting deployment.

The liquid fire-extinguishing and/or fire-retarding compositions of the present invention are further useful as extinguishants in extinguishers and/or extinguishing systems, and via existing fire extinguishing pumps and fittings. Extinguishers are for example portable and/or mobile fire extinguishers. Extinguishing systems are fixed installations, such as sprinkler systems, as illustrated in FIGS. 16A through 16B, and in other building misting systems illustrated in Applicant's US Patent Application Publication No. US2019/168047, incorporated herein by reference.

The biochemical compositions of the present invention are effective even in the dry state (long-term action) in giving a distinctly delayed ignition on the surface of a flammable material (ignition time), an appreciably reduced smoke evolution (light absorption) and almost no afterglow (anti-smoldering effect), as illustrated in FIGS. 33A through 41.

### Specification of the Mobile GPS-Tracked Anti-Fire (AF) Liquid Spraying System of the Present Invention

FIG. 8A shows a mobile GPS-tracked anti-fire (AF) fire inhibiting/extinguishing liquid spraying system 20 supported on a set of wheels 20A, having an integrated supply tank 20B and rechargeable-battery operated electric spray pump 20C with portable battery module (20C), for deployment at private and public properties having building structures, for spraying the same with environmentally-clean anti-fire (AF) (e.g. inhibiting/extinguishing) liquid using a spray nozzle assembly 20D connected to the spray pump 20C by way of a flexible 20E.

FIG. 8B shows the GPS-tracked mobile anti-fire liquid spraying system 20 of FIG. 6A as comprising a number of subcomponents, namely: a GPS-tracked and remotely-monitored AF chemical liquid spray control subsystem 20F; a micro-computing platform or subsystem 20G interfaced with the GPS-tracked and remotely-monitored AF chemical liquid spray control subsystem 20F by way of a system bus 201; and a wireless communication subsystem 20H interfaced to the micro-computing platform 20G via the system bus 201. As configured, the GPS-tracked mobile anti-fire liquid spraying system 20 enables and supports (i) the remote monitoring of the spraying of anti-fire (AF) chemical liquid from the system 20 when located at specific GPS-indexed location coordinates, and (ii) the logging of all such GPS-indexed spray application operations, and recording the data transactions thereof within a local database maintained within the micro-computing platform 20G, as well as in the remote network database 9C1 maintained at the data center 8 of the system network 1.

As shown in FIG. 8B, the micro-computing platform 20G comprises: data storage memory 20G1; flash memory (firmware storage) 20G2; a programmable microprocessor 20G3; a general purpose I/O (GPIO) interface 20G4; a GPS transceiver circuit/chip with matched antenna structure 20G5; and the system bus 201 which interfaces these components together and provides the necessary addressing, data and control signal pathways supported within the system 20.

As shown in FIG. 8B, the wireless communication subsystem 20H comprises: an RF-GSM modem transceiver 20H1; a T/X amplifier 20H2 interfaced with the RF-GSM modem transceiver 20H1; and a WIFI and Bluetooth wireless interfaces 20H3.

As shown in FIG. 8B, the GPS-tracked and remotely-controllable anti-fire (AF) chemical liquid spray control subsystem 20F comprises: anti-fire chemical liquid supply sensor(s) 20F1 installed in or on the anti-fire chemical liquid supply tank 20B to produce an electrical signal indicative of the volume or percentage of the AF liquid supply tank containing AF chemical liquid at any instant in time, and providing such signals to the AF liquid spraying system control interface 20F4; a power supply and controls 20F2 interfaced with the liquid pump spray subsystem 20C, and also the AF liquid spraying system control interface 20F4; manually-operated spray pump controls interface 20F3, interfaced with the AF liquid spraying system control interface 20F4; and the AF liquid spraying system control interface 20F4 interfaced with the micro-computing subsystem 20G, via the system bus 201. The flash memory storage 20G2 contains microcode that represents a control program that runs on the microprocessor 20G3 and realizes the various GPS-specified AF chemical liquid spray control, monitoring, data logging and management functions supported by the system 20.

In the preferred embodiment, the environmentally-clean anti-fire (AF) chemical liquid is the fire inhibiting biochemical compositions described and taught herein with respect to FIGS. 6A through 7A. When so treated, combustible products will prevent flames from spreading, and confine fire to the ignition source which can be readily extinguished, or go out by itself. In the presence of a flame, the chemical molecules in both dry and wet coatings, formed with the biochemical liquid of the present invention, and inhibiting fire by one or more pathways including interfering with the free radicals (H+, OH—, O) involved in the free-radical chemical reactions within the combustion phase of a fire, and breaking free-radical chemical reactions and extinguishing the fire's flames.

### Specification of GPS-Tracked Manned or Autonomous Vehicle for Spraying Anti-Fire (AF) Liquid on Building and Ground Surfaces

FIG. 9A shows a mobile GPS-tracked manned or autonomous vehicle anti-fire (AF) liquid spray vehicle system 30 for spraying environmentally-clean anti-fire (AF) chemical liquid on exterior building surfaces and ground surfaces in accordance with the principles of the present invention. As shown, the vehicle system 30 is supported on a set of wheels 30A driven by a propulsion drive subsystem 30 and navigated by GPS-guided navigation subsystem 30I, and carrying an integrated supply tank 30B with either rechargeable-battery-operated electric-motor driven spray pump, or gasoline/diesel or propane operated motor-driven spray pump, 30C, for deployment on private and public property parcels having building structures, for spraying the same with environmentally-clean anti-fire (AF) liquid using a spray nozzle assembly 30D connected to the spray pump 30C by way of a flexible hose 30E.

FIG. 9B shows the GPS-tracked mobile anti-fire liquid spraying system 30 of FIG. 7A as comprising a number of subcomponents, namely: a GPS-tracked and remotely-monitored AF chemical liquid spray control subsystem 30F; a micro-computing platform or subsystem 30G interfaced with the GPS-tracked and remotely-monitored AF chemical liquid spray control subsystem 30F by way of a system bus 30I; a wireless communication subsystem 30H interfaced to the micro-computing platform 30G via the system bus 30I; and a vehicular propulsion and navigation subsystem 30I employing a propulsion subsystem 30I1 and AI-driven or manually-driven navigation subsystem 30I2.

As configured in the illustrative embodiment, the GPS-tracked mobile anti-fire liquid spraying system 30 enables and supports (i) the remote monitoring of the spraying of anti-fire (AF) chemical liquid from the system 30 when located at specific GPS-indexed location coordinates, and (ii) the logging of all such GPS-indexed spray application operations, and recording the data transactions thereof within a local database maintained within the micro-computing platform 30G, as well as in the remote network database 9C1 maintained at the data center 8 of the system network 1.

As shown in FIG. 9B, the micro-computing platform 30G comprises: data storage memory 30G1; flash memory (firmware storage) 30G2; a programmable microprocessor 30G3; a general purpose I/O (GPIO) interface 30G4; a GPS transceiver circuit/chip with matched antenna structure 30G5; and the system bus 30I which interfaces these components together and provides the necessary addressing, data and control signal pathways supported within the system 30. As such, the micro-computing platform 30G is suitably configured to support and run a local control program 30G2-X on microprocessor 30G3 and memory architecture 30G1, 30G2 which is required and supported by the enterprise-level mobile application 12 and the suite of services supported by the system network 1 of the present invention.

As shown in FIG. 9B, the wireless communication subsystem 30H comprises: an RF-GSM modem transceiver 30H1; a T/X amplifier 30H2 interfaced with the RF-GSM modem transceiver 30H1; and a WIFI interface and a Bluetooth wireless interface 30H3 for interfacing with WIFI and Bluetooth data communication networks, respectively, in a manner known in the communication and computer networking art.

As shown in FIG. 9B, the GPS-tracked and remotely-controllable anti-fire (AF) chemical liquid spray control subsystem 30F comprises: anti-fire chemical liquid supply sensor(s) 30F1 installed in or on the anti-fire chemical liquid supply tank 30B to produce an electrical signal indicative of the volume or percentage of the AF liquid supply tank containing AF chemical liquid at any instant in time, and providing such signals to the AF liquid spraying system control interface 30F4; a power supply and controls 30F2 interfaced with the liquid pump spray subsystem 30C, and also the AF liquid spraying system control interface 30F4; manually-operated spray pump controls interface 30F3, interfaced with the AF liquid spraying system control interface 30F4; and the AF liquid spraying system control interface 30F4 interfaced with the micro-computing subsystem 30G, via the system bus 30I. The flash memory storage 30G2 contains microcode for a control program that runs on the microprocessor 20G3 and realizes the various GPS-specified AF chemical liquid spray control, monitoring, data logging and management functions supported by the system 30.

Notably, because the chemical components of wildfire inhibiting biochemical solution of the present invention completely dissolve in water, without crystal formation in solution, it's possible to spray the biochemical liquid using atomization and/or misting spray techniques so that very fine liquid droplets of micron dimensions can be formed and projected over long throw distances—during spraying operations. This pure-liquid property of the fire inhibiting biochemical composition (i) allows its active fire inhibiting chemistry (e.g. potassium mineral salts) to efficiently cling onto combustible surfaces of natural fuels distributed widely across ground surfaces in the rapidly expanding WUI region, and (ii) promotes surface infusion of potassium mineral salts within the microstructure of the sprayed surfaces during atomization spraying and quick drying operations. This promotes the formation of ultra-thin potassium salt crystal coatings that offer improved duration of fire protection of TPC-based potassium mineral salts contained in the wildfire inhibitor, when exposed to moisture and/or high levels of relative humidity.

Deposition of potassium mineral salt crystal coatings within the molecular surface structure surfaces being treated with the biochemical solution of the present invention using atomization-based spraying techniques, preferably at elevated spraying temperatures under the arid hot Sun, the wildfire inhibiting potassium salt coating, once dried, can be made either insensitive or less sensitive to water exposure, a property which will improve the wildfire inhibitor's duration of fire protection in the presence of rain and ambient moisture levels. Also, it is believed that better surface deposition of the biochemical composition of the present invention can be achieved by reducing the size of the spray or misting droplets of the wildfire inhibitor as small as possible using, for example, atomization-based spraying/misting techniques applied at elevated spraying temperatures. Such techniques will promote water molecules to be rapidly evaporated during spray application, and promote deposition and bonding of potassium mineral salts within surface molecules of the sprayed surface substrate, as they are deposited onto the organic fuel surfaces to be protected against the threat of ignition by wildfire. Such insights and practices inform and support optimized methods of wildfire inhibitor deposition in outdoor environments.

Using GPS-Tracking, Mapping and Recording Techniques to Know where Clean-Chemistry Wild Fire Breaks and Zones were Formed by Whom, and when

Using the cloud-based wildfire defense network's integrated GPS-tracking, mapping and recording techniques, as illustrated in FIGS. 8 through 32B, fire jurisdictions can plan and implement clean-chemistry wildfire breaks and zones (e.g. around telephone poles) to proactively protect property and life from raging wildfires—by effectively inhibiting specific regions of combustible fuel from ignition, along the path towards targeted property and life to be protected from the incidence of wildfire. Proactive wildfire protection according to the principles of the present invention is simple. Wherever combustible ground cover is sprayed/misted with the fire inhibiting biochemical composition of the present invention, illustrated in FIGS. 6A through 7A, the free radical chain reactions driving the combustible phase of wildfire will be interrupted, taking the energy out of a raging wildfire, by reducing fire ignition, flame spread, the production of smoke, thereby protecting property that has been treated in advance of a wildfire incidence.

In hot dry climates, conditioned by hot dry prevailing winds, the relative humidity will be expectedly low, and in the absence of rain, the all-natural (clear) wild fire inhibiting sprayed over wild fire break and zone regions, will last for durations into weeks and months in many situations. However, whenever rain occurs, the Network will know and advise fire departments and homeowner alike that clean-chemistry wildfire breaks and zones need to be maintained by an additional spraying of wildfire inhibiting biochemical liquid, while GPS-tracked, mapped and recorded for management purposes.

### Specification of GPS-Tracked Autonomously-Driven Drone System Adapted for Spraying Anti-Fire (AF) Liquid on Buildings and Ground Surfaces

FIG. 10A shows a mobile GPS-tracked unmanned airborne system (UAS) or drone 40 adapted for misting and spraying environmentally-clean anti-fire (AF) chemical liquid of the present invention on exterior building surfaces and ground surfaces in accordance with the principles of the present invention.

As shown, the drone vehicle system 40 comprises: a lightweight airframe 40A0 supporting a propulsion subsystem 40I provided with a set of eight (8) electric-motor driven propellers 40A1-40A8, driven by electrical power supplied by a rechargeable battery module 409, and controlled and navigated by a GPS-guided navigation subsystem 40I2; an integrated supply tank 40B supported on the airframe 40A0, and connected to either rechargeable-battery-operated electric-motor driven spray pump, or gasoline/diesel or propane operated motor-driven spray pump, 40C, for deployment on private and public property parcels having building structures; a spray nozzle assembly 40D connected to the spray pump 40C by way of a flexible hose 40E, for misting and spraying the same with environmentally-clean anti-fire (AF) liquid under the control of GPS-specified coordinates defining its programmed flight path when operating to suppress or otherwise fight wild fires.

FIG. 10B shows the GPS-tracked anti-fire liquid spraying system 40 of FIG. 8A as comprising a number of subcomponents, namely: a GPS-tracked and remotely-monitored AF chemical liquid spray control subsystem 40F; a micro-computing platform or subsystem 40G interfaced with the GPS-tracked and remotely-monitored AF chemical liquid spray control subsystem 40F by way of a system bus 401; a wireless communication subsystem 40H interfaced to the micro-computing platform 40G via the system bus 401; and a vehicular propulsion and navigation subsystem 40I employing propulsion subsystem 40I1, and AI-driven or manually-driven navigation subsystem 40I2.

As configured in the illustrative embodiment, the GPS-tracked anti-fire liquid spraying system 40 enables and supports (i) the remote monitoring of the spraying of anti-fire (AF) chemical liquid from the system 40 when located at specific GPS-indexed location coordinates, and (ii) the logging of all such GPS-indexed spray application operations, and recording the data transactions thereof within a local database maintained within the micro-computing platform 40G, as well as in the remote network database 9C1 maintained at the data center 8 of the system network 1.

As shown in FIG. 10B, the micro-computing platform 40G comprises: data storage memory 40G1; flash memory (firmware storage) 40G2; a programmable microprocessor 40G3; a general purpose I/O (GPIO) interface 40G4; a GPS transceiver circuit/chip with matched antenna structure 40G5; and the system bus 40I which interfaces these components together and provides the necessary addressing, data and control signal pathways supported within the system 40. As such, the micro-computing platform 40G is suitably configured to support and run a local control program 40G2-X on microprocessor 40G3 and memory architecture 40G1, 40G2 which is required and supported by the enterprise-level mobile application 12 and the suite of services supported by the system network 1 of the present invention.

As shown in FIG. 10B, the wireless communication subsystem 30H comprises: an RF-GSM modem transceiver 40H1; a T/X amplifier 40H2 interfaced with the RF-GSM modem transceiver 40H1; and a WIFI interface and a Bluetooth wireless interface 40H3 for interfacing with WIFI and Bluetooth data communication networks, respectively, in a manner known in the communication and computer networking art.

As shown in FIG. 10B, the GPS-tracked and remotely-controllable anti-fire (AF) chemical liquid spray control subsystem 40F comprises: anti-fire chemical liquid supply sensor(s) 40F1 installed in or on the anti-fire chemical liquid supply tank 30B to produce an electrical signal indicative of the volume or percentage of the AF liquid supply tank containing AF chemical liquid at any instant in time, and providing such signals to the AF liquid spraying system control interface 40F4; a power supply and controls 40F2 interfaced with the liquid pump spray subsystem 40C, and also the AF liquid spraying system control interface 40F4; manually-operated spray pump controls interface 40F3, interfaced with the AF liquid spraying system control interface 30F4; and the AF liquid spraying system control interface 40F4 interfaced with the micro-computing subsystem 40G, via the system bus 40I. The flash memory storage 40G2 contains microcode for a control program that runs on the microprocessor 40G3 and realizes the various GPS-specified AF chemical liquid spray control, monitoring, data logging and management functions supported by the system 40.

Specification of GPS-Tracked Aircraft (i.e. Helicopter) for Spraying Anti-Fire (AF) Liquid on Ground Surfaces

FIG. 11A shows a mobile GPS-tracked manned aircraft (i.e. helicopter) system 50 adapted for misting and spraying environmentally-clean anti-fire (AF) chemical liquid of the present invention on ground surfaces and over buildings in accordance with the principles of the present invention.

As shown, the aircraft system 50 comprises: a lightweight airframe 50A0 supporting a propulsion subsystem 50I provided with a set of axially-mounted helicopter blades 50A1-50A2 and 50A5, driven by combustion-engine and controlled and navigated by a GPS-guided navigation subsystem 50I2; an integrated supply tank 50B supported on the airframe 50A0, and connected to a gasoline/diesel operated motor-driven spray pump, 50C, for deployment on private and public property parcels having building structures; a spray nozzle assembly 50D connected to the spray pump 50C by way of a hose 50E, for misting and/or spraying the same with environmentally-clean anti-fire (AF) liquid under the control of GPS-specified coordinates defining its programmed flight path when operating to suppress or otherwise fight wild fires.

FIG. 111B shows the GPS-tracked anti-fire liquid spraying system 50 of FIG. 9A as comprising a number of subcomponents, namely: a GPS-tracked and remotely-monitored AF chemical liquid spray control subsystem 50F; a micro-computing platform or subsystem 50G interfaced with the GPS-tracked and remotely-monitored AF chemical liquid spray control subsystem 50F by way of a system bus 50I; a wireless communication subsystem 50H interfaced to the micro-computing platform 50G via the system bus 50I; and a vehicular propulsion and navigation subsystem 50I employing propulsion subsystem 50I1, and AI-driven or manually-driven navigation subsystem 50I2.

As configured in the illustrative embodiment, the GPS-tracked anti-fire liquid spraying system 50 enables and supports (i) the remote monitoring of the spraying of anti-fire (AF) (i.e. fire inhibiting) chemical liquid from the system 50 when located at specific GPS-indexed location coordinates, and (ii) the logging of all such GPS-indexed spray application operations, and recording the data transactions thereof within a local database maintained within the micro-computing platform 50G, as well as in the remote network database 9C1 maintained at the data center 8 of the system network 1.

As shown in FIG. 9B, the micro-computing platform 50G comprises: data storage memory 50G1; flash memory (firmware storage) 50G2; a programmable microprocessor 50G3; a general purpose I/O (GPIO) interface 50G4; a GPS transceiver circuit/chip with matched antenna structure 50G5; and the system bus 40I which interfaces these components together and provides the necessary addressing, data and control signal pathways supported within the system 50. As such, the micro-computing platform 50G is suitably configured to support and run a local control program 50G2-X on microprocessor 50G3 and memory architecture 50G1, 40G2 which is required and supported by the enterprise-level mobile application 12 and the suite of services supported by the system network 1 of the present invention.

As shown in FIG. 111B, the wireless communication subsystem 50H comprises: an RF-GSM modem transceiver 50H1; a T/X amplifier 50H2 interfaced with the RF-GSM modem transceiver 50H1; and a WIFI interface and a Bluetooth wireless interface 50H3 for interfacing with WIFI and Bluetooth data communication networks, respectively, in a manner known in the communication and computer networking art.

As shown in FIG. 111B, the GPS-tracked and remotely-controllable anti-fire (AF) chemical liquid spray control subsystem 50F comprises: anti-fire chemical liquid supply sensor(s) 50F1 installed in or on the anti-fire chemical liquid supply tank 50B to produce an electrical signal indicative of the volume or percentage of the AF liquid supply tank containing AF (i.e. fire inhibiting) chemical liquid of the present invention at any instant in time, and providing such signals to the AF liquid spraying system control interface 50F4; a power supply and controls 50F2 interfaced with the liquid pump spray subsystem 50C, and also the AF liquid spraying system control interface 50F4; manually-operated spray pump controls interface 50F3, interfaced with the AF liquid spraying system control interface 50F4; and the AF liquid spraying system control interface 50F4 interfaced with the micro-computing subsystem 50G, via the system bus 50I. The flash memory storage 50G2 contains microcode for a control program that runs on the microprocessor 50G3 and realizes the various GPS-specified AF chemical liquid spray control, monitoring, data logging and management functions supported by the system 50.

### Specification of GPS-Tracked Autonomously-Driven Aircraft for Spraying Anti-Fire (AF) Liquid on Building and Ground Surfaces

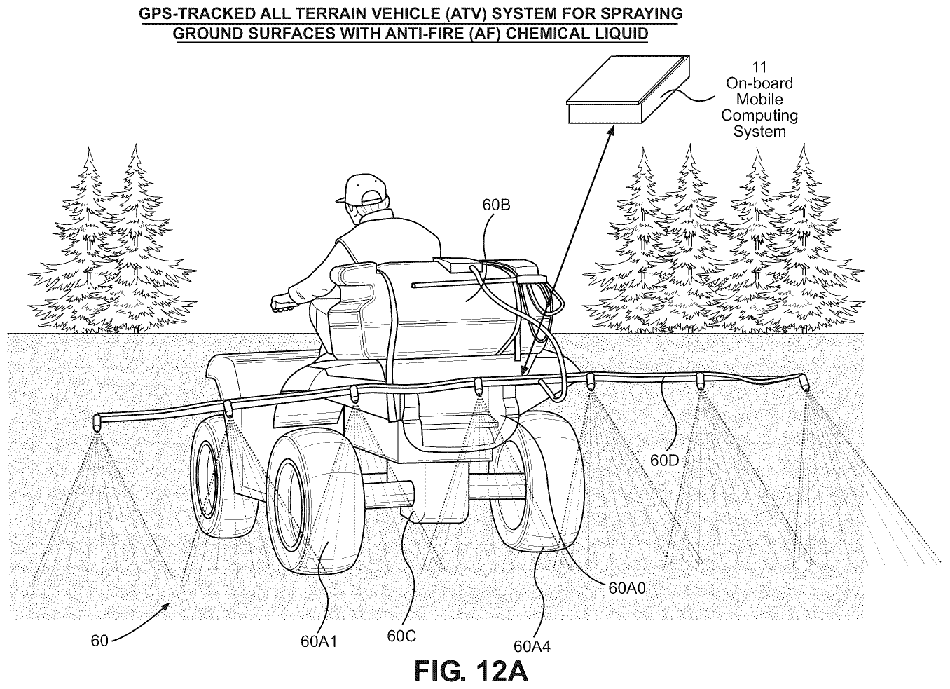

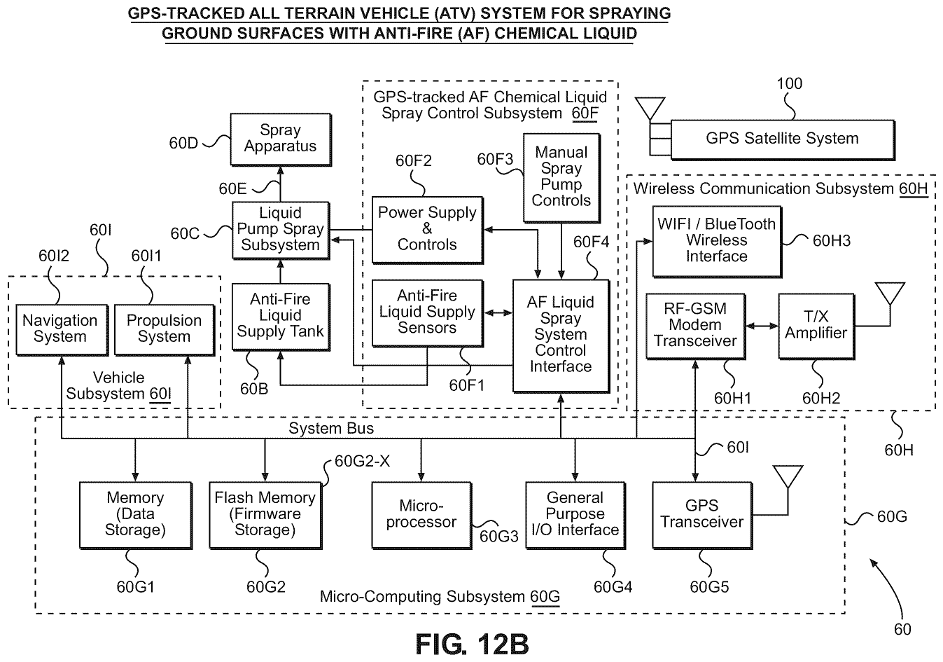

FIG. 12A shows a mobile GPS-tracked manned all-terrain vehicle (ATV) system 60 adapted for misting and spraying environmentally-clean anti-fire (AF) chemical liquid of the present invention on ground surfaces in accordance with the principles of the present invention.

As shown, the aircraft system 60 comprises: a lightweight frame/chassis 60A0 supporting a propulsion subsystem 60I provided with a set of wheels 60A1-60A4, driven by combustion-engine, and controlled and navigated by a GPS-guided navigation subsystem 60I2; an integrated supply tank 60B supported on the frame 60A0, and connected to a gasoline/diesel operated motor-driven spray pump, 60C, for deployment on private and public property parcels; a spray nozzle assembly 60D connected to the spray pump 60C by way of a hose 60E, for misting and/or spraying the same with environmentally-clean anti-fire (AF) liquid under the control of GPS-specified coordinates defining its programmed flight path when operating to suppress or otherwise fight wild fires.

FIG. 12B shows the GPS-tracked anti-fire liquid spraying system 60 of FIG. 10A as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I; and a vehicular propulsion and navigation subsystem 60I employing propulsion subsystem 60I1, and AI-driven or manually-driven navigation subsystem 60I2.

As configured in the illustrative embodiment, the GPS-tracked anti-fire liquid spraying system 60 enables and supports (i) the remote monitoring of the spraying of anti-fire (AF) chemical liquid from the system 60 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 12B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 60. As such, the micro-computing platform 60G is suitably configured to support and run a local control program 60G2-X on microprocessor 60G3 and memory architecture 60G1, 60G2 which is required and supported by the enterprise-level mobile application 12 and the suite of services supported by the system network 1 of the present invention.

As shown in FIG. 12B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 12B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF chemical liquid at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system 60.

### Specification of GPS-Tracking Backpack-Mounted Atomizing Spray Cannon System for Spraying Environmentally-Clean Anti-Fire/Fire Inhibiting Liquid Biochemical Composition on the Surfaces of Buildings and Property Ground Surfaces

FIG. 13A shows a mobile GPS-tracked backpack-mounted atomizing spray cannon (ASC) system 70 adapted for misting and spraying environmentally-clean anti-fire (AF) chemical liquid on ground surfaces in accordance with the principles of the present invention.

As shown, the GPS-tracked spray cannon system 70 comprises: a lightweight frame/chassis 60A a GPS-guided navigation subsystem 60I2 for providing the user with navigation control during GPS-tracked and mapped spraying operations; an integrated supply tank 60B supported on the frame 60A0, and connected to a gasoline/diesel or battery-powered operated motor-driven spray pump, 60C, for deployment on private and public property parcels; a spray nozzle assembly 60D connected to the spray pump 60C by way of a hose 60E, for misting and/or spraying the same with environmentally-clean anti-fire (AF) liquid under the control of GPS-specified coordinates defining its programmed flight path when operating to suppress or otherwise fight wild fires.

FIG. 13B shows the GPS-tracked anti-fire liquid spraying system 70 of FIG. 13A as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I; and a vehicular propulsion and navigation subsystem 60I employing propulsion subsystem 60I1, and AI-driven or manually-driven navigation subsystem 60I2.

As configured in the illustrative embodiment, the GPS-tracked anti-fire liquid spraying system 70 enables and supports (i) the remote monitoring of the spraying of anti-fire (AF) chemical liquid from the system 70 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 13B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 70. As such, the micro-computing platform 60G is suitably configured to support and run a local control program 60G2-X on microprocessor 60G3 and memory architecture 60G1, 60G2 which is required and supported by the enterprise-level mobile application 12 and the suite of services supported by the system network 1 of the present invention.

As shown in FIG. 13B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 13B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF chemical liquid at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system network of the present invention.

### Specification of GPS-Tracked Mobile Atomizing Spray Cannon System for Spraying Environmentally-Clean Anti-Fire Biochemical Liquid on Buildings and Ground Surfaces

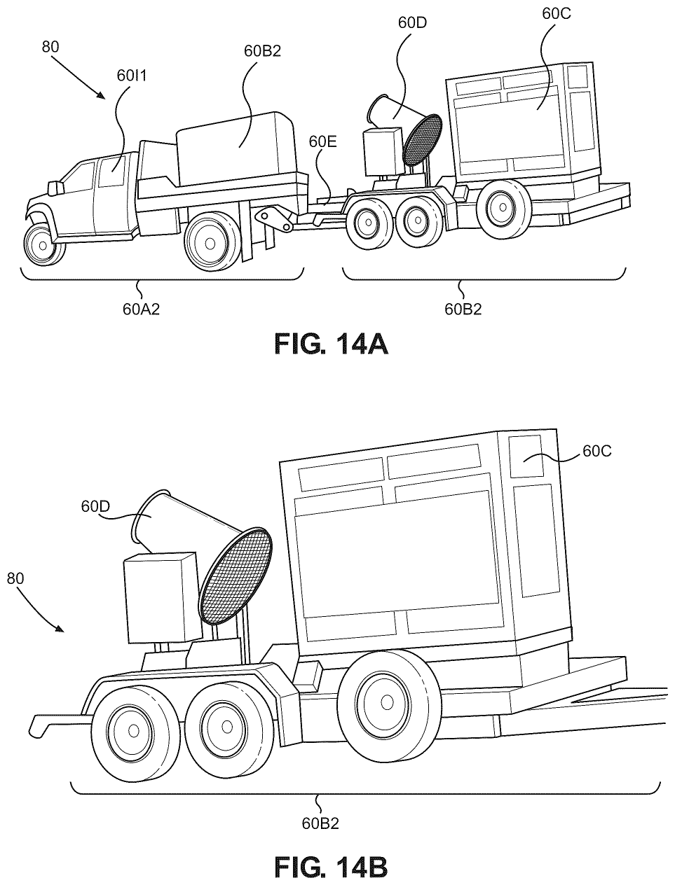

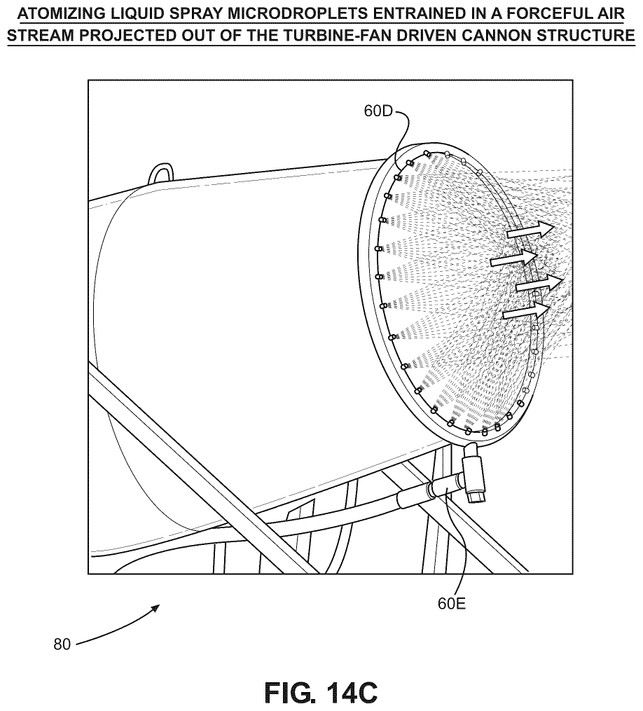

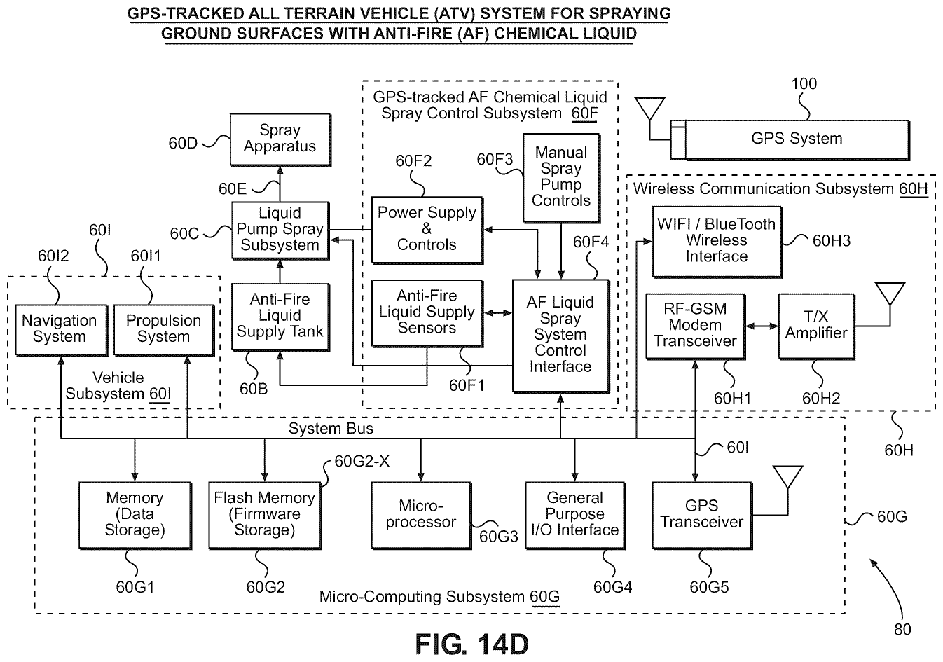

FIG. 14A shows a mobile GPS-tracked backpack-mounted atomizing spray cannon (ASC) system 80 adapted for misting and spraying environmentally-clean anti-fire/fire-inhibiting biochemical liquid on ground surfaces in accordance with the principles of the present invention.

As shown, the GPS-tracked system 80 comprises: a lightweight frame/chassis 60A provided with a set of wheels mounted on a trailer 60B2 that is pulled by tractor 60A2 driven by combustion-engine or electric battery-powered motor, that is controlled and navigated by a GPS-guided navigation subsystem 60I2; an integrated supply tank 60B supported on the frame 60A3, and connected to a gasoline/diesel operated motor-driven spray pump, 60C, for deployment on private and public property parcels; an atomizing spray nozzle assembly 60D comprising a ring a atomizing spray nozzles mounted about the aperture of a cannon-like air-blowing engine, powered by a turbine fan blower unit, and connected to the spray pump 60C by way of a hose 60E, for producing a forceful airstream enriched with atomized mist developed from a supply of the environmentally-clean fire inhibiting (i.e. anti-fire) biochemical liquid of the present invention, under the control of GPS-specified coordinates defining its programmed path or course when operating to suppress or otherwise fight wild fires.

FIG. 14B shows the GPS-tracked anti-fire liquid spraying system cannon 80 of FIG. 14A as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I; and a vehicular propulsion and navigation subsystem 60I employing propulsion subsystem 60I1, and AI-driven or manually-driven navigation subsystem 60I2.

As configured in the illustrative embodiment, the GPS-tracked anti-fire liquid spraying system 80 enables and supports (i) the remote monitoring of the spraying of anti-fire (AF) chemical liquid from the system 80 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 14B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 80. As such, the micro-computing platform 60G is suitably configured to support and run a local control program 60G2-X on microprocessor 60G3 and memory architecture 60G1, 60G2 which is required and supported by the enterprise-level mobile application 12 and the suite of services supported by the system network 1 of the present invention.

As shown in FIG. 14B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 14B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF chemical liquid at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system network of the present invention.

### Specification of GPS-Tracking Mobile Atomizing Spray Cannon System for Spraying Environmentally-Clean Anti-Fire Biochemical Liquid on Buildings and Ground Surfaces

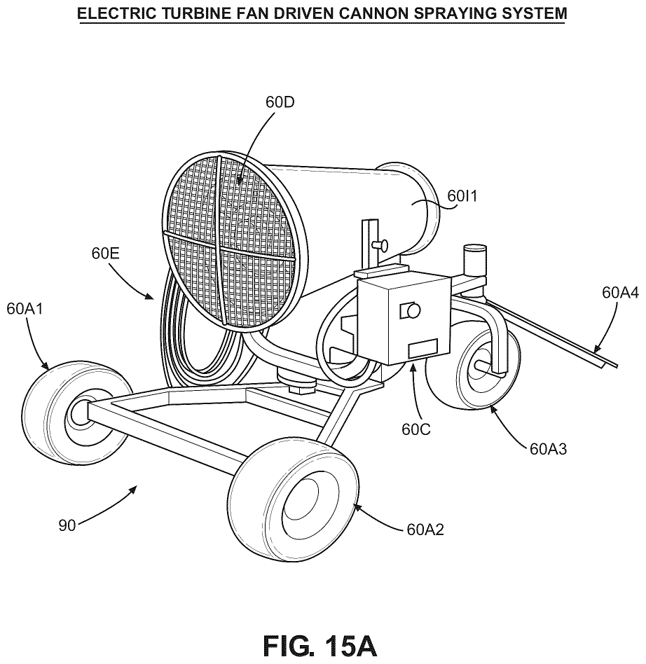

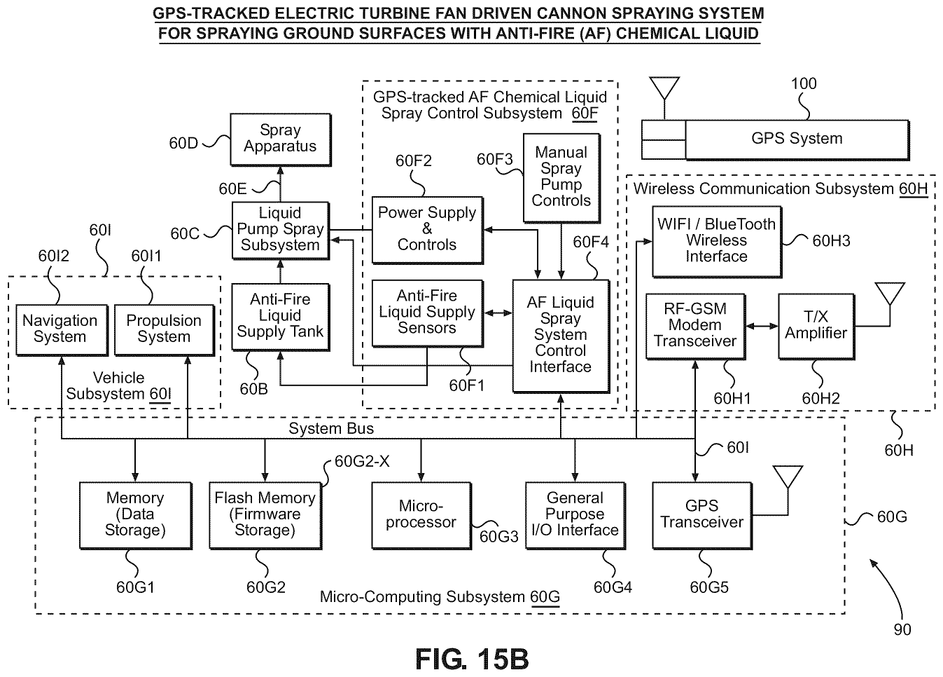

FIG. 15A shows a mobile GPS-tracked mobile atomizing spray cannon (ASC) system 90 capable of being towed along a course or desired pathway, and specially adapted for misting and spraying environmentally-clean fire inhibiting biochemical liquid composition of the present invention on ground and other property surfaces in accordance with the principles of the present invention.

As shown in FIG. 15A, the GPS-tracked cannon-type spraying system 90 comprises: a lightweight frame/chassis 60A0 supporting a propulsion subsystem 60I provided with a set of wheels 60A1-60A3, and tow bar 60A4; an integrated supply tank 60B supported on the vehicle towing the spray cannon system 90, and connected to a gasoline/diesel or electric-motor operated motor-driven spray pump, 60C, for deployment on private and public property parcels; an electric turbine fan 60I1 for producing forced air stream through the cylindrical cannon or barrel like structure as shown; an atomizing spray nozzle assembly 60D connected to the spray pump 60C by way of a hose 60E, for misting and/or spraying the same with environmentally-clean anti-fire (AF) biochemical liquid of the present invention under the control of GPS-specified coordinates defining its programmed path or course when operating to suppress or otherwise fight wild fires.

FIG. 15B shows the GPS-tracked anti-fire liquid spraying system 90 of FIG. 15A as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I; and a vehicular propulsion and navigation subsystem 60I, and AI-driven or manually-driven navigation subsystem 60I2.

As configured in the illustrative embodiment, the GPS-tracked anti-fire liquid spraying system 90 enables and supports (i) the remote monitoring of the spraying of anti-fire (AF) chemical liquid from the system 90 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 15B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 90. As such, the micro-computing platform 60G is suitably configured to support and run a local control program 60G2-X on microprocessor 60G3 and memory architecture 60G1, 60G2 which is required and supported by the enterprise-level mobile application 12, and the suite of services supported by the system network 1 of the present invention.

As shown in FIG. 15B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 15B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF (i.e. fire inhibiting) biochemical liquid of the present invention at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system network of the present invention.

Specification of GPS-Tracking Back-Pack Atomizing-Spray Fire Extinguishing System for Spraying Environmentally-Clean Fire-Inhibiting Biochemical Liquid Compositions on Active Fires, and on Surfaces of Buildings and Ground Surfaces to be Protectively Protected Against Fire

FIG. 16A shows a mobile GPS-tracked backpack-mounted atomizing fire extinguishing system 100 adapted for spraying clouds of environmentally-clean anti-fire (AF) biochemical liquid mist onto fire outbreaks (e.g. all Classes of fire A, B, C and D) wherever they may exit, to quickly extinguish the same in accordance with the principles of the present invention. The system can also be used to apply clean fire protective coatings as well using atomizing sprays of environmentally-clean biochemical liquid compositions of the present invention, disclosed herein.

As shown, the backpack-mounted fire extinguishing system 100 comprises: a liquid storage tank 401 containing 5 gallons of environmentally-clean water-based free-radical chemical-reaction interrupting liquid of the present invention, charged with 100 [PSIG] pressure from a small, pressurized air or CO2 tank 402 integrated with the housing 403. The hand-activated gun-style misting head (i.e. spray misting gun) 404 is provided with a stainless-steel misting nozzle 45 that is connected to two flexible hoses 406A and 406B. Hose 406A is connected to the water tank 41 and hose 406B is connected to the pressurized air tank 402. The hand-held gun-style misting head 404 with misting nozzle 405 is manually activated by the user depressing a finger-activated trigger 406 to discharge clean-chemistry water-based chemical-reaction interrupting mist clouds 407 from the nozzle 405 onto a fire for quick suppression and extinguishment. The portable system can be either back-mounted, or carried in one hand while the other hand is used to hold and operate the spray-misting gun 404. Fire Inhibitor chemical liquid 410 has the required free-radical chemical reaction interrupting chemistry of the present invention, such that the chemical molecules in chemical liquid will interfere with the free radicals generated during the combustion phase of a fire, and interrupt these free-radical chemical reactions within the combustion phase, to suppress and extinguish the fire. Specifically, the fire-inhibiting biochemical liquid has the required metal ions to interrupt free-radical chemical reaction interrupting chemistry of the present invention, such that chemical molecules in the chemical liquid, when transformed into a clean-chemistry-water-based mist, provides a countless supply of water-based micro-droplets, each containing dissolved ions (i.e. electrically-charged atoms or molecules) supplying free-electrons that pair with and stabilize the free-radicals (H+, OH—, O) before any other molecules in the combustion phase can do so to sustain the chemical-reactions (e.g. free-electrons that reduce and stabilize the free-radicals before rapidly-oxidizing molecules within the combustion phase of the fire to sustain the chemical-reactions), and thereby quickly suppressing and extinguishing the fire.

The superior performance of system 400 over conventional portable water mist systems can be attributed to the fact that the micro-droplets of the clean-chemistry water mist 407 will vaporize when absorbing the radiant heat energy of the hot fire, rapidly expanding into a vapor, cooling down the fire, and displacing oxygen. Also the chemical molecules in the micro-droplets will interfere with the free radicals (H+, OH—, O) and interrupt these free-radical chemical reactions within the combustion phase of a fire, and help extinguish the fire.

FIG. 16B shows the GPS-tracked mobile fire extinguishing system 100 of FIG. 16A as comprising a few subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I.

As configured in the illustrative embodiment, the GPS-tracked anti-fire liquid spraying system 100 enables and supports (i) the remote monitoring of the spraying of anti-fire (AF) biochemical liquid from the system 100 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 16B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 100. As such, the micro-computing platform 60G is suitably configured to support and run a local control program 60G2-X on microprocessor 60G3 and memory architecture 60G1, 60G2 which is required and supported by the enterprise-level mobile application 12 and the suite of services supported by the system network 1 of the present invention.

As shown in FIG. 16B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 16B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF biochemical liquid of the present invention at any instant in time, and providing such signals to the AF liquid spraying system control interface 60F4; a power supply and controls 60F2 interfaced with the liquid pump spray subsystem 60C controlling the mixing of gas source 402 with biochemical liquid source 410, and also the AF liquid spraying system control interface 60F4; manually-operated trigger 404 controlled spray pump controls interface 60F3, is interfaced with the AF liquid spraying system control interface 60F4; and the AF liquid spraying system control interface 60F4 is interfaced with the micro-computing subsystem 60G, via the system bus 60I. The flash memory storage 60G2 contains microcode for a control program that runs on the microprocessor 60G3 and realizes the various GPS-specified AF biochemical liquid spray control, monitoring, data logging and management functions supported by the system network of the present invention.

### Specification of GPS-Tracking Mobile Remotely-Controllable Atomizing Spray Cannon System for Spraying Environmentally-Clean Fire-Inhibiting Chemical Liquid on Buildings and Ground Surfaces

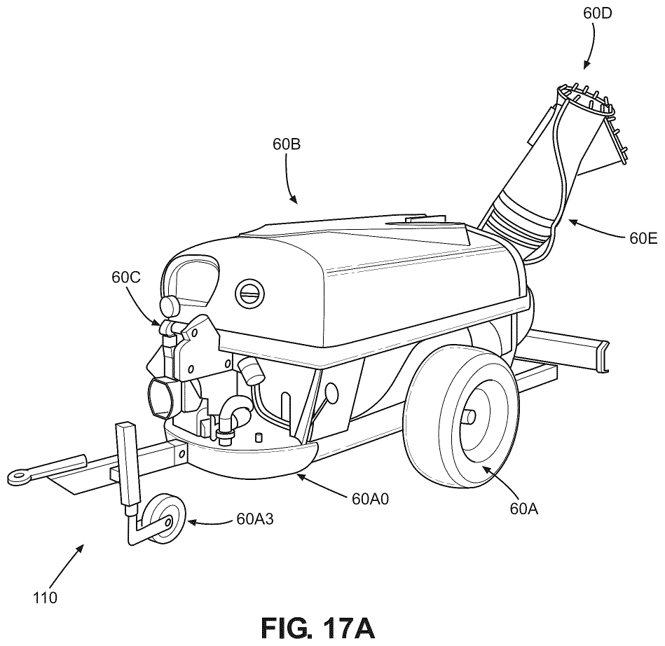

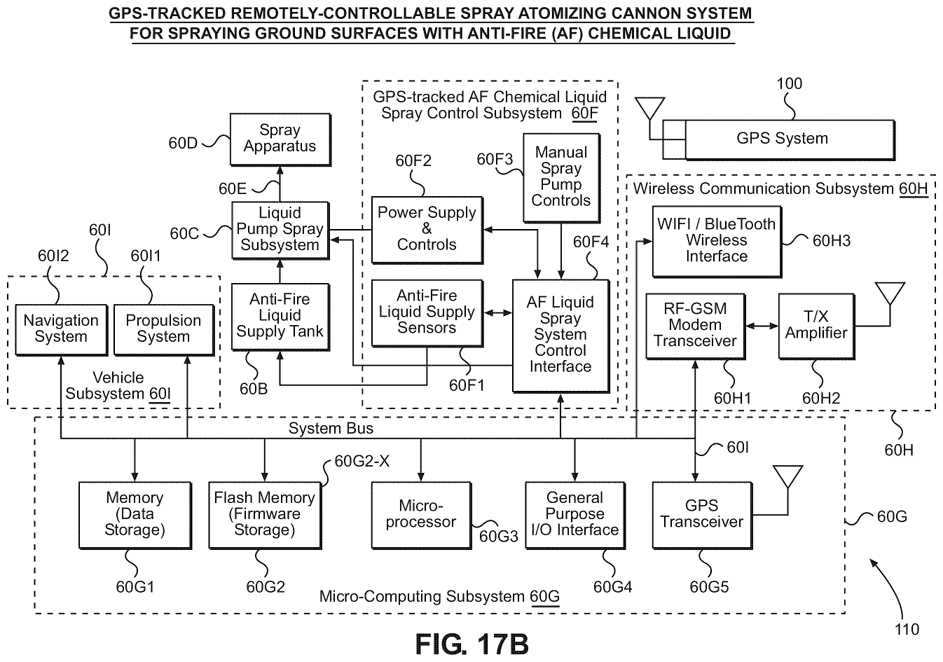

FIG. 17A shows a mobile GPS-tracked atomizing spray cannon (ASC) system 110 adapted for misting and spraying environmentally-clean anti-fire (i.e. fire extinguishing) biochemical liquid on ground surfaces in accordance with the principles of the present invention.

As shown in FIG. 17A, the GPS-tracked mobile spraying cannon system 110 comprises: a lightweight frame/chassis 60A0 supporting a propulsion subsystem 60I provided with a set of wheels 60A1-60A4, driven by combustion-engine, and controlled and navigated by a GPS-guided navigation subsystem 60I2; an integrated supply tank 60B supported on the frame 60A0, and connected to a gasoline/diesel operated motor-driven spray pump, 60C, for deployment on private and public property parcels; a spray nozzle assembly 60D connected to the spray pump 60C by way of a hose 60E, for misting and/or spraying the same with environmentally-clean anti-fire (AF) liquid under the control of GPS-specified coordinates defining its programmed path when operating to suppress or otherwise fight wild fires.

FIG. 17B shows the GPS-tracked anti-fire liquid spraying system 110 of FIG. 17A as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 60F by way of a system bus 60I; a wireless communication subsystem 60H interfaced to the micro-computing platform 60G via the system bus 50I; and AI-driven or manually-driven navigation subsystem 60I2.

As configured in the illustrative embodiment, the GPS-tracked anti-fire liquid spraying cannon system 110 enables and supports (i) the remote monitoring of the spraying of anti-fire (AF) chemical liquid from the system 110 when located at specific GPS-indexed location coordinates, and (ii) the logging of all such GPS-indexed spray application operations, and recording the data transactions thereof within a local database maintained within the micro-computing platform 60G, as well as in the remote network database 9C1 maintained at the data center 8 of the system network 1.

As shown in FIG. 17B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 110. As such, the micro-computing platform 60G is suitably configured to support and run a local control program 60G2-X on microprocessor 60G3 and memory architecture 60G1, 60G2 which is required and supported by the enterprise-level mobile application 12 and the suite of services supported by the system network 1 of the present invention.

As shown in FIG. 17B, the wireless communication subsystem 50H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

As shown in FIG. 17B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF chemical liquid at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system network of the present invention.

Specification of an Exemplary Network Database Schema for Supporting the System Network of the Present Invention and GPS-Specified Operations Involving the Spraying of Fire Inhibiting Chemical Liquid on GPS-Specified Ground, Property and Building Surfaces in Regions at Risk Prior to and During the Outbreak of Wild Fires

FIG. 18 shows an exemplary schema for the network database (RDBMS) 9C1 supported by the system network of the present invention, showing the primary enterprise level objects supported in the database tables created in the network database 9C using the schema, and the relationships that are specified or indicated. This exemplary database schema is for supporting the system network of the present invention and GPS-specified operations involving the spraying of anti-fire (i.e. fire inhibiting) biochemical liquid on GPS-specified ground, property and building surfaces in regions at risk prior to and during the outbreak of wild fires.

As shown in FIG. 18, the exemplary database schema for the system network 1 includes a number of high-level enterprise objects such as, for example: Users, with properties including User ID, Residence, Age, User Class (e.g. Wild Fire Management Administrator, Wild Fire Spray Applicator, Real Property Owner, Home Owner, Business Owner, Property Owner, Resident, etc.), and Pets; Real Property, with properties including Ownership/Lease, Location, Buildings, GPS Addresses, County, State; Vehicles, with properties such as Model, Year, Brand, Registered Owner; Water Crafts, with properties Model, ID #etc.; Anti-Fire Chemical Liquid Supplies, with properties Manufacturer, Location, Quantity, Date Delivered; Anti-Fire (AF) Liquid Spraying Aircraft Systems, with properties Manufacturer, Model, ID #; Anti-Fire Liquid Spraying Ground Systems, including Manufacturer, Model, ID #; Portable Anti-Fire Liquid Spraying Systems; Anti-Fire (AF) Chemical Liquid Spray Application Orders, including Location, ID #; Anti-Fire Chemical Liquid Spray Application Reports, with properties such as State, County, GPS Addresses; and Weather Data, with properties State, County, and GPS Addresses.

### Specification of Exemplary Graphical User Interfaces Supported on the Mobile Application Deployed on System Network of the Present Invention, for the Purpose of Delivering the Various Services Supported on the System Network

FIG. 19 illustrates an exemplary wire-frame model of a graphical user interface (GUI) 13 of the mobile application 120 for use by registered users (e.g. property parcel owners, contractors and/or agents, and other stakeholders on the system network) to request and receive services supported by the system network of the present invention. As shown in this exemplary GUI screen 13, supports a number of pull-down menus under the titles: messages 13A, where the user can view messages sent via messaging services supported by the application; maps 13B, where wild fires have been identified and mapped, tracked and ranked in terms of risk to the user and associated property; and tasks 13C, where AF liquid spray tasks have been scheduled, have been completed, or are in progress, by the user.

FIG. 19A shows an exemplary graphical user interface supported by the mobile application 12 showing a user updating the registration profile as a task on the system network. The GUI screen is accessed and delivered to LCD screen of the mobile computing device 11 when the user selects the Tasks menu to display a menu of commands, and then selects the Update command from the command menu. During this service, the user can update various information items relating to the user profile, such as, name and address, contact information (e.g. email and SMS number), property parcel linked to one's profile, and GPS-tracked spray system deployed or assigned to the user and/or property parcel(s).

FIG. 19B shows an exemplary graphical user interface supported by the mobile application 12 showing a user receiving a message “notice of request to wild-fire spray protect a property parcel” (via email, SMS messaging and/or push-notifications) issued from the command center 19 to spray GPS-specified private property parcel(s) with clean anti-fire (AF) chemical liquid and registered GPS-tracked spray equipment.

FIG. 19C shows an exemplary graphical user interface supported by the mobile application 12 showing a user receiving a notice of order (via email, SMS messaging and/or push-notifications) to wild-fire spray-protect GPS-specified public property parcel(s) with clean anti-fire (AF) liquid to create and maintain a GPS-specified public firebreak (e.g. Firebreak No. 120).

FIG. 19D shows an exemplary graphical user interface supported by the mobile application showing a user requesting a refill of clean anti-fire (AF) chemical liquid for supply to GPS-specified spray equipment registered on the system network. The user selects the Tasks menu to display a set of commands, and then selects the Refill command from the displayed command menu. The user confirms the refill order and when ready selects the Send Request command from the display screen, sending the command to the command center 19 and related data center 8 for processing and fulfillment. All operations are logged and tracked in the system network database 9C1 shown in FIG. 4A.

In the illustrative embodiment, the mobile application 12 on mobile computing device 11 supports many functions to provide many services: (i) sends automatic notifications from the command center 19 to home/business owners with the mobile application 12, instructing them to spray their real property and home/building at certain times with anti-fire (AF) liquid contained in the tanks of GPS-tracked AF liquid spraying systems 20, 30, 40, 40, 50 and 60; (ii) automatically monitors consumption of sprayed AF-liquid and generate auto-replenish order (via its onboard GSM-circuits) so as to achieve compliance with the home/neighborhood spray defense program, and report AF chemical liquid levels in each home-owner tank; and (iii) shows status of wild fire risk in the region, and actions to the taken before wild fire outbreak.

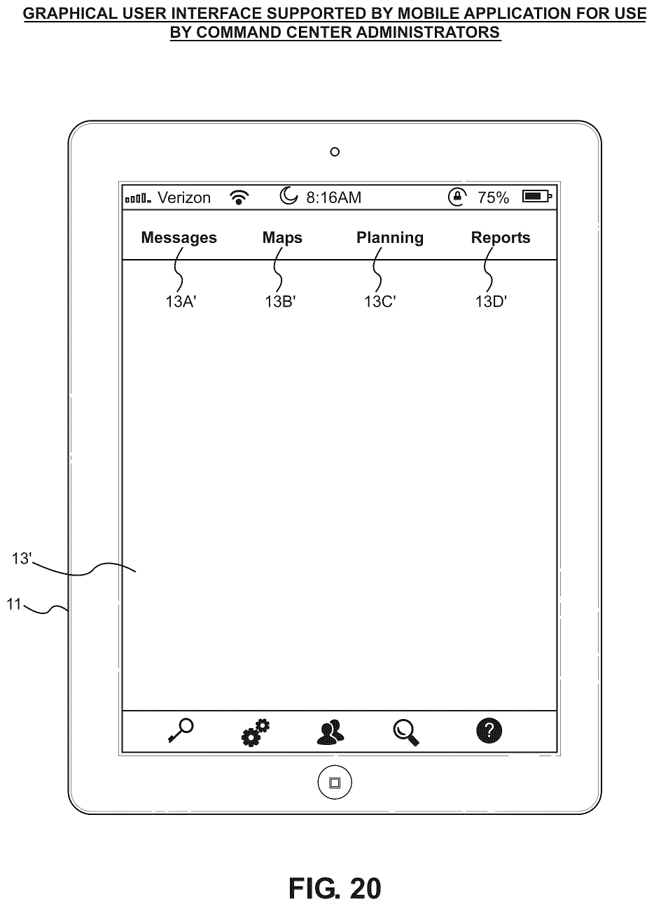

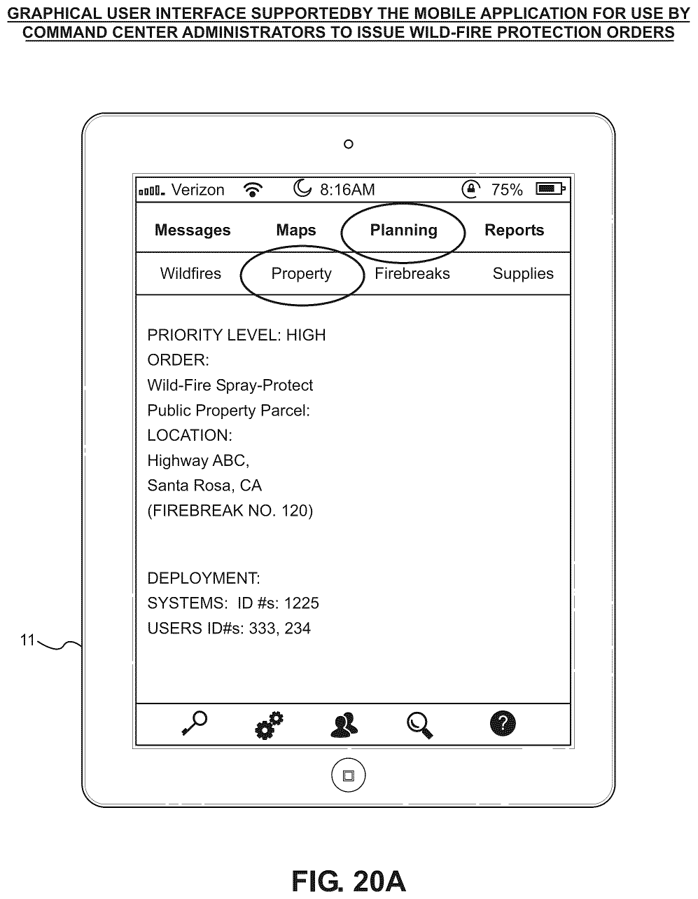

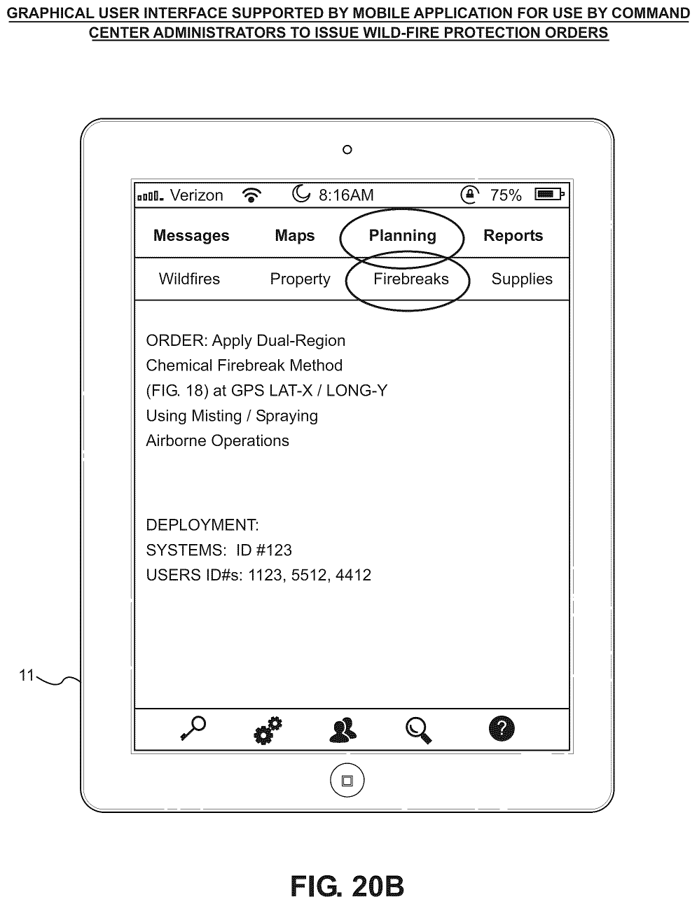

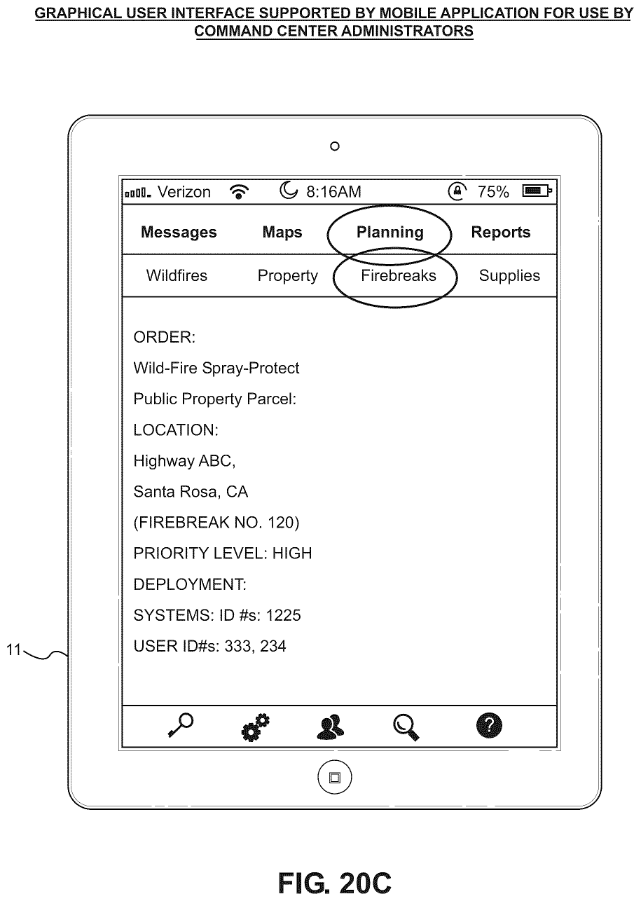

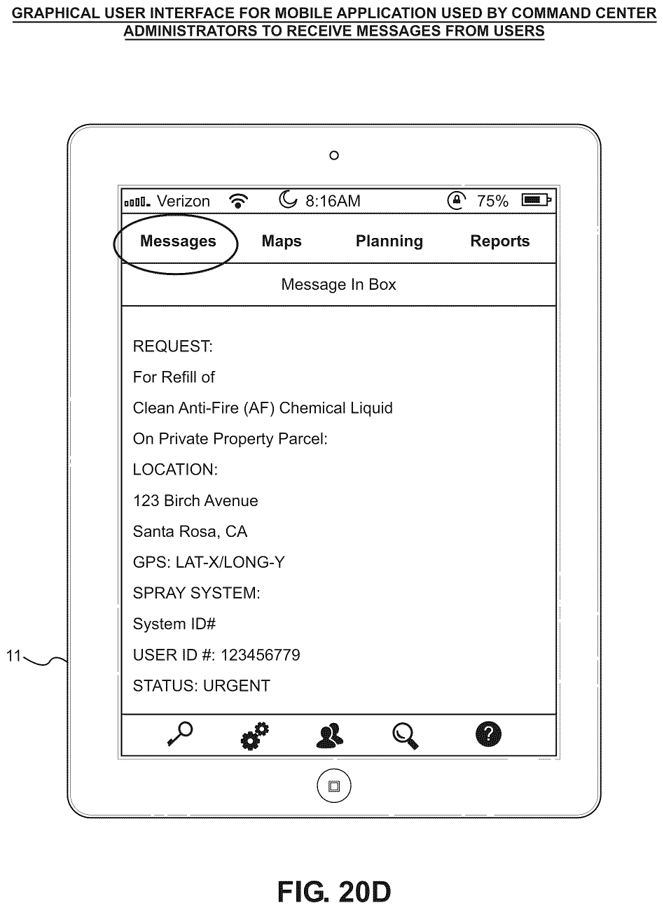

FIG. 20 shows an exemplary graphical user interface 13′ supported by the mobile application 12 configured for use by command center administrators to issue wild-fire protection orders, plan wild-fire protection tasks, generate wild-fire and protection reports, and send and receive messages to users on the system network, to carry out a wild fire suppression and management program in the region where the system network is deployed. As shown, GUI screen 13′ supports a number of pull-down menus under the titles: Messages 13A′, where project administrator and spray technicians can view messages sent via messaging services supported by the application; Maps 13B′, where wild fires have been identified, tracked, and ranked in terms of risk to certain regions at a given moment in time; Planning 13C′, wherein plans have been have been made to fight wild fires using the methods described in FIGS. 24 through 32B, status of specific plans, which one are in progress; and Reports 13D′, where reports are issued to the mobile application 12 running on mobile client systems 11 in operable communication with the web, application and database servers 9A, 9B and 9C at the data center 8, supported by the system network 1.

FIG. 20A shows an exemplary graphical user interface supported by the mobile application configured for use by command center administrators to issue wild-fire protection orders using the system network of the present invention. As shown, the user selects the Planning menu and displays a set of planning commands, and then selects the Property command, where the user is then giving to choose to select one or more parcels of property in each region, and then select an Action (e.g. Wild Fire Spray Protect). The users select the property parcel(s), and then the required Action (i.e. Wild Fire Spray Protect), and Order is set up for the command center action. When the command center selects execute from the menu, the system network issues the order and sends notice of orders to all property parcel owners or agents to oversee the immediate spraying of the GPS-specified property parcels with clean anti-fire (AF) chemical liquid supply to the property owners or agents.

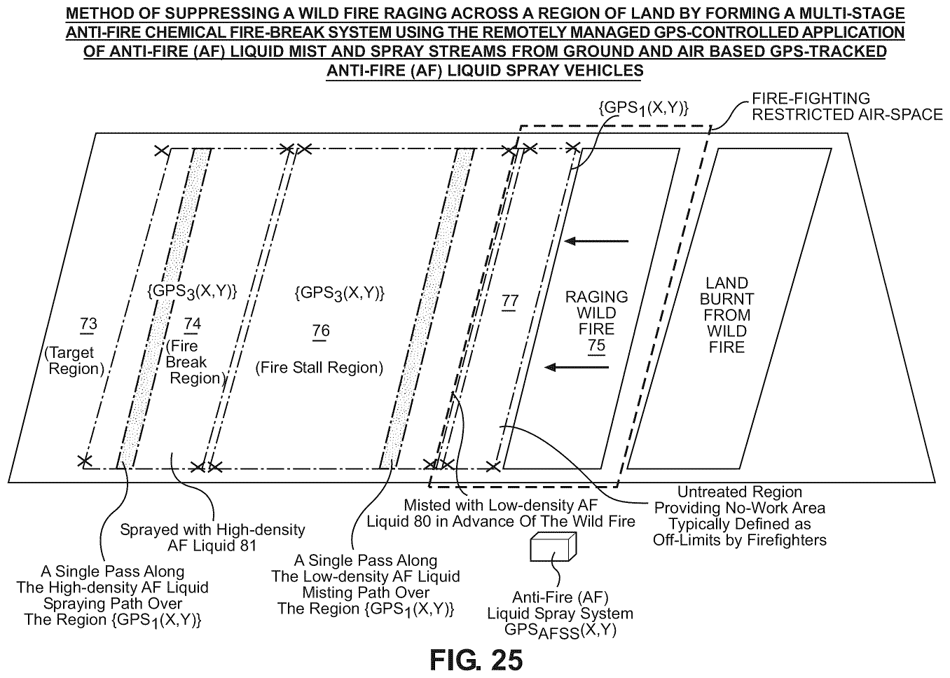

FIG. 20B shows an exemplary graphical user interface supported by the mobile application 12 configured for use by command center administrators to issue wild-fire protection orders involving the creation and maintenance of a clean AF-based chemical firebreak, as illustrated in FIG. 25, for example, using the methods of the present invention described herein. As shown, the administrator selects the Planning menu, and displays a menu of Planning commands, from which the user selects Firebreaks. In the case example shown in FIG. 20B, the administrator issues an Order to apply or rather practice the dual-region clean AF chemical firebreak method illustrated in FIG. 25, at GPS-specified coordinates GPS LAT-X/LONG-Y using AF chemical liquid misting and spraying airborne operations. As shown the order will specify the deployment of specific GPS-tracked AF spray vehicle systems, and identify them by system ID #. The order may also identify or request users (e.g. pilots) assigned to the AF chemical firebreak project/task.

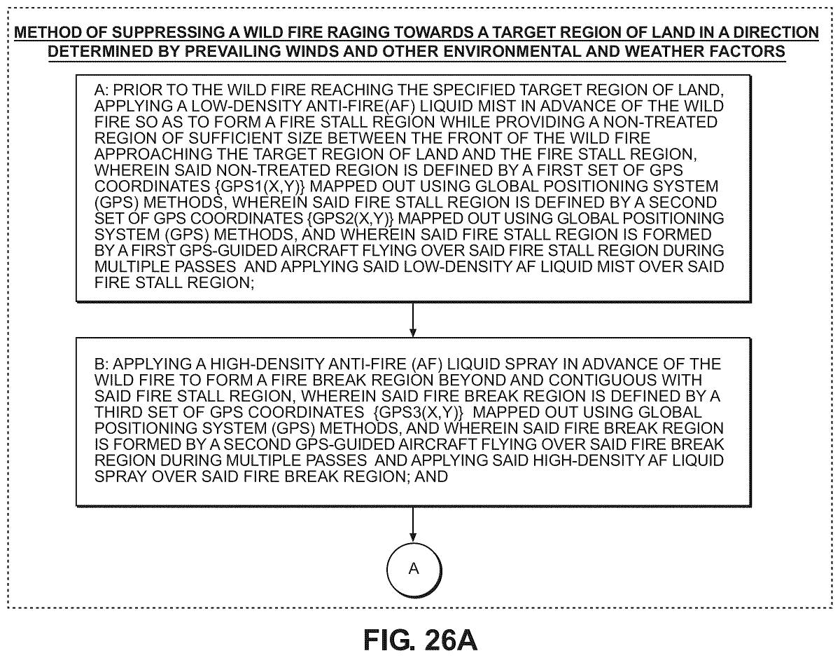

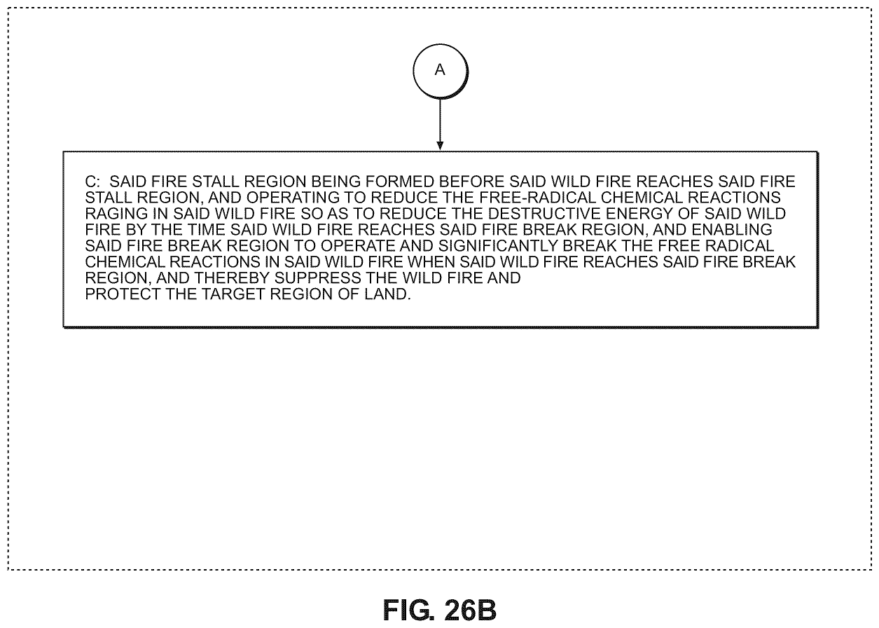

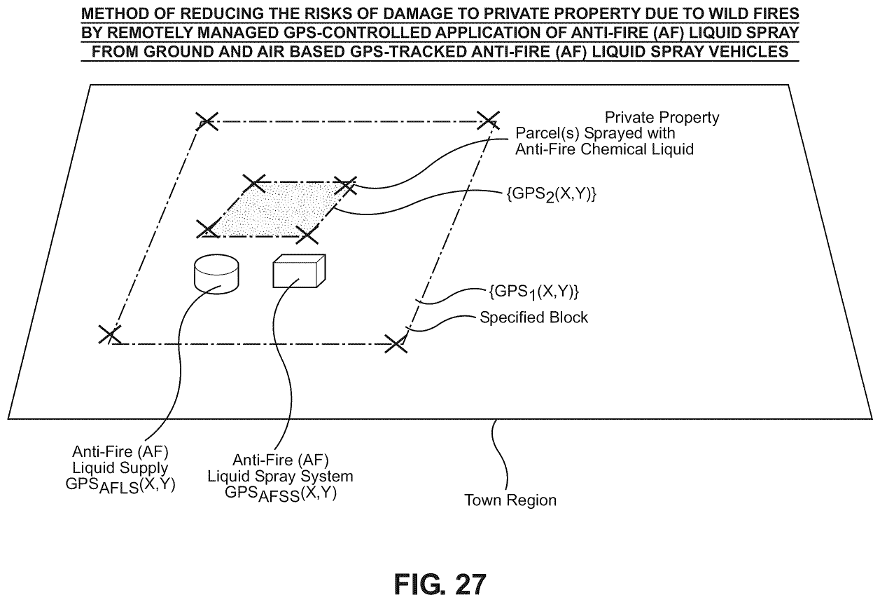

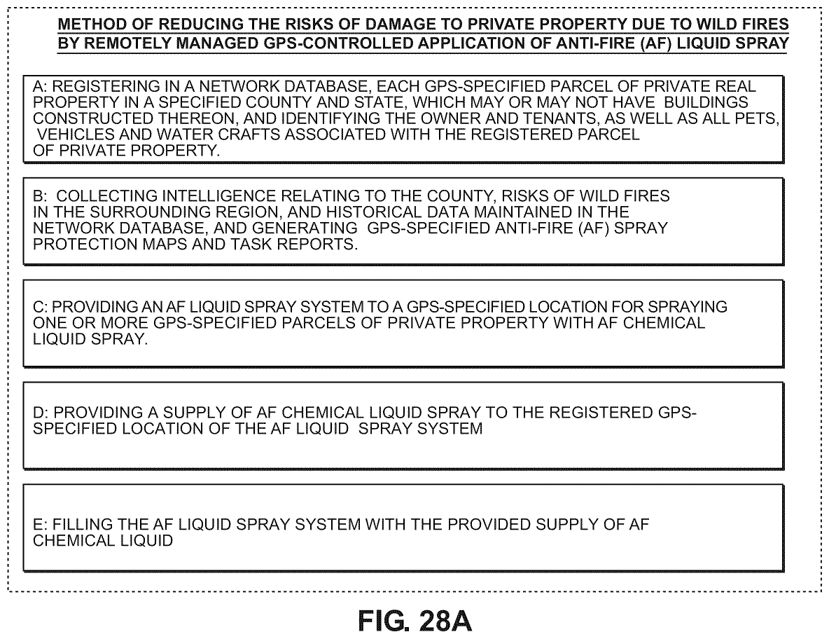

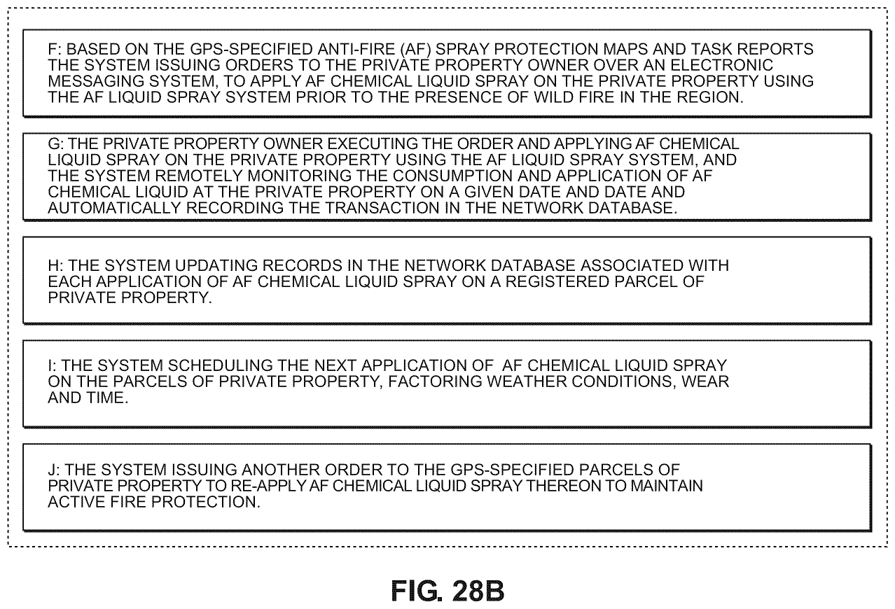

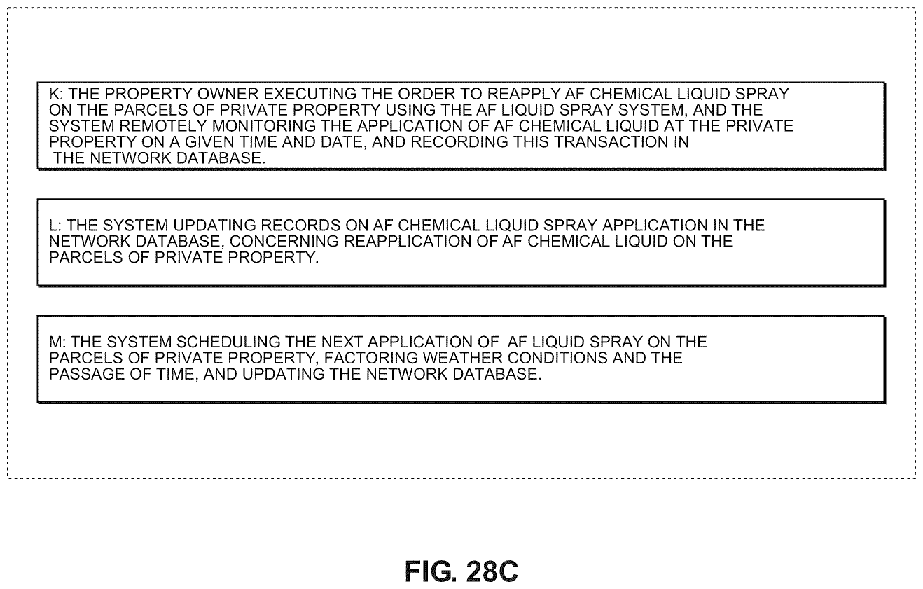

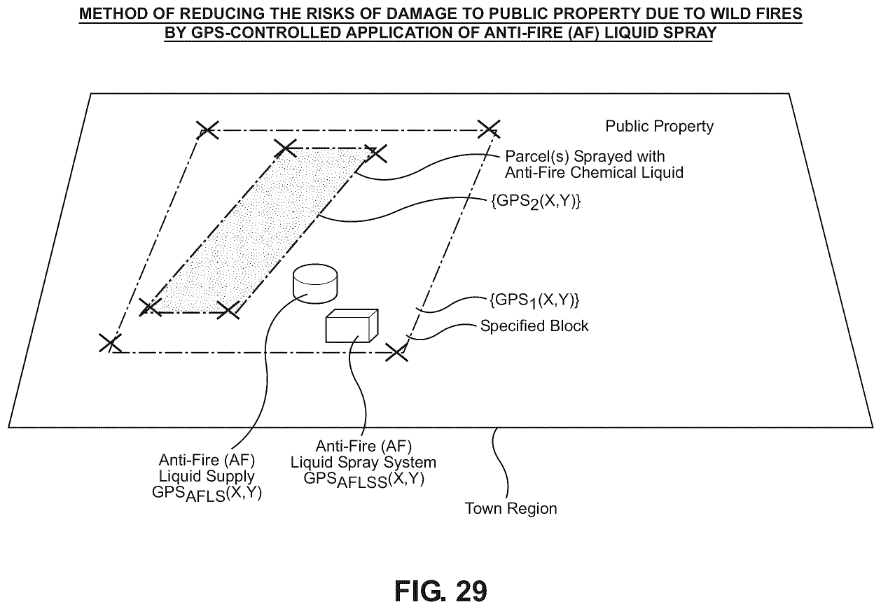

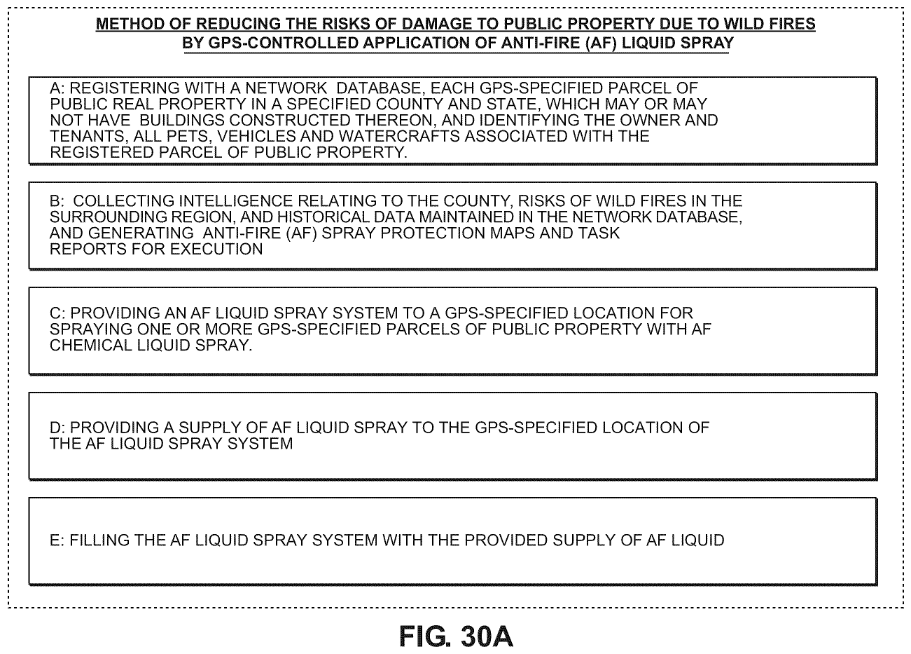

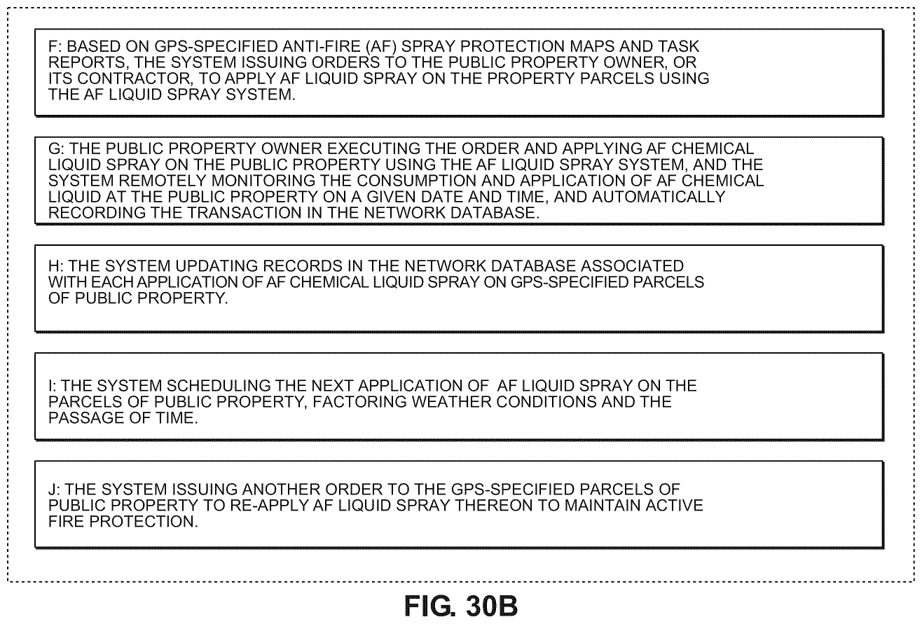

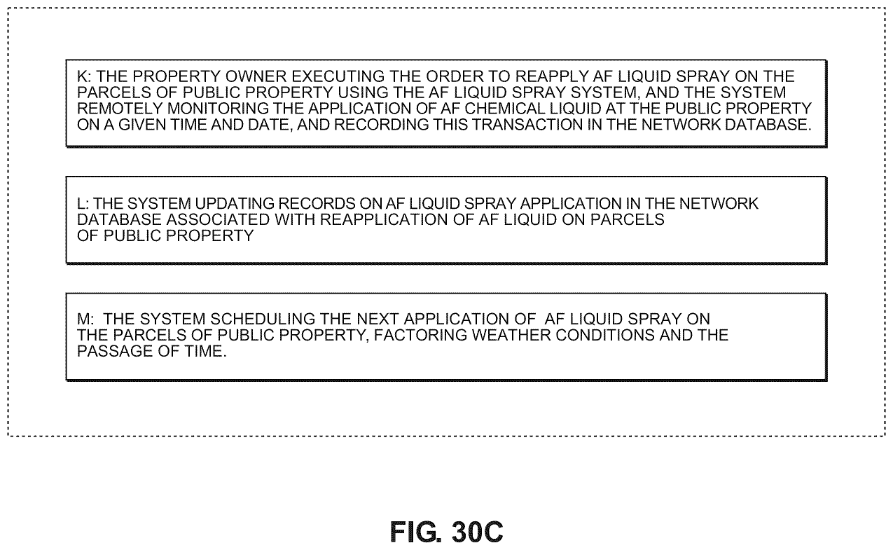

FIG. 20C shows an exemplary graphical user interface supported by mobile application 12 configured for use by command center administrators to order the creation and/or maintenance of a GPS-specified clean fire-inhibitor based chemical firebreak on one or more public/private property parcels. As shown, the administrator selects the Planning menu, and displays a menu of Planning commands, from which the user selects Firebreaks. In the case example shown in FIG. 13C, the administrator issues an Order to practice the Wild Fire Spray Protect Method alongside one or more parcels of public property, which may be a long strip of land/brush alongside or near a highway. The method may be the AF chemical firebreak method as illustrated in the FIG. 25 and described in FIGS. 26A, 26B and 26C, at GPS-specified coordinates GPS LAT-X/LONG-Y using ground-based AF chemical liquid spraying operations. As shown, the order will specify the deployment of specific GPS-tracked AF spray vehicle systems, and identify them by system ID #. The order may also identify or request users (e.g. drivers) assigned to the AF chemical firebreak project/task. Alternatively, the method disclosed in FIGS. 28A through 28C can be used to construct the clean biochemistry fire break shown in FIG. 27, and the method disclosed in FIGS. 30A, 30B and 30C can be used to construct the clean chemistry wildfire break shown in FIG. 29.

FIG. 20D shows an exemplary graphical user interface for mobile application configured used by command center administrators to receive messages from users including property owners and contractors, requesting refills for environmentally-clean fire inhibiting (i.e. anti-fire or AF) chemical liquid for GPS-specified spray system equipment.

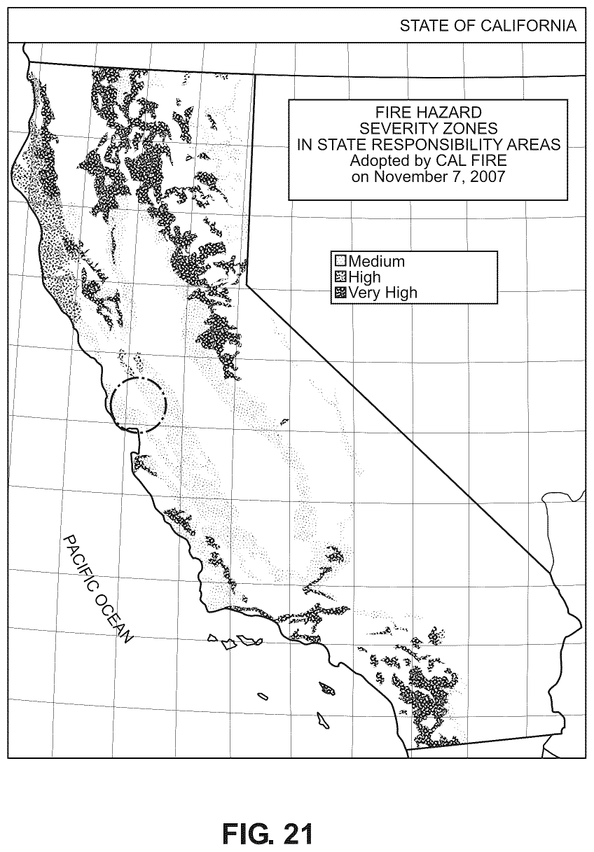

FIG. 21 shows an exemplary fire hazard severity zone (FHSZ) map generated by the CAL FIRE® System in state responsibility areas of the State of California. Such maps can be used by the system network 1 to inform the strategic application of environmentally-clean anti-fire (AF) liquid spray using the system network of the present invention. Such maps also can be displayed on the mobile application 12 to provide greater awareness of risks created by wild fires in a specific region, at certain moments in time.

### Specification of an Exemplary Anti-Fire (AF) Spray Protection Map Generated by the System Network of the Present Invention

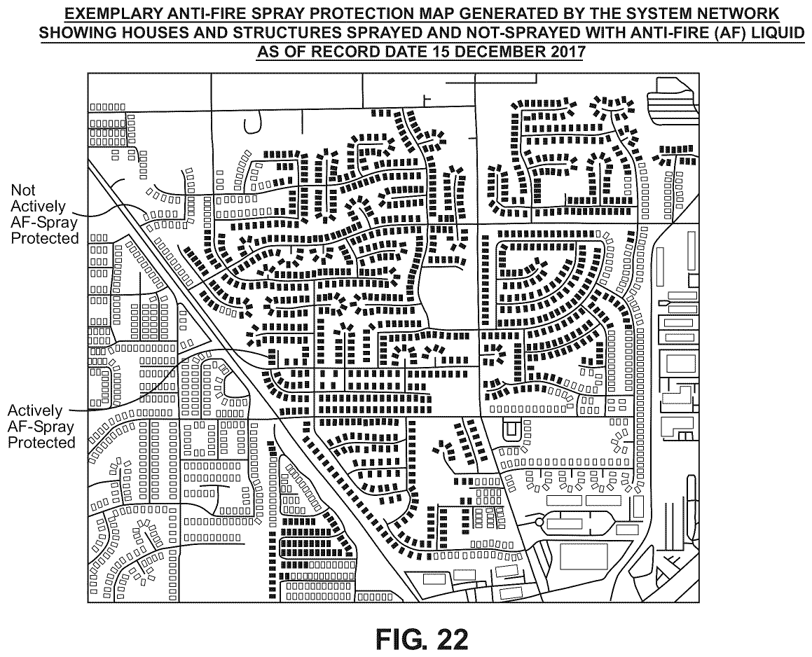

FIG. 22 shows an exemplary GPS-specified anti-fire (AF) biochemical liquid spray protection map generated by the system network 1, showing properties, houses and buildings that were sprayed, and not-sprayed, with state/county-issued anti-fire liquid as of report date, 15 Dec. 2017. The system network will periodically update these AF chemical liquid spray protection maps (e.g. every 5 minutes or less) for display to users and neighbors to see whose property/land parcels and homes/building have been spray protected with anti-fire (AF) biochemical liquid of the present invention, and whose parcels and home/buildings have not been AF-spray protected against wild fires, so that they can or may volunteer to lend a helping hand in spray protecting their neighbors properties as time and anti-fire chemical supplies allow, to provide a stronger defense against one or more wild fires raging towards their neighborhood.

In accordance with the principles of the present invention, the application servers 9B supported by the system network 1 will automatically generate anti-fire (AF) chemical liquid spray-protection task reports, as illustrated in FIG. 23, based on the analysis of spray-protection maps as shown in FIG. 22, and based on many other kinds of intelligence collected by the system, and analyzed by human analysts, as well as artificial intelligence (AI) expert systems. Based on such automated intelligence efforts, the application servers 9B will generate periodically, and as needed, AF chemical liquid (AFCL) Spray Command Program files containing GPS/Time-Frame-indexed commands and instructions that are wirelessly transmitted to assigned GPS-tracked anti-fire (AF) chemical liquid spraying systems 30, 40, 50, 60, 70, 80, 90, and 110 so that the operators of such GPS-tracked biochemical liquid spraying systems will know when and where to mist and/or spray AF biochemical liquid over and one certain GPS-specified properties, in their effort to defend against the threat of wild fires.

The AFCL Spray Command Program files, containing GPS-indexed commands and instructions, generated by the application servers 9B are transmitted over the system network 1 to the numerous deployed GPS-tracked AF liquid spraying systems 30, 40, 50, 60, 70, 80, 90, and 110 so as to orchestrate and choreograph the spray application of clean anti-fire (AF) chemical liquid over GPS-specified properties, before and during the presence of wild fires, so as to implement an orchestrated strategic and collective defense against wild fires that break out for various reasons, threatening states, counties, towns, neighborhoods homes, business, and human and animal life.

In some embodiments, the application servers 9B will generate and issue AFCL Spray Command Program files that are transmitted to specific GPS-tracked AF liquid spraying systems 30, 40, 50 60, 70, 80, 90, and 110 and containing automated instructions (i.e. commands) on when and where (i.e. in terms of time frame and GPS-specified coordinates) the GPS-tracked AF liquid spraying systems should automatically apply, via spraying operations, clean AF biochemical liquid on GPS-specified property during their course of movement over land. During such spraying operations, the system network 1 will automatically meter, dispense and log how much clean AF chemical liquid has been sprayed over and on certain GPS-specified properties. Real-time wind-speed measurements can be made and used to compensate for spraying operations in real-time, as may be required under certain weather conditions.

In other embodiments, the application servers 9B will generate and issue AFCL Spray Command Program files that are transmitted to other GPS-tracked AF liquid spraying systems 30, 40, 50, 60, 70, 80, 90, and 110 providing automated instructions (i.e. commands) on when and where the GPS-tracked AF liquid spraying systems should spray-apply clean AF chemical liquid on GPS-specified property during course of movement over land, but allowing the human operator to override such spraying instructions, and compensate and ensure greater accuracy, using human operator skill and judgment during spraying operations. While such spraying operations, the system will automatically meter, log and record all dispensed AF biochemical liquid sprayed over and over certain GPS-specified properties under the supervision and control of the human operator.

### Specification of an Exemplary Anti-Fire Spray Protection Task Report Generated by the System of the Present Invention

FIG. 23 shows an exemplary GPS-specified anti-fire spray protection task report generated by the system network 1 for state/county xxx on 15 Dec. 2017, indicating which properties on what streets, in what town, county, state, requires the reapplication of AF chemical liquid spray treatment in view of factors such as weather (e.g. rainfall, sunlight) and passage of time since last spray application. Such task reports will be transmitted by the command center 19 to registered users, along with an SMS and/or email message to attend to the AF spray task, so the requested user will promptly spray protect their land parcels and home with clean AF chemical liquid, as conditions require or suggest, using the mobile/portable GPS-tracked AF liquid spraying system 20 assigned to the property owner, and deployed over the system network 1.

As contracted AF-spray operators, and home owners alike, protect properties and homes using the GPS-tracked AF liquid spraying systems (20, 30, 40, 50, 60 70, 80, 90, and 110) the system network 1 automatically receives GSM or other RF-based signals transmitted from the GPS-tracked anti-fire (AF) chemical liquid spraying systems, indicating that certain amounts of AF chemical liquid has been dispensed and sprayed from the system onto GPS-specified property. Notably, the amounts of AF chemical liquid dispensed and sprayed from the system over and onto GPS-specified property should closely match the amounts requested in the task report transmitted to the user, to achieve the AF spray protection task directed by AI-driven management processes supported by the wild fire defense system network of the present invention.

Specification of New and Improved Wild Fire Suppression Methods in Accordance with Principles of the Present Invention

Having described the various GPS-tracked anti-fire (AF) chemical liquid spraying systems of the illustrative embodiments 20, 30, 40, 50 60, 70, 80, 90, and 110 shown in the Figure Drawings, and the various functions supported by the mobile application 12 supported by the data center 8 of the system network 1, it is appropriate at this juncture to now described the various new and improved wild fire suppression methods in accordance with principles of the present invention, each involving GPS-guided spray application of clean anti-fire (AF) chemical liquid having a chemistry that works to break a wild fire by interfering with the free-radicals produced during the combustion phase of a ranging wild fire. The benefits and advantages provided by such new and improved methods will become apparent hereinafter.

### Specification of a Method of Suppressing a Wild Fire Raging Across a Region of Land in the Direction of the Prevailing Winds

FIG. 24 shows a plan view of a wild fire 70 emerging from a forest region 71A and approaching a neighboring town 72 surrounded by other forest regions 71B, 71B and 71C, and moving in the direction determined by prevailing winds, indicated by a pair of bold arrows. This example closely resembles the pathway of many wild fires recently destroying countless acres of land (i.e. real property) in the State of California in 2017 and beyond.

FIG. 25 illustrates the various steps involved in carrying out the method of suppressing a wild fire raging across a region of land using the method of the present invention. Specifically, the method involves forming a multi-stage anti-fire chemical fire-break system illustrated in FIG. 25 using the remotely-managed GPS-controlled application of both anti-fire (AF) liquid mist streams and AF chemical liquid spray streams from ground and air-based GPS-tracked anti-fire (AF) liquid spray vehicles, as illustrated for example in FIGS. 8A through 17B.

As illustrated in FIG. 25, the method generally involves: (a) applying, prior to the wild fire reaching the specified target region of land 74, a low-density anti-fire (AF) liquid mist stream in advance of the wild fire 75 so as to form a fire stall region 76, while providing a non-treated region 77 of sufficient size between the front of the wild fire 75 approaching the target region of land 73 and the fire stall region 76; and (b) applying a high-density anti-fire (AF) liquid spray stream in advance of the wild fire 75 to form a fire break region 74 beyond and contiguous with the fire stall region 76, and also continuous with the target region 73 to be protected from the wild fire.

As illustrated in FIG. 25, the fire stall region 76 is formed before the wild fire reaches the fire stall region 76. The fire stall region 76 operates to reduce the free-radical chemical reactions raging in the wild fire 75. This fire stall region 76 helps to reduce the destructive energy of the wild fire by the time the wild fire reaches the fire break region 74, and enabling the fire break region 74 to operate and significantly break the free radical chemical reactions in the wild fire 75 when the wild fire reaches the fire break region 74. This helps to suppress the wild fire 75 and protect the target region of land 73.

FIGS. 26A and 26B describe the method of suppressing a wild fire raging towards a target region of land 73 (and beyond) in a direction determined by prevailing winds and other environmental and weather factors, as illustrated in FIG. 25. Typically, the system used to practice this method of the present invention will employ a centralized GPS-indexed real-property/land database system 7 shown in FIG. 4 containing GPS-indexed maps of all land regions under management and fire-protection, developed using methods, equipment and services known in the GPS mapping art. Such GPS-indexed maps will contain the GPS coordinates for the vertices of each parcel in any given state, county, and town in the country in which system is deployed. As shown in FIG. 4A, this central GPS-indexed real property database 7 will be operably connected to the TCP/IP infrastructure 10 of the Internet, and accessible by system network 1 of the present invention.

As indicated at Block A in FIG. 26A, prior to the wild fire reaching the specified target region of land, a GPS-tracked AF spray vehicle 50 as shown for example in FIG. 11A applies a low-density anti-fire (AF) liquid mist 80 in advance of the wild fire so as to form a fire stall region 76 while providing a non-treated region 77 of sufficient size between the front of the wild fire approaching the target region of land 73 and the fire stall region 76. The fire stall region 76 is formed by a first GPS-guided aircraft system flying over the fire stall region during multiple passes and applying the low-density AF chemical liquid mist 80 over the fire stall region 76. The non-treated region 77 is defined by a first set of GPS coordinates {GPS₁(x,y)} and, the fire stall region 76 is defined by a second set of GPS coordinates {GPS₂(x,y)}. Each of these regions are mapped out using global positioning system (GPS) methods, the GPS-indexed land database system 7, drone-type aircraft systems 40 as shown in FIG. 10A, and space-based land-imaging satellites 14 having multi-spectral imaging capabilities, and operably connected to the infrastructure of the Internet. When used alone and/or together, these systems can capture real-time intelligence on the location and spread of a particular wild fire, its direction of propagation, intensity, and other attributes. This captured data is provided to application servers in the data center 8 which, in turn, generate GPS coordinates determining the planned pathways of the GPS-traced AF chemical liquid spraying/misting aircraft systems, to provide the anti-fire protection over the GPS-indexed fire stall region 76 and GPS-specified non-treated region 75, as described in greater detail below.

As indicated at Block B in FIG. 26A, a second GPS-tracked AF spray vehicle 50 as shown in FIG. 11A, or other suitable spraying vehicle deployed on the system network, applies a high-density anti-fire (AF) liquid spray 81 over the land in advance of the wild fire to form a GPS-specified fire break region 74 beyond and contiguous with the GPS-specified fire stall region 76. The fire break region 74 is formed by the second GPS-guided aircraft flying over the fire break region 74 during multiple passes and applying the high-density AF chemical liquid spray 81 over the fire break region 74. The fire break region 74 is defined by a third set of GPS coordinates {GPS₃(x,y)} mapped out using global positioning system (GPS) methods, the GPS-indexed land database system 7, drone-type aircraft systems as shown in FIG. 8A, and/or space-based land-imaging satellites 14 having multi-spectral imaging capabilities, and operably connected to the infrastructure of the Internet. When used alone and/or together, these systems can capture real-time intelligence on the location and spread of a particular wild fire, its direction of propagation, intensity, and other attributes. This captured data is provided to application servers in the data center 8 which, in turn, generate GPS coordinates determining the planned pathways of the GPS-traced AF chemical liquid spraying/misting aircraft systems, to provide the anti-fire protection over GPS-specified fire break region 74, as described in greater detail below.

As indicated at Block C in FIG. 26B, the fire stall region 76 is formed before the wild fire 75 reaches the fire stall region 76, and operates to reduce the free-radical chemical reactions raging in the wild fire so as to reduce the destructive energy of the wild fire by the time the wild fire 75 reaches the fire break region 74, and enabling the fire break region 74 to operate and significantly break the free radical chemical reactions in the wild fire 75 when the wild fire reaches the fire break region 74, and thereby suppress the wild fire 75 and protect the target region of land 73 and beyond.

### Specification of a Method of Reducing the Risks of Damage to Private Property Due to Wild Fires by Managed Application of Anti-Fire (AF) Liquid Spray

FIG. 27 illustrates a method of reducing the risks of damage to private property due to wild fires by managed application of anti-fire (AF) liquid spray. FIGS. 28A, 28B and 28C illustrates a method of reducing the risks of damage to private property due to wild fires by managed application of anti-fire (AF) liquid spray. Typically, this method is carried out using the system network of FIG. 4A and any one or more of the GPS-tracked anti-fire (AF) liquid spray vehicle systems 14A through 14D represented in FIG. 4A and illustrated in FIGS. 8A through 17B.

As indicated at Block A in FIG. 28A, the system registers each GPS-specified parcel of private real property in a specified County and State, which may or may not have buildings constructed thereon, and identifying the owner and tenants, as well as all pets, vehicles and watercrafts associated with the registered parcel of private property. Typically, the system will request the address of the property parcel, and will automatically determine its GPS coordinates that specify the vertices of the parcel using databases, and data processing methods, equipment, and services, known in the GPS mapping art.

As indicated at Block B in FIG. 28A, the system collects intelligence relating to the County, risks of wild fires in the surrounding region, and historical data maintained in a network database, and generating GPS-specified anti-fire (AF) spray protection maps and task reports for execution.

As indicated at Block C in FIG. 28A, an AF chemical liquid spraying system is provided to a GPS-specified location for spraying one or more registered parcels of private property with AF chemical liquid spray.

As indicated at Block D in FIG. 28A, a supply of AF chemical liquid spray is provided to the GPS-specified location of the AF chemical liquid spraying system.

As indicated at Block E in FIG. 28A, the AF chemical liquid spraying system is provided with the supply of AF chemical liquid,

As indicated at Block F in FIG. 28B, based on the GPS-specified anti-fire (AF) spray protection maps and task reports, the system issues orders to the private property owner, or its contractor, to apply AF chemical liquid spray on the private property using the AF chemical liquid spraying system.

As indicated at Block G in FIG. 28B, the private property owner executes the order and applies AF chemical liquid spray on the private property using the AF chemical liquid spraying system, and the system remotely monitors the consumption and application of AF chemical liquid at the private property on a given time and date, and automatically records the transaction in the network database 9C prior to the arrival and presence of wild fire in the region.

As indicated at Block H in FIG. 28B, the system updated the records in the network database associated with each application of AF chemical liquid spray on a GPS-specified parcel of private property.

As indicated at Block I in FIG. 28B, the system scheduled the next application of AF chemical liquid spray on the GPS-specified parcel of private property, factoring weather conditions and the passage of time.

As indicated at Block J in FIG. 28B, the system issues another order to the GPS-specified parcel of private property to re-apply AF chemical liquid spray on the private property to maintain active wild fire protection.

As indicated at Block K in FIG. 28C, the property owner executes (i.e. carries out) the order to reapply AF chemical liquid spray on the parcel of private property using the AF chemical liquid spraying system, and the system remotely monitors the application of AF chemical liquid at the private property on a given time and date, and records this transaction in the network database 9C.

As indicated at Block L in FIG. 28C, the system updates records on AF chemical liquid spray application in the network database 9C associated with reapplication of AF chemical liquid on the parcel of private property.

As indicated at Block M in FIG. 28C, the system schedules the next application of AF chemical liquid spray on the parcel of private property, factoring weather conditions and the passage of time.

### Specification of a Method of Reducing the Risks of Damage to Public Property Due to Wild Fires, by Managed Spray Application of Fire Inhibiting Biochemical Liquid to Ground Cover and Building Surfaces Prior to the Arrival of Wild Fires

FIG. 29 illustrates a method of reducing the risks of damage to public property due to wild fires, by managed spray application of environmentally-clean fire-inhibiting (anti-fire) biochemical liquid of the present invention, to the exposed surfaces of ground cover and combustible building surfaces prior to the arrival of wild fires. FIGS. 23A, 23B and 23C illustrate a method of reducing the risks of damage to public property due to wild fires by managed application of anti-fire (AF) liquid spray of the present invention. Typically, this method is carried out using the system network of FIG. 4A and any one or more of the GPS-tracked anti-fire (AF) liquid spray vehicle systems 14A through 14D represented in FIG. 4A and shown in FIGS. 8A through 17B.

As indicated at Block A in FIG. 30A, each GPS-specified parcel of public real property in a specified County and State is registered with the system. Such parcels of property may or may not have buildings constructed thereon. As part of registration with the system network 1, supported by the network database 9C, it is necessary to identify the owner and tenants, as well as all pets, vehicles and watercrafts associated with the registered parcel of public property. Typically, the system will request the address of the property parcel, and will automatically determine its GPS coordinates that specify the vertices of the parcel using databases, and data processing methods, equipment, and services, known in the GPS mapping art.

As indicated at Block B in FIG. 30A, the system collects various kinds of intelligence relating to the County, risks of wild fires in the surrounding region, and historical weather and related data maintained in a network database 9C, and generates GPS-specified anti-fire (AF) spray protection maps and task reports for review and execution, along with GPS-specified spray plans (e.g. flight plans) for GPS-tracked anti-fire (AF) liquid spray vehicle systems 30 and 60, and GPS-specified spray plans.

As indicated at Block C in FIG. 30A an AF chemical liquid spraying system is provided to a GPS-specified location for spraying one or more registered parcels of public property with AF chemical liquid spray.

As indicated at Block D in FIG. 30A, a supply of AF chemical liquid spray is provided to the registered location of the AF chemical liquid spraying system.

As indicated at Block E in FIG. 30A, the AF chemical liquid spraying system is filled with the provided supply of AF chemical liquid.

As indicated at Block F in FIG. 30, based on the anti-fire (AF) spray protection maps and task reports, the system issues orders to the public property owner, or its contractor, to apply AF chemical liquid spray on the public property using the AF chemical liquid spraying system 60.

As indicated at Block G in FIG. 30B, the public property owner executes the order and applies AF chemical liquid spray on the public property using the AF chemical liquid spraying system, and the system remotely monitors the consumption and application of AF chemical liquid at the public property on a given time and date, and automatically records the transaction in the network database prior to the presence of wild fire in the region.

As indicated at Block H in FIG. 30B, the system updates records in the network database 9C associated with each application of AF chemical liquid spray on a GPS-specified parcel of public property.

As indicated at Block I in FIG. 30B, the system schedules the next application of AF chemical liquid spray on the GPS-specified parcel of public property, factoring weather conditions and the passage of time.

As indicated at Block J in FIG. 30B, the system issues another order to the GPS-specified parcels of public property to re-apply AF chemical liquid spray on the public property to maintain active fire protection.

As indicated at Block K in FIG. 30C, the property owner executes the order to reapply AF chemical liquid spray on the GPS-specified parcels of public property using the AF chemical liquid spraying system, and the system remotely monitors the application of AF chemical liquid at the public property on a given time and date, and records this transaction in the network database 9C.

As indicated at Block L in FIG. 30C, the system updates records on AF chemical liquid spray application in the network database 9C associated with reapplication of AF chemical liquid on the GPS-specified parcels of public property.

As indicated at Block M in FIG. 30C, the system schedules the next application of AF chemical liquid spray on the GPS-specified parcels of public property, factoring weather conditions and the passage of time.

### Specification of a Method of Remotely Managing the Application of Anti-Fire (AF) Liquid Spray to Ground Cover and Buildings so as to Reduce the Risks of Damage Due to Wild Fires

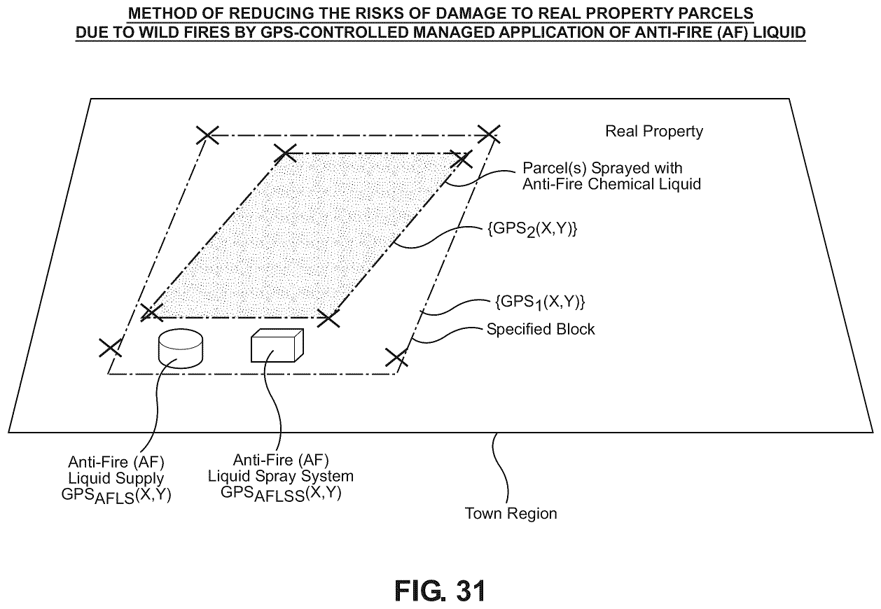

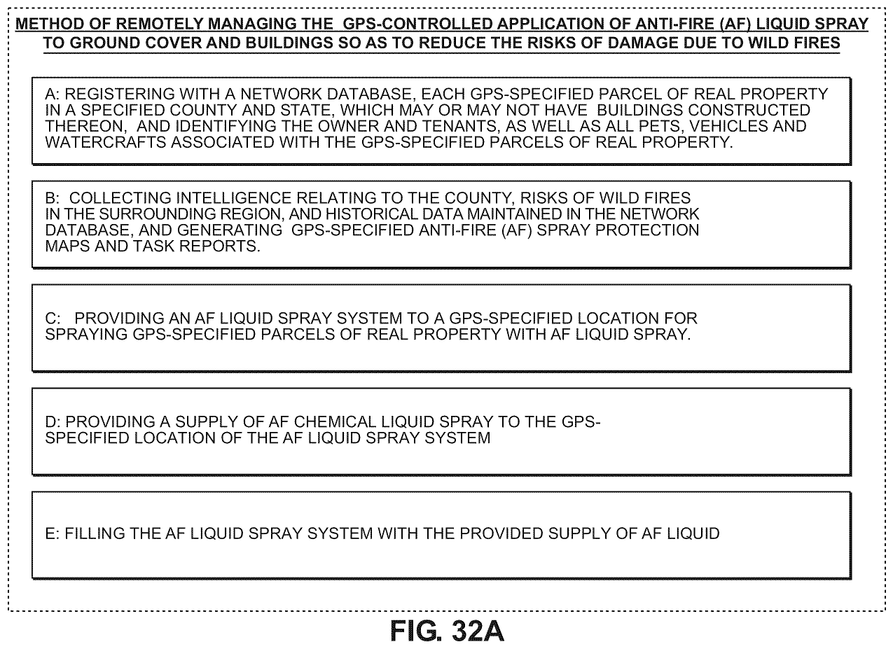

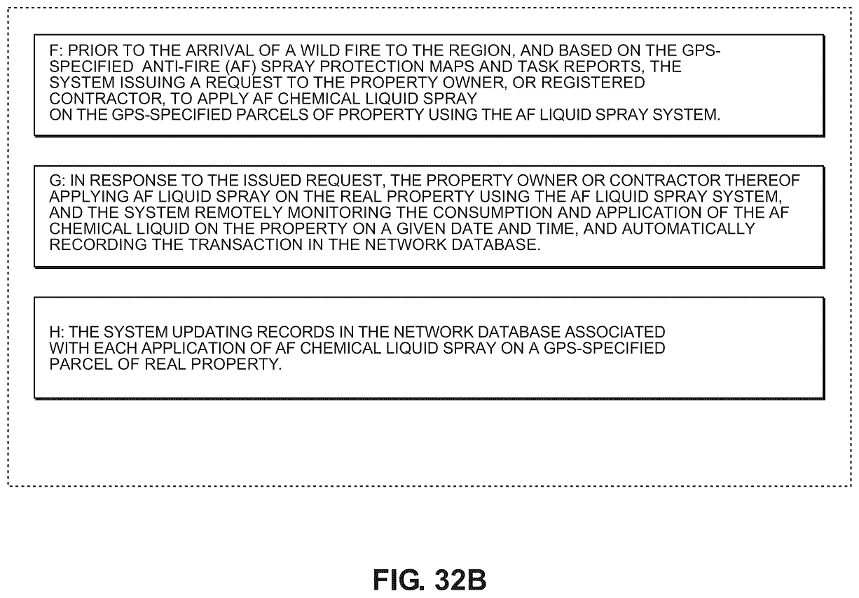

FIG. 31 is a graphical illustration showing a method of remotely managing the application of anti-fire (AF) liquid spray to ground cover and buildings to reduce the risks of damage due to wild fires. FIGS. 32A and 32B describes the high-level steps carried out by the method in FIG. 24 to reduce the risks of damage due to wild fires. Typically, this method is carried out using the system network of FIG. 4A and any one or more of the GPS-tracked anti-fire (AF) biochemical liquid spray vehicle systems 14A-14D represented in FIG. 4A and shown in FIGS. 8A, through 17B.

As indicated at Block A in FIG. 32A, the system registers each GPS-specified parcel of real property in a specified County and State, which may or may not have buildings constructed thereon, and identifying the owner and tenants, as well as all pets, vehicles and water crafts associated with the registered parcel of real property. Typically, the system will request the address of the property parcel, and will automatically determine (or estimate) its GPS coordinates that specify the vertices of the parcels using databases, and data processing methods, equipment, and services, known in the GPS mapping art. The GPS address of each parcel will be stored in the centralized GPS-indexed land database system 7 shown in FIG. 4

As indicated at Block B in FIG. 32A, the system collects intelligence relating to the County, risks of wild fires in the surrounding region, and historical data maintained in a network database, and generates GPS-specified anti-fire (AF) spray protection maps and task reports for execution.

As indicated at Block C in FIG. 32A, an AF chemical liquid spraying system is provided to a GPS-specified location for spraying the GPS-specified parcels of real property with AF chemical liquid spray.

As indicated at Block D in FIG. 32A, a supply of AF chemical liquid spray is provided to the GPS-specified location of the AF chemical liquid spraying system.

As indicated at Block E in FIG. 32A, the AF chemical liquid spraying system is filled with the provided supply of AF chemical liquid.

As indicated at Block F in FIG. 32B, prior to the arrival of a wild fire to the region, and based on the anti-fire (AF) spray protection maps generated by the system, the system issues a request to property owners, or their registered contractors, to apply AF chemical liquid spray on GPS-specified properties using deployed AF chemical liquid spraying systems.

As indicated at Block G in FIG. 32B, in response to the issued request, the property owner or contractor thereof applies AF chemical liquid spray on the real property using the AF chemical liquid spraying system, and the system remotely monitors the consumption and application of the AF biochemical liquid on the property on a given date, and automatically records the transaction in the network database.

As indicated at Block H in FIG. 32B, the system updates records in the network database associated with each application of AF chemical liquid spray on one or more GPS-specified parcels of real property.

In the illustrative embodiments, the fire inhibiting biochemical liquid of the present invention is used when practicing the present invention. While not preferred, and not desired in most cases, a liquid dye of a preferred color can be added to biochemical liquid to help visually track where AF chemical liquid has been sprayed when Applicant's GPS-tracking and mapping method is not employed. However, in most applications, it will be desired to maintain the AF biochemical liquid in a clear state, and not employ a colorant for spray-tracking, but rather use Applicant's GPS-tracking and mapping techniques instead of property depreciating dyes and colorants.

### Method of and Apparatus for Applying Fire and Smoke Inhibiting Slurry Compositions on Ground Surfaces Before the Incidence of Wild-Fires, and Thereafter, Upon Smoldering Ambers and Ashes to Reduce Smoke and Suppress Fire Re-Ignition

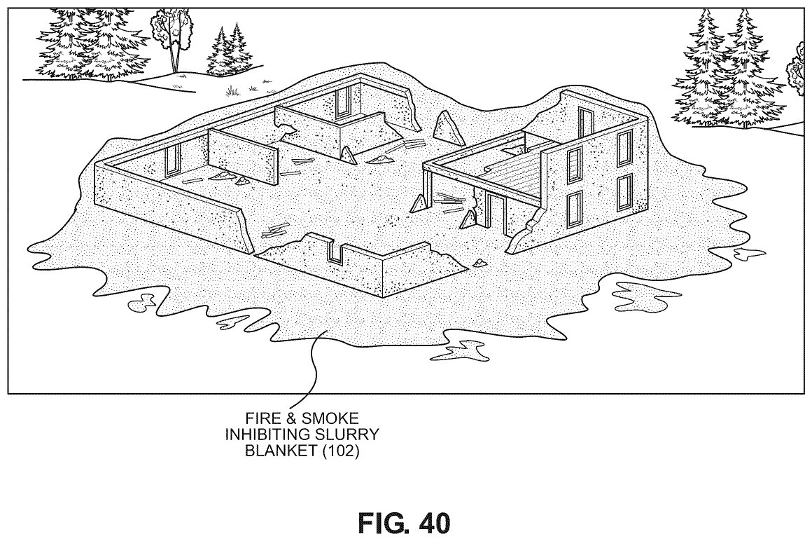

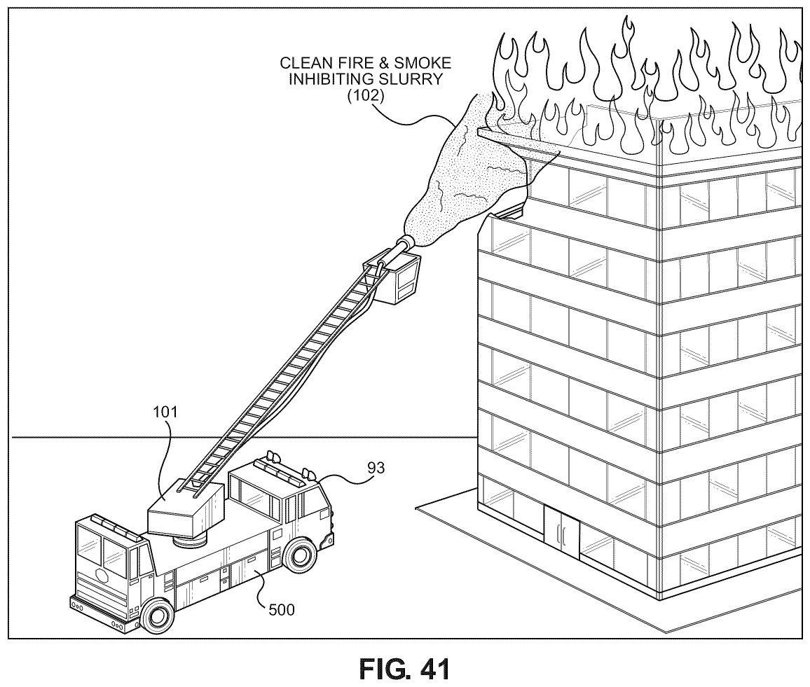

FIGS. 33A, 33B and 33C show the clean fire and smoke inhibiting slurry spray application vehicle 500 carrying a high-capacity (e.g. 3000 gallon) stainless steel mixing tank 93 with an integrated agitator mechanism (e.g. motor driven mixing paddles) 94, and a hydraulic pumping apparatus and spray nozzle 101 for mixing and spraying the environmentally-clean aqueous-based clean fire and smoke inhibiting slurry 102 (i) on ground surfaces to create CFIC-based fire breaks (105) around regions to be protected from wildfires as illustrated in FIGS. 30 and 31, (ii) to cover smoldering ambers and ash after the present of wildfires to reduce toxic waste water runoff and smoke production as shown in FIG. 40, and (iii) on burning fires destroying buildings as well as outdoor combustion material as shown in FIG. 41.

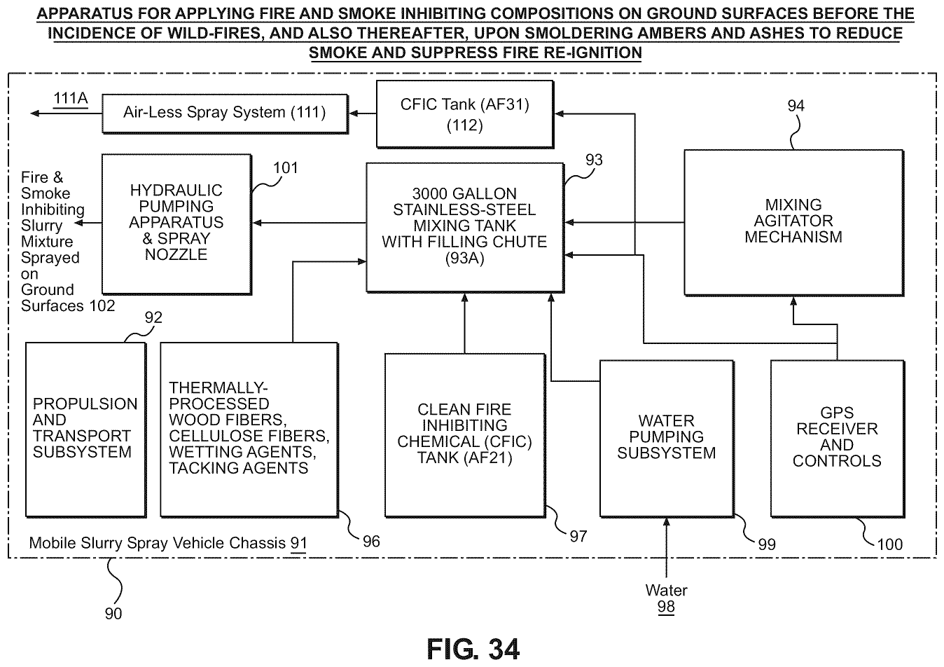

FIG. 34 shows the clan fire and smoke inhibiting slurry spray application vehicle 500 comprising: a mobile slurry mixing and spray vehicle chassis 91 having a propulsion and transport subsystem 92, with a vehicle chassis supporting a high-capacity (e.g. 3000 gallon) stainless steel mixing tank 93, with an integrated agitator mechanism (e.g. motor driven mixing paddles) 94, and having a filling chute 93A through which slurry ingredients (e.g. thermally processed wood fibers, cellulose fibers, wetting agents, tacking agents 96, and a supply of clean fire inhibiting biochemical liquid 97 of the present invention as taught herein; a water pumping subsystem 99 for pumping water 98 from an external source into the mixing tank 93 to blend with the chemicals and fiber material 96 and CFIC material 97, and produce an environmentally-clean fire and smoke inhibiting mixture 102; a hydraulic pumping apparatus and spray nozzle 101, for mixing and spraying the clean aqueous-based clean fire and smoke inhibiting slurry mixture 102 (i) on ground surfaces to create CFIC-based fire breaks around regions to be protected from wildfires, (ii) over smoldering ambers and ash after the present of wildfires to reduce toxic waste water runoff and smoke production, and (iii) on active burning fires in buildings and/or burning land and brush. As shown, the vehicle system 500 includes a GPS receiver and controls 100 for controlling apparatus specified by 91, 92, 93, 94, 98, and 101.

The system 500 also includes a second CFIC liquid tank 112 for storing a secondary CFIC liquid 113, and supplying an air-less spray system 111 for spraying CFIC liquid 113 using a spray nozzle applicator 111A. The spray applicator 112 can be mounted on the vehicle 90, alongside or in tandem with primary slurry spray nozzle 101A, or it can be via connected to a reel of hose for application of CFIC liquid 113 to the surface of the slurry coating 102 after it has been applied to the ground surface. Preferably, biochemical liquid spray 113 will be provided with a colored dye to assist in spray application over the fire and smoke inhibiting slurry 102. By providing a vehicle 90 with two tanks, one tank 93 containing the slurry mixture 102, and the other tank 112 contains an environmentally-clean fire inhibiting chemical (CFIC) liquid 113, the system 90 has an added capacity to suppress fire and smoke created by wildfires, and other sources of fire.

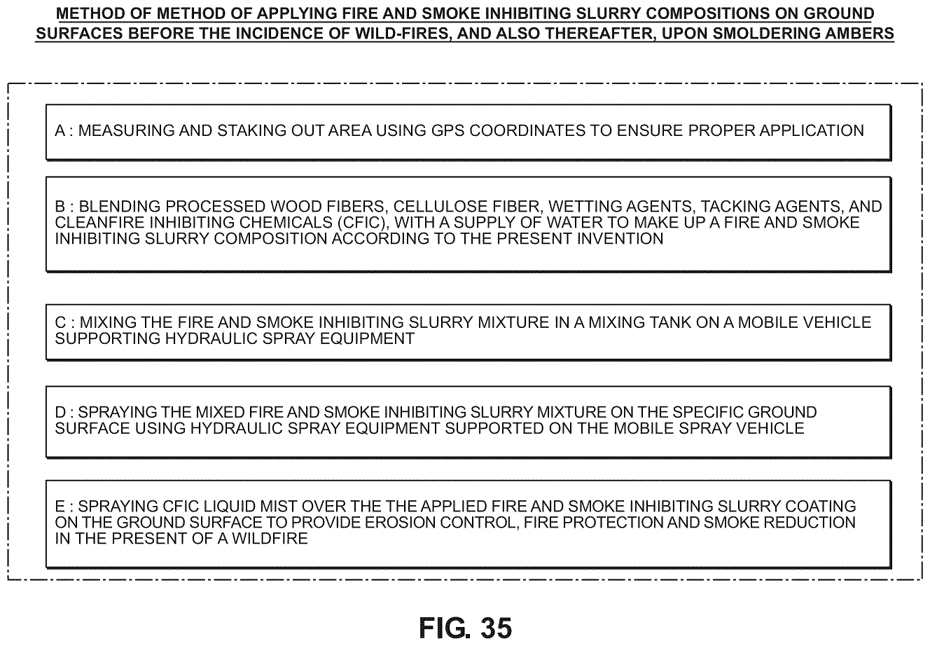

FIG. 35 describes the method of applying fire and smoke inhibiting slurry compositions of the present invention on ground surfaces before the incidence of wild-fires, and thereafter, upon smoldering ambers and ashes to reduce smoke and suppress fire re-ignition.

As indicated at Block A in FIG. 35, the first of the method involves measuring and staking out area using GPS coordinates to ensure proper application rates.

As indicated at Block B in FIG. 35, the processed wood fibers, cellulose fiber, wetting agents, tackling agents 96, and environmentally-clean fire inhibiting biochemicals (CFIC) 97 are blended with a supply of water 98 to make up a fire and smoke inhibiting slurry composition 102.

In the illustrative embodiment, the processed wood fibers, cellulose fiber, wetting agents, tackling agents 96 can be provided in several different ways and formulations. For example, one can use Hydro-Blanket® Bonded Fiber Matrix (BFM) from Profile Products, which combines Profile Product's Thermally Refined® wood fiber and multi-dimensional pacifiers for greater water-holding capacity. This BFM anchors intimately to the soil through proprietary cross-linked, hydro-colloidal pacifiers and activators and is completely biodegradable and non-toxic. When Hydro-Blanket® Bonded Fiber Matrix is blended and mixed with CFIC 97, and water 98, the slurry compositing 102 sprays on as mulch, but dries to form a breathable blanket that bonds more completely with the soil. Thermally Refined® wood fiber starts with 100% recycled wood chips which are thermally processes to create fine, long, and highly absorbent fibers, engineered fibers are the source for Profile's superior: yield and coverage; water-holding capacity; growth establishment; wet-bond strength; and erosion control performance. Profile Products offers other brands of wood, cellulose, wood-cellulose blended hydraulically-applied mulches which are preblended with one or more performance enhancing additions.

Because paper does not hold as much moisture, and does not prevent erosion nearly as well as thermally refined wood fiber mulch, many states and provinces have prohibited the use of paper mulch. Large-scale independent testing has shown that paper mulch is only 25% effective at preventing erosion, whereas wood fiber mulch with no performance enhancing additives is 45% effective at preventing erosion. ASTM standard testing methods also indicate that wood fiber mulches are superior to paper at promoting vegetation establishment. In addition, where steeper or longer slopes exist, and where greater erosion protection is required (greater than 50% effective), there are advanced technologies, beyond basic paper and wood fiber mulches, that are indicated to ensure erosion prevention and vegetation establishment.

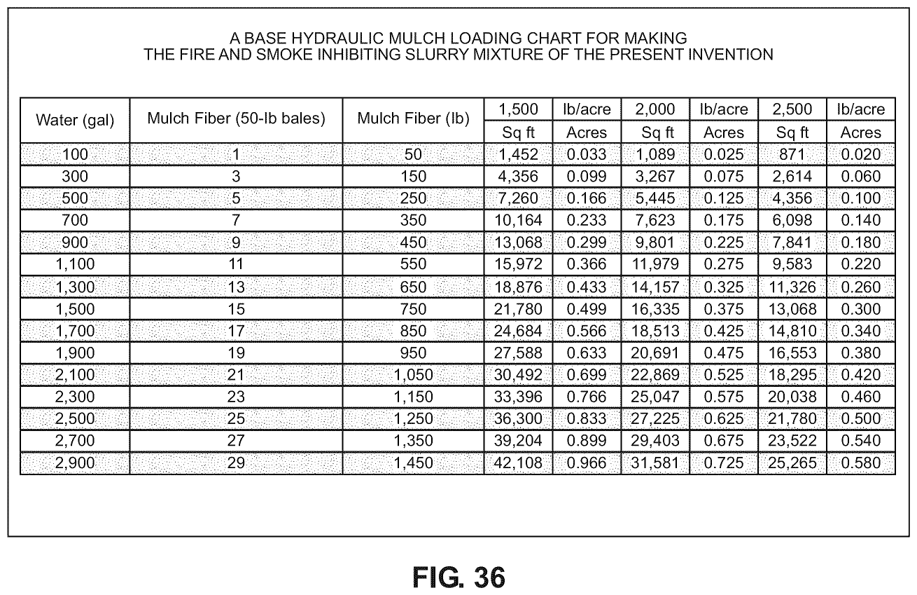

Examples of preblended mulch materials from Profile Products which may be used to practice the manufacture of the fire and smoke inhibiting slurry mixtures of the present invention 102, include the following wood-based and paper-based mulches described below. The Base Hydraulic Mulch Loading Chart shown in FIG. 36 can be used to estimate how much Profile® brand mulch fiber products (e.g. packaged in 50 lb. bales) will be required to make a fire and smoke inhibiting slurry 102 of the present invention for use on incline ground surfaces, of slope lengths, over particular surface areas (e.g. in acres). The Hydraulic Loading Chart shown in FIG. 36 for Profile® mulch fiber products provide the required hydraulic loading for specified application rates required by specific Profile® brand mulch fiber materials used on slopes, and provided for three specific application rates, namely 1500 lb./acre, 2000 lb./acre, and 2500 lb./acre.

### Wood Fiber Mulch

Materials: 100% wood fiber, made from thermally processed (within a pressurized vessel) wood fiber heated to a temperature greater than 380 degrees Fahrenheit (193 degrees Celsius) for 15 minutes at a pressure greater than 80 psi (552 kPa) and dark green marker dye.
Moisture Content: 12%+/−3%
Water-Holding Capacity: 1,100% minimum
Approved Large-Scale Erosion Control Effectiveness: 45% minimum.
When comparing the four base paper and wood mulches listed below, the key items to note are the differences in the maximum slope inclinations, slope lengths and the erosion prevention capabilities.
Cellulose (Paper) Fiber Mulch
Maximum slope inclination: 4:1
Appl. rate on maximum slope: 1,500-2,000 pounds/acre
Maximum slope length: 18 feet
Functional longevity: up to 3 months
Erosion control effectiveness: 25%
Cellulose (Paper) Fiber Mulch with Tackifier
Maximum slope inclination: 4:1
Appl. rate on maximum slope: 1,500-2,000 pounds/acre
Maximum slope length: 20 feet
Functional longevity: up to 3 months
Erosion control effectiveness: 30%

### Wood Fiber Mulch

Maximum slope inclination: 2:1
Appl. rate on maximum slope: 3,000 pounds/acre
Maximum slope length: 28 feet
Functional longevity: up to 3 months
Erosion control effectiveness: 45%
   Wood Fiber Mulch with Tackifier
Maximum slope inclination: 2:1
Appl. rate on maximum slope: 3,000 pounds/acre
Maximum slope length: 30 feet
Functional longevity: up to 3 months
Erosion control effectiveness: 50%
Maximum slope length is based on a 4H:1V slope. For applications on steeper slopes, the maximum slope length may need to be reduced based on actual site conditions.
If greater than 50% erosion prevention effectiveness is desired, then the technologies should be specified and not the four base mulch products listed above.
Stabilized Mulch Matrix (SMM)
Maximum slope inclination: 2:1
Appl. rate on maximum slope: 3,500 pounds/acre
Maximum slope length: 50 feet
Minimum cure time: 24 hours
Functional longevity: 3 to 6 months
Erosion control effectiveness: 90%
Bonded Fiber Matrix (BFM)
Maximum slope inclination: 1:1
Appl. rate on maximum slope: 4,000 pounds/acre
Maximum slope length: 75 feet
Minimum cure time: 24 hours
Functional longevity: 6 to 12 months
Erosion control effectiveness: 95%
Engineered Fiber Matrix™ (EFM)
Maximum slope inclination: >2:1
Appl. rate on maximum slope: 3,500 pounds/acre
Maximum slope length: 50 feet
Minimum cure time: 24-48 hours
Functional longevity: Up to 12 months
Erosion control effectiveness: >95%
High Performance-Flexible Growth Medium™ (HP-FGM™)
Maximum slope inclination: >1:1
Appl. rate on maximum slope: 4,500 pounds/acre
Maximum slope length: 100 feet
Minimum cure time: 2 hours
Functional longevity: 12 to 18 months
Erosion control effectiveness: 99.9%
Extended-Term Flexible Growth Medium (ET-FGM)
Maximum slope inclination: >1:1
Appl. rate on maximum slope: 4,500 pounds/acre
Maximum slope length: 125 feet
Minimum cure time: 2 hours
Functional longevity: 18 to 24 months
Erosion control effectiveness: 99.95%

Profile Product's HP-FGM and ET-FGM mulches have very short cure times, and therefore, fire and smoke inhibiting slurry mixtures, employing these mulches, can be applied onto wet soils and during a light rainfall. Maximum slope length is based on a 3H:1V slope. For applications on steeper slopes, the maximum slope length may need to be reduced based on actual site conditions.

In applications where the fire and smoke inhibiting slurry 102 is applied onto smoldering ashes and ambers of houses destroyed by wildfires, there slope will be generally zero. However, alongside roads and embankments, where wildfires may travel, following specified application rates for specified ground slopes should be followed for optimal performance and results.

In the illustrative embodiments, the CFIC liquid component 97, added to the fire and smoke inhibiting slurry mixture 102, will be realized using biochemical clean anti-fire inhibiting biochemical liquid compositions specified in FIGS. 6A1 through 6C2, and described in detail above.

When blending the fire inhibiting biochemical liquid composition 97 with Profile's hydraulic mulch fiber products in the mixing tank 93, the following mixture ratio should be used for biochemical liquid 97: about 1 gallon of biochemical liquid composition per 10 gallons of water added to the mixing tank 93 during the blending and mixing of the fire and smoke inhibiting slurry 102. So, as shown in FIG. 30, when mixing 2800 gallons of water to 1450 lbs. of mulch fiber (29×50 lb Profile® mulch fiber bales) to make a batch of fire and smoke inhibiting slurry 102, at least 280 gallons of biochemical liquid 97 will be added to the mixing tank 93 and mixed well with the 2800 gallons water and 1450 lbs. of mulch fiber, preferably from Profile Products, LLC of Buffalo Grove, Illinois, when using the 1500 lb./acre application rate.

However, additional amounts of biochemical liquid 97 can be added to the 2800 gallons of water to increase the amount of fire inhibiting biochemical liquid that infuses into the surface of the mulch fibers when being mixed within the mixing tank 93 during the blending and mixing steps of the process. Notably, a large percentage of the water in the mixing tank 93 will function as a hydraulic carrier fluid when spraying biochemical liquid infused mulch fibers in the slurry mixture to the ground surface being coated during spray applications, and thereafter, this water will quickly dry off when curing under the hot Sun, leaving behind infused fire inhibiting biochemicals (e.g. potassium citrate salt crystal structures) embodied within the mulch fibers to provide during proactive fire protection.

As indicated at Block C in FIG. 35, the blended fire and smoke inhibiting slurry mixture of the present invention is mixed in the mixing tank 93 on the mobile vehicle 500 supporting hydraulic spray equipment 101.

As indicated at Block D in FIG. 35, the mixed fire and smoke inhibiting slurry mixture 102 is then hydraulically sprayed on the specific ground surface using hydraulic spray equipment 101 supported on the mobile spray vehicle 500 The slurry spray process can be guided by GPS coordinates of the staked-out ground surface regions, using GPS receiver and controls 100.

As indicated at Block E in FIG. 35, a secondary biochemical liquid 113 is sprayed over the fire and smoke inhibiting slurry coating 102 after it has been hydraulically sprayed onto the ground. Once the slurry coating 102 has dried, and adheres to the ground surface, it will provide erosion control, as well as fire protection and smoke reduction in the presence of a wildfire in accordance with the scope and spirit of the present invention.

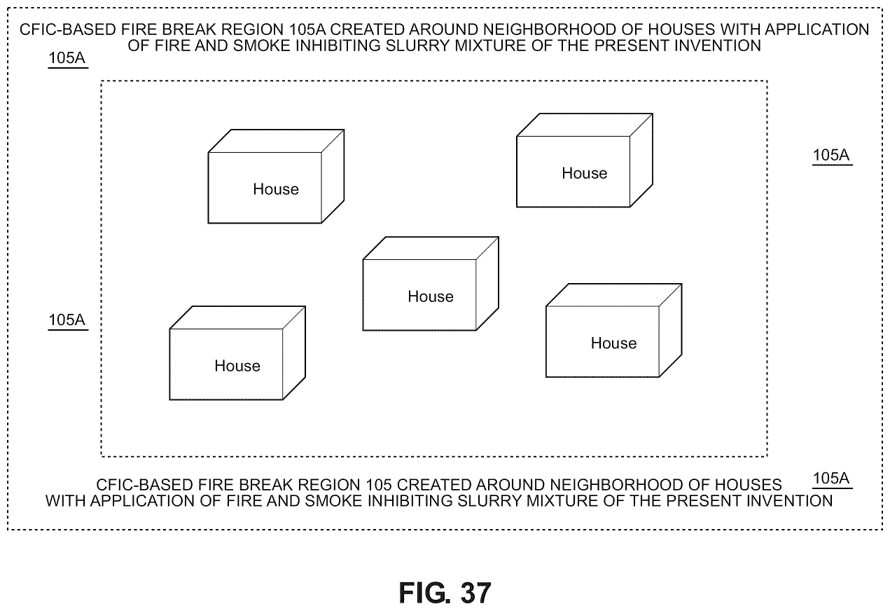

FIG. 37 shows a neighborhood of houses surrounded by a high-risk wildfire region. As shown, a wild-fire break region 105A is sprayed on the ground surface region all around a neighborhood of houses, using the clean fire and smoke inhibiting slurry composition of the present invention 102 hydraulically sprayed onto the ground surface.

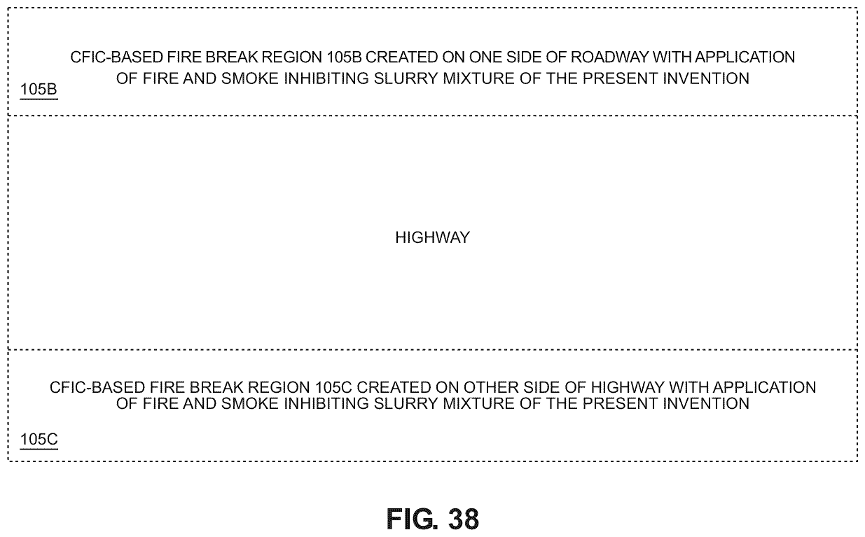

FIG. 38 shows a highway surrounded by high-risk wildfire regions on both sides of the highway. As shown, the wild-fire break regions 105A on both sides of the highway are sprayed using the clean fire and smoke inhibiting slurry composition 102 hydraulically sprayed from the vehicle 500 onto the ground surface. Spray operators can stand on top of the platform above the mixing tank 93 and use the mounted spray gun to coat the ground surface with the wet slurry mixture 102. Fire inhibiting biochemical liquid of the present invention 113 can then be sprayed upon the surface of the slurry coating 102 on the ground, if and as desired by the application at hand. By applying the clean fire and smoke inhibiting slurry composition 102 over a smoldering fire, followed with a biochemical spray coating, this double coating functions like a blanket for chemically breaking the combustion phase of a traveling wildfire and reducing smoke, and the need for water to prevent reignition to neighboring areas.

FIG. 40 shows a house that just burned to the ground after a wildfire passed through an unprotected neighborhood. As shown, the clean fire and smoke inhibiting slurry composition 102 is sprayed over the glowing ambers and fire ash to suppress and prevent re-ignition of the fire, and reduce the production of smoke and creation of toxic water runoff during post fire management operations. Spray operators can stand on top of the platform above the mixing tank 93 and use the mounted spray gun to coat the ground surface with the wet slurry mixture 102. The biochemical liquid 113 can then be sprayed upon the surface of the slurry coating 102 on hot glowing ambers and ashes. By applying the clean fire and smoke inhibiting slurry composition 102 over a smoldering fire, followed with a biochemical spray coating, this double coating functions like a blanket for chemically breaking, or interrupting the free-radical chain-reaction within the combustion phase of a traveling wildfire and reducing smoke and the need for water to prevent reignition to neighboring areas.

FIG. 41 shows a house or building that is burning due to a fire within the building. As shown, the wet fire and smoke inhibiting slurry composition of the present invention 102 is hydraulically sprayed on and over the fire in effort to suppress the fire and reduce the production of smoke. In some applications, this method may be effective in fire and smoke suppression using a minimal amount of water.

### Specification of the Automated Wildfire Ember Detection and Suppression System/Module of Present Invention

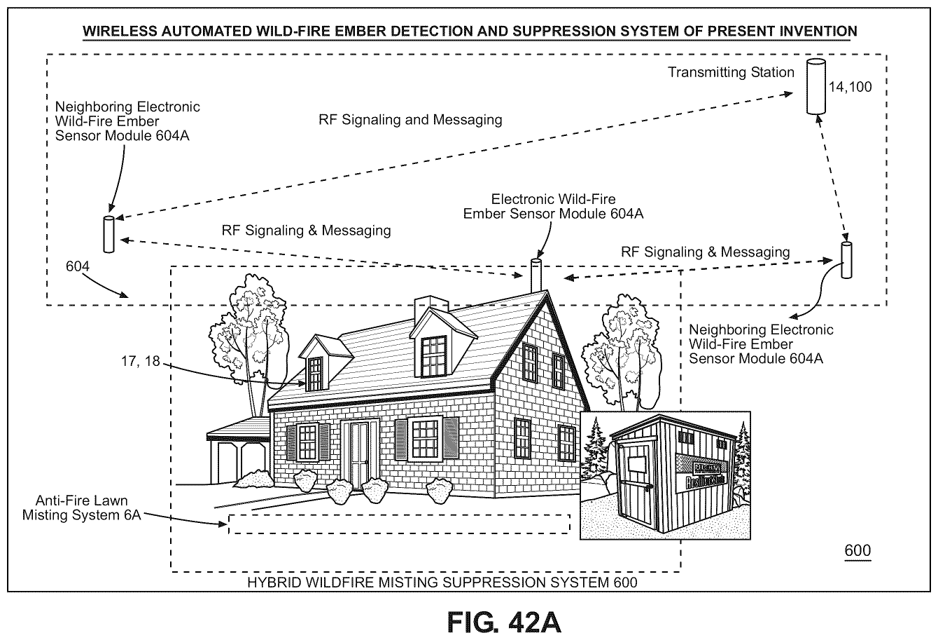

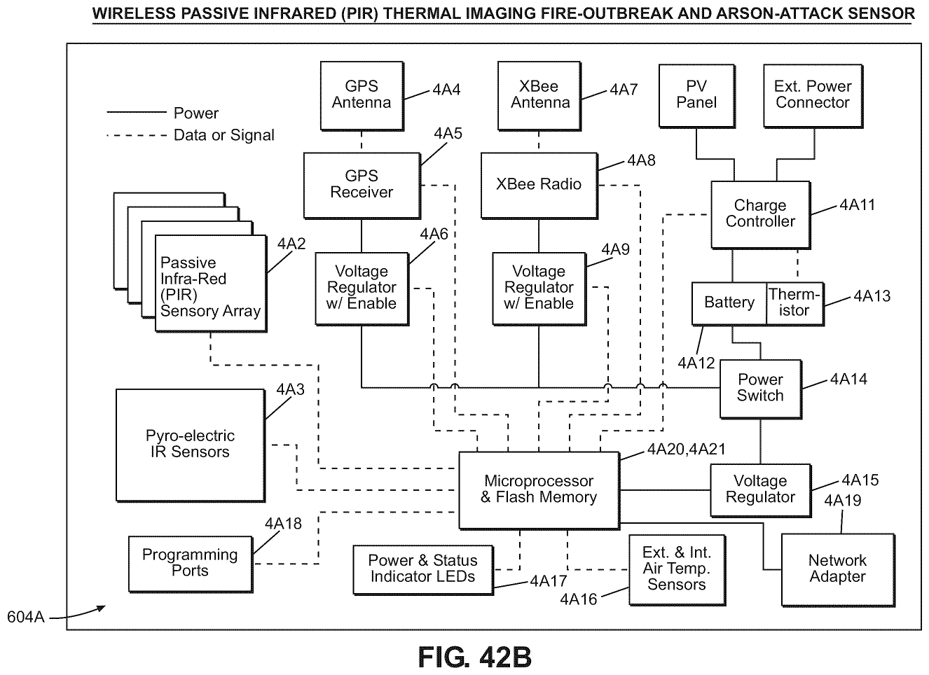

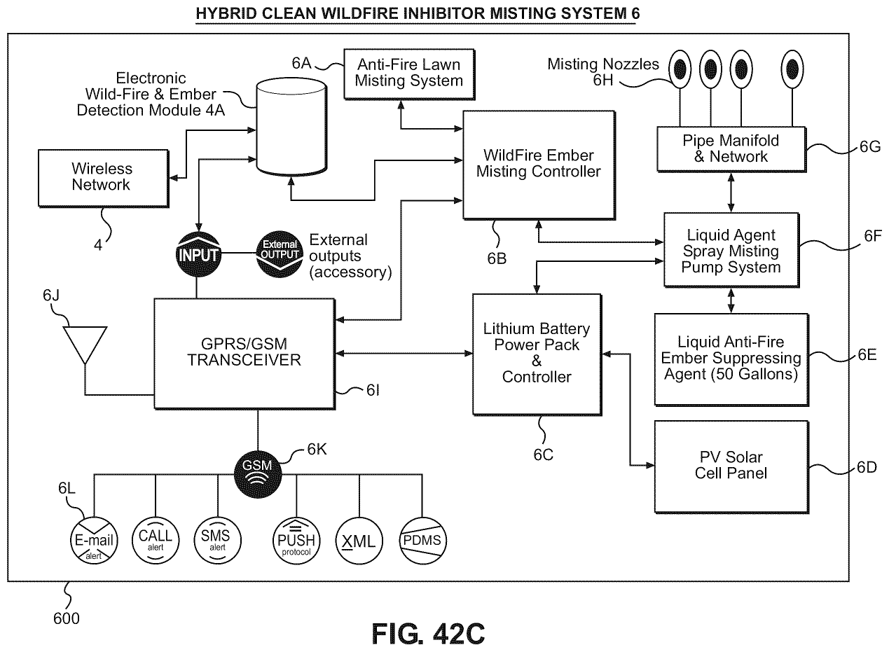

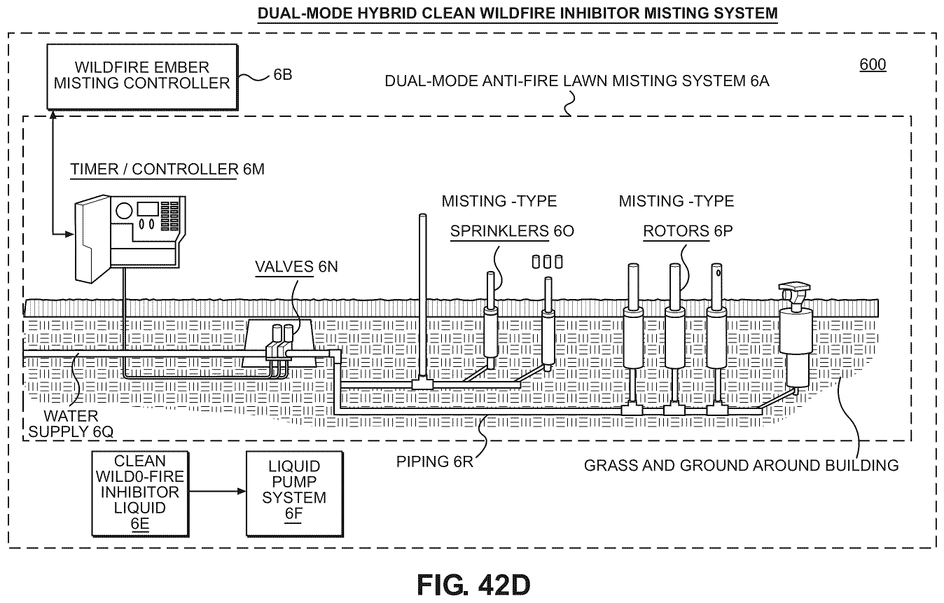

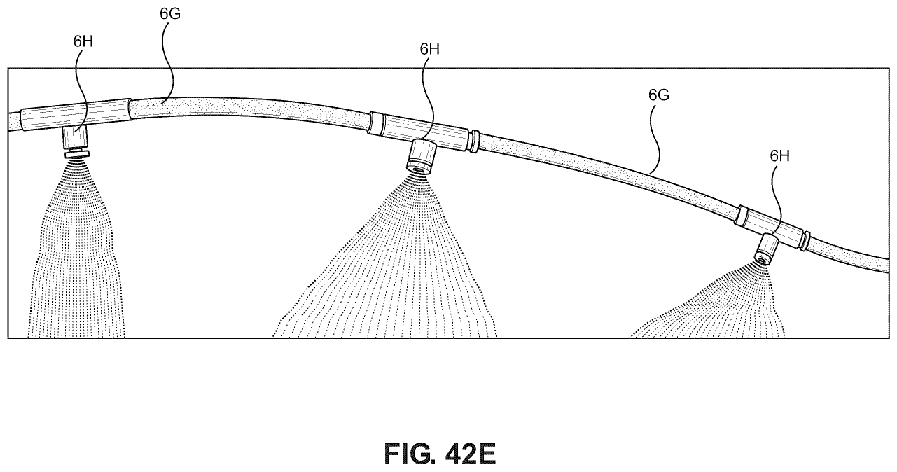

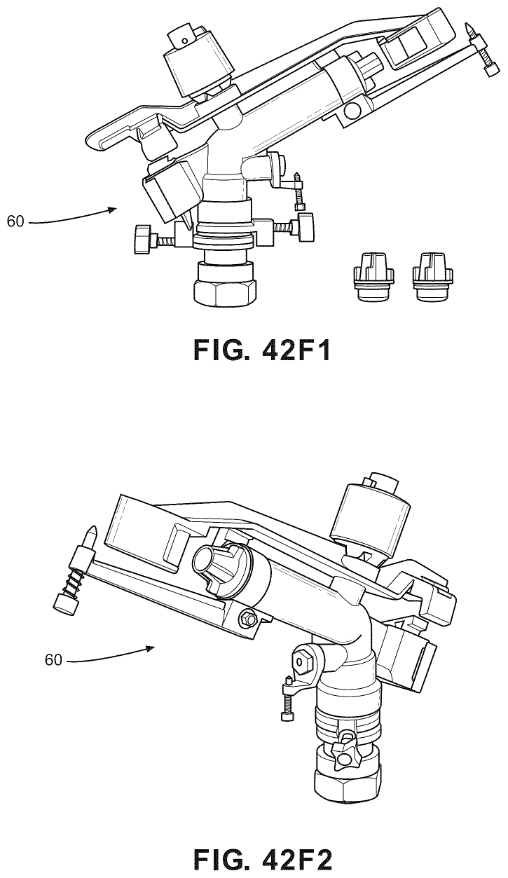

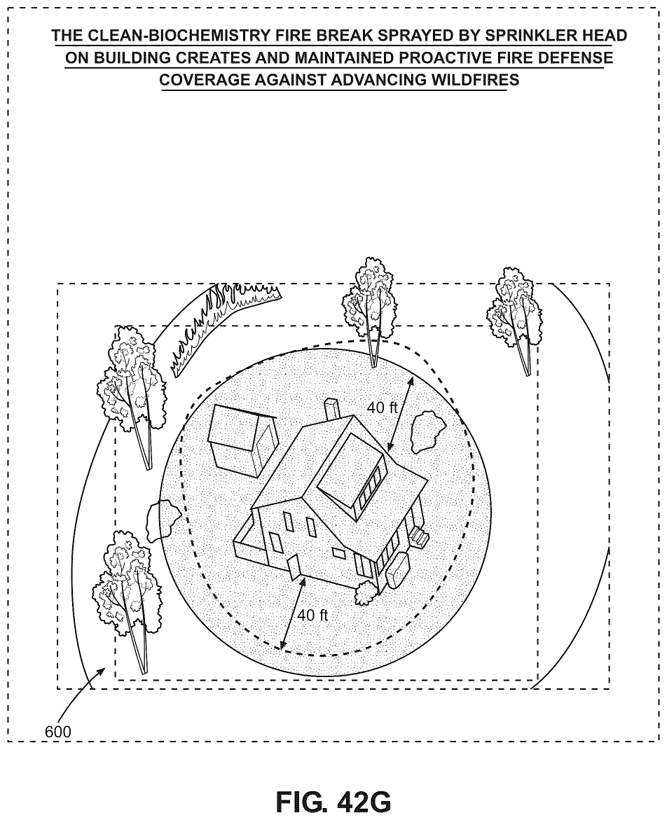

FIG. 42A shows a wildfire ember detection module 604A mounted on the top of each building 300. Each wildfire ember detection module 604A is configured in the wireless wildfire ember detection and notification network 600, for (i) receiving wildfire alerts and messages from neighboring modules 604A, (ii) sensing and processing IR thermal images for automated detection of wildfires and wildfire embers in the field of views (FOVs) of the module, (iii) sending and recording the CO2 levels in the ambient air, (iv) measuring and recording the relative humidity (%) in the ambient air, (v) measuring and recording the temperature of the ambient air, and measuring and recording other parameters relating to the ambient environment which may be helpful in automated detection of wildfires and wildfire ember storms, so the anti-fire misting systems installed on property can be timely triggered to protect the building and property when a wildfire storm rages across the property. The advantage of being part of this network is that each module 4A can scout for wildfires and alert other modules in the network in terms of GPS coordinates so that the specific properties can timely prepare for any such wildfire outbreaks in the vicinity.

### Specification of the Wireless GPS-Tracked Wildfire Ember Detection and Notification Network Employing the Wildfire Ember Detection and Suppression Systems of the Present Invention

FIG. 42A shows the wireless GPS-tracked Wildfire ember detection and notification network 604 employing with the Wildfire ember detection and suppression systems 4A. Each wireless GPS-tracked wildfire ember detection module 4A, deployed in the wireless Wildfire ember detection and notification network 604 comprises: a fire-protective housing cover 4A1; and various sensors and signal and data processing and storage components 4A2 through 4A19, shown in schematic block diagram of FIG. 42B.

As shown in FIG. 42B, the sensors and signal and data processing and storage components arranged and configured about a microprocessor 4A20 and flash memory (i.e. control subsystem) 4A21 include: one or more passive infra-red (PIR) thermal-imaging sensors 4A2 connected together with suitable IR optics to project IR signal reception field of view (FOV) before the IR receiving array; multiple pyrometric sensors 4A3 for detecting the spectral radiation of burning, organic substances such as wood, natural gas, gasoline and various plastics; a GPS antenna 4A4; a GPS signal receiver 4A5; voltage regulator 4A6; an Xbee antenna 4A7; an Xbee radio transceiver 4A8; a voltage regulator 4A9; an external power connector 4A10; a charge controller 4A11; a battery 4A12; thermistors 4A13; a power switch 4A14; a voltage regulator 4A15; external and internal temperature sensors 4A16; power and status indicator LEDs 4A17; programming ports 4A18; a digital/video camera 4A19; and other environment sensors adapted for collecting and assessing building intelligence, in accordance with the spirit of the present invention. Alternatively, the wildfire detection module 4A and wireless wildfire intelligence network 4 can be realized using the technical disclosure of U.S. Pat. No. 8,907,799, incorporated herein by reference.

In the illustrative embodiment, the wildfire ember detection system 604A supports a computing platform, network-connectivity (i.e. IP Address), and is provided with native application software installed on the system as client application software designed to communicate over the system network and cooperate with application server software running on the application servers of the system network, thereby fully enabling the functions and services supported by the system, as described above. In the illustrative embodiment, a wireless mess network is implemented using conventional IEEE 802.15.4-based networking technologies to interconnect these wireless subsystems into subnetworks and connect these subnetworks to the internet infrastructure of the system of the present invention.

Preferably, the optical bandwidth of the IR sensing arrays 4A2 used in the thermal sensors will be adequate to perform 360 degrees thermal-activity analysis operations, and automated detection of wildfire and wildfire embers. Specifically, thermal sensing in the range of the sensor can be similar to the array sensors installed in forward-looking infrared (FLIR) cameras, as well as those of other thermal imaging cameras, use detection of infrared radiation, typically emitted from a heat source (thermal radiation) such as fire, to create an image assembled for video output and other image processing operations to generate signals for use in early fire detection and elimination system of the present invention.

Pixel processing algorithms known to those skilled in the art will be used to automatically process captured and buffered pixels from different color channels and automatically determine the presence of fire, wildfire, and flying embers within the field of view (FOV) of the wildfire ember detection module 604A. Reference can be made to “Automatic Fire Pixel Detection Using Image Processing: A Comparative Analysis of Rule-based and Machine Learning Methods” by Tom Loulouse et al, 2015, University of Corsica, France; and “Fast Detection of Deflagrations Using Image Processing” by Thomas Schroeder et al, Helmut Schmidt University, Hamburg, Germany, 2014.

The pyroelectric detectors 4A3 detect the typical spectral radiation of burning, organic substances such as wood, natural gas, gasoline, and various plastics. To distinguish a flame from the sun or other intense light source such as light emissions from arc welding, and thus exclude a false alarm, the following independent criteria are considered: a typical flame has a flicker frequency of (1 . . . 5) Hz; a hydrocarbon flame produces the combustion gases carbon monoxide (CO) and carbon dioxide (CO₂); and in addition, burning produces water which can also be detected in the infrared range. Each pyroelectric detector 4A3 is an infrared sensitive optoelectronic component specifically used for detecting electromagnetic radiation in a wavelength range from (2 to 14) μm. A receiver chip of a pyroelectric infrared detector consists of single-crystalline lithium tantalite. On the upper electrode of the crystal, an absorbing layer (black layer) is applied. When this layer interacts with infrared radiation, the pyroelectric layer heats up and surface charge arises. If the radiation is switched off, a charge of the opposite polarity originates. However, the charge is very low. Before the finite internal resistance of the crystal can equalize the charges, extremely low-noise and low leakage current field-effect transistors (FET) or operational amplifier (Pomp) convert the charges into a signal voltage.

In general, most streams of digital intelligence captured by the wireless network 604 will be time and data stamped, as well as GPS-indexed by a local GPS receiver within the sensing module, so that the time and source of origin of each data package is recorded within the system database. The GPS referencing system supporting the system transmits GPS signals from satellites to the Earth's surface, and local GPS receivers located on each networked device or machine on the system network receive the GPS signals and compute locally GPS coordinates indicating the location of the networked device within the GPS referencing system.

When practicing the wireless network of the present invention, any low power wireless networking protocol of sufficient bandwidth can be used. In one illustrative embodiment, a Zigbee® wireless network would be deployed inside the wood-framed or mass timber building under construction, to build a wireless internetwork of a set of wireless PIR thermal-imaging fire outbreak detection systems deployed as a wireless subnetwork deployed within the building under construction. While Zigbee® technology, using the IEEE 802.15.1 standard, is illustrated in this schematic drawing, it is understood that any variety of wireless networking protocols including Zigbee®, WIFI and other wireless protocols can be used to practice various aspects of the present invention. Notably, Zigbee® offers low-power, redundancy and low cost which will be preferred in many, but certainly not all applications of the present invention. In connection therewith, it is understood that those skilled in the art will know how to make use of various conventional networking technologies to interconnect the various wireless subsystems and systems of the present invention, with the internet infrastructure employed by the system of the present invention.

### The Automated Hybrid Clean Wildfire Inhibitor Misting and Sprinkler System of the Present Invention, Controlled by the Wireless Automated Wildfire Ember Detection and Notification Network

As disclosed in Applicant's prior US patent applications, when treating combustible organic materials so they will not burn in the presence of a wildfire, it will be helpful in many instances to spray clean anti-fire chemical liquid over the target surfaces so that the droplets are relatively large and an adequate coating of anti-fire chemical dries over the treated surface. This way, when the chemically treated, organic material is exposed to fire, the treated surface has adequate chemicals to break the free-radical chain reactions of the fire and thereby quickly suppress and/or extinguish the fire.

However, during wildfire storms, producing burning wildfire embers flying through dried heated air, driven by strong prevailing winds, it has been discovered that clean aqueous-based anti-fire biochemical liquid of the present invention will perform as a more effective fire suppressant if provided to the burning fire in the form of a mist cloud, so that it can work on a wildfire and its embers, as described in the wildfire ember suppression process described herein.

While most mist producing apparatus disclosed herein operates on the principle of transmitting an anti-fire chemical liquid through a misting nozzle under low, medium, or high hydraulic pressure, it is understood that when spraying anti-fire chemical liquids over the surfaces of organic material during fire-protection treating operations, then spray-type nozzles will be often used as provided on the mobile spraying apparatus 5 shown herein. Using spray-type nozzles, it is possible to quickly deposit and form sufficient coatings of anti-fire chemical material on the treated surfaces, because spray-type nozzles produce liquid drops substantially larger in size than microscopic droplets formed by misting nozzles during misting operations, illustrated herein.

FIGS. 42C and 42D shows automated hybrid clean wildfire inhibitor misting system of the present invention 600, providing both an anti-fire chemical misting system for suppressing wildfire embers impacting a building as shown in FIG. 42C and a lawn and ground anti-fire chemical liquid misting system impacting the law and ground around the building as shown in FIG. 42C, both automatically controlled by an automated wildfire ember detection and notification network shown in FIGS. 42A and 42B. All these system components are integrated into the system network shown in FIG. 4A.

FIG. 42A shows a piping manifold 6G, a network of piping, and a set of misting nozzles 6H used to supply and produce anti-fire chemical misting droplets from the automated hybrid clean wildfire misting system 6 shown in FIGS. 13A and 13B.

As shown in FIG. 13A, automated multi-mode hybrid clean wildfire inhibitor misting system 600 comprises: an dual-mode anti-fire lawn and ground misting system 6A shown in FIG. 13B for either misting water from a main water supply, or misting environmentally-clean anti-fire chemical liquid of the present invention over lawns (e.g. dried out grass) and ground surfaces covered with organic material; a wildfire ember misting controller 6B (e.g. programmable microcontroller supported by a memory architecture) for controlling the various modes of the system 6; lithium battery pack and controller 6C for supplying electrical power to the electronic components in the system 6 including the DC or AC electric motor of hydraulic (e.g. diaphragm-type) liquid pumping system 6F; a photovoltaic solar cell panel 6D for recharging the lithium-ion battery back 6C while collecting sunlight with the PV solar panel 6D as solar conditions allow; a supply tank containing an adequate supply (e.g. 100 gallons) of a liquid anti-fire chemical liquid realizable using anti-fire biochemical liquid of the present invention; a liquid spray misting pump system 6F (e.g. self-priming DC or AC electrical-motor powered diaphragm liquid pump) for hydraulically pumping the anti-fire chemical liquid 6E from its supply tank (e.g. 50-100 gallons) to a plurality of misting nozzles 6H mounted all around a building being protected, and connected through adequate heat-resistant piping (e.g. ⅛″, ¼″ or ½″ metal tubing, or high-heat resistant plastic tubing such as PET) extending over relatively short distances under adequate hydraulic pressure, to support sufficient flow rates of anti-fire chemical liquid during a wildfire ember storm, determined in a manner well known in the fluid hydraulic arts; a piping manifold 6G and piping network including a set of misting nozzles 6H for producing clean anti-fire (AF) chemical mist; a GPRS/GSM transceiver 6I with suitable antennas 6J, connected to the controller 6B, and adapted for transmitting and receiving digital data packets using GPRS and GSM communication protocols, over the system network 1, to support a suite of digital communication services and protocols specified herein; a suite of communication services and protocols 6L (e.g. email, SMS alert, PUSH protocol, XML, PDMS, and CALL alert) supported by GSM, for sending and receiving messages; and at least one electronic Wildfire ember detection module 4A, with 360 degrees of sensing and associated field of views (FOVs), and in wireless communication with the wireless wildfire ember detection and notification network 4 of the present invention.

As shown in FIG. 42D, the lawn misting system 6A comprises: a water supply 6Q connected to a network of underground piping 6R; misting-type sprinklers 6O (e.g. misting nozzles) connected to the underground piping 6R; misting-type rotors 6P connected to the piping 6R; valves 6N connected to the underground piping 6R, the local water supply 6Q, and the liquid pumping system 6F, which is operably connected to the supply of clean wildfire inhibitor liquid 6E using piping; and a timer/controller 6M connected to the controllable valves 6N, and controlled by the wildfire ember misting controller 6B, which is managed by the automated wildfire ember detection and notification network 604, shown in FIG. 13A.

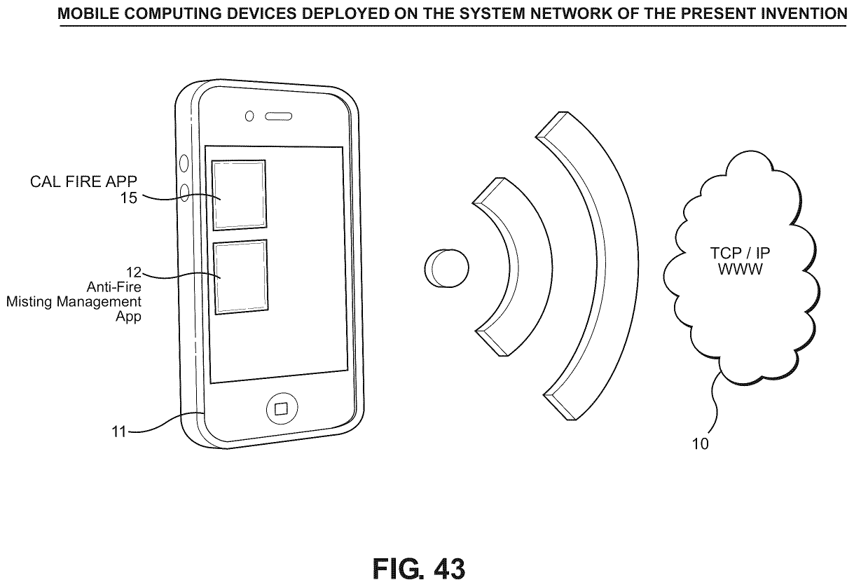

The dual-mode lawn misting system 6A shown in FIG. 43D has two modes of operation. During its first mode of operation, when no wildfire storm is detected, the lawn misting system 6A automatically mists the lawn with water supplied from the local water supply 6Q. During its second mode, when a wildfire storm is detected, the law misting system 6A automatically mists the lawn with an environmentally anti-fire (AF) liquid 6E supplied from a local supply of environmentally-clean fire inhibiting (anti-fire/AF) liquid of the present invention pumped from a pumping system 6F.

In the preferred embodiment the hybrid wildfire misting system 600 also has at least two modes operation: (i) a manual mode where a building/home owner or manager can manually activate and operate the anti-fire chemical liquid misting system 600 to protect either the building 17 and/or the lawn and ground surfaces around the building 17, as desired or required, based on intelligence in the possession of the human operator or manager; and (ii) an automated mode where the wildfire ember misting controller 6B, in cooperation with the local electronic wildfire and ember detection module 604A and associated wireless wildfire detection network 4, automatically activate and operate the anti-fire chemical liquid misting system 600 to protect both the building 17 and/or the lawn and ground surfaces around the building 17, as required, based on intelligence automatically collected by the wireless wildfire detection and notification network.

Preferably, modules 6I, 6K, 6B, 6C, 6E and 6F shown in FIG. 42C will be mounted and safely protected in the wildfire-protected shed or closet structure 50, disclosed in great technical detail in Applicant's published U.S. patent application Ser. No. 15/925,796, incorporated herein by reference. In the manual mode, a touch-screen or touch-type control panel associated with the controller 6B is used by the operator to simply operate the system 6 in its manual mode, or automatically arm the system 600 to operate in its automated, artificial intelligence (AI) mode of operation.

The system 600 will be remotely controllable by the building manger/home-owner using a mobile computing system 11 running the mobile application 12, as shown and described in FIG. 43. Suitable graphical user interfaces (GUIs) will be supported on the mobile application 12 to enable the user to monitor and control the system 600 locally, or from a remote location, in real-time, provided the wireless communication infrastructure is not disrupted by a wildfire. In the case of active wildfires, the wildfire detection and notification network 4 should be accessible by a remote user provided with the mobile application 12. As the system will continuously collect, record, and monitor intelligence about specific regions of land and any wildfires detected in such regions, and advise any specific home/building owner of the status of any specific building before, during and after a wildfire.

The system 600 will include and supported automated mechanisms for remotely monitoring and reporting the amount of anti-fire chemical liquid 6E available and remaining for use in supporting anti-fire misting operations, during an automatically detected wildfire ember storm. Preferably, adequate reserves of fire inhibiting chemical liquid 6E will be stored on each property before any given wildfire storm strike, to enable the misting/sprinkling and coating of all combustible property surfaces to form durable potassium (i.e. alkali metal) salt crystalline coatings on the combustible surfaces before the arrival of a wildfire storm and its hot-lying embers.

As shown in FIG. 42G, the sprinkler-type head(s) shown in FIGS. 42F1 and 42F2, mounted on home building rooftops and driven by automated pumps, automatically create and maintain a clean-biochemistry fire break all around the home's property area, to maintain a proactive fire defense coverage against an advancing wildfire, to help reduce risk of destruction of property and life by wildfire. Preferably, wildfire fire defense system is provided with a mode of operation in the system 600 is locked and loaded, with a full supply of clean fire inhibiting liquid biochemical composition of the present invention stored in a storage tank, and connected to a battery-powered pump, connected to the sprinkler and misting heads installed on and around the property, and on the home building roof structure, equipped and ready to automatically spray the predetermined amount of fire inhibiting liquid biochemical from the sprinklers 6O and misting nozzles 64 over all the property surfaces, so as to create a proactive zone of fire protection from potassium citrate salt crystalline structures formed and dried on all combustible property surfaces, and effective against hot embers and fire from an wildfire advancing toward the proactively protected property.

Typically, the home wildfire defense sprinkling system will be manually triggered by the owners several hours and just before the owners are required to evacuate their homes and property for safety reasons, by authorities such as the local fire chief and deputies. Alternatively, the wildfire home defense system can also be remotely triggered using a mobile smartphone as shown in FIG. 43, if required, with the property owners not home to manually triggering the spraying defense mode of the system.

To provide adequate protection against flying wildfire embers combusting in a low humidity environment, the misting nozzles 64 will be mounted about the building 17 so as to provide adequate coverage over all air-inlet vents provided on the specific building being equipment with the wildfire misting/sprinkler system of the present invention, as well as on wood and other organic surfaces that might be vulnerable to hot wildfire embers during a wildfire ember storm, as illustrated in FIG. 42A. The liquid spraying pattern of each misting nozzle 6H and sprinkler 60 being used in the misting system 600 will be considered and exploited to provide the adequate misting protection required by the wildfire protection application at hand. Computer software tools may be developed and distributed to installers to assist in the design and installation of a hybrid wildfire misting system in accordance with the principles of the present invention.

In the illustrative embodiment, the clean fire inhibiting biochemical liquid of the present invention shown in FIGS. 6 through 6V4 to be used for wildfire ember misting/sprinkling operations disclosed herein. It is expected that service-oriented businesses will support the rapid design, installation and installation of the automated wildfire detection and misting suppression systems of the present invention, as well as the supplying and replenishing of clean anti-fire chemical liquid on each GPS—indexed property. It is expected that this can occur with the efficiency currently provided by conventional liquid propane supply companies around the country. Because of the reduced risk of loss of wood-framed or other buildings to wildfire, which the systems and method of the present invention will provide, while advancing the best practices for home and building property protection against wildfires, it is expected that fire insurance companies will embrace the best practices represented by the present invention, for reason of the great benefits such inventions will provide, predicted by Benjamin Franklin's time-honored principle of fire protection: “An ounce of prevention is worth a pound of cure.”

When encountering the potassium salt crystalline coatings applied before the arrival of a wildfire storm, wildfire embers will be quickly suppressed or readily extinguished by the molecules of the coating interfering with the free radicals (H+, OH—, O) involved in the free-radical chemical reactions within the combustion phase of a fire, or wildfire embers.

Just-In-Time Wood-Framed Building Factory Method, System and Network Supporting Multiple Production Lines for Producing Pre-Fabricated Class-A Fire-Protected Wood-Framed Components as Needed to Construct Custom and Pre-Specified Wood-Framed Buildings Ordered by Customers

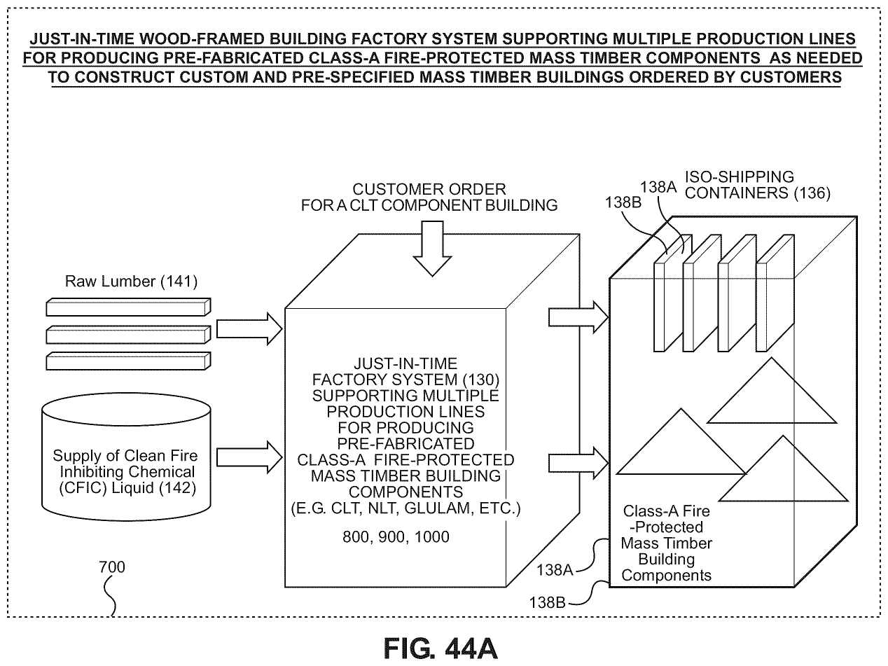

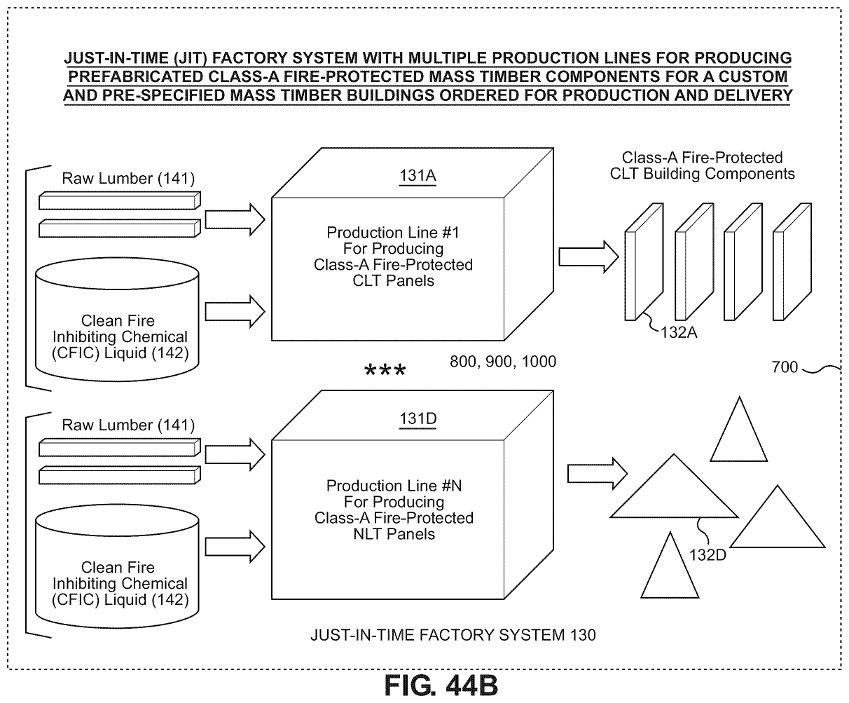

FIG. 44A shows a just-in-time wood-framed building factory system 700 supporting multiple production lines 131A, 131B, 131C, etc. for producing pre-fabricated Class-A fire-protected wood-framed components as needed to construct custom and pre-specified wood-framed buildings ordered by customers from anywhere around the globe. In accordance with the principles of the present invention, each production line includes a conveyor for conveying wood components (e.g. raw lumber, finger-jointed lumber, CLT components and/or LVL components) along at least a portion of the production line and through, into and out of a dipping tank, as described herein, filled with clean fire inhibiting biochemical liquid (142) of the invention in FIG. 6 through 6V4, and allowed to dry and form potassium salt crystalline coating, and attain Class-A fire-protection properties during the wood-framed component fabrication process.

FIG. 44B shows the just-in-time (JIT) factory system 700 with production lines shown for producing various kinds of prefabricated Class-A fire-protected wood-framed components (e.g. wood-framed walls, staircases, roof trusses, floor trusses, etc.) 132A, 132B, and 132C which are used in constructing custom and pre-specified wood-framed buildings ordered by customers for production and delivery. As shown, each production line 131 requires inputs such as (i) an order for a customer or pre-specified wood-framed building; (ii) raw lumber 141 of a certain type and in a certain quantity to build the ordered custom or prespecified wood-framed building; as well as (iii) CFIC liquid 142 in sufficient supply to render the raw lumber Class-A fire-protected in accordance with the principles of the present invention disclosed herein. As shown, the outputs from the factory system 130 are Class-A fire-protected wood-framed building components such as (i) wall panels 132A, (ii) floor panels 132B, (iii) floor trusses 132C, (iv) roof trusses 132D, and (v) stair panels 132E, manufactured using the dip-coating methods disclosed herein, for use in constructing custom and specified wood-framed buildings.

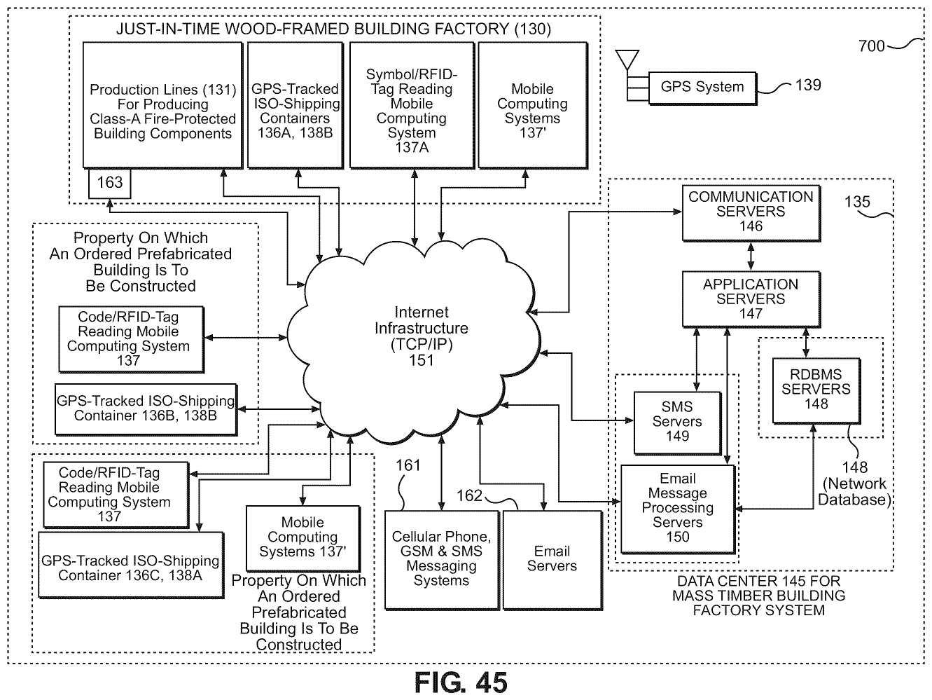

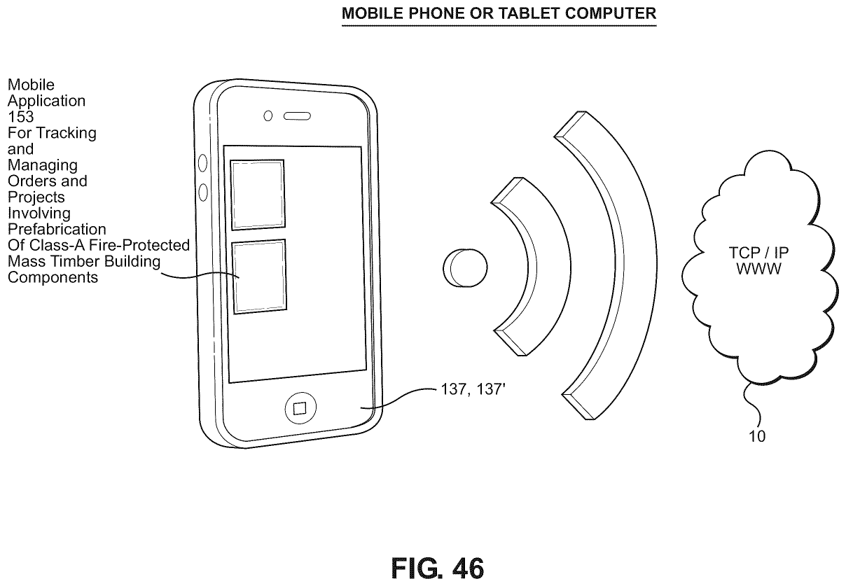

FIG. 45 shows the just-in-time factory system network 700 shown in FIGS. 44A and 44B, shown comprising: (i) the just-in-time wood-framed building factory 130, with multiple production lines 131A through 131D for producing Class-A fire-protected building components as illustrated in FIG. 44A; (ii) RFID-tagged/coded ISO-shipping containers 136 shown in FIG. 44A, and mobile code symbol/RFID tag reading mobile computing systems 137 for reading optical code symbols (e.g. PDF 417, etc.) 138A and RFID tags 138B well known in the shipment tracking art; a (iii) a data center 145, operably connected to the TCP/IP internet infrastructure 151 for supporting enterprise resource planning (ERP) related operations within the wood-framed building factory system 130 shown in FIGS. 44A and 44B, and supporting a network of mobile computing devices 137 shown in FIG. 46, each running a mobile application 153 adapted to help track and manage (i) orders placed by customers for prefabricated Class-A fire-protected wood-framed buildings, and (ii) projects within the factory system involving the placed customer orders. As shown, the data center 145 comprises: web (http and ftp) communication servers 146; application servers 147; database servers (RDBMS) 148; SMS servers 149; and email message servers 150, well known in the art.

As shown in FIG. 45, the system also includes a GPS system 139 for transmitting GPS reference signals transmitted from a constellation of GPS satellites deployed in orbit around the Earth, to GPS transceivers installed aboard each GPS-tracking ISO-shipping containers 136A, 136B, as part of the illustrative embodiments. From the GPS signals it receives, each GPS transceiver is capable of computing in real-time the GPS location of its host system, in terms of longitude and latitude. In the case of the Empire State Building in NYC, NY, its GPS location is specified as: N40° 44.9064′, W073° 59.0735′; and in number only format, as: 40.748440, −73.984559, with the first number indicating latitude, and the second number representing longitude (the minus sign indicates “west”).

FIG. 46 shows the mobile client computing system(s) 137, 137′ used in the system network 135 supporting mobile application 153 installed on each registered mobile computing system 137, 137′. The purpose of the mobile application 153 is to provide a convenient tool for tracking and managing projects involving factory-applied clean fire inhibiting chemical (CFIC) liquid dip-coating (or spray-based) treatment of wood pieces during the prefabrication of Class-A fire-protected wood-framed buildings.

### Specification of the Network Architecture of the System Network of the Present Invention

FIG. 45 illustrates the network architecture of the system network of the present invention 700 for the case where the system of the present invention is implemented as a stand-alone platform deployed on the Internet.

As shown in FIG. 45, the Internet-based system network 700 comprises: cellular phone and SMS messaging systems 161; email servers 1162; a network of mobile computing systems 136 (136A, 136B) running enterprise-level mobile application software; and one or more industrial-strength data center(s) 145, preferably mirrored with each other and running Border Gateway Protocol (BGP) between its router gateways.

As shown in FIG. 45, each data center 145 comprises: a cluster of communication servers 146 for supporting http and other TCP/IP based communication protocols on the Internet (and hosting Web sites); a cluster of application servers 147; a cluster of RDBMS servers 148 configured within a distributed file storage and retrieval ecosystem/system, and interfaced around the TCP/IP infrastructure of the Internet well known in the art; an SMS gateway server 149 supporting integrated email and SMS messaging, handling and processing services that enable flexible messaging across the system network 700, supporting push notifications; and a cluster of email processing servers 150.

Referring to FIG. 45, the cluster of communication servers 146 is accessed by web-enabled clients (e.g. smart phones, wireless tablet computers, desktop computers, computer workstations, etc.) 137 (137A, 137B) used by stakeholders accessing services supported by the system network. The cluster of application servers 147 implement many core and compositional object-oriented software modules supporting the system network 145. The cluster of RDBMS servers 148 use SQL to query and manage datasets residing in its distributed data storage environment.

As shown in FIG. 45, the system network architecture 700 further comprises many different kinds of users supported by mobile computing devices 137 running the mobile application 153 of the present invention, namely: a plurality of mobile computing devices 137 running the mobile application 153, and used by fire departments to access services supported by the system network 145; a plurality of mobile computing systems 137 running mobile application 153 and used by insurance underwriters to access services on the system network 145; a plurality of mobile computing systems 137 running mobile application 153 and used by architects and their firms to access the services supported by the system network 145 of the present invention; a plurality of mobile client machines 137 (e.g. mobile computers such as iPad, and other Internet-enabled computing devices with graphics display capabilities, etc.) for use by spray-project technicians and administrators, and running a native mobile application 137 supported by server-side modules, and the various illustrative GUIs shown in FIGS. 69 through 70J, supporting client-side and server-side processes on the system network of the present invention; and a GPS-tracked GSM-linked digital camera 163 installed over each CFIC liquid dip-coating tank, installed along a production line 131, for capturing digital images and video recordings of the CFIC liquid dip-coating (or spray-based) process, along the production line, where wood pieces are dip-coated (or sprayed) and Class-A fire-protected prior art to use in fabricating Class-A fire-protected wood-framed building components.

In general, the system network 135 will be realized as an industrial-strength, carrier-class Internet-based network 700 of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 153 of the present invention, described above.

### Specification of System Architecture of an Exemplary Mobile Smartphone System Deployed on the System Network of the Present Invention

FIG. 46 shows an exemplary mobile the mobile client computing system (e.g. client device) 137 that is deployed on the system network 135 and supporting the many services offered by system network servers of the present invention. As shown in FIG. 5B, the mobile computing device 137 (137′) can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 137 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 137 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 137 can be found in U.S. Pat. No. 8,631,358 incorporated herein by reference in its entirety.

### Different Ways of Implementing the Mobile Client Machines and Devices on the System Network of the Present Invention

In one illustrative embodiment, the enterprise-level system network 700 is realized as a robust suite of hosted services delivered to Web-based client subsystems 137 using an application service provider (ASP) model. In this embodiment, the Web-enabled mobile application 153 can be realized using a web-browser application running on the operating system (OS) (e.g. Linux, Application IOS, etc.) of a mobile computing device 137 to support online modes of system operation, only. However, it is understood that some or all the services provided by the system network 135 can be accessed using Java clients, or a native client application, running on the operating system of a client computing device, to support both online and limited off-line modes of system operation. In such embodiments, the native mobile application 153 would have access to local memory (e.g. a local RDBMS) on the client device 137, accessible during off-line modes of operation to enable consumers to use certain or many of the system functions supported by the system network during off-line/off-network modes of operation. It is also possible to store in the local RDBMS of the mobile computing device 137 most if not all relevant data collected by the mobile application for any fire-protection spray project, and to automatically synchronize the dataset for user's projects against the master datasets maintained in the system network database 148A, within the data center 145 shown in FIG. 45. This way, when using a native application, during off-line modes of operation, the user will be able to access and review relevant information regarding any building spray project, and make necessary decisions, even while off-line (i.e. not having access to the system network).

As shown and described herein, the system network 700 of the present invention has been designed for several different kinds of user roles including, for example, but not limited to: (i) building purchasers, builders, and architects who might or will have the authority to place or make purchase orders online to commence a Class-A fire-protected wood-framed building project; and (ii) prefabrication building project administrators and technicians registered on the system network. Depending on which role, for which the user requests registration, the system network will request different sets of registration information, including name of user, address, contact information, information about wood-framed buildings, builders, architects, etc. In the case of a web-based responsive application on the mobile computing device 137, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 700 can be realized as mobile web-browser application, or as a native application, each having a “responsive-design” and adapted to run on any client computing device (e.g. iPhone, iPad, Android or other Web-enabled computing device) 137 and designed for use by anyone interested in managing, overseeing and/or monitoring on-site CFIC liquid spray projects involving owners of specific wood-framed buildings seeking Class-A fire-protection.

### Specification of Database Schema for System Network Database Supported on the System Network of the Present Invention

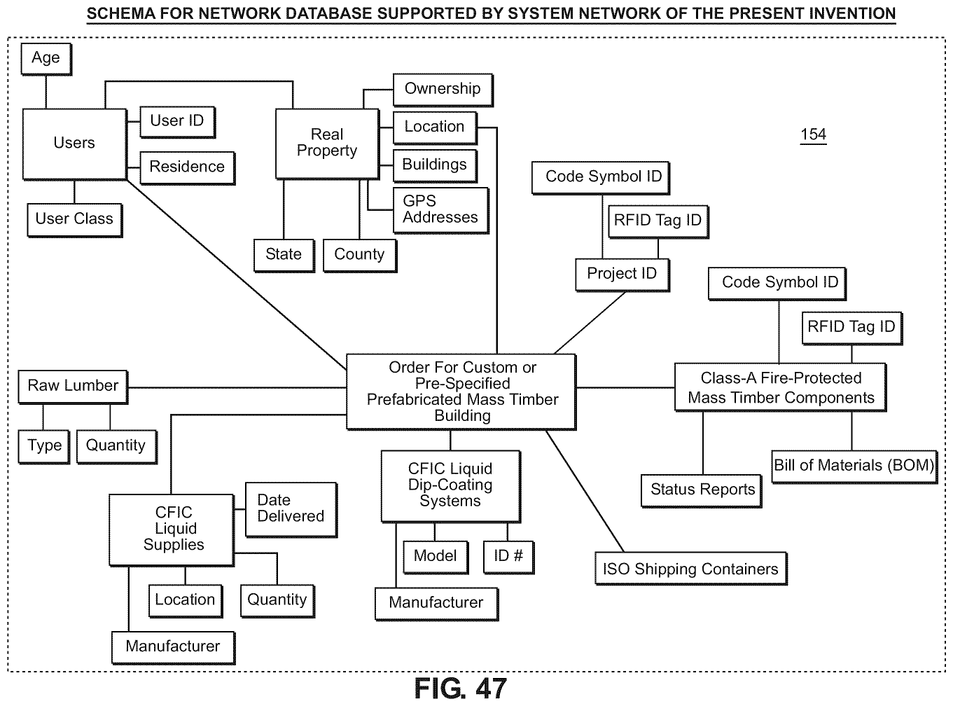

As shown in FIG. 47, the schema 154 includes objects such as, for example: users of the system (e.g. property owners, builders, insurance companies, etc.); real property on which the building will be constructed (if known at the time of ordering); orders for custom or pre-specified prefabricated wood-framed building; and construction project. Each of these objects have further attributes specified by other sub-objects, including, for example: project ID; raw lumber; CFIC liquid; CFIC liquid dip coating (and spraying) systems; Class-A fire-protected wood-framed components; and ISO-shipping containers.

### Specifications of Services Supported by the Graphical User Interfaces Supported on System Network of the Present Invention for Building Purchasers, Builders, Architects, Property Insurers and Other Stakeholders

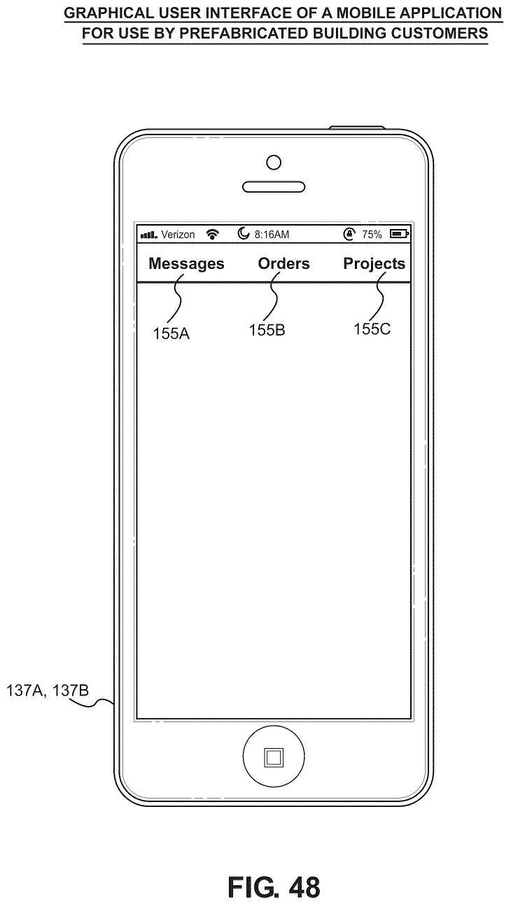

FIG. 48 illustrates an exemplary graphical user interface (GUI) 155 of the mobile application 153 used by customers who place orders for prefabricated Class-A fire-protected wood-framed buildings, supported by the system of the present invention. As shown in this exemplary GUI screen, a number of pull-down menus are supported under the titles: Messages 155A, where the user can view messages sent via messaging services supported by the application; Orders 155B, where orders for prefabricated buildings have been placed and scheduled, have been completed, or are in progress; and Projects 155C, which have been have been scheduled, have been completed, or are in progress, and where uploaded authenticated certifications can be reviewed, downloaded and forwarded as needed by authorized stakeholders, to the appropriate parties and authorities.

Notably, the GUIs will designed and configured for use by the prefabricated building administrators and technicians who will be responsible for (i) taking orders for prefabricated Class-A fire-protected wood buildings, and (ii) managing each prefabricated fire-protected building project, from start to finish, so that building owners, builders, architects, property insurance agents and financial institutions (e.g. banks) may rely on the prefabrication company managing each and every step of each project using the system network 700. Exemplary GUIs supporting these functions are shown and described in Applicant's granted U.S. Pat. No. 10,332,222 which is incorporated herein by reference in its entirety.

Specification of Services Supported by the Graphical User Interfaces Supported on System Network of the Present Invention for Use by Fabricators, Administrators and Technicians Involved in the Production of Prefabricated Class-A Fire-Protected Wood-Framed Buildings and Components

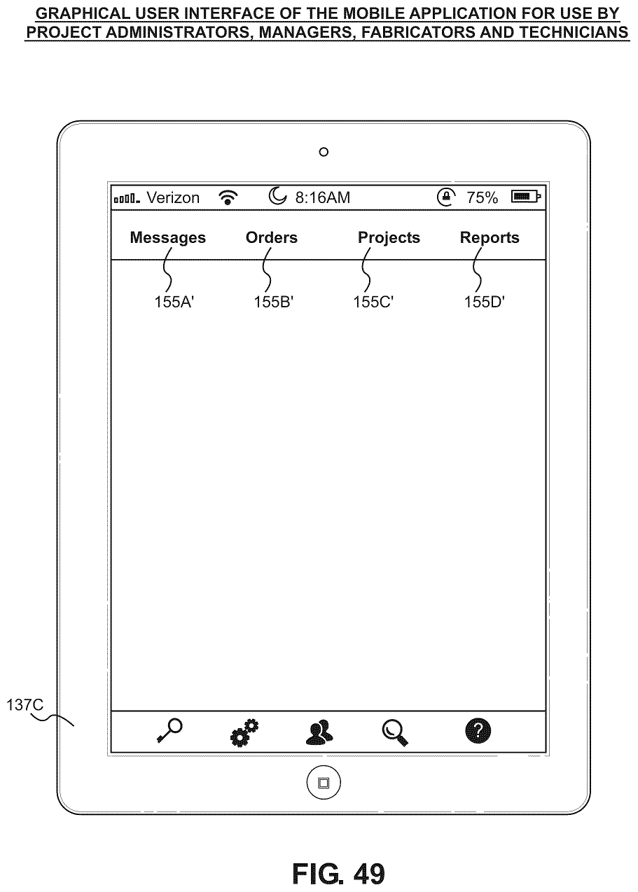

FIG. 49 shows an exemplary graphical user interface 156 for the mobile application 153 configured for use by JIT wood-framed building administrators and supervisors supported by the system network 700. As shown in this exemplary GUI screen 156, supports a number of pull-down menus under the titles: Messages 156A, where project administrators and supervisors can view messages sent via messaging services supported by the application; Orders 156B, where orders for prefabricated wood-framed buildings have been placed and/or scheduled, have been completed, or are in progress, with status notes, terms, conditions and other considerations made of record; Projects 156C, which have been have been scheduled, have been completed, or are in progress; and Reports 156D, which are generated for Orders, Projects and Supplies, on prefabricated wood-framed building projects are managed by the mobile application 153 running on the mobile client system 137C in operable communication with web, application and database servers 146, 147, 148 at the JIT factory data center 145.

Notably, the GUIs will be designed and configured for use by the prefabricated building administrators and technicians who will be responsible for (i) taking orders for a prefabricated Class-A fire-protected wood-framed building, (ii) managing the entire prefabricated fire-protected building project, from start to finish, so that building owners, builders, architects, property insurance agents and financial institutions (e.g. banks), as well as local, state and federal authorities, may rely on their services and work product of the prefabrication company managing each and every step of project using the system network 135. Exemplary GUIs supporting these functions are shown and described in Applicant's granted U.S. Pat. No. 10,332,222 which is incorporated herein by reference in its entirety.

In one illustrative embodiment, the mobile application 153 and/or digital camera systems can be used to review digital images and audio-video (AV) recordings taken of CFIC liquid dipped-coated wood pieces along the production line, relating to prefabricated wood-framed building components being fabricated, and uploaded to the system network database 148A under the project ID # of the prefabricated building project. All captured documents and evidence of CFIC liquid dip-coated wood can be uploaded, logged and time/date-stamped and stored into the project-specific document folder maintained on the system network database 148A of the system network 700 using document capture, time/date-stamping and cataloguing capabilities.

Alternatively, Class-A fire-protected lumber, and/or engineered wood products (EWPs), that are dip-coated in CFIC liquid, will be used to construct prefabricated Class-A fire-protected wood-framed building components (e.g. wall panels, roof trusses, floor trusses, roofing systems, flooring systems, and stair assemblies). Once constructed in the factory on the production line, a barcoded/RFID-tagged inspection label 400 is applied to each prefabricated Class-A fire-protected wood-framed building component produced on the production line 131. Each barcoded/RFID-tagged inspection label 400 will include a bar code symbol and RFID tag that has a unique building-component identifier (e.g. an alphanumeric character string) encoded into the symbology used in the barcode symbol and RFID tag identifier, and this building-component identifier will be used to identify subfolders or subdirectories where collection data, information and documents are stored in a building-component subfolder (indexed with the building-component identifier), in the building-project folder on the network database 113A, maintained on the system network 700. The building-component identifier will be read during each scan/read of the barcoded/RFID-tag label 400, and used by the mobile application 153 to access the appropriate building-component subfolder in the building project folder where all such certifications of dip-coating, inspection and oversight, and photos, and videos are stored and archived for posterity.

The mobile application 153 has access to all services supported in the mobile computing device 137 (e.g. Apple iPhone or iPad) as the case may be, for verifying and documenting the CFIC liquid spray treatment of each completed Class-A fire-protected wood-framed building fabricated in the factory. Such documentation should include capturing and uploading digital images and AV-recordings of certificates of CFIC liquid dip-coating stamped and verified along the production line involved the fabrication process.

In the event the purchaser of the prefabricated wood-framed building requested on-site application of Class-A fire-protection spray treatment, using CFIC biochemical liquid of the present invention shown in FIGS. 6 through 6V4, a professional fire-protection spray treatment (provider) team will use the system network 100 to apply, certify, verify, and document the Class-A fire protection liquid spray process as described in detail above, in synchronism with the prefabricated builder's schedule. As each predesignated section of the wood-framed building is constructed by assembling pre-fabricated Class-A fire-protected wood-framed building components (e.g. wall panels, floor and roof truss panels, stair components, etc.), the spray technicians will spray treat all exposed interior surface of the completed section of the wood-framed building, and certify, verify and document the spray treatment using the mobile application 153 using mobile computing devices 137 and services supported by the system network 700. Once completed, the prefabricated Class-A fire-protected wood-framed building will be double-protected with Class-A fire-protection, providing the building owner with many benefits, including potentially lower property insurance premiums, since significant risk of destruction by fire has been significantly reduced or otherwise minimized.

By virtue of the JIT factory system 130, it is now possible to produce, as needed, a custom or pre-specified wood-framed building made from Class-A fire-protected wood-framed building components, thereby minimizing inventory and cost of manufacture, and improving the quality and precision of prefabricated Class-A fire-protected prefabricated wood-framed buildings.

Specification of the Method of and Apparatus for Producing a Bundle of Class-A Fire-Protected Lumber Produced in Accordance with the Principles of the Present Invention

While most fires start small, they often spread rapidly onto surrounding flammable surfaces. Before long, the phenomenon of flash over occurs, where superheated gases cause a whole room to erupt into flame within minutes. Class-A fire-protected lumber of the present invention, as shown in FIG. 50, bears a clear or transparent surface coating formed by dip-coating and/or spraying lumber pieces in clean fire inhibiting chemical (CFIC) liquid of the present invention. When so treated, Class-A fire-protected lumber products will prevent flames from spreading, and confine fire to the ignition source which can be readily extinguished, or go out by itself.

FIG. 50 shows a bundle of Class-A fire-protected finger-jointed lumber 29 produced using the method of and apparatus of the present invention. FIG. 19 shows an automated lumber factory system 20 for continuously fabricating wrapped and packaged bundles of Class-A fire-protected finger-jointed lumber product 29 in a high-speed manner, in accordance with the principles of the present invention. However, it is understood that this automated factory and production methods can be used to treat and protect solid wood and timber products, as well, to produce Class-A fire-protected solid wood products (e.g. studs, beams, boards, etc.), as well as engineered wood products.

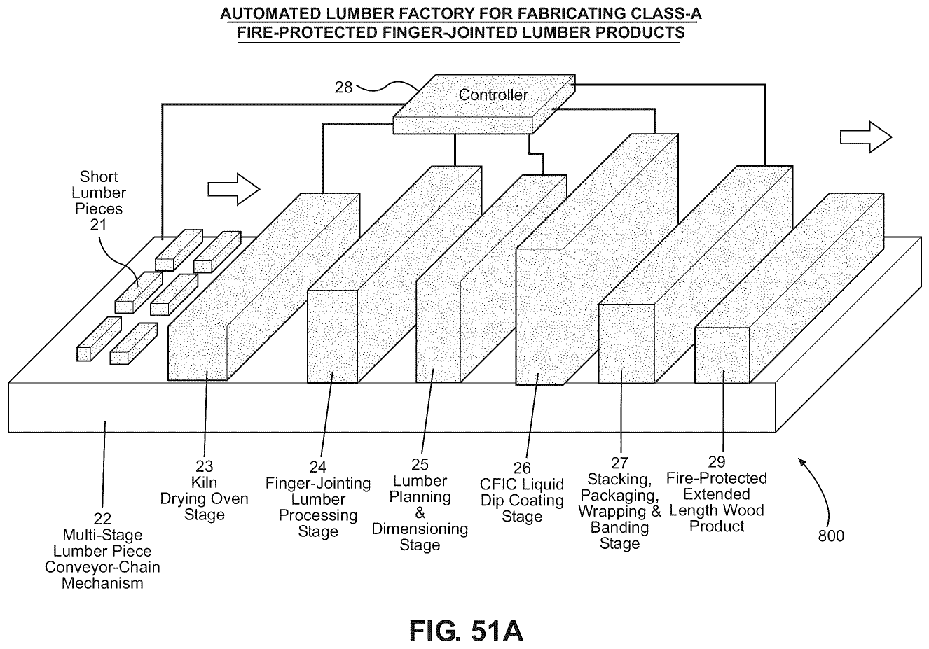

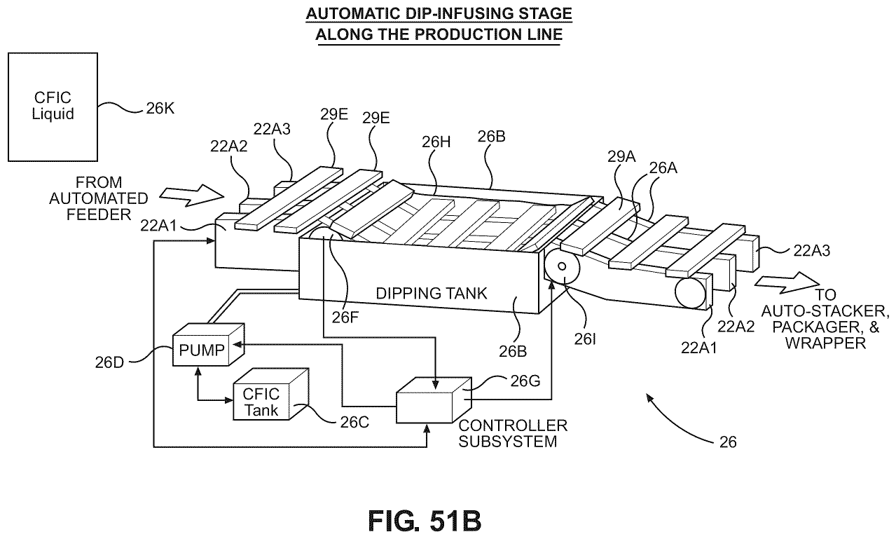

As shown in FIG. 51A, the factory 800 comprises a number of automated industrial stages integrated together under automation and control of controller 28, namely: a high-speed multi-stage lumber piece conveyor-chain mechanism 22 having 6 primary stages in the illustrative embodiment shown in FIGS. 51A and 51B; a kiln-drying stage 23 receiving short pieces of lumber 21 from a supply warehouse maintained in or around the factory; a finger-jointing lumber processing stage 24, for processing short-length pieces of kiln-dried lumber and automatically fabricating extended-length finger-jointed pieces of lumber 29, as output from this stage; a lumber planing and dimensioning stage 25 for planing and dimensioning elongated pieces of finger-jointed lumber into lumber pieces having lengths and dimensions for the product application at hand (e.g. studs); an in-line high-speed continuous CFIC liquid dip-coating stage 26, as further detailed in FIG. 51A; an automated stacking, packaging, wrapping and banding/strapping stage 27, from which bundles of packaged, wrapped and strapped Class-A fire-protected lumber product are produced in a high-speed automated manner.

In general, the kiln-drying stage 23 can be implemented in different ways. One way is providing a drying room with heaters that can be driven by electricity, natural or propane gas, and/or other combustible fuels which release heat energy required to dry short-length lumber pieces prior to the finger-joint wood processing stage. Batches of wood to be treated are loaded into the drying room and treated with heat energy over time to reduce the moisture content of the wood to a predetermined level (e.g. 19% moisture). In alternative embodiments, the kiln-drying stage 23 might be installed an elongated tunnel on the front end of the production line, having input and output ports, with one stage of the conveyor-chain mechanism 22 passing through the heating chamber, from its input port to output port, allowing short-length lumber to be kiln-dried as it passes through the chamber along its conveyor mechanism, in a speed-controlled and temperature-controlled manner. Other methods and apparatus can be used to realize this stage along the lumber production line, provided that the desired degree of moisture within the wood is removed at this stage of the process.

As illustrated in FIG. 51A, the finger-jointing lumber processing stage 24 can be configured as generally disclosed in US Patent Application Publication Nos. US20070220825A1 and US20170138049A1, incorporated herein by reference. In general, this stage involves robotic wood-working machinery, automation, and programmable controls, well known in the finger-jointing wood art, and transforms multiple smaller-pieces of kiln-dried lumber into an extended-length piece of finger-jointed lumber, which is then planed and dimensioned during the next planning/dimensioning stage of the production line. An example of commercial equipment that may be adapted for the finger-jointing processing stage 24 of the present invention may be the CRP 2500, CRP 2750 or CRP 3000 Finger Jointing System from Conception R.P., Inc., Quebec, Canada http://www.conceptionrp.com/finger-jointing-systems.

As illustrated in FIG. 51A, the lumber planing and dimensioning stage 25 includes wood planing equipment, such industrial band or rotary saws designed to cut and dimension finger-jointed lumber pieces produced from the finger-jointing lumber processing stage 24, into lumber boards of a specified dimension and thickness, in a highly programmed and automated manner.

As shown in FIG. 51B, the dip-coating stage 26 of the factory system 800 comprises a number of components integrated together on the production line with suitable automation and controls, namely: a multi-stage chain-driven conveyor subsystem 22, supporting several parallel sets of chain-driven transport rails 22A1, 22A2 and 22A3, as shown, extending from the planing and dimensioning stage 25 towards the dipping tank 26B, and then running inside and along the bottom of the dipping tank 26B, and then running out thereof towards the stacking, packing, wrapping and banding/strapping stage 27, as shown, and having the capacity of transporting extend-length finger-jointed lumber pieces (i.e. boards) having a length as long as 30 or so feet; a dipping reservoir 26B having a width dimension to accommodate the width of the chain-driven conveyor rails 22A1, 22A2 and 22A3 mounted and running outside of and also within the dipping tank 26B, as shown, to transport up planed and dimensioned finger-jointed lumber pieces 29A supported upon the chain-driven rails 22A1, 22A2 and 22A3, while the boards are fully immersed and submerged at least 6 inches deep in CFIC liquid 26H contained in the dipping tank 26B, while moving at high speed, such as 300 feet/minute through the dipping tank 26B during the CFIC dip-coating process of the present invention; electrically-powered driven motors 261 for driving the chain-driven conveyors 22A1, 22A2 and 22A3 under computer control to transport finger-jointed pieces of lumber from stage to stage along the lumber production line; a level sensor 26F for sensing the level of CFIC liquid 26B in the dipping tank at any moment in time during production line operation; a reservoir tank 26C for containing a large volume or supply of CFIC liquid solution 26K; a computer controller 26G for controlling the conveyor subsystem 22, and an electric pump 26D for pumping CFIC liquid into the dipping tank 26B to maintain a constant supply level during system operation in response to the liquid level measured by the level sensor 26F.

The high-speed CFIC liquid dip-coating subsystem 26 shown in FIG. 51B may also include additional apparatus including, for example, liquid heaters, circulation pumps and controls for (i) maintaining the temperature of CFIC liquid solution in the dipping tank 26B, and (ii) controlling the circulation of CFIC liquid around submerged pieces of finger-jointed lumber 29A being transported through the dipping tank 26B in a submerged manner during a CFIC coating process. Controlling such dip-coating parameters may be used to control the amount and degree of absorption of CFIC liquid within the surface fibers of the finger-jointed lumber 29A as it is rapidly transported through the dipping tank 26B between the lumber planing and dimensioning stage 25 and the lumber stacking, packaging, wrapping, and banding/strapping stage 27 of the lumber production line. Notably, the dip coating process of the present invention allows for the rapid formation a surface coating, or surface barrier, on the surface of each piece of dipped lumber, and in the presence of the surfactant in the CFIC liquid in the dipping tank, shallow impregnation of CFIC liquid 26H to occur into the surface fibers of each piece of lumber 29A near atmospheric pressure (i.e. below 6 inches of liquid CFIC in the dipping tank) during the dip-coated process according to the principles of the present invention. It is understood that drip pans may also be provided beyond the dipping tank 26B, installed beneath the chain-driven conveyor subsystem arranged between the dripping tank 26B and the stacking, packaging, wrapping and banding/strapping stage 27, to recover excess CFIC liquid dripping from the dip-coated lumber pieces 29A and returning this recovered CFIC liquid to the dipping tank 26B after appropriate filtering of the CFIC liquid if and as necessary.

As illustrated in FIG. 51A, the stacking, packaging, wrapping and banding stage 27 includes equipment designed to automatically receive CFIC-coated finger-jointed lumber pieces 29A while still dripping and wet from CFIC liquid 26H, and wet stacking a predetermined number of lumber pieces into a package, and then wrapping the package of lumber with a sheet of wrapping material (e.g. TVEK or like material) that covers the top portion and at least half way down each side of the lumber package, and then banding or strapping the wrapped package with fiberglass or steel banding, well known in the art. The wrapping will typically be preprinted with trademarks and logos of the lumber manufacturer's brand. Finally, the ends of the lumber pieces in the strapped, wrapped lumber package are painted with a fire-protective paint also containing CFIC liquid in amounts to be effective in Class-A fire suppression.

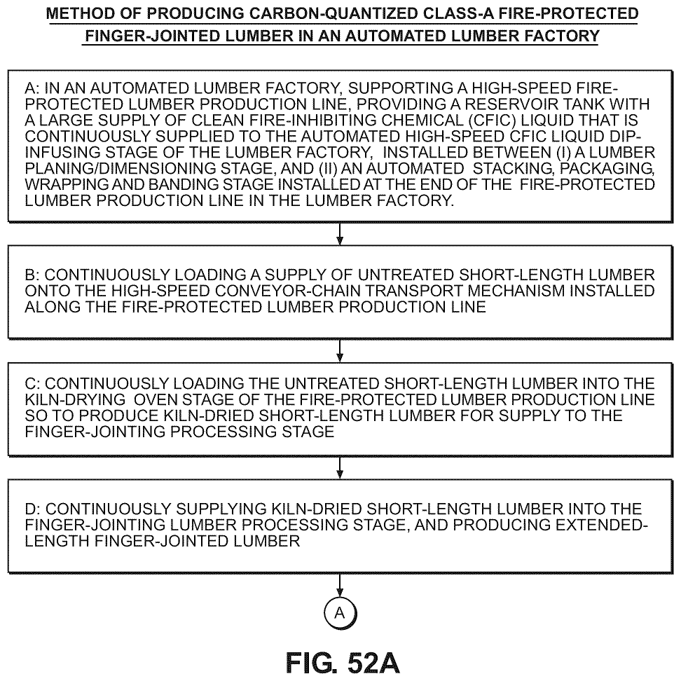

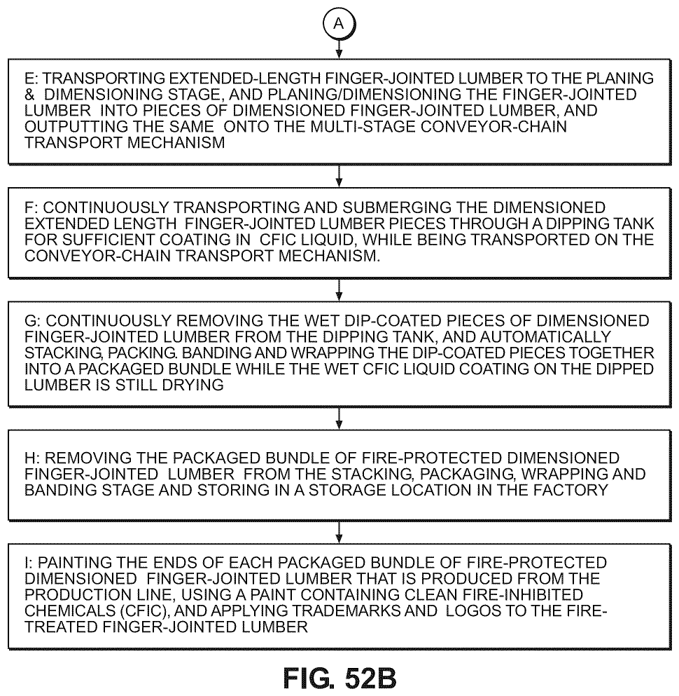

FIGS. 52A and 52B describe the high-level steps carried out when practicing the method of producing bundles of Class-A fire-protected finger-jointed lumber 29 for use in fire-protected building construction.

As indicated at Block A in FIG. 52A, in an automated lumber factory, a high-speed Class-A fire-protected lumber production line is installed and operated, with a reservoir tank 26C containing a large supply of clean fire inhibiting chemical (CFIC) liquid 26K that is supplied to the automated CFIC liquid dip-coating stage 26 of the lumber factory 20, installed between (i) the lumber planing/dimensioning stage 25, and (ii) an automated stacking, packaging, wrapping and banding stage 27 in the lumber factory 20.

As indicated at Block B in FIG. 52A, a supply of untreated short-length lumber is loaded onto the high-speed conveyor-chain transport mechanism 22 and auto-feeder installed along and between the stages of the lumber production line.

As indicated at Block C in FIG. 52A, the untreated short-length lumber is loaded into the controlled-drying stage 23 of the fire-protected lumber production line so to produce suitably dried short-pieces of lumber for supply to the finger-jointing processing stage 24. This stage can be performed by loading batches of short length lumber into the drying room or oven, whose temperature and humidity are strictly controlled using electric heaters and other equipment under computer control. Alternatively, short-length lumber pieces can be controllably dried by moving batches of short-length lumber through a tunnel-like drying room or chamber, through which chain-driven conveyor mechanism 22 passes, like other stages along the lumber production line, while the temperature and humidity of the environment is controlled using electric-driven or gas-combusting heaters under computer control in a manner well known in the art.

As indicated at Block D in FIG. 52A, the controllably-dried short-length lumber is continuously supplied into the finger-jointing lumber processing stage 24, for producing pieces of extended-length finger-jointed lumber in a highly automated manner.

As indicated at Block E in FIG. 52B, produced pieces of extended-length finger-jointed lumber are automatically transported to the planing/dimensioning stage 25 so that the finger-jointed lumber can be planed/dimensioned into pieces of dimensioned finger-jointed lumber 29A, and outputted onto the multi-stage conveyor-chain transport mechanism 22.

As indicated at Block F in FIG. 52B, the dimensioned finger-jointed lumber pieces 29A are continuously transported and submerged through an automated dipping tank 26B for sufficient coating in CFIC liquid while being transported on the conveyor-chain transport mechanism 22.

As indicated at Block G in FIG. 52B, the wet dip-coated pieces of dimensioned finger-jointed lumber are continuously removed from the dipping tank 26B, and automatically wet-stacking, packing, wrapping, and banding the wet dip-coated pieces into a packaged bundle of Class-A fire-protected finger-jointed lumber.

As indicated at Block H in FIG. 52B, the packaged bundle of Class-A fire-protected finger-jointed lumber is removed from the stacking, packaging, wrapping and banding stage 27 and stored in a storage location in the factory. The strapping for the bundle material used may be made of high-strength fiberglass plastic or metal banding material.

As indicated at Block I in FIG. 52B, the ends of each packaged bundle of fire-protected dimensioned finger-jointed lumber 29, produced from the production line, are painted using a Class-A fire-protected paint containing clean fire-inhibited chemicals (CFIC) (e.g. 25% fire inhibiting biochemical liquid of the present invention, 75% liquid polymer binder, and black liquid pigment) and applying trademarks and logos to the wrapped package of Class-A fire-protected finger-jointed lumber.

In the illustrative embodiment, a fire inhibitor biochemical liquid of the present invention is used as the CFIC liquid 26H that is deposited as a CFIC surface coating during the dip-coating and/or spray-coating of wood/lumber products on the production line of the present invention described above. The surfactants in biochemical formulation break the surface tension and allow its chemical molecules to impregnate ever so slightly the surface of the treated wood. This way, in the presence of a flame, the chemical molecules in the alkali metal salt crystalline coating (i.e. CFIC-coating) on the surface of the fire-protected lumber, interferes with the free radicals (H+, OH—, O—) produced during the combustion phase of a fire, and breaks the fire's chemical reaction and extinguishes its flame. This is a primary fire suppression mechanism implemented by the CFIC-coatings deposited on wood surfaces in accordance with the various principles of invention disclosed and taught herein.

Expectedly, the flame spread and smoke development indices of fire-protected lumber 29 produced using the method of the illustrative embodiment, using biochemical liquid of the present invention as a CFIC liquid dip coating material, described in FIGS. 52A and 52B, should meet or exceed the standards of ASTM E84 Testing for proactively treated wood under the ASTM Standards.

Specification of the Method of and Apparatus for Producing Class-A Fire-Protected Cross-Laminated Timber (CLT) Panels in Accordance with the Principles of the Present Invention

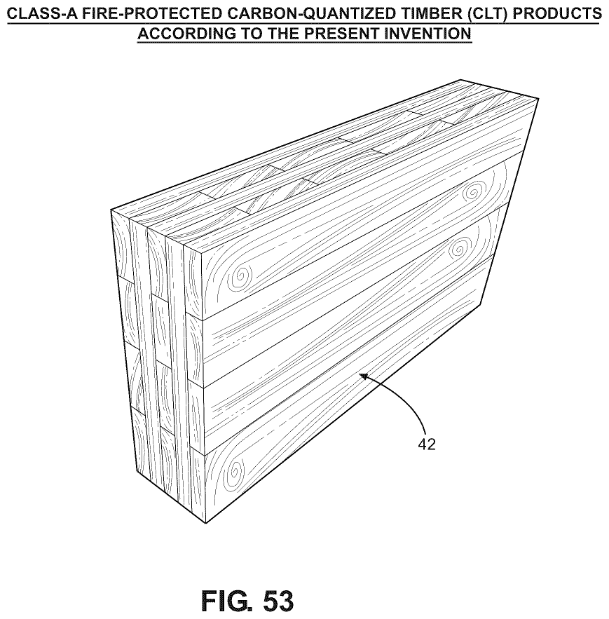

FIG. 53 shows a bundle of fire-protected cross-laminated timber (CLT) products (e.g. panels 42) produced using the method and apparatus of the present invention. The Class-A fire-protected cross-laminated timber (CLT) of the present invention 42 bears a surface coating of clean fire inhibiting chemical (CFIC) liquid. This CFIC coating prevents flames from spreading by breaking the free radical chemical reaction within the combustion phase of fire, and confining the fire to the ignition source which can be readily extinguished, or go out by itself. When practicing the present invention, it is important that other fungicides, biocides, wood preservatives, and/or mildew agents are not added to the CFIC solution 39H in the CFIC dip coating tank 32B because it has been discovered that such agents will chemically interfere with and adversely affect the fire-inhibiting properties and characteristics of the fire-inhibiting biochemicals.

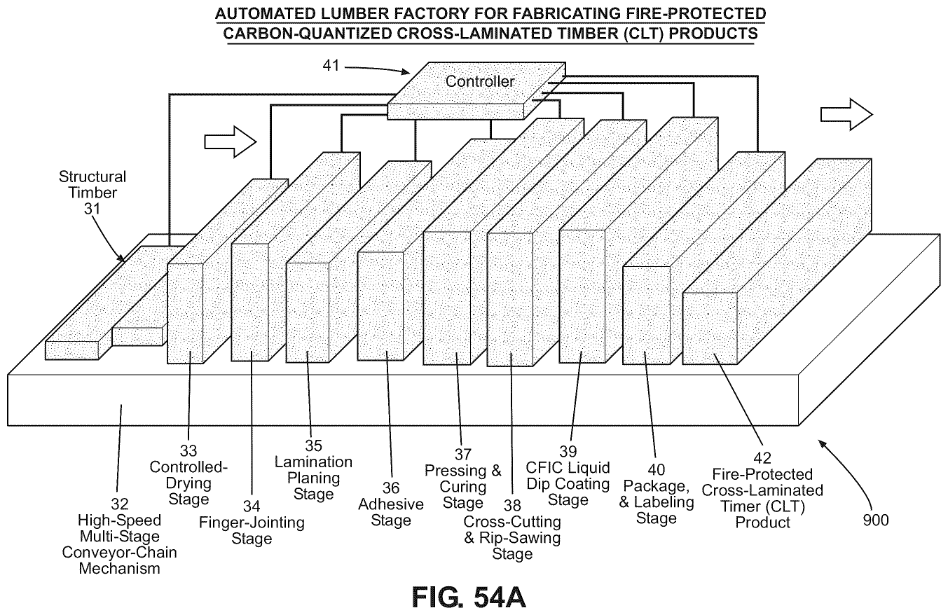

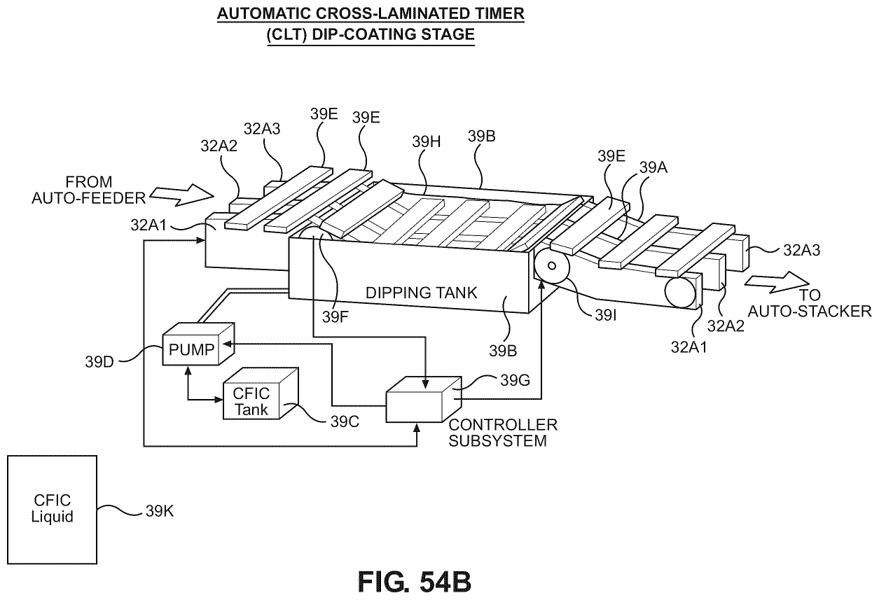

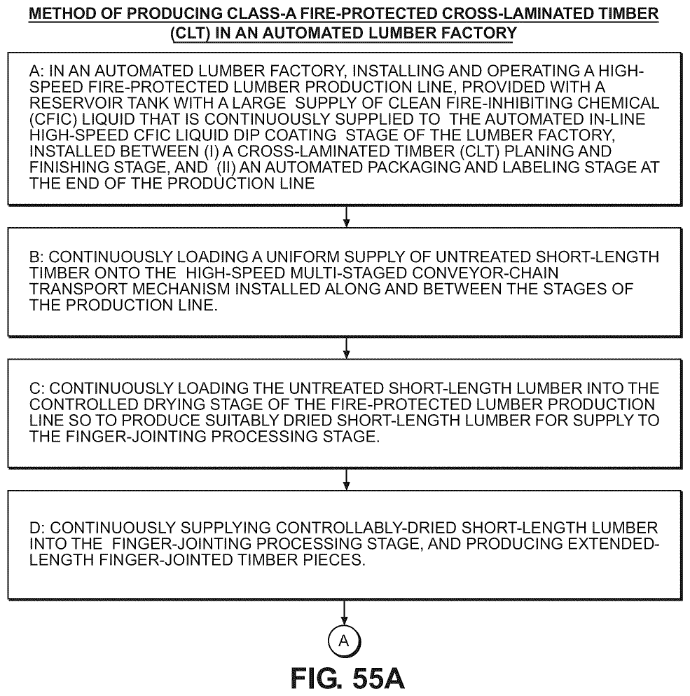

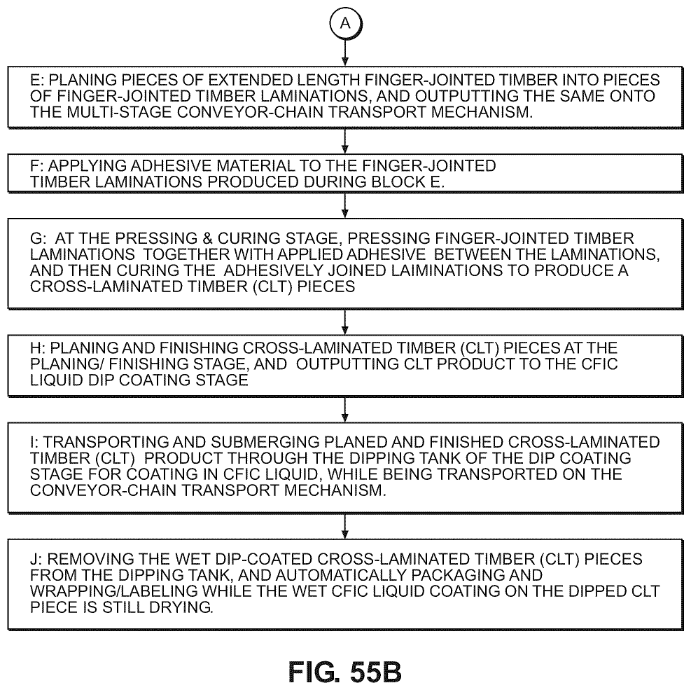

FIG. 54A shows an automated factory system 900 for producing Class-A fire-protected cross-laminated timber (CLT) panels, beams, and other products 42 in a high-volume manner. As shown in FIG. 54A, the factory 900 comprises a number of automated stages integrated together under automation and control, namely: a multi-stage conveyor-chain mechanism 32 having numerous primary stages in the illustrative embodiment shown in FIGS. 55A and 55B; a controlled-drying stage 33 receiving short pieces of lumber from a supply warehouse maintained in or around the factory and drying them in a controlled manner well known in the art; a finger-jointing stage 34, for processing short-length pieces of dried timber (i.e. lumber) and automatically fabricating extended-length finger-jointed pieces of timber, as output from this stage; a lamination planing stage 35 for planing finger-jointed pieces of timber to produce finger-jointed timber laminations; an automated adhesive stage 36 for applying adhesive to the finger-jointed timer laminations; a pressing and curing stage 37 where the finger-jointed laminations with adhesive are stacked in a cross-directional manner and then placed in pressing machine where the adhesive is cured under pressure to produce a cross-laminated timber (CLT) panel, beam or other product; cross-cutting and rip-sawing stage 38 for cutting and ripping cross-laminated timber (CLT) panels into CLT products 42A; a chain-driven conveyor 32 for conveying the CLT product 42A along the next few stages of the production line; an in-line CFIC liquid dip-coating stage 39, as further detailed in FIG. 54A, supporting an elongated dipping tank 39B through which the chain-driven conveyor 32 transports CLT product into the dipping tank 39H and along its length while submerged under CFIC liquid 39H during dip-coating operations, to form a CFIC coating on the surfaces of the CLT product, and removing the CFIC-coated CLT product from the dipping tank and transport it to the next stage along the production line; a packaging and wrapping/labeling stage 40 for packaging and wrapping/labeling CLT product 42A either after it has dried, or while the CFIC-coated CLT product is still wet and allowed to dry in its wrapping.

In general, the controlled-drying stage 33 will include drying room with heaters that can be driven by electricity, natural or propane gas, or other combustible fuels which produce heat energy required to dry short-length lumber prior to the finger-joint wood processing stage. Some alternative embodiments, the controlled-drying stage 33 might be installed on the front end of the production line, and having input and output ports, with one stage of the conveyor-chain mechanism 32 passing through the heating chamber, from its input port to output port, allowing short-length lumber to be kiln-dried as it passes through the chamber along its conveyor mechanism. Other methods and apparatus can be used to realize this stage of the lumber production line of the present invention, provided that the desired degree of moisture within the wood is removed with heat or radiant energy at this stage of the process.

As illustrated in FIG. 54A, the finger-jointing lumber processing stage 34 can be configured as generally disclosed in US Patent Application Publication Nos. US20070220825A1 and US20170138049A1, incorporated herein by reference. In general, this stage involves robotic wood-working machinery, automation, and programmable controls, well known in the finger-jointing wood art, and transforms multiple smaller-pieces of kiln-dried lumber into an extended-length piece of finger-jointed lumber, which is then planed and dimensioned during the next planning/dimensioning stage of the production line. An example of commercial equipment that may be adapted for the finger-jointing processing stage 34 of the present invention may be the CRP 2500, CRP 2750 or CRP 3000 Finger Jointing System from Conception R.P., Inc., Quebec, Canada http://www.conceptionrp.com/finger-jointing-systems.

As illustrated in FIG. 54A, the laminating planing stage 35 includes wood lamination planing equipment, such industrial band or rotary saws designed to cut, plane and dimension finger-jointed lumber pieces produced from the finger-jointing stage 34, into finger-jointed timber laminations of a specified dimension and thickness.

As illustrated in FIG. 54A, the lamination planing stage 35 can be realized using a band or radial saw as may be required to produce finger-jointed laminations.

As illustrated in FIG. 54A, the adhesive application stage 36 can be realized using automated adhesive applicators well known in the art to apply a predetermined controlled amount of adhesive to each finger-jointed timber lamination during the automated finger-jointing process.

As illustrated in FIG. 54A, the pressing and curing stage 37 can be realized using an automated pressing and curing machine well known in the art to apply a predetermined controlled amount of pressure to the timber laminations after they have been cross-configured, and placed into the machine for pressing and subsequent curing operations.

LEDINEK Engineering, do.o.o, of Hoce, Slovenia, offers complete turnkey CLT production lines for high-volume automated production of cross-laminated timber (CLT) panels. Such systems comprise: lamination planers; finger jointing machines; presses & curing machines; and automation and controllers. Such technologies and machines can be used to implement many of the stages described above in the CLT panel production line of the present invention. https://www.ledinek.com/engineered-timber

As shown in FIG. 54B, the in-line high-speed continuous CFIC liquid dip-coating stage 39 of the production line comprises a number of components integrated together, with suitable automation and controls, namely: a multi-stage lumber board chain-driven conveyor subsystem 32, supporting several parallel sets of chain-driven transport rails 32A1, 32A2 and 32A3, as shown, extending from the pressing and curing stage 39 towards a dipping tank 39B, and then running inside and along the bottom of the dipping tank 39B, and then running out thereof, towards the packing and wrapping stage 40, as shown, and having the capacity of transporting CLT panels and boards having a length up to 30 or so feet.

In the illustrative embodiment, the dipping tank 39B has a width dimension of 32 or so feet to accommodate the width of the CLT product being transported on chain-driven conveyor rails 32A1, 32A2 and 32A3 mounted and running outside of and within the dipping tank 39B, as shown. As shown, the CLT products 42A are supported upon the chain driven rails 32A1, 32A2 and 32A3 while the CLT products are transported through the dipping tank 39B while fully immersed and submerged at least 6 inches deep in CFIC liquid 39H contained in the dipping tank 39B, moving lumber in and out of the dipping tank 39B in just a few seconds during the CFIC dip-coating process of the present invention. Electrically-powered driven motors 391 are provided for the purpose of driving the chain-driven conveyors 32A1, 32A2 and 32A3 under computer control to transport CLT products 39E from stage to stage along the production line. A level sensor 39F is used for real-time sensing and control of the liquid level of CFIC liquid 39H in the dipping tank 39B at any moment in time during production line operation. A reservoir tank 39C is provided for containing a large volume or supply of made up CFIC liquid solution. Also, a computer controller 39G is used for controlling the conveyor subsystem 32, and an electric pump 39D for pumping CFIC liquid into the dipping tank 39B to maintain a constant supply level during system operation in response to the liquid level measured by the level sensor 39F and supplied to the control computer 39G.

The high-speed dip-coating subsystem 39 may also include additional apparatus including, for example, liquid heaters, circulation pumps and controls for (i) maintaining the temperature of CFIC liquid solution in the dipping tank 39B, and (ii) controlling the circulation of CFIC liquid around submerged CLT product 39E being transported through the dipping tank in a submerged manner during a CFIC coating process. Controlling such dip coating parameters may be used to control the amount and degree of absorption of CFIC liquid within the surface fibers of the CLT product, as it is rapidly transported through the dipping tank 39B. Notably, the dip coating process allows for the rapid formation a surface coating, or surface barrier, on the surface of each piece of dipped CLT product 39E, and in the presence of a surfactant in the CFIC liquid in the dipping tank 39B, shallow impregnation of CFIC liquid 39H can occur into the surface fibers of each CLT piece 42A near atmospheric pressure (i.e. below 6 inches of liquid CFIC in the dipping tank). It is understood that drip pans may also be provided beyond the dipping tank 39B, installed beneath the chain-driven conveyor subsystem 32 arranged between the dripping tank 39B and the packaging and wrapping stage 40, to recover excess CFIC liquid dripping from the dip-coated lumber pieces and returning this recovered CFIC liquid to the dipping tank 39B after appropriate filtering of the CFIC liquid if and as necessary.

In alternative embodiments, the dipping tank can be replaced with an air-less spraying station for spraying CFIC liquid solution over surfaces of CLT products.

As illustrated in FIG. 54A, the packaging and wrapping stage 40 includes equipment designed to receive CFIC-coated CLT product while still dripping and wet from CFIC liquid, and wrapping the CLT product 42A with a sheet of wrapping material (e.g. TVEK or like material) that covers the top portion and at least half way down each side of the CLT product, and then banding or strapping the wrapped package 42 with fiberglass or steel banding, well known in the art. The wrapping will typically be preprinted with trademarks and logos of the lumber manufacturer's brand. Finally, the ends of the lumber pieces in the strapped, wrapped lumber package 42 are painted with a fire-protective paint also containing CFIC liquid material, in amounts to be effective in fire suppression.

FIGS. 55A and 55B describe the high-level steps carried out when practicing the method of producing bundles of Class-A fire-protected cross-laminated timber (CLT) 42 for use in fire-protected building construction.

As indicated at Block A in FIG. 55A, in an automated lumber factory 900, a high-speed Class-A fire-protected lumber production line is installed and operated, with a reservoir tank 39B containing a large supply of clean fire inhibiting chemical (CFIC) liquid 39H that is continuously supplied to the automated high-speed CFIC liquid dip-coating stage 39 of the lumber factory 900, installed between (i) a cross-cutting and rip-sawing stage 38, and (ii) an automated stacking, packaging, wrapping and banding/strapping stage 40 installed at the end of the production line in the factory 900.

As indicated at Block B in FIG. 55A, a supply of untreated short-length lumber is loaded onto the conveyor-chain transport mechanism 32 installed along and between the stages of the production line.

As indicated at Block C in FIG. 55A, the untreated short-length lumber is loaded into the controlled-drying stage of the production line so to produce suitably dried short-length lumber for supply to the finger-jointing processing stage 34. This stage can be performed by loading batches of short length lumber into the drying room or oven, whose temperature and humidity are strictly controlled using electric heaters and other equipment under computer control. Alternatively, short-length lumber pieces can be controllably dried by moving batches of short-length lumber through a tunnel-like drying room or chamber, through which chain-driven conveyor mechanism 32 passes, like other stages along the lumber production line of the present invention, while the temperature and humidity of the environment is controlled using electric-driven or gas-combusting space heaters under computer control in a manner well known in the art.

As indicated at Block D in FIG. 55A, the controllably-dried short-length lumber is continuously supplied into the finger-jointing stage 34, for producing pieces of extended-length finger-jointed timber (lumber) in a highly automated manner.

As indicated at Block E in FIG. 55B, pieces of extended length finger-jointed timber are planed and dimensioned into pieces of finger-jointed timber laminations, and outputting the same onto the conveyor-chain transport mechanism 32.

As indicated at Block F in FIG. 55B, adhesive material is applied to the finger-jointed timber laminations produced during Block E.

As indicated at Block G in FIG. 55B, at the pressing & curing stage 37, pressing a plurality of finger-jointed timber laminations together with applied adhesive between the laminations, and then curing the adhesively joined laminations to produce a cross-laminated timber (CLT) pieces.

As indicated at Block H in FIG. 55B, cross-laminated timber (CLT) pieces are planed and finished at the cross-cutting and rip-sawing stage 38, and outputting finished CLT product to the CFIC liquid dip coating stage 39.

As indicated at Block I in FIG. 55B, the finished CLT products are continuously transported and submerged through the dipping tank 39B of the dip coating stage 39 for sufficient coating in CFIC liquid 39H, while being transported on the conveyor-chain transport mechanism 32.

As indicated at Block I in FIG. 55B, continuously removing the wet dip-coated cross-laminated timber (CLT) pieces are continuously removed from the dipping tank 39B, and automatically stacked, packaged, and wrapped/labeled while wet with CFIC liquid coating, and allowed to dry within the package wrapping.

In the illustrative embodiment, CFIC biochemical liquid 34H of the present invention is used to form the CFIC surface coating onto treated wood/lumber products produced on the production line of the factory 900 described above. The potassium citrate salt crystalline structures in the resultant fire inhibiting coating (i.e. CFIC surface) will cling to the surface of the CFIC-coated wood, while surfactants properties in its coalescing agent help to break the surface tension and allow potassium salt ions to penetrate ever so slightly the surface of the treated wood. This way, in the presence of aflame, the potassium citrate salt crystalline structures in the CFIC-coating on the surface of the fire-protected lumber, are present to interrupt the combustion phase of fire by one or more pathways including interferes with the free radicals (H+, OH—, O—) of the chemical reaction produced within the combustion phase of a fire, and breaking the fire's chemical reaction and extinguishes its flame.

Specification of Method of Producing Clean Fire-Protected Oriented Strand Board (OSB) Sheathing Constructed in Accordance with the Principles of the Present Invention

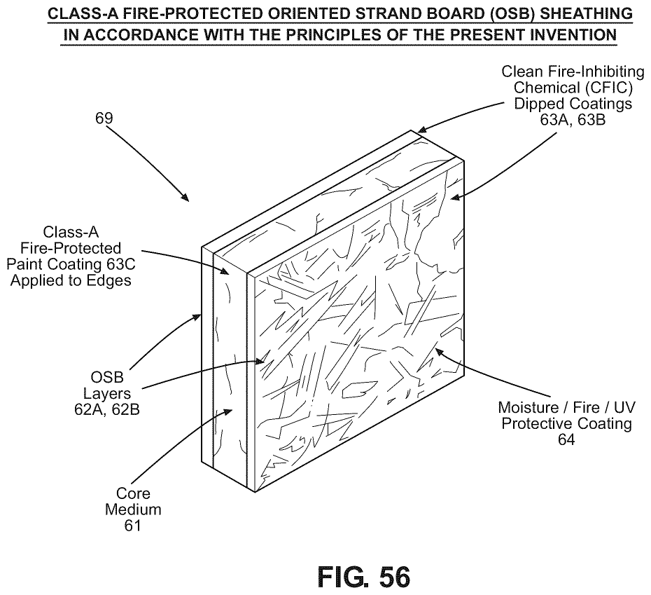

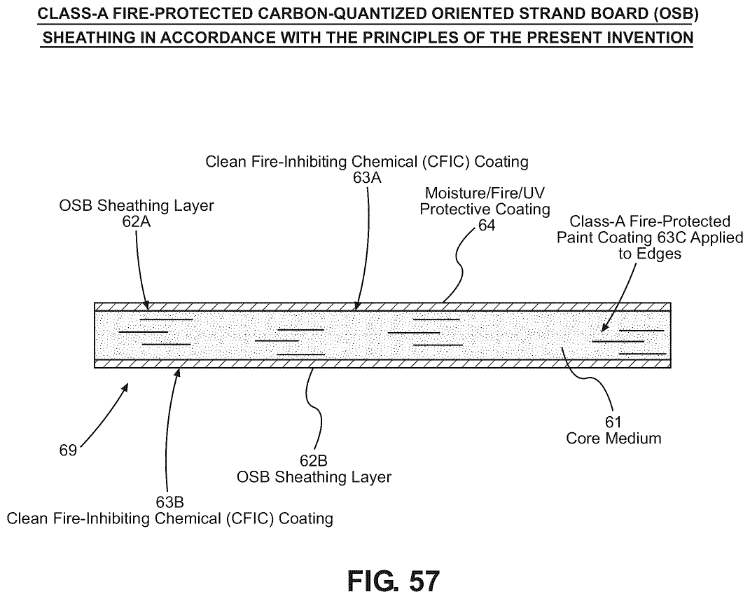

FIGS. 56 and 57 show a piece of Class-A fire-protected oriented strand board (OSB) sheathing 60 constructed in accordance with the principles of the present invention. This Class-A fire-protected OSB sheathing is provided with a moisture, fire and UV protection coating 64 that supports weather during building construction when roof, wall and floor sheeting gets hammered by the natural environment until the building is “dried in.” The coating 64 also protects the CFIC dip-coatings 63A and 63B and paint coating 63C from getting washed out by the weather during the construction phase, as otherwise occurs with most conventional pressure-treated lumber products.

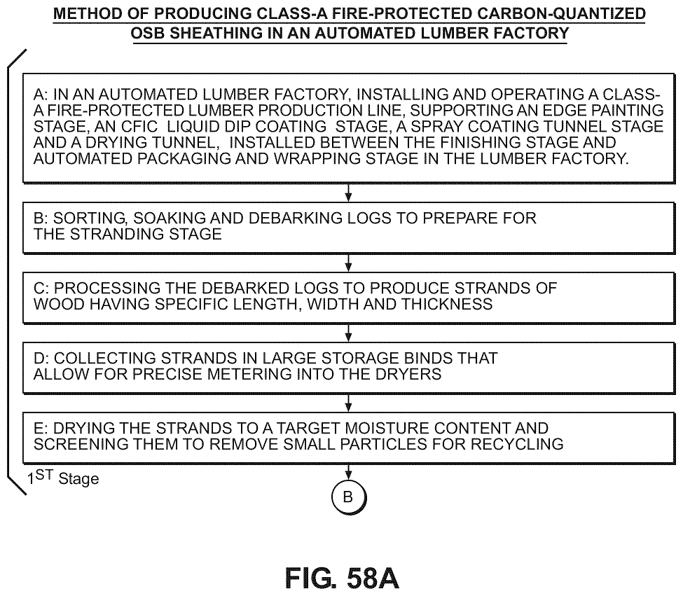

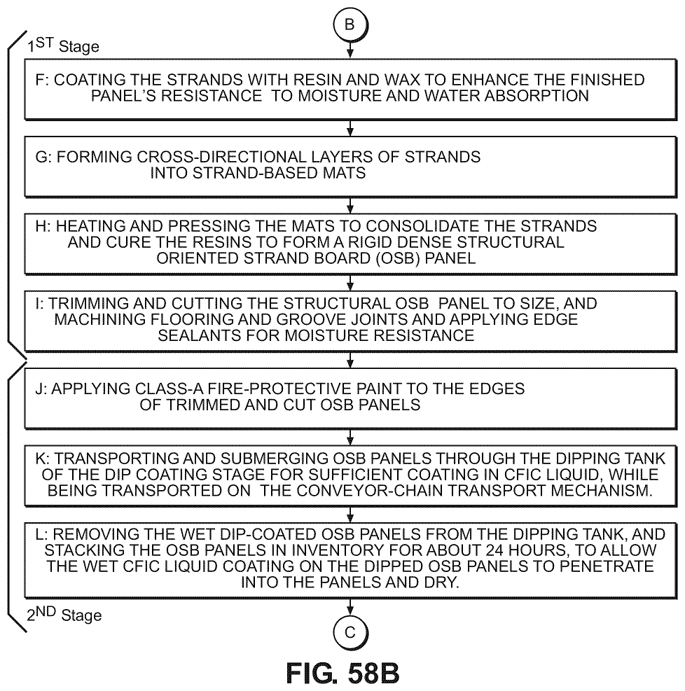

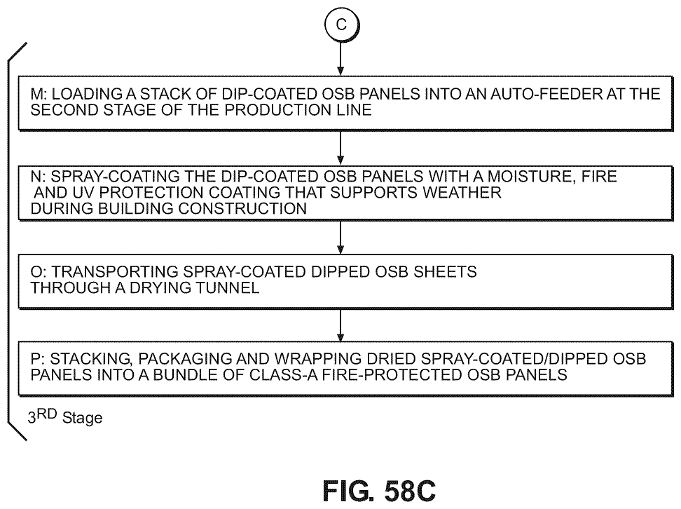

As shown in FIGS. 56 and 57, the Class-A fire-protective OSB sheathing 60 comprises: a core medium layer 61 made of wood pump, binder and/or adhesive materials; OSB sheathing layers 62A and 62B bonded to the core medium layer 61; a clean fire inhibiting chemical (CFIC) coating 63C painted onto the edge surfaces of the core medium layer 61, using a Class-A fire-protective paint containing a CFIC liquid of the present invention illustrated in FIGS. 6 through 6V4, realized using a fire inhibiting biochemical liquid composition of the present invention illustrated in FIGS. 6A1 through 6C2; CFIC coatings 63A and 63B applied to the surface of OSB sheathing layers 62A and 62B respectively, by dipping the OSB sheathing 66 into a CFIC liquid 66H contained in a dipping tank 66B, and allowing shallow surface absorption or impregnation into the OSB sheathing layers 62A and 62B at atmospheric pressure for spraying CFIC liquid over all surfaces of the OSB sheathing 60; and a moisture/fire/UV protective coating 64 spray-coated over the CFIC coatings 63A, 63B and 63C applied to protect these underlying CFIC coatings from outdoor weather conditions such as rain, snow and UV radiation from Sunlight. FIGS. 58A and 58B describes the preferred method of producing Class A fire-protected carbon quantized OSB sheathing in an automated lumber factory.

In the illustrative embodiment, CFIC biochemical liquid 66H of the present invention shown in FIGS. 6 through 6V4, is used to form the CFIC surface coatings 63A, 63B and 63C over the surfaces of the OSB product (e.g. sheet) 66. The clinging agent in the CFIC liquid 66H enables its chemical molecules to cling to the surface of the CFIC-coated OSB product, while its surfactants help to break the surface tension and allow chemical molecules to impregnate ever so slightly the surface of the treated wood. The CFIC paint coating 63A can be formulated by adding the biochemical liquid, 25-30% by volume, to a water-based paint containing liquid polymer binder.

In the illustrative embodiment, the moisture/fire/UV protection liquid 68A comprises a formulation comprising: 99% by volume, the biochemical liquid composition of the present invention; and ceramic microsphere dust, 1.0-0.75 [cups/gallon] (e.g. ThermaCels™ insulating ceramic microsphere dust by Hy-Tech Thermal Solutions, LLC, of Melbourne, FL).

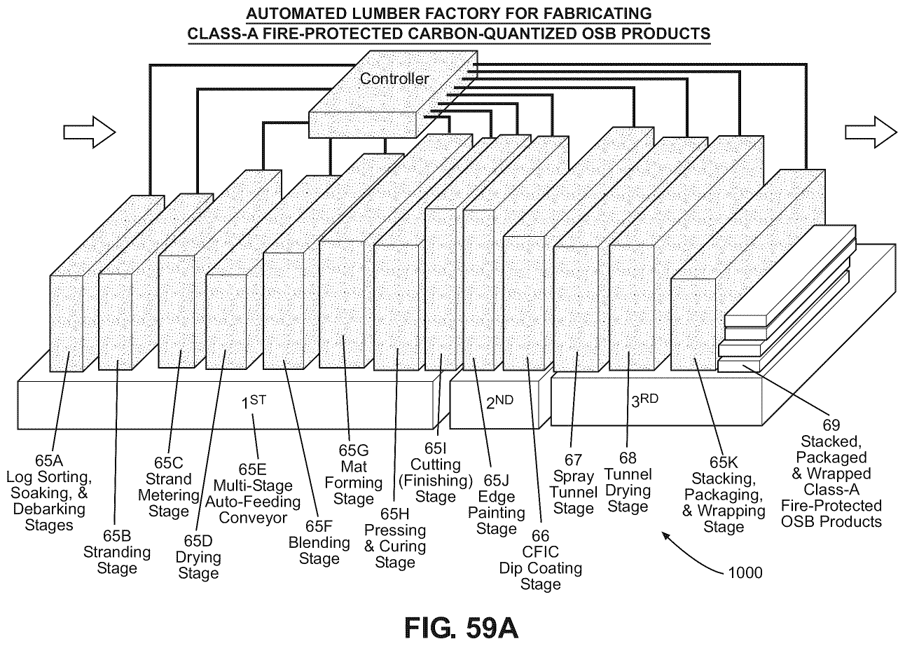

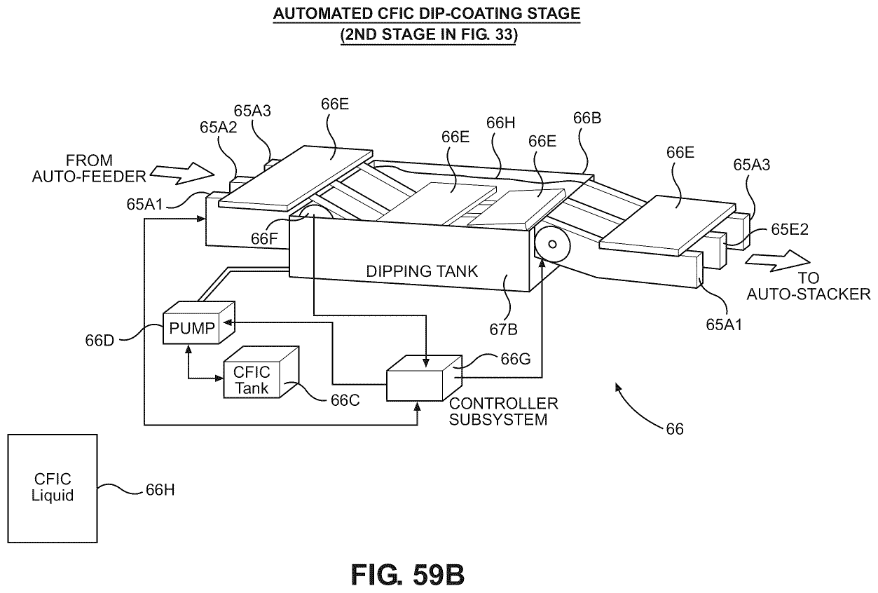

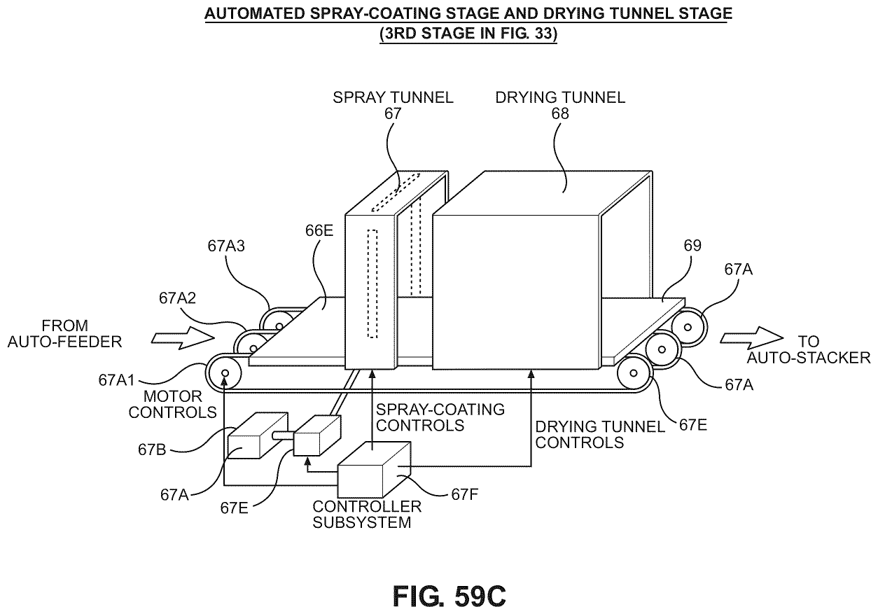

FIG. 59A shows an automated factory system 1000 for producing Class-A fire-protected laminated OSB products in a high-volume manner in accordance with the principles of the present invention. As shown in FIG. 59A, the factory 1000 comprises several automated stages integrated together under automation and control, namely: a conveyor-chain mechanism 65E having numerous primary stages in the illustrative embodiment shown in the process of FIGS. 58A, 58B and 58C.

As shown in FIG. 59A, the OSB production line comprises an arrangement of stages for high-volume automated production of OSB products. Such systems comprise: presses & curing machines; automation and controllers. Such technologies and machines can be used to implement many of the stages described above in the OSB product production line of the present invention. Suzhou CMT Engineering Company Limited offers complete turnkey OSB production lines.

As shown in FIG. 59B, the dip-coating stage 66 comprises a chain-driven conveyor subsystem 65E, supporting several parallel sets of chain-driven transport rails 65E1, 65E2 and 65E3 as shown, extending from the pressing and curing stage 65H towards a dipping tank 54B, and then running inside and along the bottom of the dipping tank 66B, and then running out thereof towards the stacking, packing, and wrapping stage 65K, as shown. In the illustrative embodiment, the dipping tank 66B has a width dimension to accommodate the width of the OSB product 66E being transported on chain-driven conveyor rails 65E1, 65E2 and 65E3 mounted and running outside of and within the dipping tank 66B, as shown, and allowing sufficient dwell time in the CFIC liquid 66H during the dip-coating process. As shown, the OSB products are supported upon the chain driven rails 65E1, 65E2 and 65E3 while the OSB products 66E are transported through the dipping tank 66B while fully immersed and submerged at least 6 inches deep in CFIC liquid 66H contained in the dipping tank 66B, moving at the linear rate of 300 feet/minute through the dipping tank 66B during the CFIC dip-coating process of the present invention. Electrically-powered driven motors are provided for the purpose of driving the chain-driven conveyors under computer control to transport OSB products 66E from stage to stage along the production line. A level sensor 66F is used for sensing the level of CFIC liquid 66H (i.e. biochemical liquid composition of the present invention—illustrated FIGS. 6A1-6C2, and more generally FIGS. 6 through 6V4) in the dipping tank at any moment in time during production line operation. A reservoir tank 66C is provided for containing a large volume or supply of CFIC liquid 66H. Also, a computer controller 66G is used for controlling the conveyor subsystem, and an electric pump 66D is provided for pumping CFIC liquid 66H into the dipping tank 66B to maintain a constant supply level thereof during system operation in response to the liquid level measured by the level sensor 66F and controlled by the controller 66G.

The high-speed dip-coating stage 66 may also include additional apparatus including, for example, liquid heaters, circulation pumps and controls for (i) maintaining the temperature of CFIC liquid solution in the dipping tank 66B, and (ii) controlling the circulation of CFIC liquid around submerged OSB product 66E being transported through the dipping tank in a submerged manner during the CFIC dip-coating process. Controlling such dip coating parameters may be used to control the amount and degree of absorption of CFIC liquid within the surface fibers of the OSB product 66E as it is rapidly transported through the dipping tank 66B between the cross-cutting and rip-sawing stage 65I and the lumber packaging and wrapping stage 65K of the production line. Notably, the dip coating process allows for the rapid formation a surface coating, or surface barrier, on the surface of each piece of dipped OSB product, or in the presence of a surfactant added to the CFIC liquid in the dipping tank 66B, shallow impregnation of CFIC liquid 66H to occur into the surface fibers of each OSB sheet 66E near atmospheric pressure (i.e. below 6 inches of liquid CFIC in the dipping tank) during the dip-coated process. It is understood that drip pans may also be provided beyond the dipping tank 66B, installed beneath the chain-driven conveyor subsystem arranged between the dripping tank 66B and the packaging and wrapping stage 65K to recover excess CFIC liquid dripping from the dip-coated lumber pieces and returning this recovered CFIC liquid to the dipping tank after appropriate filtering of the CFIC liquid if and as necessary. In illustrative embodiments, the dip coating stage 66 can be replaced with a spray-coating stage for forming alkali metal salt crystalline coating on lumber by the spraying operations, to provide proactive fire defense and protection.

As shown in FIG. 59B, the moisture, fire and UV protection is provided using the spray tunnel stage 67 deployed immediately after the CFIC-liquid dip-coating stage 66. As shown, the spray tunnel stage 67 comprises: a storage tank 67A for storing a large supply of moisture/fire/UV-protective liquid chemical 67B; a spray tunnel 67C for supporting an array of spray nozzles 67D arranged about the conveyor rails 67A1, 67A2 and 67A3, operably connected to a liquid pump 67E connected to the storage tank 67A under controller 67F, to provide a 360 degrees of spray coverage in the tunnel 67, for spray-coating dip-coated OSB sheets 66E within a controlled plane of moisture/fire/UV-protection liquid 67B sprayed to cover 100% of surfaces of such OSB sheets 66E as they are being transported through the spray tunnel 67 at high-speed; and a drying tunnel stage 56 installed after the spray tunnel stage 67, for quick drying of spray-coated Class-A fire-protected OSB sheet 66E, as they move through the drying tunnel 68 towards the automated stacking, packaging and wrapping stage 65K, under the control of the subsystem controller 58. In the preferred embodiment, the moisture/fire/UV protection liquid 67B sprayed in the spray tunnel 67 is formulated as follows: 99% by volume, the biochemical liquid of the present invention; and 0.75 [cups/gallon] of Hy-Tech ceramic microsphere dust, as an additive.

As illustrated in FIG. 59A, the automated stacking, packaging and wrapping stage 65K includes equipment designed to receive Class-A fire-protected OSB sheets 66E, automatically stacking the fire-protected OSB sheets, packaging and wrapping the sheets with wrapping material (e.g. plastic, TVEK or other wrapping material) that covers the top portion and at least half way down each side of the stacked OSB sheets, and then banding or strapping the wrapped package with fiberglass or steel banding, well known in the art. The wrapping will typically be preprinted with trademarks and logos of the lumber manufacturer's brand. Finally, the ends of the OSB lumber sheets 69 in the strapped, wrapped lumber package 69 are painted with a fire-protective paint also containing CFIC liquid material (e.g. 25% by volume, fire inhibiting biochemical liquid composition of the present invention) to be effective in achieving Class-A fire-protection.

FIGS. 58A, 58B and 58C describe the high-level steps of the process carried out when producing Class-A fire-protected OSB sheathing 69 in the automated factory 1000 shown in FIGS. 44A, 44B and 45, in accordance with the method and principles of the present invention.

Provided with this innovative two-coating system of UV/moisture/fire-protection, in the presence of a flame, the chemical molecules in both the moisture/fire/UV-protective coating 64 and CFIC-coatings (e.g. potassium citrate crystalline structures) 63A, 63B capture the free radicals (H+, OH—, O) produced during a fire, and break the fire's chemical reaction and extinguish its flame. This is a primary fire suppression mechanism deployed or rather implemented by the CFIC-coatings deposited on wood surfaces in accordance with the various principles of invention, disclosed and taught herein.

As indicated at Block A in FIG. 58A, in an automated factory 1000 configured for automated production of Class-A fire-protected OSB sheeting, an edge painting stage 65J, an CFIC liquid dip coating stage 67, a spray tunnel stage 67, and a drying tunnel stage 68 are installed between the finishing stage 65I and automated packaging and wrapping stage 65K along the lumber production line.

As indicated at Block B in FIG. 58A, logs are sorted, soaked, and debarked at stage 65A to prepare for the logs for the stranding stage 65B.

As indicated at Block C in FIG. 58A, the debarked logs are processed at the stranding stage 65B to produce strands of wood having specific length, width, and thickness.

As indicated at Block D in FIG. 58A, at the strand metering stage 65C, the strands are collected in large storage binds that allow for precise metering into the dryers.

As indicated at Block E in FIG. 58A, the strands are dried at the drying stage 65D to a target moisture content and screening them to remove small particles for recycling.

As indicated at Block F in FIG. 58B, the strands are coated with resin and wax at the blending 65F to enhance the finished panel's resistance to moisture and water absorption.

As indicated at Block G in FIG. 58B, cross-directional layers of strands are formed into strand-based mats at the mat forming stage 65G.

As indicated at Block H in FIG. 58B, the mats are heated and pressed at the pressing and curing stage 65H to consolidate the strands and cure the resins and form a rigid dense structural oriented strand board (OSB) panel.

As indicated at Block I in FIG. 58B, at the finishing stage 65I, the structural OSB panel is trimmed and cut to size, and groove joints machined, and edge sealants applied for moisture resistance.

As indicated at Block J in FIG. 58B, Class-A fire-protective paint (containing CFIC liquid, 25% by volume) is applied to the edges of the trimmed and cut OSB panels, at the edge painting stage 65J.

As indicated at Block K in FIG. 58B, OSB panels are transported and submerged through the dipping tank 66B of the dip coating stage 66 for sufficient coating in CFIC liquid 66H, while being transported on the conveyor-chain transport mechanism 65E.

As indicated at Block L in FIG. 58B, the wet dip-coated OSB panels are removed from the dipping tank 66B, and wet stacked and set aside for about 24 hours or so, to allow the wet CFIC liquid coating on the dipped OSB panels 66E to penetrate the panels 69 as the coating dries.

As indicated at Block M in FIG. 58C, a stack of air-dried dip-coated OSB panels 66E is loaded to the auto-feeder of the second stage of the production line, shown in FIG. 33B.

As indicated at Block N in FIG. 58C, the dip-coated OSB panels 66E are spray-coated with a moisture, fire and UV protection coating 64 that supports weather during building construction, to produce Class-A fire-protected OSB panels 69.

As indicated at Block O in FIG. 58C, spray-coated dipped OSB sheets 69 are transported through a drying tunnel at stage 68.

As indicated at Block P in FIG. 58C, dried spray-coated/dipped OSB panels 69 are stacked, packaged, and wrapped into a bundle of Class-A fire-protected OSB panels at the stacking, packaging, and wrapping stage 65K.

As shown and described above, the lumber factory 1000 is configured for producing Class-A fire-protected OSB sheathing 69 fabricated in accordance with the principles of the present invention.

Best Practices on when to Spray and Respray the Fire Inhibiting Biochemical Compositions of the Present Invention on Dry Native Vegetation, Decks, Fences, Patio Covers and Vertical Framing for Best Early Fire Elimination Results

Below are some best practices on when to spray and respray the fire inhibiting biochemical compositions of the present invention on dry native vegetation, decks, fences, patio covers and vertical framing, to get the best early fire elimination results.

When vegetation is bright green, it will not support easy ember ignition and fire advance the way it will when vegetation starts to dry out and turn brown and gold in color. When proactively spraying the biochemical compositions of the present invention, its best to spray using spray equipment during dry conditions when lumber and vegetation are bone dry. Also, after wood or dry vegetation has been sprayed with the biochemical compositions, one needs to consider any reduction in early proactive fire defense that may have resulted to sprayed fire-protective salt crystalline structure coatings that may have been exposed to heavy water sprays from rain, garden sprinklers and/or a hose. After any type of heavy watering or rain to treated surfaces, it is advised to respray to surfaces to be re-protected and ensure that the best proactive fire defense has been provided to such combustible surfaces. When property owners or contractors are proactive spraying the biochemical compositions for wildfire defense, best results can be obtained using the GPS-tracking back-pack atomizing spray cannon system shown in FIGS. 13A through 13C. When spraying framing lumber on a construction site or elsewhere, the best results can be achieved using an airless paint sprayer provided with a #25 tip. In both applications, for best results, vegetation and lumber should be dry, with less than 19% moisture content.

Modifications to the Present Invention which Readily Come to Mind

While the preferred embodiments of the environmentally-clean fire inhibiting biochemical liquid solutions of the present invention are shown and described as being formulated using a single alkali metal salt derived from a non-polymeric saturated carboxylic acid having carbon chain length less than eight (8) to meet practical solubility requirements, it is understood that two or more alkali metal salts derived from different non-polymeric saturated carboxylic acids may be combined together and dissolved in aqueous solution, along with a suitable ester-based coalescing agent, to produce additional embodiments of the water-based biochemical solutions of the present invention that can perform with acceptable fire inhibiting/extinguishing functions, in accordance with the principles of the present invention. Such modifications fall within the scope and spirit of the present invention.

The illustrative embodiments disclose the formulation, application and use of environmentally-clean fire inhibiting (i.e. anti-fire/AF) biochemical solutions and compositions of matter. Such biochemical solutions and compositions, and methods and apparatus for dispensing and applying the same, are disclosed and taught herein for use in proactively coating the combustible surfaces such as existing on wood, lumber, and timber, and other combustible matter, wherever fire may exist or wherever wild fires may travel. However, it is understood that alternative clean fire inhibiting biochemical liquids may be used to practice the various wild fire suppression methods according to the principles of the present invention, including fire extinguishing methods required when fire outbreaks without time for proactive defense to have been timely applied.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1. An environmentally-clean liquid fire inhibiting composition for spray application on combustible surfaces and air-drying to the ambient atmosphere, comprising:
a water functioning as a solvent, dispersant and carrier;
at least one alkali metal salt dissolved in the water, functioning as a fire inhibiting agent, and derived from a non-polymerized saturated carboxylic acid characterized by having carbon chain length of less than eight carbon atoms (C1-C7), wherein the alkali metal contained in said alkali metal salt is selected from the group consisting of potassium, calcium, sodium and/or magnesium; and
a dispersing and coalescing agent, dissolved in the water to result in an aqueous solution having a low viscosity, and derived from said saturated non-polymerized carboxylic acid and/or another saturated non-polymerized carboxylic acid, and functioning to promote (i) the dispersing and coalescing properties of alkali metal ions present in the resulting aqueous solution when applied to combustible surfaces, and (ii) the formation of thin alkali metal salt crystalline structures and coatings on the combustible surfaces upon evaporation of water molecules from the applied aqueous solution;
wherein the thin alkali metal salt crystalline coatings formed on the combustible surfaces contain alkali metal ions that inhibit fire ignition, flame spread and production of smoke.

2. The environmentally-clean liquid fire inhibiting composition of claim 1,
wherein the water is present in a major amount having a weight percent of about 60.00% to about 90.00% relative to the total weight of the liquid fire inhibiting biochemical composition;
wherein said at least one alkali metal salt is present in a major amount having a weight percent of about 10.00% to about 40.00% relative to the total weight of the liquid fire inhibiting composition;
wherein said dispersing and coalescing agent is present in a minor amount having a weight percent of about 0.50% to about 5.00% relative to the total weight of the liquid fire inhibiting composition;
wherein the sum of the weight percent of the chemical components in the liquid fire inhibiting composition does not exceed 100% by weight.

3. The environmentally-clean liquid fire inhibiting composition of claim 1, wherein said at least one alkali metal salt is derived from the non-polymeric saturated carboxylic acid (R—COOH) selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid; malic acid; malonic acid; caproic acid; adipic (hexanedioic) acid; citric acid; and benzoic acid.

4. The environmentally-clean liquid fire inhibiting composition of claim 3, wherein said low viscosity of said aqueous solution is in the range of at about 5.0 [mPas] and preferably not more than 50 [mPas] (or 50 centipois) [cps]) for most applications, when used in diverse temperature environments ranging from as low as 32 F to as high as 130 F, so as to facilitate spray-atomization methods using said aqueous-based solution and form said thin alkali metal salt crystalline structures and coatings on the combustible surfaces upon evaporation of water molecules from the applied aqueous solution, wherein said thin alkali metal salt crystalline coatings formed on the combustible surfaces contain alkali metal ions that inhibit fire ignition, flame spread and production of smoke.

5. The environmentally-clean liquid fire inhibiting composition of claim 2, wherein said at least one alkali metal salt is derived from the C1 carboxylic acid (R—COOH), called formic acid (i.e. methanoic acid), and selected from the group consisting of: potassium formate; calcium formate; sodium formate; and magnesium formate.

6. The environmentally-clean liquid fire inhibiting composition of claim 2, wherein said at least one alkali metal salt is derived from the C1 carboxylic acid (R—COOH), carbonic acid (i.e. hydroxymethanoic acid), and selected from the group consisting of: potassium carbonate; sodium bicarbonate; and magnesium carbonate.

7. The environmentally-clean liquid fire inhibiting composition of claim 2, wherein said at least one alkali metal salt is derived from the C2 carboxylic acid (R—COOH), called acetic acid (ethanoic acid), and selected from the group consisting of: potassium acetate; calcium acetate; sodium acetate; and magnesium acetate.

8. The environmentally-clean liquid fire inhibiting composition of claim 2, wherein said at least one alkali metal salt is derived from the C2 carboxylic acid (R—COOH), called glycolic acid (hydroxyacetic acid), and are selected from the group consisting of: potassium glycolate; calcium glycolate; and sodium glycolate.

9. The environmentally-clean liquid fire inhibiting composition of claim 2, wherein said at least one alkali metal salt is derived from the C2 carboxylic acid (R—COOH), called glyoxylic acid C₂H₂O₃, and are selected from the group consisting of: potassium glyoxylate; calcium glyoxylate; and sodium glyoxylate (monohydrate).

10. The environmentally-clean liquid fire inhibiting composition of claim 2, wherein said at least one alkali metal salt is derived from the C2 carboxylic acid (R—COOH), called oxalic acid, and are selected from the group consisting of: potassium oxalate; calcium oxalate; and sodium oxalate.

11. The environmentally-clean liquid fire inhibiting composition of claim 2, wherein said at least one alkali metal salt is derived from the C3 carboxylic acid (R—COOH), called propionic acid, and are selected from the group consisting of: potassium propionate; calcium propionate; sodium propionate; and magnesium propionate.

12. The environmentally-clean liquid fire inhibiting composition of claim 2, wherein said at least one alkali metal salt is derived from the C3 carboxylic acid (R—COOH), called lactic acid, specifically, and are selected from the group consisting of: potassium lactate; calcium lactate; sodium lactate; and magnesium lactate.

13. The environmentally-clean liquid fire inhibiting composition of claim 2, wherein said at least one alkali metal salt is derived from the C3 carboxylic acid (R—COOH), called glyceric acid, and are selected from the group consisting of: potassium glycerate; calcium glycerate; and sodium glycerate.

14. The environmentally-clean liquid fire inhibiting composition of claim 2, wherein said at least one alkali metal salt is derived from the C3 carboxylic acid (R—COOH), called pyruvic acid, and are selected from the group consisting of: potassium pyruvate; calcium pyruvate; sodium pyruvate; and magnesium pyruvate.

15. The environmentally-clean liquid fire inhibiting composition of claim 2, wherein said at least one alkali metal salt is derived from alkali metal salts produced from the C3 carboxylic acid (R—COOH), called tartaric acid C₃H₄₅, and are selected from the group consisting of: potassium tartrate (potassium bitartrate); calcium tartrate; sodium tartrate; and magnesium tartrate.

16. The environmentally-clean liquid fire inhibiting composition of claim 2, wherein said at least one alkali metal salt is derived from the C4 carboxylic acid (R—COOH), called butyric acid CH3(CH2)2COOH, and are selected from the group consisting of: potassium butyrate (or butanoate); calcium butyrate; sodium butyrate; and magnesium butyrate.

17. The environmentally-clean liquid fire inhibiting composition of claim 2, wherein said at least one alkali metal salt is derived from the C4 carboxylic acid (R—COOH), called malic acid, and are selected from the group consisting of: potassium malate; calcium malate; sodium malate; and magnesium malate.

18. The environmentally-clean liquid fire inhibiting composition of claim 2, wherein said at least one alkali metal salt is derived from the C4 carboxylic acid (R—COOH), called malonic acid, and are selected from the group consisting of: potassium malonate; calcium malonate; sodium malonate; and di-magnesium malonate.

19. The environmentally-clean liquid fire inhibiting composition of claim 2, wherein said at least one alkali metal salt is derived from the C5 carboxylic acid (R—COOH), called pivalic acid, and are selected from the group consisting of: potassium pivalate; calcium pivalate; sodium pivalate; and magnesium pivalate.

20. The environmentally-clean liquid fire inhibiting composition of claim 2, wherein said at least one alkali metal salt is derived from the C6 carboxylic acid (R—COOH), called caproic acid, and are selected from the group consisting of: potassium caproate (hexanoate); calcium caproate; sodium caproate; and magnesium caproate.

21. The environmentally-clean liquid fire inhibiting composition of claim 2, wherein said at least one alkali metal salt is derived from the C6 carboxylic acid (R—COOH), called adipic (hexanedioic) acid, and are selected from the group consisting of: potassium adipate; calcium adipate; sodium adipate; and magnesium adipate.

22. The environmentally-clean liquid fire inhibiting composition of claim 2, wherein said at least one alkali metal salt is derived from the C6 carboxylic acid (R—COOH), called citric acid, and are selected from the group consisting of: (tri)potassium citrate; calcium citrate; sodium citrate; and magnesium citrate.

23. The environmentally-clean liquid fire inhibiting solution of claim 2, wherein said at least one alkali metal salt is derived from the C6 carboxylic acid (R—COOH), called d-gluconic acid, and are selected from the group consisting of: potassium gluconate; calcium gluconate; sodium gluconate; and magnesium gluconate.

24. The environmentally-clean liquid fire inhibiting composition of claim 2, wherein said at least one alkali metal salt is derived from the C7 carboxylic acid (R—COOH), benzoic acid, and are selected from the group consisting of: potassium benzoate; calcium benzoate; sodium benzoate; and magnesium benzoate.

25. The environmentally-clean liquid fire inhibiting composition of claim 1, wherein said at least one alkali metal salt, derived from said nonpolymeric saturated carboxylic acid, is selected from the group consisting of:
(i) Alkali metal salts produced from the C1 carboxylic acid (R—COOH) called formic acid (i.e. methanoic acid), specifically: potassium formate; calcium formate; sodium formate; and magnesium formate;
(ii) Alkali metal salts produced from the C1 carboxylic acid (R—COOH) called carbonic acid (i.e. hydroxymethanoic acid); specifically: potassium carbonate; sodium bicarbonate; magnesium carbonate;
(iii) Alkali metal salts produced from the C2 carboxylic acid (R—COOH) called acetic acid (ethanoic acid), specifically: potassium acetate; calcium acetate; sodium acetate; and magnesium acetate;
(iv) Alkali metal salts produced from the C2 carboxylic acid (R—COOH) called glycolic acid (hydroxyacetic acid); specifically: potassium glycolate; calcium glycolate; and sodium glycolate;
(v) Alkali metal salts produced from the C2 carboxylic acid (R—COOH) called glyoxylic acid, specifically: potassium glyoxylate; calcium glyoxylate; sodium glyoxylate (monohydrate);
(vi) Alkali metal salts produced from the C3 carboxylic acid (R—COOH) called propionic acid, specifically: potassium propionate; calcium propionate; sodium propionate; and magnesium propionate;
(vii) Alkali metal salts produced from the C3 carboxylic acid (R—COOH) called lactic acid, specifically: potassium lactate; calcium lactate; sodium lactate; and magnesium lactate;
(viii) Alkali metal salts produced from the C3 carboxylic acid (R—COOH) called glyceric acid, specifically: potassium glycerate; calcium glycerate; and sodium glycerate;
(ix) Alkali metal salts produced from the C3 carboxylic acid (R—COOH), pyruvic acid, specifically: potassium pyruvate; calcium pyruvate; sodium pyruvate; and magnesium pyruvate;
(x) Alkali metal salts produced from the C3 carboxylic acid (R—COOH) called, tartaric acid C₃H₄₅, specifically: potassium tartrate (potassium bitartrate); calcium tartrate; sodium tartrate; and magnesium tartrate;
(xi) Alkali metal salts produced from the carboxylic acid (R—COOH) called butyric acid, specifically: potassium butyrate (or butanoate); calcium butyrate; sodium butyrate C4H₇NaO₂; and magnesium butyrate;
(xii) Alkali metal salts produced from the C4 carboxylic acid (R—COOH) called malic acid specifically: potassium malate; calcium malate; sodium malate; and magnesium malate;
(xiii) Alkali metal salts produced from the C4 carboxylic acid (R—COOH) called malonic acid, specifically: potassium malonate; calcium malonate; sodium malonate; and di-magnesium malonate;
(xiv) Alkali metal salts produced from the C5 carboxylic acid (R—COOH) called pivalic acid, specifically: potassium pivalate; calcium pivalate; sodium pivalate; and magnesium pivalate;
(xv) Alkali metal salts produced from the C6 carboxylic acid (R—COOH) called caproic acid, specifically: potassium caproate (hexanoate); calcium caproate; sodium caproate; and magnesium caproate;
(xvi) Alkali metal salts produced from the C6 carboxylic acid (R—COOH) called adipic (hexanedioic) acid, specifically: potassium adipate; calcium adipate; sodium adipate; and magnesium adipate;
(xvii) Alkali metal salts produced from the C6 carboxylic acid (R—COOH) called citric acid, specifically: (tri)potassium citrate; calcium citrate; sodium citrate; and magnesium citrate;
(xviii) Alkali metal salts produced from the C6 carboxylic acid (R—COOH) called d-gluconic acid, specifically: potassium gluconate; calcium gluconate; sodium gluconate; and magnesium gluconate; and
(xix) Alkali metal salts produced from the C7 carboxylic acid (R—COOH) called benzoic acid, specifically: potassium benzoate; calcium benzoate; sodium benzoate; and magnesium benzoate.

26. An environmentally-clean liquid fire inhibiting composition for spray application on combustible surfaces and air-drying to the ambient atmosphere, comprising:
an aqueous mixture of an amount of alkali metal salt derived from a non-polymerized saturated carboxylic acid characterized by having less than 8 carbon atoms, and dissolved in an amount of water along with an amount of dispersing and coalescing agent, realized as an ester of a non-polymerized saturated carboxylic acid, so as to provide a liquid fire inhibiting solution that can be sprayed on combustible surfaces to form thin alkali metal salt crystalline coatings on the combustible surfaces when and as water molecules in the liquid fire inhibiting solution evaporate to the environment during drying operations, to inhibit fire ignition, flame spread and smoke development;
wherein said alkali metal salt is selected from the group consisting of:
(i) Alkali metal salts produced from the C1 carboxylic acid (R—COOH) called formic acid (i.e. methanoic acid), including potassium formate, calcium formate, sodium formate, and magnesium formate;
(ii) Alkali metal salts produced from the C1 carboxylic acid (R—COOH) called carbonic acid (i.e. hydroxymethanoic acid); including potassium carbonate, sodium bicarbonate, and magnesium carbonate;
(iii) Alkali metal salts produced from the C2 carboxylic acid (R—COOH) called acetic acid (ethanoic acid), including potassium acetate, calcium acetate, sodium acetate, and magnesium acetate;
(iv) Alkali metal salts produced from the C2 carboxylic acid (R—COOH) called glycolic acid (hydroxyacetic acid); including potassium glycolate, calcium glycolate, and sodium glycolate;
(v) Alkali metal salts produced from the C2 carboxylic acid (R—COOH) called glyoxylic acid, specifically: including potassium glyoxylate, calcium glyoxylate, sodium glyoxylate (monohydrate);
(vi) Alkali metal salts produced from the C3 carboxylic acid (R—COOH) called propionic acid, including potassium propionate, calcium propionate, sodium propionate, and magnesium propionate;
(vii) Alkali metal salts produced from the C3 carboxylic acid (R—COOH) called lactic acid, including potassium lactate, calcium lactate, sodium lactate, and magnesium lactate;
(viii) Alkali metal salts produced from the C3 carboxylic acid (R—COOH) called glyceric acid, including potassium glycerate, calcium glycerate, and sodium glycerate;
(ix) Alkali metal salts produced from the C3 carboxylic acid (R—COOH), pyruvic acid, specifically: including potassium pyruvate, calcium pyruvate, sodium pyruvate, and magnesium pyruvate;
(x) Alkali metal salts produced from the C3 carboxylic acid (R—COOH) called, tartaric acid C3H45, including potassium tartrate (potassium bitartrate), calcium tartrate, sodium tartrate, and magnesium tartrate;
(xi) Alkali metal salts produced from the carboxylic acid (R—COOH) called butyric acid, specifically: potassium butyrate (or butanoate); calcium butyrate; sodium butyrate C₄H₇NaO₂; and magnesium butyrate;
(xii) Alkali metal salts produced from the C4 carboxylic acid (R—COOH) called malic acid including potassium malate, calcium malate, sodium malate, and magnesium malate;
(xiii) Alkali metal salts produced from the C4 carboxylic acid (R—COOH) called malonic acid, including potassium malonate, calcium malonate, sodium malonate, and di-magnesium malonate;
(xiv) Alkali metal salts produced from the C5 carboxylic acid (R—COOH) called pivalic acid, including potassium pivalate, calcium pivalate, sodium pivalate, and magnesium pivalate;
(xv) Alkali metal salts produced from the C6 carboxylic acid (R—COOH) called caproic acid, including potassium caproate (hexanoate), calcium caproate, sodium caproate, and magnesium caproate;
(xvi) Alkali metal salts produced from the C6 carboxylic acid (R—COOH) called adipic (hexanedioic) acid, including potassium adipate, calcium adipate, sodium adipate, and magnesium adipate;
(xvii) Alkali metal salts produced from the C6 carboxylic acid (R—COOH) called citric acid, including (tri)potassium citrate, calcium citrate, sodium citrate, and magnesium citrate;
(xviii) Alkali metal salts produced from the C6 carboxylic acid (R—COOH) called d-gluconic acid, including, potassium gluconate, calcium gluconate, sodium gluconate, and magnesium gluconate; and
(xix) Alkali metal salts produced from the C7 carboxylic acid (R—COOH) called benzoic acid, including potassium benzoate, calcium benzoate, sodium benzoate, and magnesium benzoate.

27. An environmentally-clean aqueous-based fire inhibiting biochemical solution comprising:
water, functioning as a solvent, carrier and dispersant, present in a major amount having a weight percent of about 60.00% to about 90.00% relative to the to the total weight of the aqueous-based fire inhibiting biochemical composition;
at least one alkali metal salt derived from a nonpolymeric saturated carboxylic acid wherein the carbon chain length of the carboxylic acid is less than eight (C1-C7), and
wherein the alkali metal salt is selected from the group consisting of potassium, calcium, sodium and/or magnesium, functioning as a fire inhibitor, and present in a major amount having a weight percent of about 10.00% to about 40.00% relative to the total weight of the aqueous-based fire inhibiting biochemical composition; and
an ester of a saturated non-polymerized carboxylic acid having less than eight carbon atoms (C=8), functioning as a dispersant/coalescent, and present in a minor amount having a weight percent of about 0.50% to about 5.00% relative to the total weight of the aqueous-based fire inhibiting biochemical composition;
wherein the sum of the weight percent of the chemical components above does not exceed 100% by weight;
wherein the resulting aqueous-based fire inhibiting biochemical composition is stable when mixed so that its chemical components do not precipitate in the aqueous solution when stored in a storage container, making the aqueous solution ready for use in diverse temperature environments ranging from as low as 32 F to as high as 130 F.

28a. The environmentally-clean aqueous-based fire inhibiting biochemical solution of claim 27, wherein said at least one alkali metal salt derived from said nonpolymeric saturated carboxylic acid is selected from the group consisting of:
(i) Alkali metal salts produced from the C1 carboxylic acid (R—COOH) called formic acid (i.e. methanoic acid), including potassium formate, calcium formate, sodium formate, and magnesium formate;
(ii) Alkali metal salts produced from the C1 carboxylic acid (R—COOH) called carbonic acid (i.e. hydroxymethanoic acid); including potassium carbonate, sodium bicarbonate, and magnesium carbonate;
(iii) Alkali metal salts produced from the C2 carboxylic acid (R—COOH) called acetic acid (ethanoic acid), including potassium acetate, calcium acetate, sodium acetate, and magnesium acetate;
(iv) Alkali metal salts produced from the C2 carboxylic acid (R—COOH) called glycolic acid (hydroxyacetic acid); including potassium glycolate, calcium glycolate, and sodium glycolate;
(v) Alkali metal salts produced from the C2 carboxylic acid (R—COOH) called glyoxylic acid, specifically: including potassium glyoxylate, calcium glyoxylate, sodium glyoxylate (monohydrate);
(vi) Alkali metal salts produced from the C3 carboxylic acid (R—COOH) called propionic acid, including potassium propionate, calcium propionate, sodium propionate, and magnesium propionate;
(vii) Alkali metal salts produced from the C3 carboxylic acid (R—COOH) called lactic acid, including potassium lactate, calcium lactate, sodium lactate, and magnesium lactate;
(viii) Alkali metal salts produced from the C3 carboxylic acid (R—COOH) called glyceric acid, including potassium glycerate, calcium glycerate, and sodium glycerate;
(ix) Alkali metal salts produced from the C3 carboxylic acid (R—COOH), pyruvic acid, specifically: including potassium pyruvate, calcium pyruvate, sodium pyruvate, and magnesium pyruvate;
(x) Alkali metal salts produced from the C3 carboxylic acid (R—COOH) called, tartaric acid C3H45, including potassium tartrate (potassium bitartrate), calcium tartrate, sodium tartrate, and magnesium tartrate;
(xi) Alkali metal salts produced from the carboxylic acid (R—COOH) called butyric acid, specifically: potassium butyrate (or butanoate); calcium butyrate; sodium butyrate C₄H₇NaO₂; and magnesium butyrate;
(xii) Alkali metal salts produced from the C4 carboxylic acid (R—COOH) called malic acid including potassium malate, calcium malate, sodium malate, and magnesium malate;
(xiii) Alkali metal salts produced from the C4 carboxylic acid (R—COOH) called malonic acid, including potassium malonate, calcium malonate, sodium malonate, and di-magnesium malonate;
(xiv) Alkali metal salts produced from the C5 carboxylic acid (R—COOH) called pivalic acid, including potassium pivalate, calcium pivalate, sodium pivalate, and magnesium pivalate;
(xv) Alkali metal salts produced from the C6 carboxylic acid (R—COOH) called caproic acid, including potassium caproate (hexanoate), calcium caproate, sodium caproate, and magnesium caproate;
(xvi) Alkali metal salts produced from the C6 carboxylic acid (R—COOH) called adipic (hexanedioic) acid, including potassium adipate, calcium adipate, sodium adipate, and magnesium adipate;
(xvii) Alkali metal salts produced from the C6 carboxylic acid (R—COOH) called citric acid, including (tri)potassium citrate, calcium citrate, sodium citrate, and magnesium citrate;
(xviii) Alkali metal salts produced from the C6 carboxylic acid (R—COOH) called d-gluconic acid, including, potassium gluconate, calcium gluconate, sodium gluconate, and magnesium gluconate; and
(xix) Alkali metal salts produced from the C7 carboxylic acid (R—COOH) called benzoic acid, including potassium benzoate, calcium benzoate, sodium benzoate, and magnesium benzoate.

28b-58. (canceled)
